(19) United States
(12) Patent Application Publication
(10) Pub. No.: US 2024/0296512 A1
(43) Pub. Date: Sep. 5, 2024

(54) AIRCRAFT, SATELLITE, SPACECRAFT, TECHNOLOGY, INFRASTRUCTURE, AND RESOURCE INVESTMENT MANAGEMENT SYSTEM, SERVER AND METHOD

(71) Applicant: O3 Worldwide, Inc., Huntington Beach, CA (US)

(72) Inventor: Tariq Syed Hasan, Huntington Beach, CA (US)

(21) Appl. No.: 18/374,720

(22) Filed: Sep. 29, 2023

Related U.S. Application Data
(63) Continuation of application No. 16/855,391, filed on Apr. 22, 2020, now abandoned.
(60) Provisional application No. 62/837,007, filed on Apr. 22, 2019.

(51) Int. Cl. G06Q 50/26; G06F 16/2455; G06Q 40/06

(52) U.S. Cl. CPC G06Q 50/26; G06F 16/24556; G06Q 40/06

(57) ABSTRACT

Some embodiments include a computer-implemented method that manages immigrant investor visas and/or investments in pursuit of immigrant investor visas including, but not limited to, the United States Citizenship and Immigration Service (“USCIS”) Employment-Based Fifth Preference Immigrant Investor Program (“EB-5 Program” or “EB-5”). In some embodiments, the system includes the ability to accept and process visa applications, accept and process expedited visa applications, authenticate investment source of funds, enable background check processing, enable national security related screening and processing, track visa processing, track legal compliance, track securities law compliance, track national security law compliance, suggest investments, track job creation, track investment performance, and/or monitor investments for fraud. In some embodiments, the system significantly increases the likelihood of obtaining an immigrant investor visa including, but not limited to, an EB-5 visa while mitigating risk associated with investment.

### CROSS-REFERENCE RELATED APPLICATIONS

This application is a Continuation application of U.S. patent application Ser. No. 16/855,391, filed Apr. 22, 2022, which claims the benefit of and priority to U.S. Provisional Application No. 62/837,007, filed Apr. 22, 2019, entitled “Aircraft, Satellite, Spacecraft, Technology, Infrastructure, and Resource Investment Management System, Server and Method”, the entire contents of which are incorporated herein by reference.

### BACKGROUND

Immigrant investor visa programs or citizenship-by-investment programs are programs designed to attract foreign capital and/or foreign nationals into a selected country by providing the right of residence and/or citizenship in the selected country as an incentive for investment.

The United States Citizenship and Immigration Service (“USCIS”) Employment-Based Fifth Preference Immigrant Investor Funding Program (“EB-5 Program” or “EB-5”) is the current immigrant investor program in the United States. The EB-5 Program was established by Congress in 1990 to stimulate the United States economy through job creation and capital investment by foreign investors and is administered by the USCIS within the United States Department of Homeland Security (“DHS”). The EB-5 Program establishes a path to permanent residency for up to 10,000 immigrants (and immediate family members) annually who invest in an existing or new business in the United States and create or preserve at least 10 U.S. jobs. To obtain an EB-5 visa, foreign investors must invest $1,800,000 (or at least $900,000 in a “Targeted Employment Area”, defined as an area with high unemployment and/or a rural area), and create or preserve at least 10 jobs for United States workers excluding the investor and their immediate family. The EB-5 investment amount has changed over the course of the EB-5 program and is subject to change in the future.

There is a need for a novel and transformational system to acquire up to or over $350 billion of commercial aircraft, commercial satellites and spacecraft, and finance and develop up to or over $5 trillion of infrastructure in the United States including, but not limited to, border security, transportation, 5G Space Internet and energy. The EB-5 Program establishes a path to permanent residency for immigrants (and immediate family members) who invest in an existing or new business in the United States and create or preserve at least 10 United States jobs. The State Department, in conjunction with the Department of Homeland Security, has the administrative authority to recapture unused EB-5 visas in the national interest, within the specific context of immigration law, supported by legal, legislative, regulatory and policy precedent, without the need for an act of Congress or Congressional approval. A system that includes EB-5 regional center application, business plan, and focus on financing and developing infrastructure in the national interest, provides the procedural basis for the United States Government to expedite the recapturing of unused EB-5 visas in the national interest.

A system enabling acquisition of commercial aircraft, commercial satellites and spacecraft will create or preserve, based on United States Government figures, up to or over 2,011,450 jobs in the United States, which is more than the 2,000,000 jobs required to recapture up to 200,000 EB-5 Visas. Additionally, infrastructure projects would be able to create or preserve up to or over 75,750,000 jobs in the United States, resulting in creating or preserving up to or over 77,761,450 jobs and up to or over 389 jobs per EB-5 Visa.

According to the United States Department of Commerce (“Department of Commerce”), the United States gains 5,747 domestic jobs for each $1 billion spent on the manufacturing of commercial aircraft, commercial satellites and spacecraft. A system enabling large-scale acquisition of commercial aircraft, commercial satellites and spacecraft would support the creation or preservation of up to or over 2,011,450 aerospace jobs in the United States providing the baseline jobs to recapture up to or over 200,000 unused EB-5 visas and, as a related matter, a structure to finance up to or over a $5 trillion investment in United States infrastructure and the creation of up to or over 75, 750,000 infrastructure jobs in the United States, resulting in creating or preserving up to or over 77,761,450 jobs and up to or over 389 jobs per EB-5 Visa. Further, the acquisition of commercial aircraft, commercial satellites and spacecraft would support sustainable national interest-centric infrastructure development and to provide uncommon financial and strategic benefit to the aerospace and multiple infrastructure sectors in the United States. Further, the ability to utilize a funded balance sheet and coordinate investments across multiple interrelated verticals would enable mitigation of low-equity returns and financing risk.

There is a need to create an immigrant investor program including, but not limited to, a EB-5 program that will benefit the federal government, the national economy, and immigrant investors including, but not limited to, EB-5 investors. Moreover, there is a need to structure and create an immigrant investor program including, but not limited to, a EB-5 program to help federal policymakers strengthen the utility of immigrant investor visas including, but not limited to, EB-5 and better accomplish the central goal of immigrant investors programs, which is to aid regional economic development, especially in distressed areas.

There is a need for an immigrant investors program including, but not limited to, a EB-5 program to reduce fraud and national security threats in the immigrant investors area including, but not limited to, in the EB-5 area with the objective to benefit investors, regional center administration, the federal government, and the national economy.

There is a need for a transformational and proprietary financing program, inclusive of EB-5 capital or EB-5 financing, that reduces United States government costs related to EB-5, improves services for EB-5 applicants, reduces burdens on employers, and combats waste, fraud, and abuse in the EB-5 area, while safeguarding interests of American workers. Such a program would increase consumer choice within the United States commercial aviation market; strengthen traditionally underfunded infrastructure and real estate assets on a national basis; create millions of land-side, air-side, manufacturing, construction and service jobs on a national basis; and improve the competitiveness of the United States in the global economy.

Referring to at least FIGS. 1-5, and 12-44, there are up to approximately 200,000 unused EB-5 Visas, from 1990-2020, that can potentially be recaptured in the national interest pursuant to United States law according to some embodiments. In some embodiments, at $1,800,000 per EB-5 Visa, the recapture of 200,000 unused EB-5 Visas can result in $360 billion of unlevered funding in the national interest; at $900,000 per EB-5 Visa, the recapture of 200,000 unused EB-5 Visas can result in $180 billion of unlevered funding in the national interest. The United States Department of State (“State Department”), in conjunction with the DHS, has the administrative authority to recapture unused EB-5 visas in the national interest, within the specific context of immigration law, supported by legal, legislative, regulatory and policy precedent, without the need for an act of Congress or Congressional approval. Moreover, an EB-5 Regional Center application, business plan, and focus on financing and developing infrastructure in the national interest, could provide the procedural basis for the United States government to expedite the recapturing of unused EB-5 visas in the national interest.

The global aerospace sector is rapidly growing to meet the worldwide demand for new commercial aircraft and aviation products. The two largest manufacturers of commercial aircraft are The Boeing Company®, which manufactures commercial airplanes under its Boeing Commercial Airplanes® division, and Airbus SE®, which manufactures commercial airplanes under its Airbus Commercial Aircraft® division.

Air travel volume has more than doubled in the past 15 years in response to a growing global economy. In 2018, Boeing® and Airbus® delivered a combined estimated total of $130 billion worth of aircraft and this amount is expected to rise to $185 billion by 2021. Airlines typically operate on low margins and, as a result, seek external sources to raise funding to replenish their fleet.

Leasing agents have become a core part of the aviation industry. Leasing reduces the initial capital outlay for airlines, provides access to the latest technologies and models, and allows airlines to alter the size of their feet to mirror demand. In 2018, approximately 40% of funding came from lessors.

Infrastructure refers to the fundamental facilities and systems serving a country, city, or other area, including the services and facilities necessary for the relevant economy to function. Infrastructure is composed of public and private physical improvements such as roads, bridges, tunnels, water supply, sewers, electrical grids, and telecommunications (including Internet connectivity and broadband speeds). In general, it has also been defined as “the physical components of interrelated systems providing commodities and services essential to enable, sustain, or enhance societal living conditions.”

Infrastructure development lies at the nexus of economic growth, productive investment, job creation, and poverty reduction. Financing the huge infrastructure investment gaps in the United States and globally, including in emerging market economies (EMEs), which is estimated to be approximately $1.3 trillion per year, is critical to sustained economic, sociopolitical and sociocultural development.

The system utilizes a capitalized holding company structure maintaining an investment-grade credit rating, ideally from at least two of the three major rating agencies, and serving as guarantor for the company's operations within, for example, aviation, space and infrastructure according to some embodiments. In some embodiments, the system is designed to be in the national interest and national in scope, and offering competitive advantages for investment in commercial airplanes, commercial satellites and spacecraft, and infrastructure development. In some embodiments, the system expedites immigrant investor visa processing in the national interest or otherwise creating a premium immigrant investor visa product including, but not limited to, a premium EB-5 product, involving the $1,800,000 EB-5 visa category as opposed the current $900,000 targeted employment area (TEA) EB-5 category providing for the recapture of up to or over 200,000 EB-5 visas enabling the creation of up to or over 389 jobs per EB-5 visa, as opposed to 10 jobs per EB-5 visa, and addressing four major concerns with the EB-5 program.

For example, credible and predictable long-term United States jobs are needed (certain members of Congress have expressed concern with the common exaggeration of job creation in the EB-5 space and lack of long-term job creation with many EB-5 Regional Centers.) Further, the legality of funding and compliance with relevant federal and state securities law, including: (i) the Securities Act of 1933; (ii) the Securities Exchange Act of 1934; (iii) the Investment Company Act of 1940; (iv) the Investment Advisers Act of 1940; (v) Jumpstart Our Business Startups Act (JOBS Act); (vi) CROWDFUND Act; and (vii) State “Blue Sky” laws. Further, return on invested capital for EB-5 investors and return of invested capital for EB-5 investors has often been problematic (there have been many instances of EB-5 Regional Centers and related businesses not providing a return on invested capital and return of invested capital to EB-5 investors). Further, at least some national security-related concerns exist including, but not limited to: (i) Committee on Foreign Investment in the United States (CFIUS), Foreign Investment Risk Review Modernization Act of 2018 (FIRRMA) and Critical Technology Pilot Program; (ii) detailed source of funds review; (iii) compliance with Uniting and Strengthening America by Providing Appropriate Tools to Restrict, Intercept and Obstruct Terrorism Act of 2001 (USA PATRIOT Act), Know-Your-Customer (KYC), Anti-Money Laundering (AML), Bank Secrecy Act (BSA) and; (iv) Office of Foreign Asset Control (OFAC) requirements.

### SUMMARY

Some embodiments include a computer-implemented method that manages immigrant investor visas and/or investments in pursuit of immigrant investor visas including, but not limited to, the United States Citizenship and Immigration Service (“USCIS”) Employment-Based Fifth Preference Immigrant Investor Program (“EB-5 Program” or “EB-5”). In some embodiments, the system includes the ability to accept and process visa applications, accept and process expedited visa applications, authenticate investment source of funds, enable background check processing, enable national security related screening and processing, track visa processing, track legal compliance, track securities law compliance, track national security law compliance, suggest investments, track job creation, track investment performance, and/or monitor investments for fraud. In some embodiments, the system significantly increases the likelihood of obtaining an immigrant investor visa including, but not limited to, an EB-5 visa while mitigating risk associated with investment.

Some embodiments include a computer-implemented method that includes at least specifically programming at least one computer system or a portion of at least one computer system to aggerate, manage and track immigrant investor visas and/or immigrant investor visas funding including, but not limited to, EB-5 to be used for investment and/or credit enhancement to finance certain investment. Some embodiments include a computer-implemented method that includes at least specifically programming at least one computer system or a portion of at least one computer system to aggerate, manage and track immigrant investor visas and/or immigrant investor visas funding including, but not limited to, EB-5 to be used for investment and/or credit enhancement to finance certain aerospace products. Some embodiments include a computer-implemented method that includes at least specifically programming at least one computer system to aggerate, manage and track immigrant investor visas and/or immigrant investor visas funding including, but not limited to, EB-5 to be used for investment and/or credit enhancement to finance certain infrastructure. Some embodiments include a computer-implemented method that includes at least specifically programming at least one computer system to aggerate, manage and track immigrant investor visas and/or immigrant investor visas funding including, but not limited to, EB-5 to be used for investment and/or credit enhancement to finance certain aerospace products and/or infrastructure and/or investment.

Some embodiments include a computer-implemented method that includes at least specifically programming at least one computer system to aggerate, manage and track immigrant investor visas and/or immigrant investor visas funding including, but not limited to, EB-5 to be used for investment and/or credit enhancement to finance certain aerospace products as a basis and structure to finance certain infrastructure. Some embodiments include a computer-implemented method that includes at least specifically programming at least one computer system to aggerate, manage and track immigrant investor visas and/or immigrant investor visas funding including, but not limited to, EB-5 to be used for investment and/or credit enhancement to finance certain aerospace products as a basis and structure to finance certain investment. Some embodiments include a computer-implemented method that includes at least specifically programming at least one computer system to aggerate, manage and track immigrant investor visas and/or immigrant investor visas funding including, but not limited to, EB-5 to be used for investment and/or credit enhancement to finance certain aerospace products as a basis and structure to finance certain aerospace products and/or infrastructure and/or investment.

Some embodiments include a computer-implemented method that includes at least specifically programming at least one computer system to aggerate, manage and track immigrant investor visas and/or immigrant investor visas funding including, but not limited to, EB-5 to be used for investment and/or credit enhancement to finance certain Commercial Airplanes and/or Commercial Satellites and/or Spacecraft as a basis and structure to finance certain infrastructure. Some embodiments include a computer-implemented method that includes at least specifically programming at least one computer system to aggerate, manage and track immigrant investor visas and/or immigrant investor visas funding including, but not limited to, EB-5 to be used for investment and/or credit enhancement to finance certain Commercial Airplanes and/or Commercial Satellites and/or Spacecraft as a basis and structure to finance certain investment. Some embodiments include a computer-implemented method that includes at least specifically programming at least one computer system to aggerate, manage and track immigrant investor visas and/or immigrant investor visas funding including, but not limited to, EB-5 to be used for investment and/or credit enhancement to finance certain Commercial Airplanes and/or Commercial Satellites and/or Spacecraft as a basis and structure to finance certain aerospace products and/or infrastructure and/or investment.

Some embodiments include a computer-implemented method that includes at least specifically programming at least one computer system to aggregate, manage and track immigrant investor visas job creation. Some embodiments include a computer-implemented method that includes at least specifically programming at least one computer system to aggregate, manage and track EB-5 visas job creation.

Some embodiments include a computer-implemented method that includes at least specifically programming at least one computer system to aggerate, manage and track immigrant investor visas and/or immigrant investor visas funding including, but not limited to, EB-5 that utilizes and accesses financial information to authenticate investment source of funds and utilizes and accesses criminal background information and other background information to engage in national security related processing, screening and compliance. Some embodiments include a computer-implemented method that includes at least specifically programming at least one computer system to aggerate, manage and track immigrant investor visas and/or immigrant investor visas funding including, but not limited to, EB-5 and compliance with relevant federal and state securities law, including but not limited to: (i) Securities Act of 1933; (ii) Securities Exchange Act of 1934; (iii) Investment Company Act of 1940; (iv) Investment Advisers Act of 1940; (v) State “Blue Sky” laws. Some embodiments include a computer-implemented method that includes at least specifically programming at least one computer system to aggerate, manage and track immigrant investor visas and/or immigrant investor visas funding including, but not limited to, EB-5 and a return on invested capital for immigrant investor visas investment. Some embodiments include a computer-implemented method that includes at least specifically programming at least one computer system to aggerate, manage and track immigrant investor visas and/or immigrant investor visas funding including, but not limited to, EB-5 and a return of invested capital for immigrant investor visas investment. Some embodiments include a computer-implemented method that includes at least specifically programming at least one computer system to aggerate, manage and track immigrant investor visas and/or immigrant investor visas funding including, but not limited to, EB-5 and national security-related concerns including, but not limited to: (i) Committee on Foreign Investment in the United States (CFIUS), Foreign Investment Risk Review Modernization Act of 2018 (FIRRMA) and Critical Technology Pilot Program; (ii) detailed source of funds review; (iii) compliance with Uniting and Strengthening America by Providing Appropriate Tools to Restrict, Intercept and Obstruct Terrorism Act of 2001 (USA PATRIOT Act), Know-Your-Customer (KYC), Anti-Money Laundering (AML), Bank Secrecy Act (BSA) and; (iv) Office of Foreign Asset Control (OFAC) requirements.

Some embodiments include a computer-implemented method that includes at least specifically programming at least one computer system or a portion of at least one computer system to aggerate, manage and track recaptured EB-5 visas and/or recaptured EB-5 visas funding for use in subsequent fiscal years for investment and/or credit enhancement to finance certain investment. Some embodiments include a computer-implemented method that includes at least specifically programming at least one computer system or a portion of at least one computer system to aggerate, manage and track recaptured EB-5 visas and/or recaptured EB-5 visas funding for use in subsequent fiscal years for investment and/or credit enhancement to finance certain aerospace products. Some embodiments include a computer-implemented method that includes at least specifically programming at least one computer system or a portion of at least one computer system to aggerate, manage and track recaptured EB-5 visas and/or recaptured EB-5 visas funding for use in subsequent fiscal years for investment and/or credit enhancement to finance certain infrastructure. Some embodiments include a computer-implemented method that includes at least specifically programming at least one computer system or a portion of at least one computer system to aggerate, manage and track recaptured EB-5 visas and/or recaptured EB-5 visas funding for use in subsequent fiscal years to be used for investment and/or credit enhancement to finance certain aerospace products and/or infrastructure and/or investment.

Some embodiments include a computer-implemented method that includes at least specifically programming at least one computer system or a portion of at least one computer system to aggerate, manage and track recaptured EB-5 visas and/or recaptured EB-5 visas funding for use in subsequent fiscal years for investment and/or credit enhancement to finance certain aerospace products as a basis and structure to finance certain infrastructure. Some embodiments include a computer-implemented method that includes at least specifically programming at least one computer system or a portion of at least one computer system to aggerate, manage and track recaptured EB-5 visas and/or recaptured EB-5 visas funding for use in subsequent fiscal years for investment and/or credit enhancement to finance certain aerospace products as a basis and structure to finance certain investment. Some embodiments include a computer-implemented method that includes at least specifically programming at least one computer system or a portion of at least one computer system to aggerate, manage and track recaptured EB-5 visas and/or recaptured EB-5 visas funding for use in subsequent fiscal years for investment and/or credit enhancement to finance certain aerospace products and/or infrastructure and/or investment as a basis and structure to finance certain infrastructure.

Some embodiments include a computer-implemented method that includes at least specifically programming at least one computer system or a portion of at least one computer system to aggerate, manage and track recaptured EB-5 visas and/or recaptured EB-5 visas funding for use in subsequent fiscal years for investment and/or credit enhancement to finance certain Commercial Airplanes and/or Commercial Satellites and/or Spacecraft as a basis and structure to finance certain infrastructure. Some embodiments include a computer-implemented method that includes at least specifically programming at least one computer system or a portion of at least one computer system to aggerate, manage and track recaptured EB-5 visas and/or recaptured EB-5 visas funding for use in subsequent fiscal years for investment and/or credit enhancement to finance certain Commercial Airplanes and/or Commercial Satellites and/or Spacecraft as a basis and structure to finance certain investment. Some embodiments include a computer-implemented method that includes at least specifically programming at least one computer system or a portion of at least one computer system to aggerate, manage and track recaptured EB-5 visas and/or recaptured EB-5 visas funding for use in subsequent fiscal years to be used for investment and/or credit enhancement to finance certain Commercial Airplanes and/or Commercial Satellites and/or Spacecraft as a basis and structure to finance certain aerospace products and/or infrastructure and/or investment.

Some embodiments include a computer-implemented method that includes at least specifically programming at least one computer system or a portion of at least one computer system to aggregate, manage and track recaptured EB-5 visas and/or recaptured EB-5 visas funding for use in subsequent fiscal years and recaptured EB-5 visa job creation.

Some embodiments include a computer-implemented method that includes at least specifically programming at least one computer system or a portion of at least one computer system to aggerate, manage and track recaptured EB-5 visas and/or recaptured EB-5 visas funding that utilizes and accesses financial information to authenticate investment source of funds and utilizes and accesses criminal background information and other background information to engage in national security related processing, screening and compliance. Some embodiments include a computer-implemented method that includes at least specifically programming at least one computer system or a portion of at least one computer system to aggerate, manage and track recaptured EB-5 visas and/or recaptured EB-5 visas funding for use in subsequent fiscal years and compliance with relevant federal and state securities law, including but not limited to: (i) Securities Act of 1933; (ii) Securities Exchange Act of 1934; (iii) Investment Company Act of 1940; (iv) Investment Advisers Act of 1940; (v) State “Blue Sky” laws. Some embodiments include a computer-implemented method that includes at least specifically programming at least one computer system or a portion of at least one computer system to aggerate, manage and track recaptured EB-5 visas and/or recaptured EB-5 visas funding for use in subsequent fiscal years and a return on invested capital for recaptured EB-5 visas investment. Some embodiments include a computer-implemented method that includes at least specifically programming at least one computer system or a portion of at least one computer system to aggerate, manage and track recaptured EB-5 visas and/or recaptured EB-5 visas funding for use in subsequent fiscal years and a return of invested capital for recaptured EB-5 visas investment. Some embodiments include a computer-implemented method that includes at least specifically programming at least one computer system or a portion of at least one computer system to aggerate, manage and track recaptured EB-5 visas and/or recaptured EB-5 visas funding for use in subsequent fiscal years and national security-related concerns including, but not limited to: (i) Committee on Foreign Investment in the United States (CFIUS), Foreign Investment Risk Review Modernization Act of 2018 (FIRRMA) and Critical Technology Pilot Program; (ii) detailed source of funds review; (iii) compliance with Uniting and Strengthening America by Providing Appropriate Tools to Restrict, Intercept and Obstruct Terrorism Act of 2001 (USA PATRIOT Act), Know-Your-Customer (KYC), Anti-Money Laundering (AML), Bank Secrecy Act (BSA) and; (iv) Office of Foreign Asset Control (OFAC) requirements.

In some embodiments, the system includes EB-5 availability software. In some embodiments, the EB-5 software is configured to receive EB-5 visa data. In some embodiments, the EB-5 data includes an unused EB-5 visas total from past years and/or the present year. In some embodiments, the EB-5 data includes a currently available EB-5 visas total. In some embodiments, the EB-5 software is configured to calculate the total number of available visas by adding the number of unused EB-5 visas from past years to the number of available visas in the current year. In some embodiments, the system includes a communications module configured to receive investment data and immigration data from one or more databases. In some embodiments, the EB-5 software includes the communications module.

In some embodiments, the system includes automated visa application software. In some embodiments, the visa application software includes an immigration module configured to execute one or more steps described throughout this application regarding immigration and/or visa tracking. In some embodiments, the visa application software is configured to receive an input in one language and translate it to another language. In some embodiments, the visa application software is configured to receive one or more biometric identifiers (e.g., photographs, fingerprints, retinal scans, DNA, and/or any other biometric data). In some embodiments, the visa application software is configured to receive one or more electronic documents including immigration information (e.g., name, date-of-birth, address, marital status, criminal history, current income, current net worth, authentication of immigrant investor source of funds, and/or any information required by immigration officials) spouse information (e.g., immigration information), and/or children information (e.g., immigration information).

In some embodiments, the visa application software is configured to compare an applicant's immigration information against credit databases and/or criminal databases (e.g., foreign, federal, state, and/or local law enforcement databases) and/or other databases useful for information verification. In some embodiments, the visa application software is configured to compare an application immigration information to one or more criminal databases and return a warning message and/or deny a visa application in response to a correlation between the immigrant information and criminal activity and/or association with known criminals. In some embodiments, the visa application software is configured to compare an application immigration information to terrorist watchlists and return a warning message and/or deny a visa application in response to a correlation between a visa application information and/or biometric data and a known terrorist and/or terrorist organization.

In some embodiments the visa application software is configured to aggerate, manage and track immigrant investor visas and/or immigrant investor visas funding including, but not limited to, EB-5 that utilizes and accesses financial information to authenticate investment source of funds and utilizes and accesses criminal background information and other background information to engage in national security related processing, screening and compliance.

In some embodiments the visa application software is configured to aggerate, manage and track immigrant investor visas and/or immigrant investor visas funding including, but not limited to, EB-5 and compliance with relevant federal and state securities law, including but not limited to: (i) Securities Act of 1933; (ii) Securities Exchange Act of 1934; (iii) Investment Company Act of 1940; (iv) Investment Advisers Act of 1940; (v) State “Blue Sky” laws.

In some embodiments the visa application software is configured to aggerate, manage and track immigrant investor visas and/or immigrant investor visas funding including, but not limited to, EB-5 and national security-related concerns including, but not limited to: (i) Committee on Foreign Investment in the United States (CFIUS), Foreign Investment Risk Review Modernization Act of 2018 (FIRRMA) and Critical Technology Pilot Program; (ii) detailed source of funds review; (iii) compliance with Uniting and Strengthening America by Providing Appropriate Tools to Restrict, Intercept and Obstruct Terrorism Act of 2001 (USA PATRIOT Act), Know-Your-Customer (KYC), Anti-Money Laundering (AML), Bank Secrecy Act (BSA) and; (iv) Office of Foreign Asset Control (OFAC) requirements.

In some embodiments, the visa application software is configured to calculate the probability of getting an EB-5 visa. In some embodiments, the visa application software is configured to access and/or store records and/or statistics regarding visa denials. In some embodiments, the visa application software is configured to compare immigration information to denial statistics to score and/or rank an applicant's visa application probability. In some embodiments, a higher score correlates to a higher probability of obtaining a visa.

In some embodiments, the visa application software is configured to store the applicant's information in a secured and/or encrypted database. In some embodiments, the visa application software is configured to encrypt and/or store an applicant's information on a visa document. In some embodiments, the visa document is a visa card the applicant can carry for identification purposes.

In some embodiments, the visa document includes a verification system. In some embodiments, the verification system includes a computer readable microchip and/or radio frequency identification device (RFID) which stores the applicant's information and/or enables visa tracking. In some embodiments, the visa application software is configured to receive the verification system at a remote location (i.e., a remote computer) to allows the applicant to “check-in” with immigration authorities periodically. In some embodiments, the visa application software is configured to notify an applicant of their visa status and/or request communication and/or documents when a user “checks-in.”

In some embodiments, the visa application software is configured to create a digital certificate for electronic communication security. In some embodiments, the system issues a key to decode a digital certificate for communication security. In some embodiments, the visa application software is configured to receive biometric identifiers from a remote computer. In some embodiments, the system uses one or more biometric identifiers and/or digital certificates for electronic communications. In some embodiments, the system in configured to receive report from foreign, federal, state, local, and/or credit agencies regarding an applicant's activity while in a country.

In some embodiments, the investment evaluation software (i.e., module) matches an investor and an investment. In some embodiments, the investment evaluation software collects, stores, and/or transmits one or more regional center projects to an applicant. In some embodiments, the investment evaluation software is configured to estimate the number of jobs created from an investment. In some embodiments, the investment evaluation software is configured to determine if jobs created are one or more of direct jobs, indirect jobs, and/or induced jobs (as defined by the United States Citizenship and Immigration Services (USCIS) under the EB-5 Immigrant Investor Program; hereafter “jobs”).

In some embodiments, the investment evaluation software is configured to identify, store, evaluate, and/or send information regarding regional center (as defined by USCIS) investment opportunities (investment, investment opportunity, and plurals thereof are used interchangeably herein). In some embodiments, the investment evaluation software is configured to identify, store, evaluate, score and/or send information regarding individual businesses for sale and/or investment and/or lending. In some embodiments, the investment evaluation software is configured to estimate the number of new jobs created by an investment. In some embodiments, the investment evaluation software is configured to score an investment that creates more new jobs higher than an investment that creates less new jobs. In some embodiments, the investment evaluation software is configured to use the jobs score in a financial risk-return calculation.

In some embodiments, the investment evaluation software is configured to arrange investments by asset classes. In some embodiments, the investment evaluation software is configured to receive a current investment portfolio from an investor. In some embodiments, the investment evaluation software is configured to identify, match, evaluate, score, store, and/or send information regarding investments that are similar in risk to an investor's current portfolio. In some embodiments, the investment evaluation software is configured to determine a risk score based on an applicant's current investment portfolio. In some embodiments, a risk score is determined by scoring and/or ranking the risk associated with each current investment in an applicant's current investment portfolio. In some embodiments, the investment evaluation software is configured to use the portfolio score and/or rank in a risk-return calculation. In some embodiments, the investment evaluation software portion of the system is configured to return a list of potential investments to an applicant that has the highest probability of obtaining an EB-5 visa. In some embodiments, the list includes protentional investments with the highest probability of creating the most jobs.

In some embodiments, the investment evaluation software is configured to identify investments that are eligible for crowd sourcing and/or donations (hereafter collectively “crowd sourcing”). In some embodiments, the investment evaluation software assigns a score to investments based on the ability to raise capital through crowd sourcing. In some embodiments, the investment evaluation software is configured to identify investments with crowd sourcing by utilizing publicly disclosed list. In some embodiments, the investment evaluation software is configured to score an investment based on one or more public records (e.g., rate of growth, valuation, number of employees, demand for product, backorders, social media information, assets, liabilities, number of rounds of funding, profit/non-profit status, tax returns, etc.) investment evaluation software assigns a score to investments based the change in one or more public records between when the investment was listed and the public records currently available.

In some embodiments, the investment evaluation software is configured to select and display one or more investments ranked by score. In some embodiments, the investment evaluation software is configured to display simulations of time-based growth. In some embodiments, the simulations use probability and/or statistics (i.e., statistical analysis) to determine time-based growth. In some embodiments, the investment evaluation software scores and/or ranks an investment at least in part based on time-based growth. In some embodiments, the investment evaluation software uses statistical analysis to correlate time-based growth to employee hiring growth to predict the number of employees needed for growth over time. In some embodiments, the investment evaluation software ranks an investment higher for more employee growth over time than an investment with less employee growth over the same time period. In some embodiments, the investment evaluation software is configured to remove investments from consideration that do not meet one or more job creation criteria (e.g., employee growth of a desired number of employees within 2 years). In some embodiments, the investment evaluation software scores and/or ranks higher an investment that meets one or more job creation criteria faster than investments that take a longer time to reach the job creation criteria. In some embodiments, a job creation criterion is 10 jobs. In some embodiments, the job creation criterion is 5 jobs. In some embodiments, the investment evaluation software displays a list of potential investments ranked by score with graphical representations of one or more predictions.

In some embodiments, the employee pool software is configured to identify employee pool skillsets. In some embodiments, employee pool software is configured to categorize employee pools by one or more geographical locations. In some embodiments, employee pools are defined by one or more investment locations (e.g., locations of investments on the list created by the investment software). In some embodiments, the employee pool software is configured to determine Targeted Employment Areas (TEA; as defined by the USCIS). In some embodiments, the employee pool software is configured to identify high unemployment areas (i.e., areas with an unemployment rate of at least 150% of the U.S. national average). In some embodiments, the employee pool software scores and/or ranks an area and/or employee pool higher if the employee pool is located in a TEA. In some embodiments, the employee pool software scores and/or ranks an area and/or employee pool lower if the employee pool is located in a TEA.

In some embodiments, the score and/or rank for an employee pool for the employment pool software is based on input from the investment evaluation software. In some embodiments, the investment evaluation software is configured to score and/or rank an employee pool based on the capital an applicant has available to invest. In some embodiments, the investment evaluation software is configured to score and/or rank a TEA employment pool higher if an applicant has greater or equal to $900,000 (U.S. dollar equivalent) and less than or equal to $1.8 million. In some embodiments, the investment evaluation software adjusts an employment pools' score and/or rank higher if an applicant has greater than $1.8 million to invest. In some embodiments, the investment evaluation software ranks a TEA and a non-TEA employment pool the same.

In some embodiments, the employment pool software is configured to evaluate an employee pool's skillset. In some embodiments, the employment pool software is configured to predict if there are enough potential employees with qualifying skillsets within a geographical area to meet one or more job creation criteria. In some embodiments, the employment pool software is configured to rank an area with more potential employees with qualifying skillsets higher than an area with less potential employees with qualifying skillsets. In some embodiments, the investment evaluation software is configured to remove investments from the list with employment pools predicted not to meet one or more job creation criteria. In some embodiments, the employment pool software is configured to display one or more graphical representations, probabilities, and/or statistics of one or more predictions as described herein.

In some embodiments, system includes a capital tracking software. In some embodiments, the capital tracking software mitigates the risk of crime, corruption, and fraud affecting an investment. In some embodiments, the capital tracking software is configured to receive, store, analyze, track and/or report on one or more investments' finances (e.g., credit score, account balances, total investment amounts, applicant investment amounts, assets, liabilities, expenditures, inventory, insurance payments, insurance claims, lawsuits, criminal charges, and/or any business expense or credit). In some embodiments, the capital tracking software is configured to calculate an applicant's capital as a percentage of total capital in an investment. In some embodiments, the system is configured to calculate an applicant's capital gains and/or losses as a percentage of total capital gains and/or losses of an investment. In some embodiments, the capital tracking software is configured to track and report an investment's capital delta (i.e. total available capital and/or credit change with respect to time). In some embodiments, the capital tracking software is configured to generate and alert if the capital delta exceeds a preset limit. In some embodiments, the capital tracking software is configured to generate an alert if a capital delta correlates to not meeting one or more job creation criteria within 2 years.

In some embodiments, the system comprises capital tracking software that is configured to generate an alert in response to a finance anomaly within an investment's finances. In some embodiments, a finance anomaly is a sudden change in capital delta with no corresponding income and/or expenditure. In some embodiments, the capital tracking software is configured to analyze purchases and compare an asset's purchase and/or sale value against an asset's market value to generate a market value delta. In some embodiments, the capital tracking software is configured to generate and alert if the market value delta exceeds a preset limit.

In some embodiments, the system includes an aggregation module configured to aggregate the investment data and the immigration data into aggregated data. The aggregation module performs one or more steps associated with aggregation as described throughout this application according to some embodiments. In some embodiments, the system aggregates (i.e., collects and assigns) unused EB-5 visas into one or more business models that satisfies the requirements of the EB-5 program, such as the creation of jobs. In some embodiments, the one or more businesses are used to fund multiple different projects and/or continuously fund projects in sequential order as each project is completed.

In some embodiments, the system utilizes the financing of up to or over $350 billion of commercial airplanes, commercial satellites and spacecraft to support the creation or preservation of up to or over 2,011,450 aerospace jobs in the United States providing the baseline jobs to recapture up to or over 200,000 unused EB-5 visas to raise up to or over $360 billion of unlevered EB-5 funding and, as a related matter, a structure to finance up to or over a $5.05 trillion private investment in United States infrastructure and/or other industries and the creation of approximately up to or over 77 million infrastructure jobs and/or jobs in other industries in the United States.

In some embodiments, the system utilizes up to or over $360 billion of EB-5 funding to be enhanced up to or over fifteen times to raise up to or over $5.4 trillion of funding for public-private partnership investment in United States aerospace and infrastructure and/or other industries. In some embodiments, the system utilizes the financing and/or acquisition of commercial airplanes, commercial satellites and spacecraft to support sustainable national interest-centric infrastructure development and to provide uncommon financial and strategic benefit to the aerospace and multiple infrastructure sectors and/or other industries in the United States. In some embodiments, the system utilizes the financing of up to or over $350 billion of commercial airplanes, commercial satellites and spacecraft and, as a related matter, the system utilizes the financing of up to or over $5 trillion of infrastructure in the United States including, but not limited to, border security, transportation, 5G Space Internet and energy. In some embodiments, the system utilizes the financing of certain secured transactions in aerospace mobile equipment (movable equipment) (commercial airplanes, commercial satellites and spacecraft) as a basis and structure to finance certain types of infrastructure in the United States and/or globally. In some embodiments, the system utilizes the financing of certain secured transactions in aerospace mobile equipment (movable equipment) (Commercial Airplanes, Commercial Satellites and Spacecraft) as a basis and structure to finance certain types of other industries including, but not limited to, manufacturing, telecommunications, information technology, and healthcare in the United States and/or globally. In some embodiments, the system utilizes the Article Two executive power pursuant to the United States Constitution to facilitate a large-scale investment in the United States aerospace sector and, as a related matter, to facilitate a large-scale investment in United States infrastructure without the need for an act of Congress or Congressional approval. Additionally, in some embodiments, the system utilizes the system is implemented with taxpayer funding.

Some embodiments of the invention include a system to utilize EB-5 funding to (i) finance Boeing Commercial Airplanes® and Boeing Defense, Space & Security® products and; (ii) finance and develop infrastructure in the United States. In some embodiments, the system utilizes EB-5 funding to (i) finance Commercial Airplanes, and/or Commercial Satellites and/or Spacecraft; and (ii) finance and develop infrastructure in the United States. In some embodiments, the system utilizes the Recapture of up to 200,000 or more unused EB-5 Visas in the national interest to raise up to or over $360 billion of EB-5 funding to finance Boeing Commercial Airplanes, Boeing Defense, Space & Security products and finance and develop infrastructure in the United States. In some embodiments, the system utilizes the Recapture of up to 200,000 or more unused EB-5 Visas in the national interest to raise up to or over $360 billion of EB-5 funding to finance Commercial Airplanes and/or Commercial Satellites and/or Spacecraft and finance and develop infrastructure in the United States. In some embodiments, the system utilizes the Recapture of up to 200,000 or more unused EB-5 Visas to raise up to or over $360 billion of EB-5 funding to finance investment in the United States. In some embodiments, the system utilizes the Recapture of up to 200,000 or more unused EB-5 Visas to raise up to or over $360 billion of EB-5 funding to finance investment in the United States and globally. In some embodiments, the system utilizes present/future contractually obligated income in the form of up to or over $360 billion of EB-5 funding for the recapture of up to or over 200,000 unused EB-5 Visas. In some embodiments, the system utilizes debt financing related to financing of Boeing Commercial Airplanes, which benefits from (i) U.S. Bankruptcy Code Section 1110 Enhanced Equipment Trust Certificates (“EETC”) financing; (ii) Cape Town Convention on International Interests in Mobile Equipment EETC financing; (iii) asset-based securitization; and (iv) U.S. Internal Revenue Code supported accelerated depreciation. In some embodiments, the system utilizes debt financing related to financing Commercial Airplanes and/or Commercial Satellites and/o Spacecraft, which benefits from (i) U.S. Bankruptcy Code Section 1110 Enhanced Equipment Trust Certificates (“EETC”) financing; (ii) Cape Town Convention on International Interests in Mobile Equipment EETC financing; (iii) asset-based securitization; and (iv) U.S. Internal Revenue Code supported accelerated depreciation. In some embodiments, the system utilizes debt financing involving present/future contractually obligated income in the form of up to or over $360 billion of EB-5 funding to reduce cost of debt financing of Boeing Commercial Airplanes and Boeing Defense, Space & Security products. In some embodiments, the system utilizes debt financing involving present/future contractually obligated income in the form of up to or over $360 billion of EB-5 funding to reduce cost of debt financing of Commercial Airplanes and/or Commercial Satellites and/or Spacecraft. In some embodiments, the system utilizes present/future contractually obligated income in the form of up to or over $360 billion of EB-5 funding for investment in the United States and/or globally. In some embodiments, the system utilizes debt financing related to infrastructure financing; a system utilizes debt financing related to infrastructure financing supported by aircraft securitization. In some embodiments, the system utilizes debt financing related to infrastructure financing supported by infrastructure public-private partnerships in the United States and/or globally. In some embodiments, the system utilizes present/future contractually obligated income in the form of up to or over $360 billion of EB-5 funding to reduce cost of debt financing of United States infrastructure and/or infrastructure on a global basis. In some embodiments, the system utilizes attractive debt financing related to United States and/or global infrastructure development supported by infrastructure-asset-based securitization. In some embodiments, the system utilizes New Markets Tax Credit, other Tax Credit, Cap-and-Trade Programs (Carbon Emissions Trading) and other government incentives for United States infrastructure financing and development.

In some embodiments, the system utilizes the Article Two executive power pursuant to the United States Constitution to facilitate a large-scale investment in the United States aerospace sector and, as a related matter, to facilitate a large-scale investment in United States infrastructure without the need for an act of Congress or Congressional approval. In some embodiments, the system is implemented without taxpayer funding. In some embodiments, the system utilizes multiple investment and jobs scenarios including topline/optimal and baseline/conservative and hybrid scenarios. In some embodiments, the system utilizes multiple investment and jobs scenarios involving single or multiple companies including topline/optimal and baseline/conservative and hybrid scenarios. In some embodiments, the system utilizes multiple investment and jobs scenarios involving single or multiple industries including topline/optimal and baseline/conservative and hybrid scenarios. In some embodiments, the system utilizes the U.S. Department of State (“State Department”), in conjunction with the U.S. Department of Homeland Security (“DHS”), to engage federal administrative authority to recapture unused EB-5 visas in the national interest, within the specific context of immigration law, supported by legal, legislative, regulatory and policy precedent, without the need for an act of Congress or Congressional approval.

In some embodiments, the system utilizes the U.S. Department of State (“State Department”), in conjunction with the U.S. Department of Homeland Security (“DHS”), to engage administrative authority to recapture unused EB-5 visas, within the specific context of immigration law, supported by legal, legislative, regulatory and policy precedent, without the need for an act of Congress or Congressional approval.

In some embodiments, the system utilizes current or future United States law including, but not limited to federal law, to recapture unused EB-5 visas in the national interest, within the specific context of immigration law, supported by legal, legislative, regulatory and policy precedent, without the need for an act of Congress or Congressional approval.

In some embodiments, the system utilizes current or future United States law including, but not limited to federal law, to recapture unused EB-5 visas, within the specific context of immigration law, supported by legal, legislative, regulatory and policy precedent, without the need for an act of Congress or Congressional approval.

In some embodiments, the system utilizes current or is configured to use future United States law including, but not limited to federal law, including current and/or future immigrant investor visas, within the specific context of immigration law, supported by legal, legislative, regulatory and policy precedent, without the need for an act of Congress or Congressional approval.

In some embodiments, the system utilizes current or future United States law including, but not limited to federal law, including current and/or future immigrant investor visas, within the specific context of immigration law, supported by legal, legislative, regulatory and policy precedent, with an act of Congress or Congressional approval.

In some embodiments, the system utilizes a capitalized holding company structure maintaining an investment-grade credit rating, ideally from at least two of the three major rating agencies, and serving as guarantor for the company's operations within, for example, aviation, space and infrastructure. In some embodiments, the system is designed to be in the national interest and national in scope, and offering competitive advantages for investment in commercial airplanes, commercial satellites and spacecraft, and infrastructure development. In some embodiments, the system is configured to expedite immigrant investor visa processing in the national interest or otherwise creating a premium immigrant investor visa product including, but not limited to, a premium EB-5 product, involving the $900,000 targeted employment area (TEA) EB-5 category providing for the recapture of up to or over 200,000 EB-5 visas enabling the creation of up to or over 389 jobs per EB-5 visa, as opposed to 10 jobs per EB-5 visa, and addressing four major concerns with the EB-5 program.

In some embodiments, the system utilizes a capitalized holding company structure maintaining an investment-grade credit rating, ideally from at least two of the three major rating agencies, and serving as guarantor for the company's operations within, for example, aviation, space and infrastructure. In some embodiments, the program is designed to be in the national interest and national in scope, and offering competitive advantages for investment in commercial airplanes, commercial satellites and spacecraft, and infrastructure development. In some embodiments, the system expedites immigrant investor visa processing in the national interest or otherwise creating a premium immigrant investor visa product including, but not limited to, a premium EB-5 product, involving the $1,800,000 EB-5 visa category as opposed the current $900,000 targeted employment area (TEA) EB-5 category providing for the recapture of up to or over 200,000 EB-5 visas enabling the creation of up to or over 389 jobs per EB-5 visa, as opposed to 10 jobs per EB-5 visa, and addressing four major concerns with the EB-5 program.

In some embodiments, the system utilizes a capitalized holding company structure maintaining an investment-grade credit rating, ideally from at least two of the three major rating agencies, and serving as guarantor for the company's operations within, for example, aviation, space and infrastructure. In some embodiments, the system is designed to be in the national interest and national in scope, and offering competitive advantages for investment in commercial airplanes, commercial satellites and spacecraft, and infrastructure development. In some embodiments, the system expedites immigrant investor visa processing in the national interest or otherwise creating a premium immigrant investor visa product including, but not limited to, a premium EB-5 product, involving the $900,000 targeted employment area (TEA) EB-5 category providing for the recapture of up to or over 200,000 EB-5 visas enabling the creation of up to or over 389 jobs per EB-5 visa, as opposed to 10 jobs per EB-5 visa, and addressing four major concerns with the EB-5 program.

In some embodiments, the system utilizes and addresses four major concerns with the EB-5 program: (1) Credible and predictable long-term U.S. jobs (certain members of Congress have expressed concern, privately and publicly, with the frequent exaggeration and puffery of U.S. job creation in the EB-5 space and lack of long-term job creation with many EB-5 Regional Centers); (2) Legality of funding and compliance with relevant federal and state securities law, including: (i) the Securities Act of 1933; (ii) the Securities Exchange Act of 1934; (iii) the Investment Company Act of 1940; (iv) the Investment Advisers Act of 1940; (v) Jumpstart Our Business Startups Act (JOBS Act); (vi) CROWDFUND Act; and (vii) State “Blue Sky” laws; (3) Return on invested capital for EB-5 investors and return of invested capital for EB-5 investors (there have been many instances of EB-5 Regional Centers and related businesses not providing a return on invested capital and return of invested capital to EB-5 investors); (4) National security-related concerns including, but not limited to: (i) CFIUS, FIRRMA and Critical Technology Pilot Program; (ii) detailed source of funds review; (iii) compliance with USA PATRIOT Act, Know-Your-Customer (KYC), Anti-Money Laundering (AML), Bank Secrecy Act (BSA) and; (iv) Office of Foreign Asset Control (OFAC) requirements.

In some embodiments, the system utilizes a single regional center for EB-5 purposes with a contiguous geographic scope encompassing the entire continental United States. In some embodiments, the system utilizes a regional center that is composed of up to 100 or more separate investment funds and special purpose vehicles (SPV) that will each be composed of up to 1,999 accredited investors-limited partners. In some embodiments, the O3 regional center investment funds/SPV will invest in O3 Aviation, O3 Infrastructure, O3 Real Estate and O3 Space projects. In some embodiments, the O3 regional center will include a Matter of Ho compliant business plan, actual projects, hypothetical projects and exemplar projects sufficient to recapture 200,000 unused EB-5 visas with the requisite 2,000,000 jobs to be created within two years or a reasonable period of time.

Some embodiments include a computer-implemented method that includes at least specifically programming at least one computer system or a portion of at least one computer system to aggregate immigrant investor visas including, but not limited to, the United States Citizenship and Immigration Service (“USCIS”) Employment-Based Fifth Preference Immigrant Investor Program (“immigrant investor funding Program” or “immigrant investor funding”) (collectively, “immigrant investor visas” or “immigrant investor visa funding”), for the purposes of immigrant investor visa automated application processing; and/or immigrant investor visa automated legal processing; and/or immigrant investor visa automated securities law compliance; and/or immigrant investor visa automated securities law compliance processing; and/or immigrant investor visa automated expedited processing; and/or immigrant investor visa automated authentication of source of funds processing; and/or immigrant investor visa automated background check processing; and/or immigrant investor visa automated national security related screening and processing, and/or investment; and/or investment in aircraft; and/or investment in satellites; and/or investment in spacecraft; and/or investment in commercial aviation; and/or investment in aerospace; and/or investment in infrastructure; and/or investment in real estate; and/or investment in information technology software; and/or investment in information technology hardware; and/or investment in telecommunications; and/or investment in aircraft and/or satellites and/or spacecraft to finance infrastructure; and/or investment in high-speed rail; and/or investment in smart grid; and/or investment in 5G; and/or investment in Space Internet; and/or investment in water supply system or water supply network; and/or investment in water infrastructure; and/or investment in airport infrastructure; and/or investment in port infrastructure; and/or investment in inland port infrastructure; and/or investment in sports venue; and/or investment in air transportation infrastructure; and/or investment in surface transportation infrastructure; and/or investment in rail infrastructure; and/or investment in highway infrastructure; and/or investment in road infrastructure; and/or investment in education; and/or investment in energy infrastructure; and/or investment in renewable energy; and/or investment in nuclear energy; and/or investment in civil infrastructure; and/or investment in autonomous vehicle infrastructure; and/or investment in flying vehicle infrastructure; and/or investment in military infrastructure; and/or investment in autonomous vehicle manufacturing; and/or investment in flying vehicle manufacturing; and/or investment in crypto currency; and/or investment in block chain; and/or investment in military hardware; and/or investment in automobile manufacturing; and/or investment in aircraft manufacturing; and/or investment in aviation education; and/or investment involving Islamic finance; and/or investment involving donation; and/or investment involving crowd funding; and/or deriving revenues through the leasing model.

Some embodiments of the invention comprise a computer-implemented method that includes at least one of: specifically programming at least one computer system or a portion of at least one computer system to perform at least one of the following: aggregate Islamic finance for investment; and/or Islamic finance for investment in aircraft; and/or Islamic finance for investment in satellites; and/or Islamic finance for investment in spacecraft; and/or Islamic finance for investment in commercial aviation; and/or Islamic finance for investment in aerospace; and/or Islamic finance for investment in infrastructure; and/or Islamic finance for investment in real estate; and/or Islamic finance for investment in information technology software; and/or Islamic finance for investment in information technology hardware; and/or Islamic finance for investment in telecommunications; and/or Islamic finance for investment in aircraft and/or satellites and/or spacecraft to finance infrastructure; and/or Islamic finance for investment in high-speed rail; and/or Islamic finance for investment in smart grid; and/or Islamic finance for investment in 5G; and/or Islamic finance for investment in Space Internet; and/or Islamic finance for investment in water supply system or water supply network; and/or Islamic finance for investment in water infrastructure; and/or Islamic finance for investment in airport infrastructure; and/or Islamic finance for investment in port infrastructure; and/or Islamic finance for investment in inland port infrastructure; and/or Islamic finance for investment in sports venue; and/or Islamic finance for investment in air transportation infrastructure; and/or Islamic finance for investment in surface transportation infrastructure; and/or Islamic finance for investment in rail infrastructure; and/or Islamic finance for investment in highway infrastructure; and/or Islamic finance for investment in road infrastructure; and/or Islamic finance for investment in education; and/or Islamic finance for investment in energy infrastructure; and/or Islamic finance for investment in renewable energy; and/or investment in nuclear energy; and/or Islamic finance for investment in civil infrastructure; and/or Islamic finance for investment in autonomous vehicle infrastructure; and/or Islamic finance for investment in flying vehicle infrastructure; and/or Islamic finance for investment in military infrastructure; and/or Islamic finance for investment in autonomous vehicle manufacturing; and/or Islamic finance for investment in flying vehicle manufacturing; and/or Islamic finance for investment in crypto currency; and/or Islamic finance for investment in block chain; and/or Islamic finance for investment in military hardware; and/or Islamic finance for investment in automobile manufacturing; and/or Islamic finance for investment in aircraft manufacturing; and/or Islamic finance for investment involving Islamic finance; and/or Islamic finance for investment involving donation; and/or Islamic finance for investment involving crowd funding.

Some embodiments of the invention comprise a computer-implemented method that includes at least: specifically programming at least one computer system or a portion of at least one computer system to perform at least one of the following: aggregate donation for investment; and/or donation for investment in aircraft; and/or donation for investment in satellites; and/or donation for investment in spacecraft; and/or donation for investment in commercial aviation; and/or donation for investment in aerospace; and/or donation for investment in infrastructure; and/or donation for investment in real estate; and/or donation for investment in information technology software; and/or donation for investment in information technology hardware; and/or donation for investment in telecommunications; and/or donation for investment in aircraft and/or satellites and/or spacecraft to finance infrastructure; and/or donation for investment in high speed rail; and/or donation for investment in smart grid; and/or donation for investment in 5G; and/or donation for investment in Space Internet; and/or donation for investment in water supply system or water supply network; and/or donation for investment in water infrastructure; and/or donation for investment in airport infrastructure; and/or donation for investment in port infrastructure; and/or donation for investment in inland port infrastructure; and/or donation for investment in sports venue; and/or donation for investment in air transportation infrastructure; and/or donation for investment in highway infrastructure; and/or donation for investment in road infrastructure; and/or donation for investment in education; and/or donation for investment in energy infrastructure; and/or donation for investment in renewable energy; and/or investment in nuclear energy; and/or donation for investment in civil infrastructure; and/or donation for investment in autonomous vehicle infrastructure; and/or donation for investment in flying vehicle infrastructure; and/or donation for investment in military infrastructure; and/or donation for investment in autonomous vehicle manufacturing; and/or donation for investment in flying vehicle manufacturing; and/or donation for investment in crypto currency; and/or donation for investment in block chain; and/or donation for investment in military hardware; and/or donation for investment in automobile manufacturing; and/or donation for investment in aircraft manufacturing; and/or donation for investment involving Islamic finance; and/or donation for investment involving donation; and/or donation for investment involving crowd funding.

Some embodiments of the invention comprise a computer-implemented method that includes at least: specifically programming at least one computer system or a portion of at least one computer system to perform at least one of the following: aggregate crowd funding for investment; and/or crowd funding for investment in aircraft; and/or crowd funding for investment in satellites; and/or crowd funding for investment in spacecraft; and/or crowd funding for investment in commercial aviation; and/or crowd funding for investment in aerospace; and/or crowd funding for investment in infrastructure; and/or crowd funding for investment in real estate; and/or crowd funding for investment in information technology software; and/or crowd funding for investment in information technology hardware; and/or crowd funding for investment in telecommunications; and/or crowd funding for investment in aircraft and/or satellites and/or spacecraft to finance infrastructure; and/or crowd funding for investment in high-speed rail; and/or crowd funding for investment in smart grid; and/or crowd funding for investment in 5G; and/or crowd funding for investment in Space Internet; and/or crowd funding for investment in water supply system or water supply network; and/or crowd funding for investment in water infrastructure; and/or crowd funding for investment in airport infrastructure; and/or crowd funding for investment in port infrastructure; and/or crowd funding for investment in inland port infrastructure; and/or crowd funding for investment in sports venue; and/or crowd funding for investment in air transportation infrastructure; and/or crowd funding for investment in highway infrastructure; and/or crowd funding for investment in road infrastructure; and/or crowd funding for investment in education; and/or crowd funding for investment in energy infrastructure; and/or crowd funding for investment in renewable energy; and/or investment in nuclear energy; and/or crowd funding for investment in civil infrastructure; and/or crowd funding for investment in autonomous vehicle infrastructure; and/or crowd funding for investment in flying vehicle infrastructure; and/or crowd funding for investment in military infrastructure; and/or crowd funding for investment in autonomous vehicle manufacturing; and/or crowd funding for investment in flying vehicle manufacturing; and/or crowd funding for investment in crypto currency; and/or crowd funding for investment in block chain; and/or crowd funding for investment in military hardware; and/or crowd funding for investment in automobile manufacturing; and/or crowd funding for investment in aircraft manufacturing; and/or crowd funding for investment involving donation; and/or crowd funding for investment involving Islamic finance; and/or crowd funding for investment involving donation; and/or crowd funding for investment involving crowd funding.

Some embodiments of the invention comprise a computer-implemented method that includes specifically programming at least one computer system or a portion of at least one computer system to perform at least one of the following: deriving revenues through the leasing model involving investment; and/or deriving revenues through the leasing model involving investment in aircraft; and/or deriving revenues through the leasing model involving investment in satellites; and/or deriving revenues through the leasing model involving investment in spacecraft; and/or deriving revenues through the leasing model involving investment in commercial aviation; and/or deriving revenues through the leasing model involving investment in aerospace; and/or deriving revenues through the leasing model involving investment in infrastructure; and/or deriving revenues through the leasing model involving investment in real estate; and/or deriving revenues through the leasing model involving investment in information technology software; and/or deriving revenues through the leasing model involving investment in information technology hardware; and/or deriving revenues through the leasing model involving investment in telecommunications; and/or deriving revenues through the leasing model involving investment in aircraft and/or satellites and/or spacecraft to finance infrastructure; and/or deriving revenues through the leasing model involving investment in high-speed rail; and/or deriving revenues through the leasing model involving investment in smart grid; and/or deriving revenues through the leasing model involving investment in 5G; and/or deriving revenues through the leasing model involving investment in Space Internet; and/or deriving revenues through the leasing model involving investment in water supply system or water supply network; and/or deriving revenues through the leasing model involving investment in water infrastructure; and/or deriving revenues through the leasing model involving investment in airport infrastructure; and/or deriving revenues through the leasing model involving investment in port infrastructure; and/or deriving revenues through the leasing model involving investment in inland port infrastructure; and/or deriving revenues through the leasing model involving investment in sports venue; and/or deriving revenues through the leasing model involving investment in air transportation infrastructure; and/or deriving revenues through the leasing model involving investment in surface transportation infrastructure; and/or deriving revenues through the leasing model involving investment in rail infrastructure; and/or deriving revenues through the leasing model involving investment in highway infrastructure; and/or deriving revenues through the leasing model involving investment in road infrastructure; and/or deriving revenues through the leasing model involving investment in education; and/or deriving revenues through the leasing model involving investment in energy infrastructure; and/or deriving revenues through the leasing model involving investment in renewable energy; and/or investment in nuclear energy; and/or deriving revenues through the leasing model involving investment in civil infrastructure; and/or deriving revenues through the leasing model involving investment in autonomous vehicle infrastructure; and/or deriving revenues through the leasing model involving investment in flying vehicle infrastructure; and/or deriving revenues through the leasing model involving investment in military infrastructure; and/or deriving revenues through the leasing model involving investment in autonomous vehicle manufacturing; and/or deriving revenues through the leasing model involving investment in flying vehicle manufacturing; and/or deriving revenues through the leasing model involving investment in crypto currency; and/or deriving revenues through the leasing model involving investment in block chain; and/or deriving revenues through the leasing model involving investment in military hardware; and/or deriving revenues through the leasing model involving investment in automobile manufacturing; and/or deriving revenues through the leasing model involving investment in aircraft manufacturing; and/or deriving revenues through the leasing model involving investment in aviation education; and/or deriving revenues through the leasing model in investment involving Islamic finance; and/or deriving revenues through the leasing model in investment involving donation; and/or deriving revenues through the leasing model in investment involving crowd funding.

### DESCRIPTION OF THE DRAWINGS

FIG. 1 illustrates a strategic overview of EB-5 visa program enabled implementation in accordance with some embodiments of the invention.

FIG. 2 illustrates a strategic overview of EB-5 visa program enabled implementation in accordance with some embodiments of the invention.

FIG. 3 illustrates a strategic overview of EB-5 visa program enabled implementation in accordance with some embodiments of the invention.

FIG. 4 illustrates a strategic overview of EB-5 visa program enabled implementation in accordance with some embodiments of the invention.

FIG. 5 illustrates a strategic overview of EB-5 visa program enabled implementation in accordance with some embodiments of the invention.

FIG. 6 illustrates a strategic overview of EB-5 visa program enabled implementation in accordance with some embodiments of the invention.

FIG. 7 illustrates a strategic overview of EB-5 visa program enabled implementation in accordance with some embodiments of the invention.

FIG. 8 illustrates a jobs flowchart in accordance with some embodiments of the invention.

FIG. 9 illustrates a jobs flowchart in accordance with some embodiments of the invention.

FIG. 10 illustrates an EB-5 visa premium product investment pyramid chart in accordance with some embodiments of the invention.

FIG. 11 illustrates an infrastructure investment pyramid chart in accordance with some embodiments of the invention.

FIG. 12 illustrates a strategic overview and process of EB-5 visa program enabled implementation in accordance with some embodiments of the invention.

FIG. 13 illustrates a strategic overview and process of EB-5 visa program enabled implementation in accordance with some embodiments of the invention.

FIG. 14 illustrates a strategic overview and process of EB-5 visa program enabled implementation in accordance with some embodiments of the invention.

FIG. 15 illustrates a strategic overview and process of EB-5 visa program enabled implementation in accordance with some embodiments of the invention.

FIG. 16 illustrates a strategic overview and process of commercial airplanes, satellites and infrastructure financing in accordance with some embodiments of the invention.

FIG. 17 illustrates a system provider investor and/or credit enhancement financing process in accordance with some embodiments of the invention.

FIG. 18 illustrates a system provider investor financing process in accordance with some embodiments of the invention.

FIG. 19 illustrates a system provider credit enhancement financing process in accordance with some embodiments of the invention.

FIG. 20 illustrates a system provider airplanes and infrastructure financing process in accordance with some embodiments of the invention.

FIG. 21 illustrates a system provider satellites and infrastructure financing process in accordance with some embodiments of the invention.

FIG. 22 illustrates a system provider spacecraft and infrastructure financing process in accordance with some embodiments of the invention.

FIG. 23 illustrates a system provider investment and infrastructure financing process in accordance with some embodiments of the invention.

FIG. 24 illustrates United States jobs, investments and jobs per-EB-5 visa process totals in accordance with some embodiments of the invention.

FIG. 25 illustrates a credit facility strategy, relationship and process to finance Boeing® products in accordance with some embodiments of the invention.

FIG. 26 illustrates a credit facility strategy, relationship and process to finance Boeing® products in accordance with some embodiments of the invention.

FIG. 27 illustrates a credit facility strategy, relationship and process to finance aerospace products in accordance with some embodiments of the invention.

FIG. 28 illustrates a credit facility strategy, relationship and process to finance aerospace products in accordance with some embodiments of the invention.

FIG. 29 illustrates a credit facility strategy, relationship and process to finance infrastructure investment in accordance with some embodiments of the invention.

FIG. 30 illustrates a credit facility strategy, relationship and process to finance infrastructure investment in accordance with some embodiments of the invention.

FIG. 31 illustrates a credit facility strategy, relationship and process to finance investment in accordance with some embodiments of the invention.

FIG. 32 illustrates a credit facility strategy, relationship and process to finance investment in accordance with some embodiments of the invention.

FIG. 33 illustrates an econometrics analysis in accordance with some embodiments of the invention.

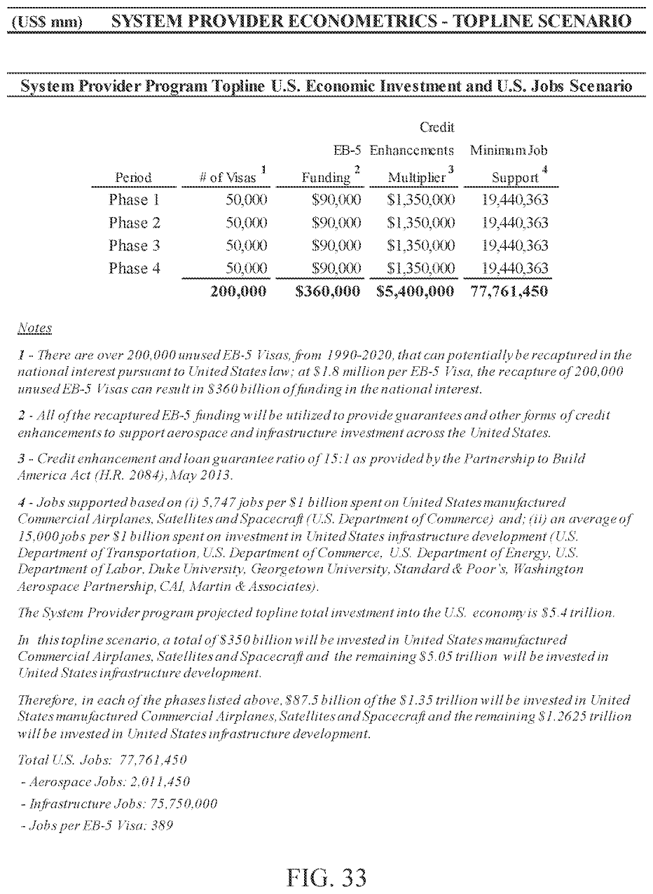

FIG. 34 illustrates an econometrics analysis in accordance with some embodiments of the invention.

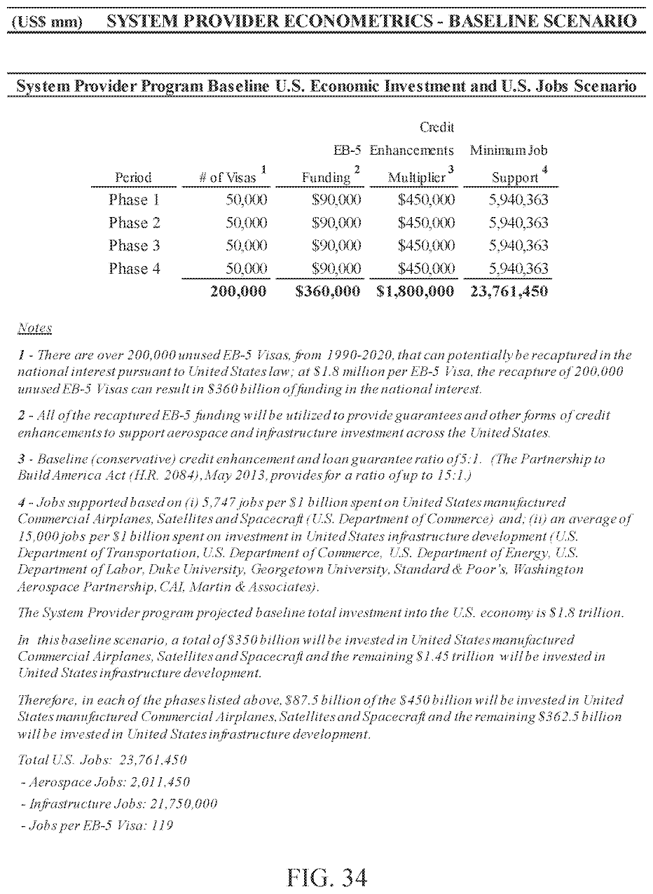

FIG. 35 illustrates an econometrics analysis in accordance with some embodiments of the invention.

FIG. 36 illustrates an econometrics analysis in accordance with some embodiments of the invention.

FIG. 37 illustrates a strategic overview of EB-5 visa program enabled implementation in accordance with some embodiments of the invention.

FIG. 38 illustrates a strategic overview of EB-5 visa program enabled implementation in accordance with some embodiments of the invention.

FIG. 39 illustrates a strategic overview of EB-5 visa program enabled implementation in accordance with some embodiments of the invention.

FIG. 40 illustrates a legal immigration preference system in accordance with some embodiments of the invention.

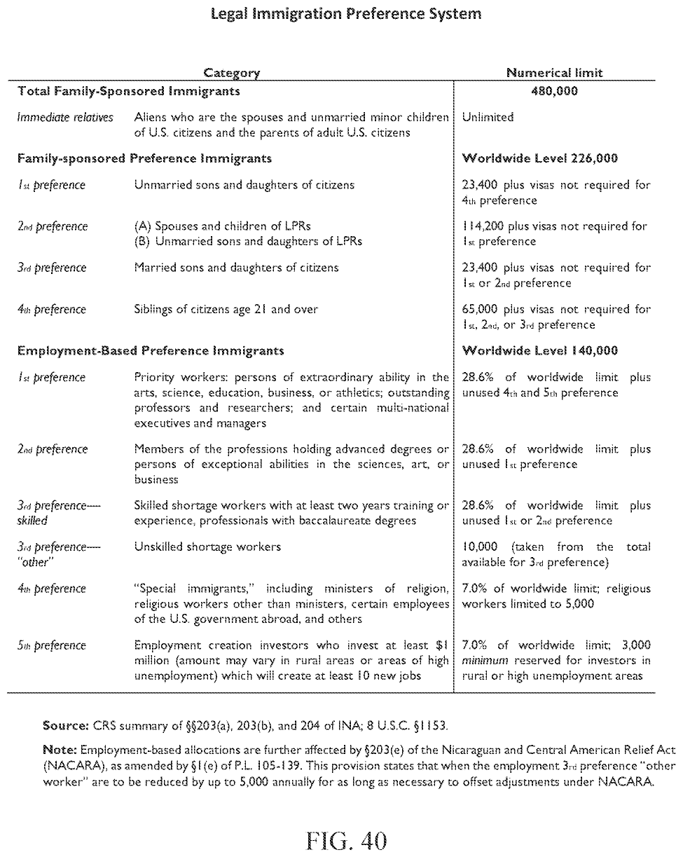

FIG. 41 illustrates an employment-based visa preference category table in accordance with some embodiments of the invention.

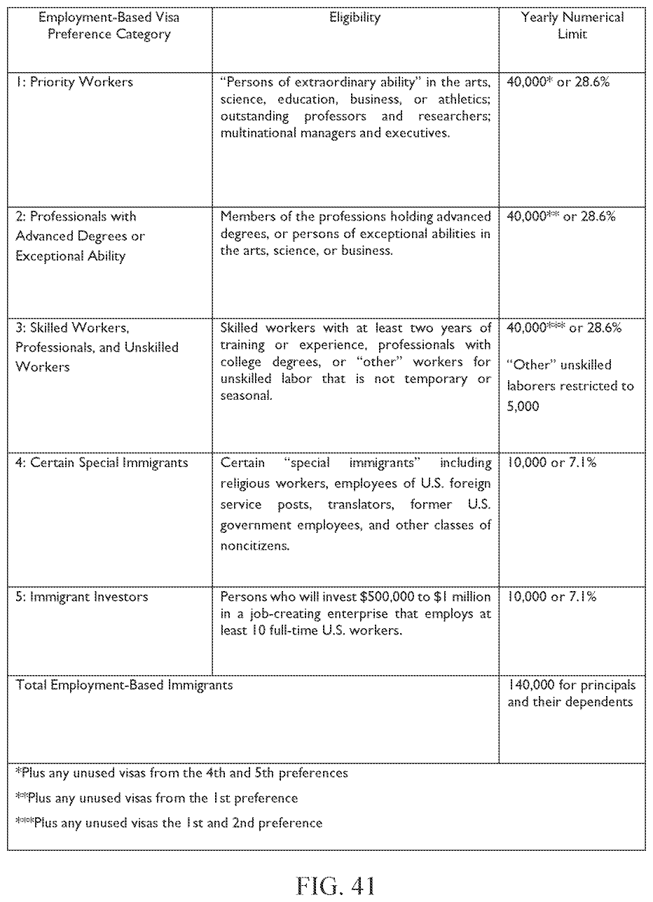

FIG. 42 illustrates an overview of a recapture scenario in accordance with some embodiments of the invention.

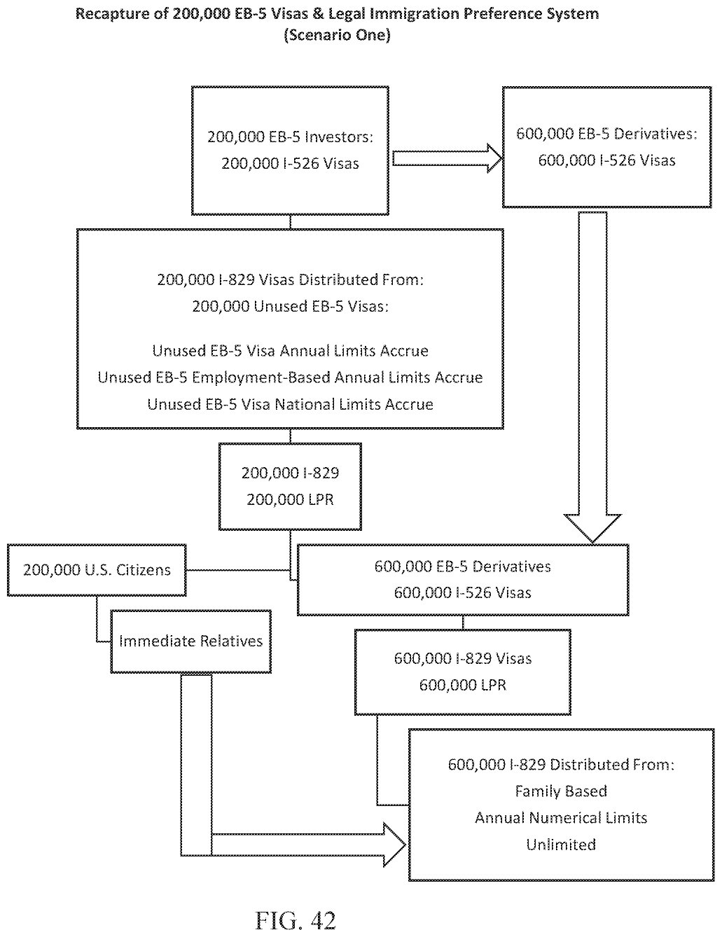

FIG. 43 illustrates an overview of a recapture scenario in accordance with some embodiments of the invention.

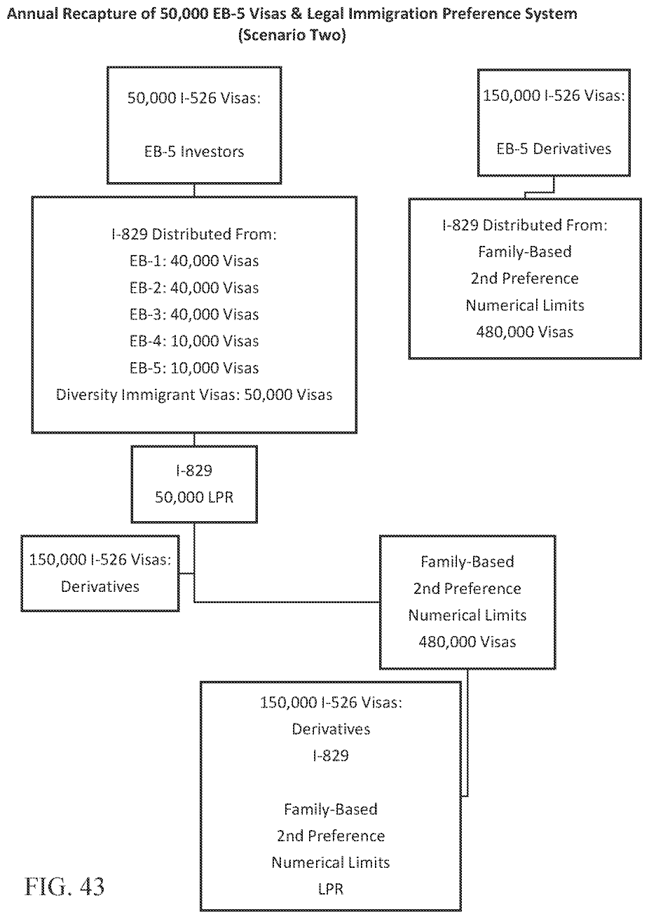

FIG. 44 illustrates an overview of a recapture scenario in accordance with some embodiments of the invention.

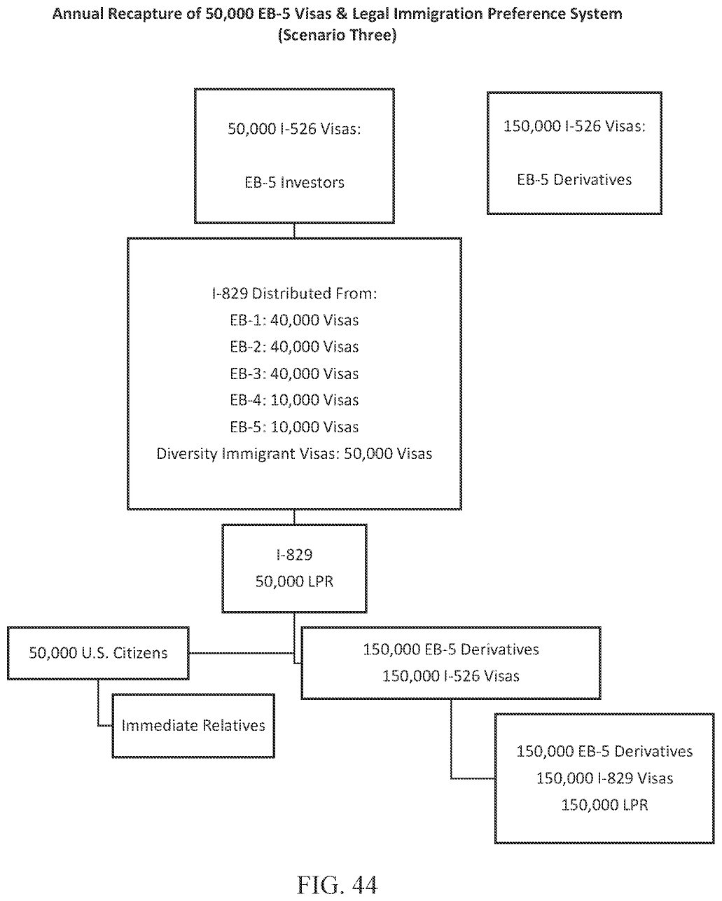

FIG. 45 illustrates a regional center, business plan and projects flowchart in accordance with some embodiments of the invention.

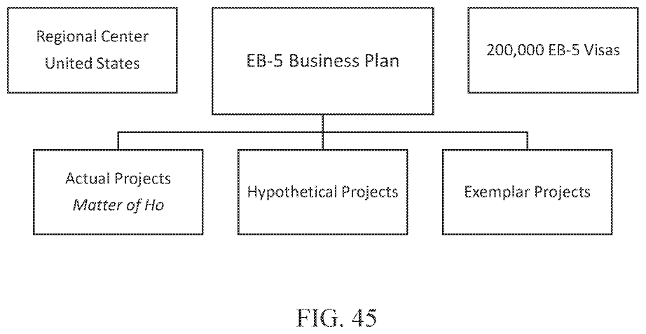

FIG. 46 illustrates a system provider aviation plan in accordance with some embodiments of the invention.

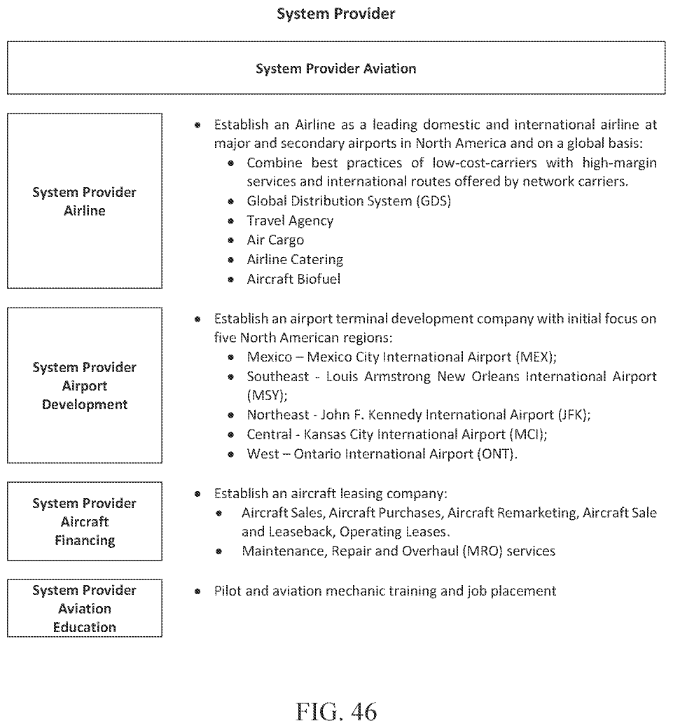

FIG. 47 illustrates a financing relationship in accordance with some embodiments of the invention.

FIG. 48 illustrates a naming rights sponsorship relationship in accordance with some embodiments of the invention.

FIG. 49 illustrates a financing relationship in accordance with some embodiments of the invention.

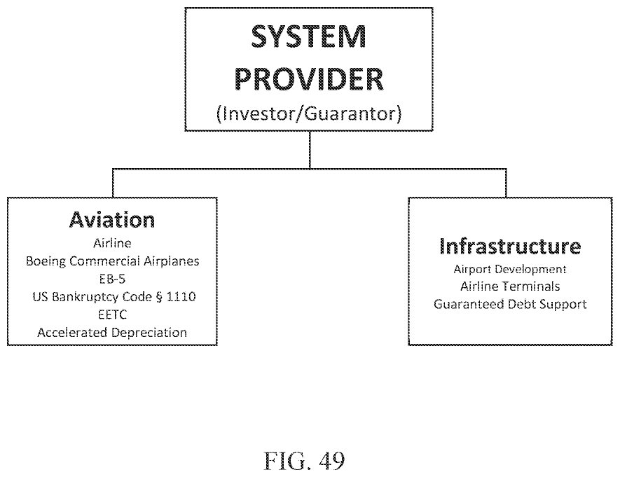

FIG. 50 illustrates a financing and naming rights relationship in accordance with some embodiments of the invention.

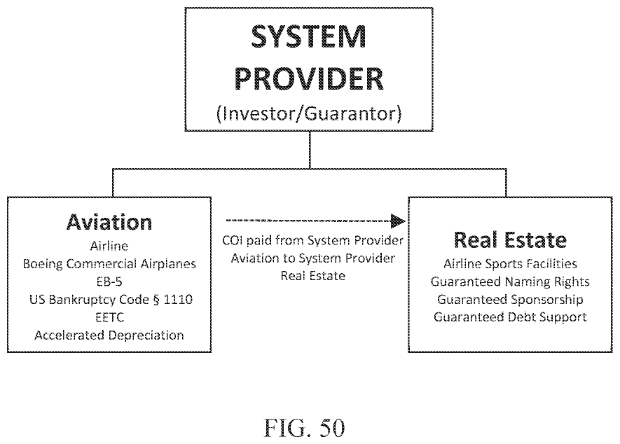

FIG. 51 illustrates a financing and naming rights relationship in accordance with some embodiments of the invention.

FIG. 52 illustrates a financing and naming rights relationship as an example of a financing and naming rights relationship in accordance with some embodiments of the invention.

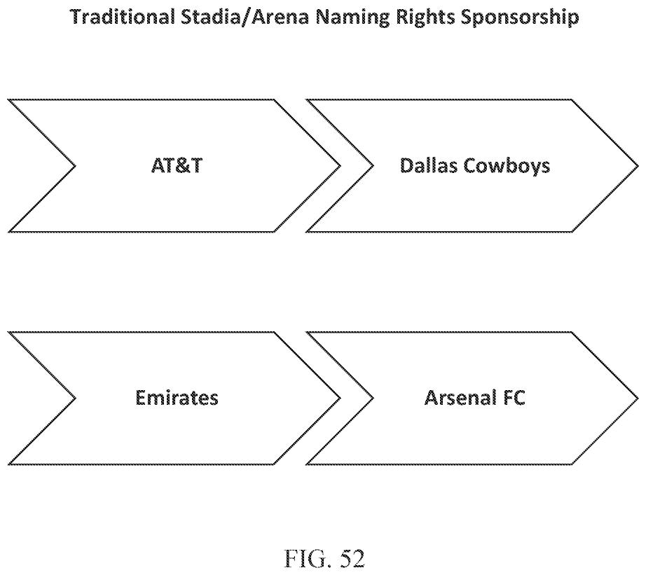

FIG. 53 illustrates EB-5 visa enabled financing relationship diagrams in accordance with some embodiments of the invention.

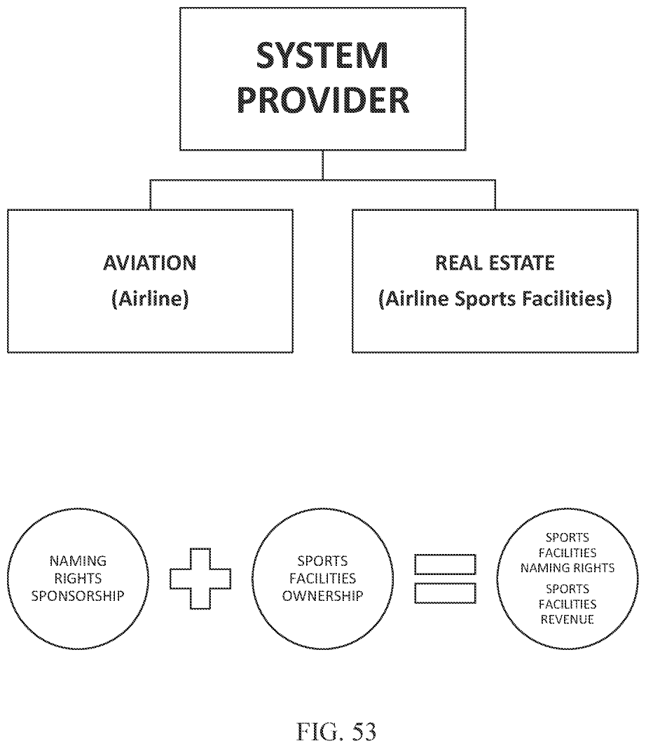

FIG. 54 illustrates an investor system process in accordance with some embodiments of the invention.

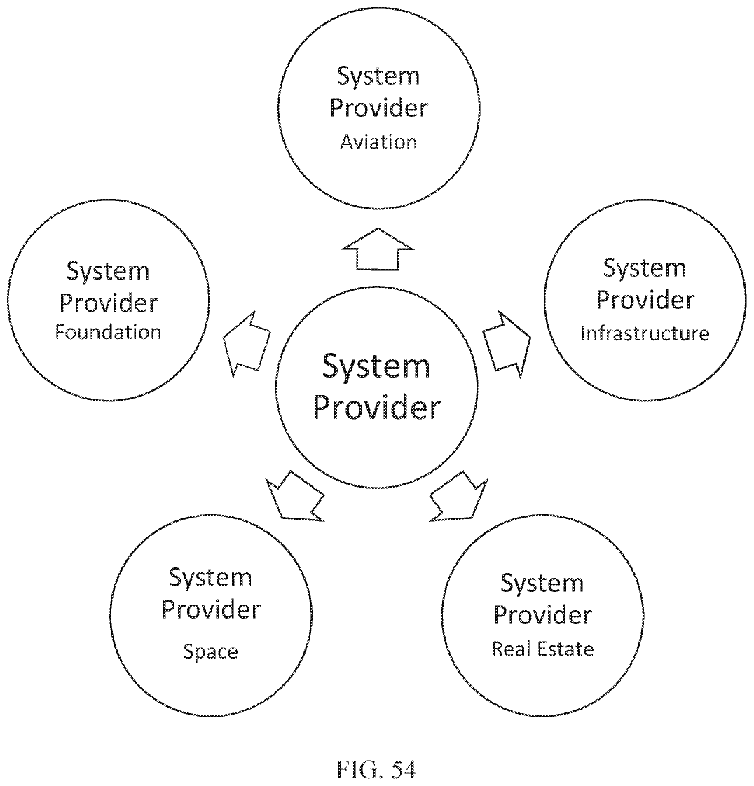

FIG. 55 shows a block diagram of a server system for implementing or operating any of the processes or methods of the invention.

FIG. 56 illustrates an investor process in accordance with some embodiments of the invention.

FIG. 57 illustrates an investor system process in accordance with some embodiments of the invention.

FIG. 58 illustrates a system network for performing the processes of FIGS. 56-57 in accordance with some embodiments of the invention.

### DETAILED DESCRIPTION

In some embodiments, immigrant investor visa programs or citizenship-by-investment programs are programs designed to attract foreign capital and/or foreign nationals into a selected country by providing the right of residence and/or citizenship in the selected country in return. In some embodiments, immigrant investor programs usually have multiple criteria that must be fulfilled for the investment to qualify, often pertaining to job creation, real estate purchases, non-refundable contributions or specific targeted industries. In some embodiments, most of these programs are structured to ensure that the investment contributes to the welfare, advancement and economic development of the selected country in which the foreign nationals wish to reside or obtain citizenship. In some embodiments, many countries including the United States have immigrant investor visa programs.

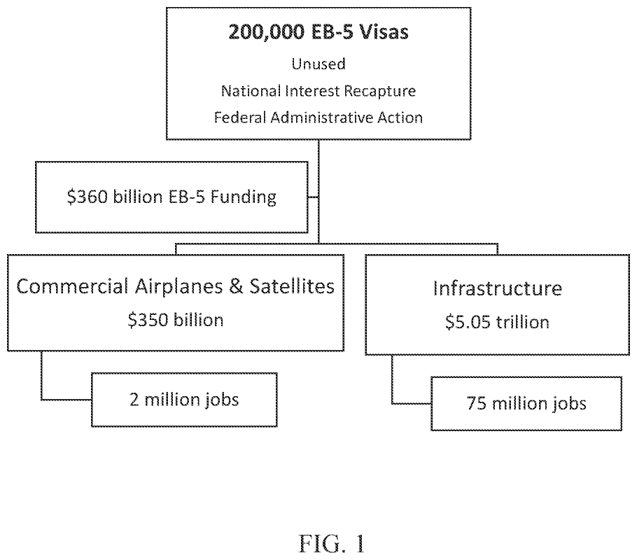

FIG. 1 illustrates one or more steps implemented by the system involving the recapture of unused EB-5 visas for use in subsequent fiscal years according to some embodiments. In some embodiments, the system is configured to process the recapture of unused EB-5 visas (e.g., up to 200,000 unused EB-5 visas) for use in subsequent fiscal years. In some embodiments, the system is configured to collect, process, store, and track EB-5 funding. In some embodiments, the system is configured to identify one or more projects which match criteria and/or rules associated with EB-5 funding. In some embodiments, one or more projects comprise commercial airplane and/or satellite projects. In some embodiments, for example, the system is configured to process the recapture of up to 200,000 unused EB-5 visas for use in subsequent fiscal years utilizing the $1,800,000 EB-5 visa funding amount to finance up to or over $350 billion of commercial airplanes and satellites resulting in creating or preserving up to or over 2,000,000 aerospace jobs in the United States and $350 billion in commercial airplanes and/or satellites projects. In some embodiments, the system is configured to calculate and/or process request for credit enhancement. In some embodiments, the unused portion of the aggregated EB-5 funding is used by the system in calculating increased funding for credit enhancement. In some embodiments, the increased funding is used for infrastructure projects. In some embodiments, the system is configured to incorporate the unused portion of the aggregated EB-5 funding (e.g., $360 billion) to calculate projected available funds to finance and develop infrastructure (e.g. up to or over $5 trillion of infrastructure) in the United States resulting in creating or preserving up to or over 75,000,000 infrastructure jobs and a total of up to or over 77,000,000 jobs in the United States. In some embodiments, the system uses proprietary software to execute one or more computer-implemented steps described throughout this application. In some embodiments, the system uses conventional software to execute one or more computer-implemented steps described throughout this application. In some embodiments, the steps described throughout this application are directed to a financial method. As used herein, in some embodiments, the term “aggregate” means “aggregate, manage and/or track”.

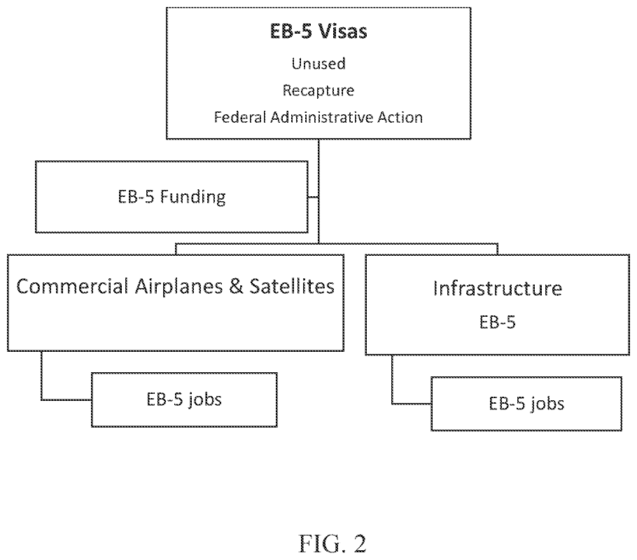

FIG. 2 illustrates one or more steps implemented by the system involving the recapture of unused EB-5 visas for use in subsequent fiscal years according to some embodiments. In some embodiments, the system is configured to process the recapture of unused EB-5 visas for use in subsequent fiscal years. In some embodiments, the system is configured to collect, process, store, and track EB-5 funding. In some embodiments, the system is configured to identify one or more projects which match criteria and/or rules associated with EB-5 funding. In some embodiments, one or more projects comprise commercial airplanes and/or satellites projects. In some embodiments, the system is configured to calculate and/or process request for credit enhancement. In some embodiments, the unused portion of the aggregated EB-5 funding is used by the system in calculating increased funding for credit enhancement. In some embodiments, the increased funding is used for infrastructure projects. In some embodiments, the system is configured to incorporate the unused portion of the aggregated EB-5 funding to calculate projected available funds to finance and develop infrastructure in the United States resulting in creating or preserving jobs in the United States.

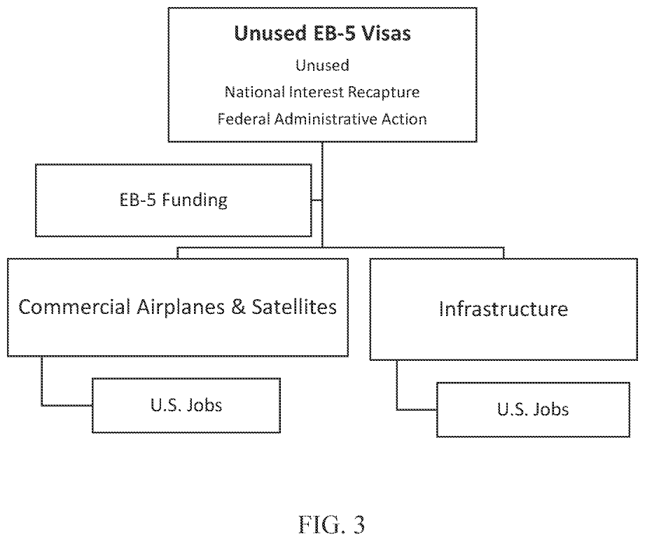

FIG. 3 illustrates one or more steps implemented by the system involving the recapture of unused EB-5 visas for use in subsequent fiscal years according to some embodiments. In some embodiments, the system is configured to process the recapture of unused EB-5 visas for use in subsequent fiscal years. In some embodiments, the system is configured to collect, process, store, and track EB-5 funding. In some embodiments, the system is configured to identify one or more projects which match criteria and/or rules associated with EB-5 funding. In some embodiments, one or more projects comprise commercial airplanes and/or satellites projects. In some embodiments, the system is configured to calculate and/or process request for credit enhancement. In some embodiments, the unused portion of the aggregated EB-5 funding is used by the system in calculating increased funding for credit enhancement. In some embodiments, the increased funding is used for infrastructure projects. In some embodiments, the system is configured to incorporate the unused portion of the aggregated EB-5 funding to calculate projected available funds to finance and develop infrastructure in the United States resulting in creating or preserving jobs in the United States.

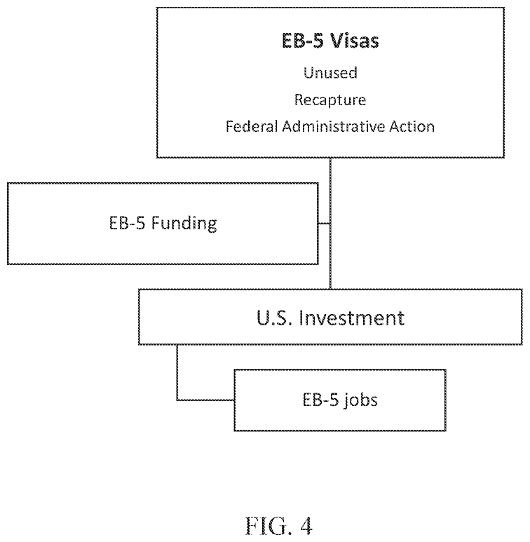

FIG. 4 illustrates one or more steps implemented by the system involving the recapture of unused EB-5 visas for use in subsequent fiscal years according to some embodiments. In some embodiments, the system is configured to process the recapture of unused EB-5 visas for use in subsequent fiscal years. In some embodiments, the system is configured to collect, process, store, and track EB-5 funding. In some embodiments, the system is configured to identify one or more projects which match criteria and/or rules associated with EB-5 funding. In some embodiments, one or more projects comprise investment. In some embodiments, the system is configured to calculate and/or process request for credit enhancement. In some embodiments, the unused portion of the aggregated EB-5 funding is used by the system in calculating increased funding for credit enhancement. In some embodiments, the increased funding is used for investment. In some embodiments, the system is configured to incorporate the unused portion of the aggregated EB-5 funding to calculate projected available funds to finance investment in the United States resulting in creating or preserving jobs in the United States.

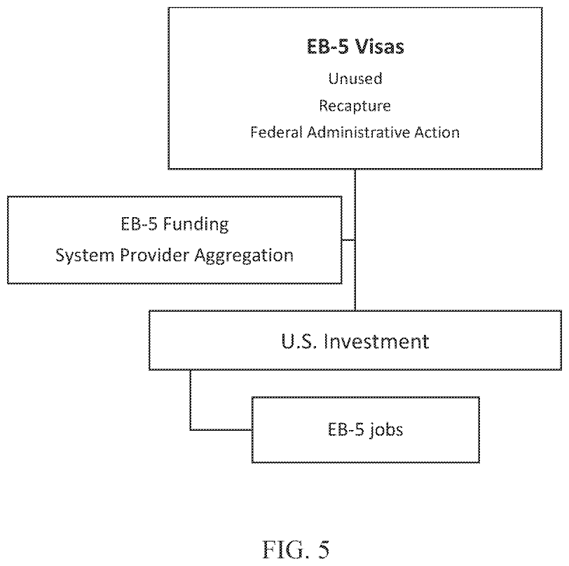

FIG. 5 illustrates one or more steps implemented by the system involving the recapture of unused EB-5 visas for use in subsequent fiscal years according to some embodiments. In some embodiments, the system is configured to process the recapture of unused EB-5 visas for use in subsequent fiscal years as a result of federal administrative action. In some embodiments, the system is configured to collect, process, store, and track EB-5 funding. In some embodiments, the system is configured to identify one or more projects which match criteria and/or rules associated with EB-5 funding. In some embodiments, one or more projects comprise investment. In some embodiments, the system is configured to calculate and/or process request for credit enhancement. In some embodiments, the unused portion of the aggregated EB-5 funding is used by the system in calculating increased funding for credit enhancement. In some embodiments, the increased funding is used for investment. In some embodiments, the system is configured to incorporate the unused portion of the aggregated EB-5 funding to calculate projected available funds to finance investment in the United States resulting in creating or preserving jobs in the United States.

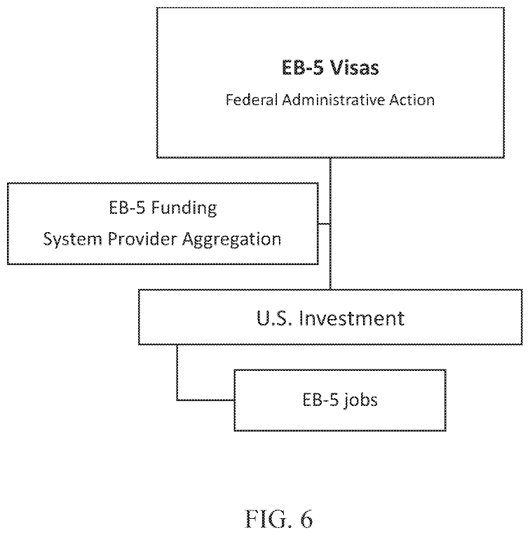

FIG. 6 illustrates one or more steps implemented by the system involving EB-5 visas according to some embodiments. In some embodiments, the system is configured to process EB-5 visas as a result of federal administrative action. In some embodiments, the system is configured to collect, process, store, and track EB-5 funding. In some embodiments, the system is configured to identify one or more projects which match criteria and/or rules associated with EB-5 funding. In some embodiments, one or more projects comprise investment. In some embodiments, the system is configured to calculate and/or process request for credit enhancement. In some embodiments, the unused portion of the aggregated EB-5 funding is used by the system in calculating increased funding for credit enhancement. In some embodiments, the increased funding is used for investment. In some embodiments, the system is configured to incorporate the unused portion of the aggregated EB-5 funding to calculate projected available funds to finance investment in the United States resulting in creating or preserving jobs in the United States.

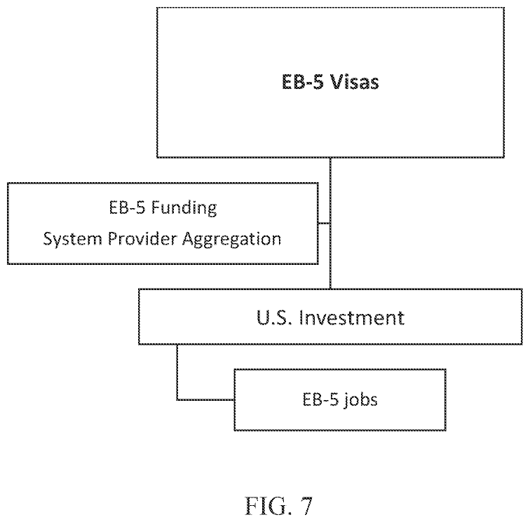

FIG. 7 illustrates one or more steps implemented by the system involving EB-5 visas according to some embodiments. In some embodiments, the system is configured to process EB-5 visas. In some embodiments, the system is configured to collect, process, store, and track EB-5 funding. In some embodiments, the system is configured to identify one or more projects which match criteria and/or rules associated with EB-5 funding. In some embodiments, one or more projects comprise investment. In some embodiments, the system is configured to calculate and/or process request for credit enhancement. In some embodiments, the unused portion of the aggregated EB-5 funding is used by the system in calculating increased funding for credit enhancement. In some embodiments, the increased funding is used for investment. In some embodiments, the system is configured to incorporate the unused portion of the aggregated EB-5 funding to calculate projected available funds to finance investment in the United States resulting in creating or preserving jobs in the United States.

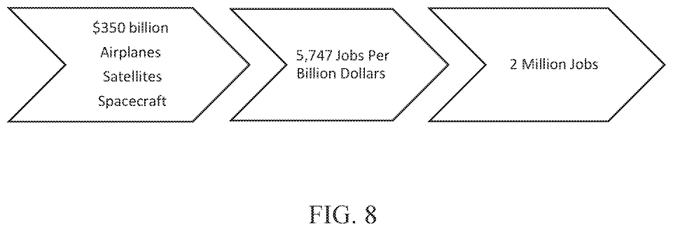

FIG. 8 illustrates one or more steps implemented by the system involving the financing and acquisition of $350 billion of commercial airplanes and/or satellites and/or spacecraft resulting in creating or preserving up to or over 2,000,000 aerospace jobs in the United States based on 5,747 jobs per $1 billion of investment in United States commercial airplanes and/or satellites and/or spacecraft.

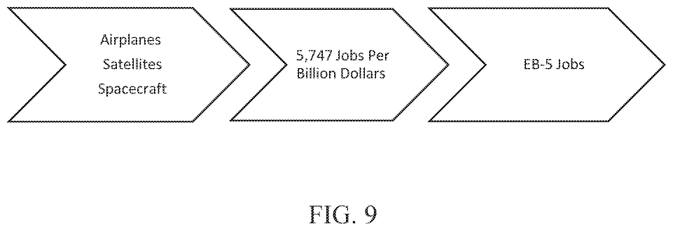

FIG. 9 illustrates one or more steps implemented by the system involving the financing and acquisition of commercial airplanes and/or satellites and/or spacecraft resulting in creating or preserving 5,747 jobs per $1 billion of investment in United States commercial airplanes and/or satellites and/or spacecraft.

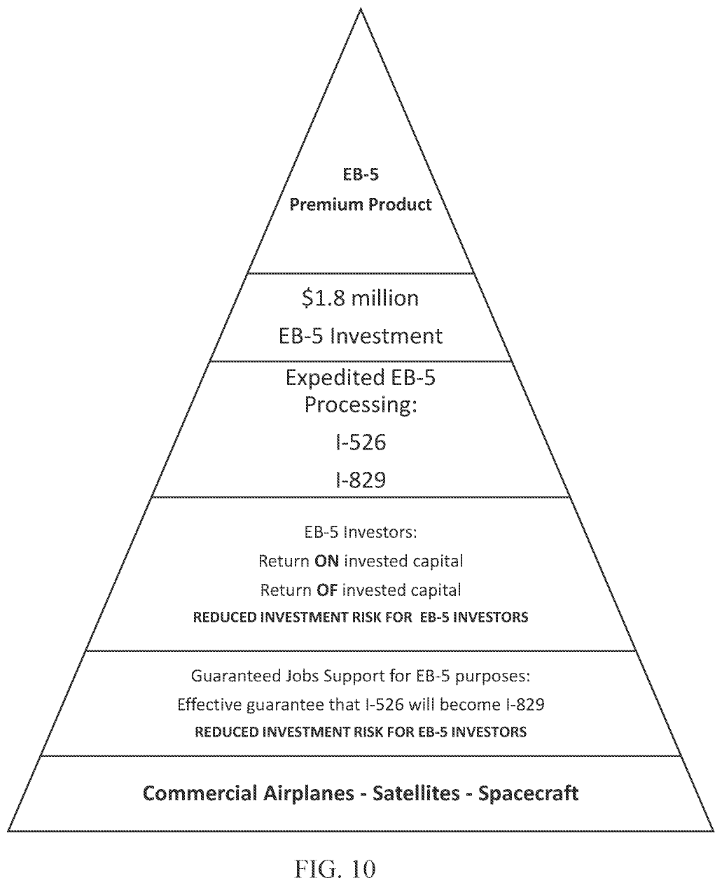

FIG. 10 illustrates one or more steps implemented by the system that that manages immigrant investor visas and/or investments in pursuit of immigrant investor visas including involving EB-5 according to some embodiments. In some embodiments, the system includes the ability to implement one or more of the following operations: accept and process visa applications, accept and process expedited visa applications, authenticate investment source of funds, enable background check processing, enable national security related screening and processing, track visa processing, track legal compliance, track securities law compliance, track national security law compliance, suggest investments, track job creation, track investment performance, and/or monitor investments for fraud. In some embodiments, the system significantly increases the likelihood of obtaining an immigrant investor visa including, but not limited to, an EB-5 visa while mitigating risk associated with investment.

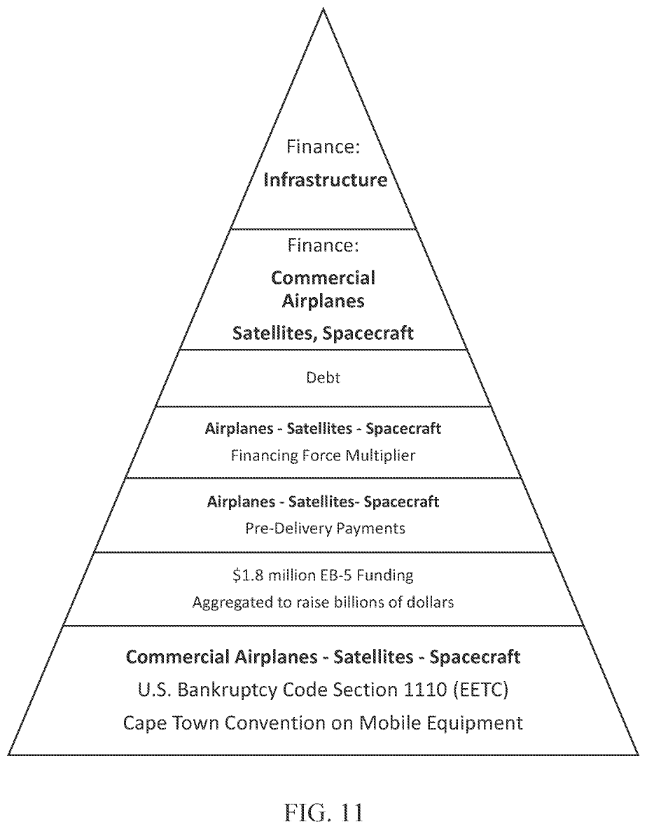

FIG. 11 illustrates one or more steps implemented by the system involving EB-5 visas according to some embodiments. In some embodiments, the system is configured to process EB-5 visas. In some embodiments, the system is configured to collect, process, store, and track EB-5 funding. In some embodiments, the system is configured to identify one or more projects which match criteria and/or rules associated with EB-5 funding. In some embodiments, one or more projects comprise commercial airplanes and/or satellite projects. In some embodiments, for example, the system is configured to process EB-5 visas utilizing the $1,800,000 EB-5 visa funding amount to finance commercial airplanes and/or satellites and/or spacecraft. In some embodiments, the system is configured to calculate and/or process request for credit enhancement. In some embodiments, the unused portion of the aggregated EB-5 funding is used by the system in calculating increased funding for credit enhancement. In some embodiments, the increased funding is used for infrastructure projects. In some embodiments, the system is configured to incorporate the unused portion of the aggregated EB-5 funding to calculate projected available funds to finance and develop infrastructure in the United States resulting in creating or preserving aerospace and infrastructure jobs in the United States.

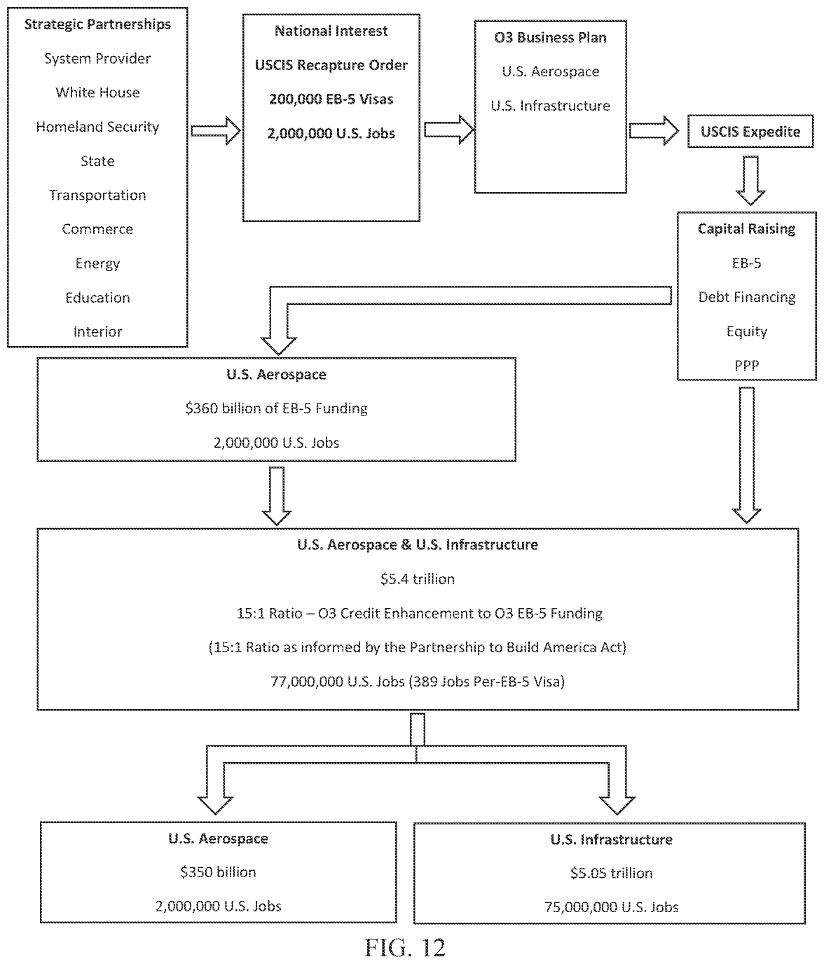

FIG. 12 illustrates one or more steps implemented by the system involving the recapture of unused EB-5 visas for use in subsequent fiscal years according to some embodiments. In some embodiments, the system is configured to process the recapture of unused EB-5 visas (e.g., up to 200,000 unused EB-5 visas) for use in subsequent fiscal years using federal administrative action and strategic partnerships with the White House and/or U.S. Department of State and/or U.S. Department of Homeland Security and/or U.S. Department of Transportation and/or U.S. Department of Transportation and/or U.S. Department of Commerce and/or U.S. Department of Energy and/or U.S. Department of Education and/or U.S. Department of Interior. In some embodiments, the system is configured to collect, process, store, and track EB-5 funding. In some embodiments, the system is configured to identify one or more projects which match criteria and/or rules associated with EB-5 funding. In some embodiments, one or more projects comprise commercial airplane and/or satellite projects. In some embodiments, for example, the system is configured to process the recapture of up to 200,000 unused EB-5 visas for use in subsequent fiscal years utilizing the $1,800,000 EB-5 visa funding amount to finance up to or over $350 billion of commercial airplanes and satellites resulting in creating or preserving up to or over 2,000,000 aerospace jobs in the United States and $350 billion in commercial airplanes and/or satellites projects. In some embodiments, the system is configured to calculate and/or process one or more request for credit enhancement. In some embodiments, the unused portion of the aggregated EB-5 funding is used by the system in calculating increased funding for credit enhancement. In some embodiments, the increased funding is used for infrastructure projects. In some embodiments, the system is configured to incorporate the unused portion of the aggregated EB-5 funding (e.g., $360 billion) to calculate projected available funds to finance and develop infrastructure (e.g. up to or over $5 trillion of infrastructure) in the United States resulting in creating or preserving up to or over 75,000,000 infrastructure jobs and a total of up to or over 77,000,000 jobs in the United States.

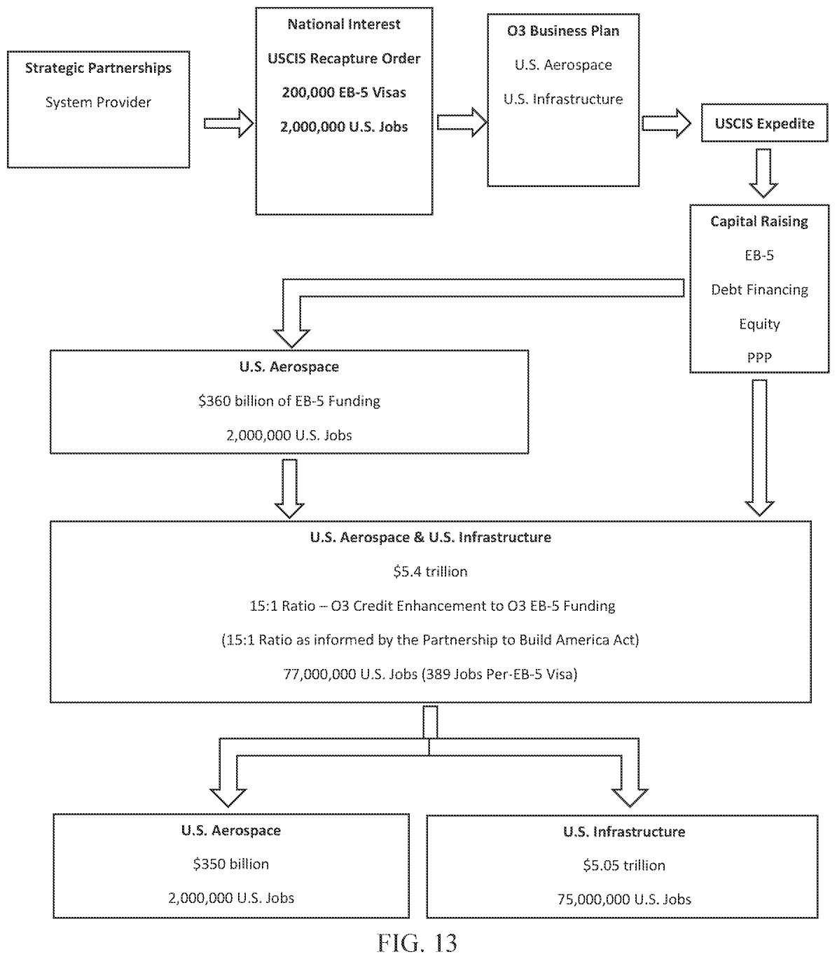

FIG. 13 illustrates one or more steps implemented by the system involving the recapture of unused EB-5 visas for use in subsequent fiscal years according to some embodiments. In some embodiments, the system is configured to process the recapture of unused EB-5 visas (e.g., up to 200,000 unused EB-5 visas) for use in subsequent fiscal years using federal administrative action and strategic partnerships. In some embodiments, the system is configured to collect, process, store, and track EB-5 funding. In some embodiments, the system is configured to identify one or more projects which match criteria and/or rules associated with EB-5 funding. In some embodiments, one or more projects comprise commercial airplane and/or satellite projects. In some embodiments, for example, the system is configured to process the recapture of up to 200,000 unused EB-5 visas for use in subsequent fiscal years utilizing the $1,800,000 EB-5 visa funding amount to finance up to or over $350 billion of commercial airplanes and satellites resulting in creating or preserving up to or over 2,000,000 aerospace jobs in the United States and $350 billion in commercial airplanes and/or satellites projects. In some embodiments, the system is configured to calculate and/or process request for credit enhancement. In some embodiments, the unused portion of the aggregated EB-5 funding is used by the system in calculating increased funding for credit enhancement. In some embodiments, the increased funding is used for infrastructure projects. In some embodiments, the system is configured to incorporate the unused portion of the aggregated EB-5 funding (e.g., $360 billion) to calculate projected available funds to finance and develop infrastructure (e.g. up to or over $5 trillion of infrastructure) in the United States resulting in creating or preserving up to or over 75,000,000 infrastructure jobs and a total of up to or over 77,000,000 jobs in the United States.

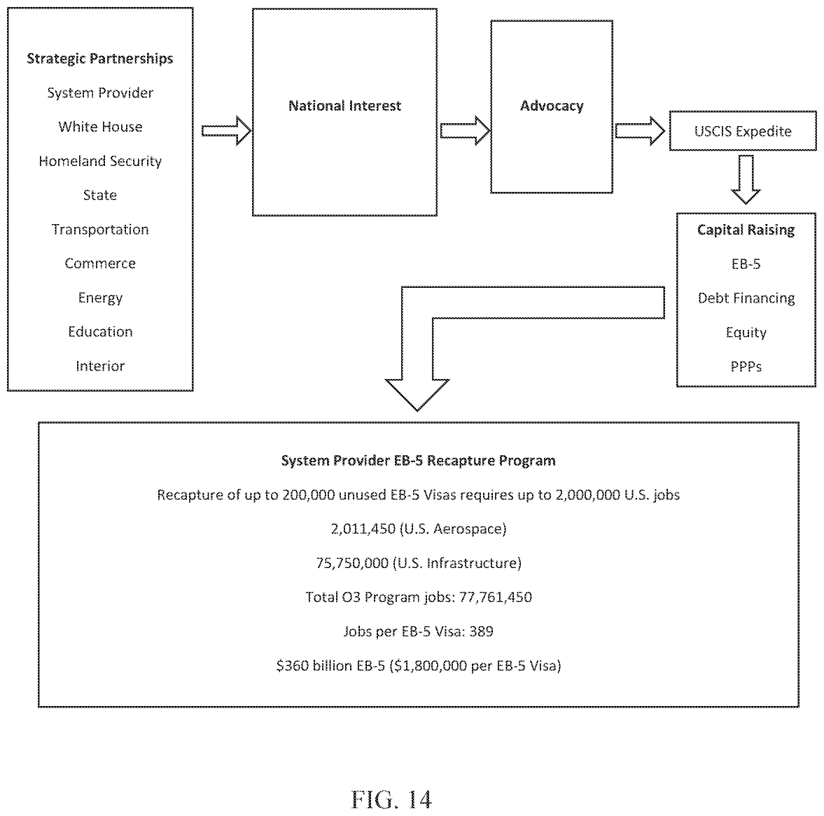

FIG. 14 illustrates one or more steps implemented by the system involving the recapture of unused EB-5 visas for use in subsequent fiscal years according to some embodiments. In some embodiments, the system is configured to process the recapture of unused EB-5 visas (e.g., up to 200,000 unused EB-5 visas) for use in subsequent fiscal years using federal administrative action and strategic partnerships with the White House and/or U.S. Department of State and/or U.S. Department of Homeland Security and/or U.S. Department of Transportation and/or U.S. Department of Transportation and/or U.S. Department of Commerce and/or U.S. Department of Energy and/or U.S. Department of Education and/or U.S. Department of Interior. In some embodiments, the system is configured to collect, process, store, and track EB-5 funding. In some embodiments, the system is configured to identify one or more projects which match criteria and/or rules associated with EB-5 funding. In some embodiments, one or more projects comprise commercial airplane and/or satellite projects. In some embodiments, for example, the system is configured to process the recapture of up to 200,000 unused EB-5 visas for use in subsequent fiscal years utilizing the $1,800,000 EB-5 visa funding amount to finance up to or over $350 billion of commercial airplanes and satellites resulting in creating or preserving up to or over 2,011,450 aerospace jobs in the United States and $350 billion in commercial airplanes and/or satellites projects. In some embodiments, the system is configured to calculate and/or process request for credit enhancement. In some embodiments, the unused portion of the aggregated EB-5 funding is used by the system in calculating increased funding for credit enhancement. In some embodiments, the increased funding is used for infrastructure projects. In some embodiments, the system is configured to incorporate the unused portion of the aggregated EB-5 funding (e.g., $360 billion) to calculate projected available funds to finance and develop infrastructure (e.g. up to or over $5 trillion of infrastructure) in the United States resulting in creating or preserving up to or over 75,750,000 infrastructure jobs and a total of up to or over 77,761,450 jobs in the United States and 389 jobs per EB-5 visa.

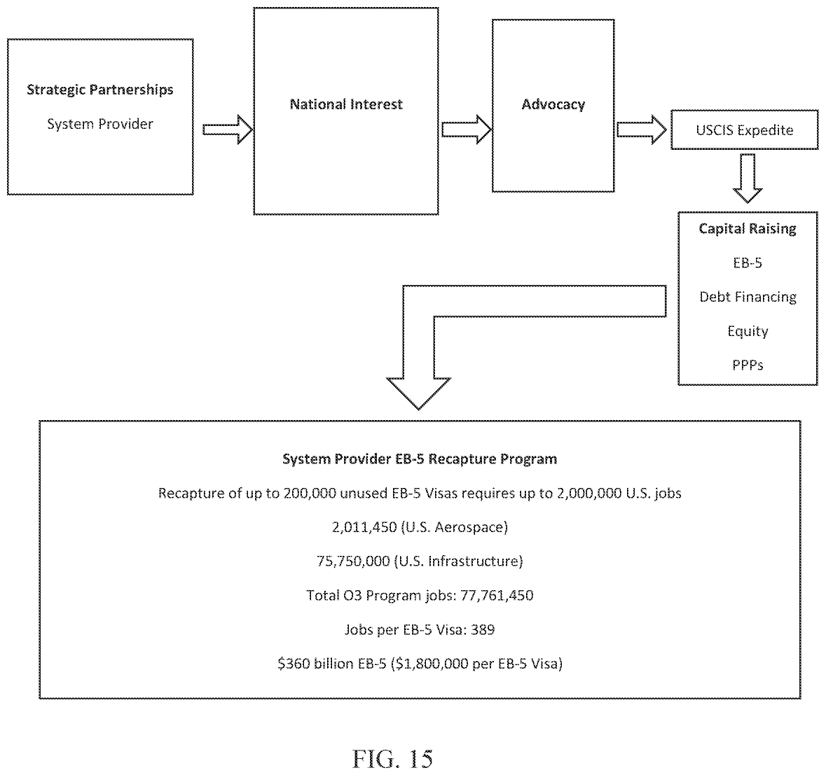

FIG. 15 illustrates one or more steps implemented by the system involving the recapture of unused EB-5 visas for use in subsequent fiscal years according to some embodiments. In some embodiments, the system is configured to process the recapture of unused EB-5 visas (e.g., up to 200,000 unused EB-5 visas) for use in subsequent fiscal years using federal administrative action and strategic partnerships. In some embodiments, the system is configured to collect, process, store, and track EB-5 funding. In some embodiments, the system is configured to identify one or more projects which match criteria and/or rules associated with EB-5 funding. In some embodiments, one or more projects comprise commercial airplane and/or satellite projects. In some embodiments, for example, the system is configured to process the recapture of up to 200,000 unused EB-5 visas for use in subsequent fiscal years utilizing the $1,800,000 EB-5 visa funding amount to finance up to or over $350 billion of commercial airplanes and satellites resulting in creating or preserving up to or over 2,011,450 aerospace jobs in the United States and $350 billion in commercial airplanes and/or satellites projects. In some embodiments, the system is configured to calculate and/or process request for credit enhancement. In some embodiments, the unused portion of the aggregated EB-5 funding is used by the system in calculating increased funding for credit enhancement. In some embodiments, the increased funding is used for infrastructure projects. In some embodiments, the system is configured to incorporate the unused portion of the aggregated EB-5 funding (e.g., $360 billion) to calculate projected available funds to finance and develop infrastructure (e.g. up to or over $5 trillion of infrastructure) in the United States resulting in creating or preserving up to or over 75,750,000 infrastructure jobs and a total of up to or over 77,761,450 jobs in the United States and 389 jobs per EB-5 visa.

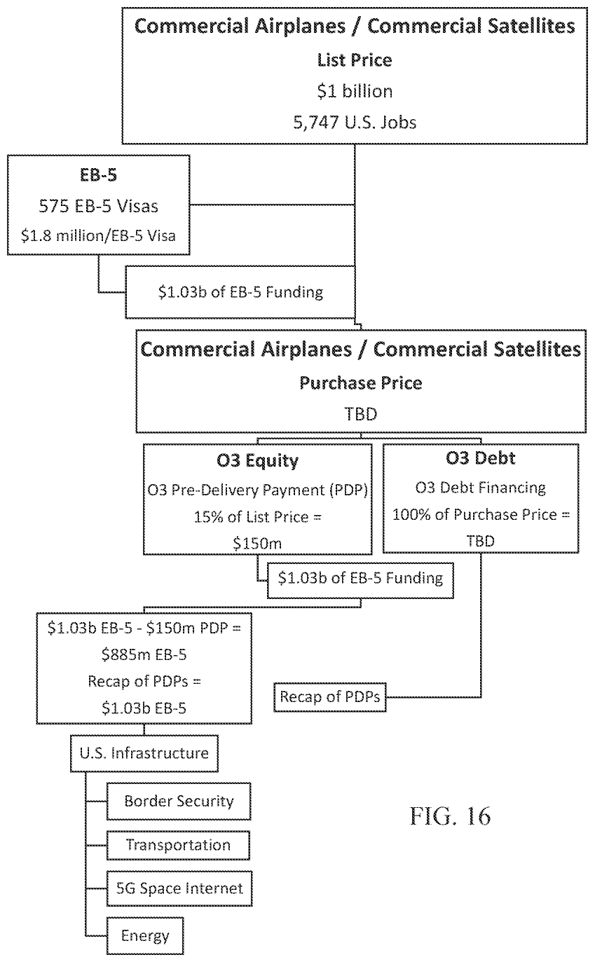

FIG. 16 illustrates one or more steps implemented by the system according to some embodiments involving the financing of $1 billion of commercial airplanes and/or commercial satellites at list price resulting in creating or preserving 5,747 aerospace jobs in the United States resulting in 575 EB-5 visas and, at $1,800,000 per EB-5 visa, $$1.03 billion of EB-5 funding, a portion of which is used as a predelivery payment (PDP) for the financing and acquisition of commercial airplanes and/or commercial satellites. According to some embodiments, $150 million of the EB-5 funding is used as a PDP for the financing of commercial airplanes and/or commercial satellites providing $885 million to be used to finance infrastructure including, but not limited to, border security, transportation, 5G Space Internet and energy. According to some embodiments, the $150 million PDP is recapitalized with $150 million of debt financing prior to delivery of the commercial airplanes and/or commercial satellites providing an additional $150 million of funding for infrastructure investment and/or credit enhancement as a result of the recapitalization of the $150 million PDP for commercial airplanes and/or spacecraft.

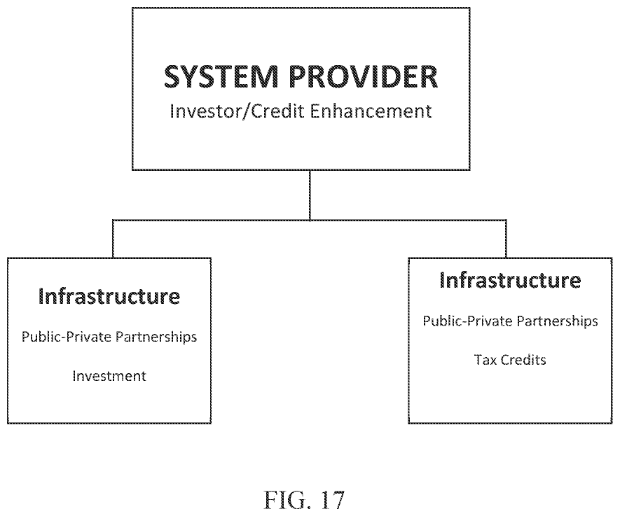

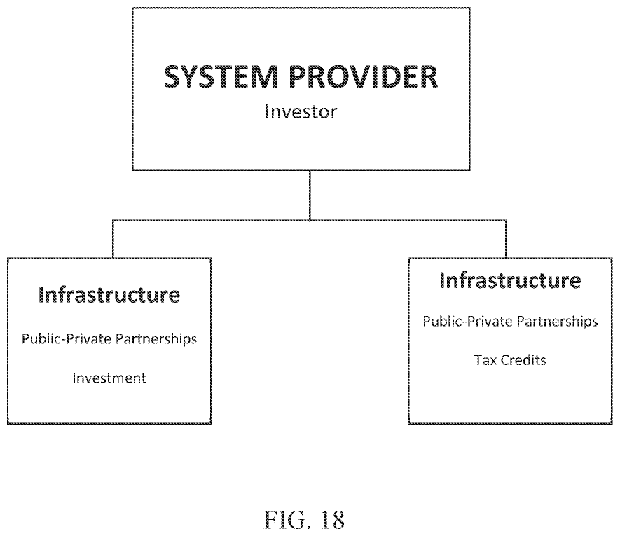

FIGS. 17-19 illustrate one or more steps implemented by the system to calculate investment and/or credit enhancement and/or tax credit for infrastructure public-private partnerships investment and/or infrastructure public-private partnerships credit enhancement and/or infrastructure public-private partnership tax credit. In some embodiments, the system is configured to identify one or more infrastructure public-private partnerships for investment and/or infrastructure public-private partnerships for credit enhancement and/or infrastructure public-private partnerships for tax credit. In some embodiments, the system is configured to calculate and/or process infrastructure credit enhancement. In some embodiments, the system is configured to calculate and/or process infrastructure tax credit.

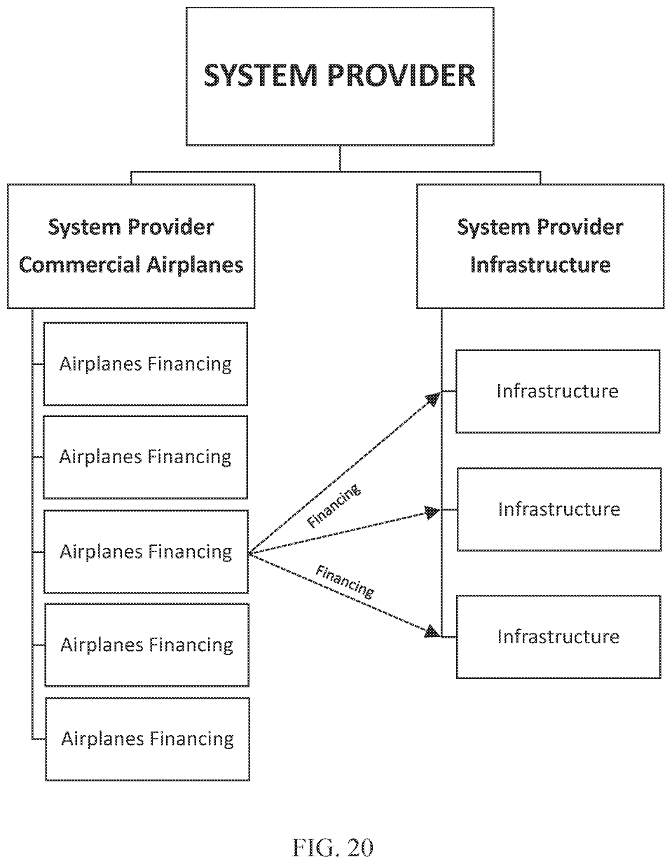

FIG. 20 illustrates one or more steps implemented by the system according to some embodiments to calculate investment and/or credit enhancement and/or credit facility involving commercial airplanes as a basis and structure to finance infrastructure. In some embodiments, the system is configured to calculate, collect, process, store, and track investor funding involving commercial airplanes and/or infrastructure. In some embodiments, the system is configured to identify one or more commercial airplanes investment and/or infrastructure investments which match criteria and/or rules associated with securities law including, but not limited to, (i) the Securities Act of 1933; (ii) the Securities Exchange Act of 1934; (iii) the Investment Company Act of 1940; (iv) the Investment Advisers Act of 1940; (v) Jumpstart Our Business Startups Act (JOBS Act); (vi) CROWDFUND Act; and (vii) State “Blue Sky” laws. In some embodiments, one or more projects comprise commercial airplanes and/or infrastructure investment. In some embodiments, the system is configured to calculate and/or process request for credit enhancement. In some embodiments, the system calculates unused investment funding to calculate additional funding for credit enhancement. In some embodiments, the additional funding is used for infrastructure projects. In some embodiments, the system is configured to incorporate the unused portion of the investment funding to calculate projected available funds to finance and develop infrastructure resulting in creating and/or preserving jobs. In some embodiments, system provider is investment-grade and serves as ultimate guarantor for commercial airplanes and/or infrastructure investment, creating a well-capitalized vertically integrated entity. In some embodiments, the system provider is investment-grade and provides direct investment and/or credit enhancement for airplanes and/or infrastructure financing.

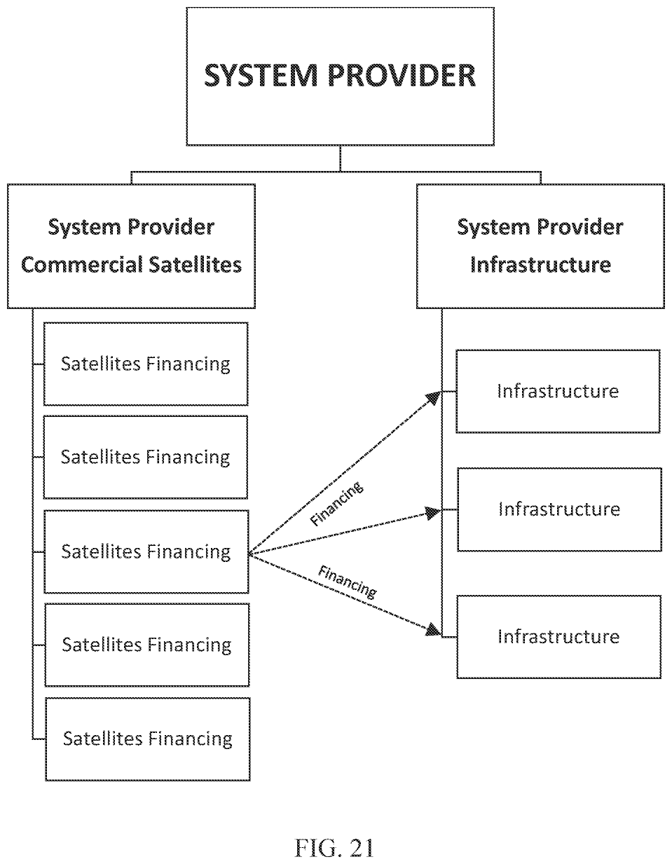

FIG. 21 illustrates one or more steps implemented by the system according to some embodiments to calculate investment and/or credit enhancement and/or credit facility involving commercial satellites as a basis and structure to finance infrastructure. In some embodiments, the system is configured to calculate, collect, process, store, and track investor funding involving commercial satellites and/or infrastructure. In some embodiments, the system is configured to identify one or more commercial satellites investment and/or infrastructure investments which match criteria and/or rules associated with securities law including, but not limited to, (i) the Securities Act of 1933; (ii) the Securities Exchange Act of 1934; (iii) the Investment Company Act of 1940; (iv) the Investment Advisers Act of 1940; (v) Jumpstart Our Business Startups Act (JOBS Act); (vi) CROWDFUND Act; and (vii) State “Blue Sky” laws. In some embodiments, one or more projects comprise commercial satellites and/or infrastructure investment. In some embodiments, the system is configured to calculate and/or process request for credit enhancement. In some embodiments, the system calculates unused investment funding to calculate additional funding for credit enhancement. In some embodiments, the additional funding is used for infrastructure projects. In some embodiments, the system is configured to incorporate the unused portion of the investment funding to calculate projected available funds to finance and develop infrastructure resulting in creating or preserving jobs. In some embodiments, system provider is investment-grade, serve as ultimate guarantor for commercial satellites and/or infrastructure investment, creating a well-capitalized vertically integrated entity. In some embodiments, the system provider is investment-grade and provides direct investment and/or credit enhancement for satellites and/or infrastructure financing.

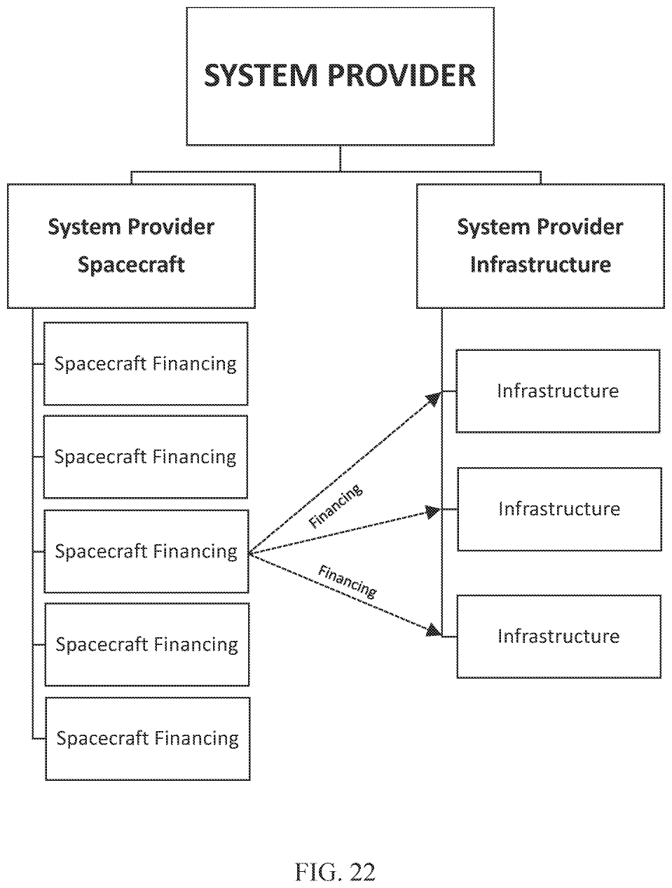

FIG. 22 illustrates one or more steps implemented by the system according to some embodiments to calculate investment and/or credit enhancement and/or credit facility involving spacecraft as a basis and structure to finance infrastructure. In some embodiments, the system is configured to calculate, collect, process, store, and track investor funding involving spacecraft and/or infrastructure. In some embodiments, the system is configured to identify one or more spacecraft investment and/or infrastructure investments which match criteria and/or rules associated with securities law including, but not limited to, (i) the Securities Act of 1933; (ii) the Securities Exchange Act of 1934; (iii) the Investment Company Act of 1940; (iv) the Investment Advisers Act of 1940; (v) Jumpstart Our Business Startups Act (JOBS Act); (vi) CROWDFUND Act; and (vii) State “Blue Sky” laws. In some embodiments, one or more projects comprise spacecraft and/or infrastructure investment. In some embodiments, the system is configured to calculate and/or process request for credit enhancement. In some embodiments, the system calculates unused investment funding to calculate additional funding for credit enhancement. In some embodiments, the additional funding is used for infrastructure projects. In some embodiments, the system is configured to incorporate the unused portion of the investment funding to calculate projected available funds to finance and develop infrastructure resulting in creating or preserving jobs. In some embodiments, the system provider is investment-grade, and serves as ultimate guarantor for spacecraft and/or infrastructure investment, creating a well-capitalized vertically integrated entity. In some embodiments, the system provider is investment-grade and provides direct investment and/or credit enhancement for spacecraft and/or infrastructure financing.

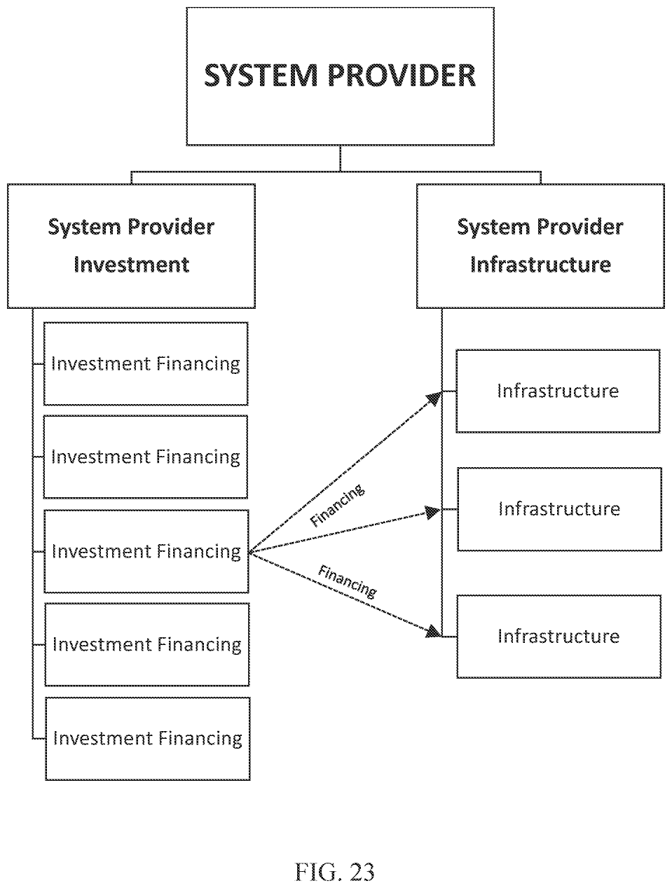

FIG. 23 illustrates one or more steps implemented by the system according to some embodiments to calculate investment and/or credit enhancement and/or credit facility involving investment in general as a basis and structure to finance infrastructure. In some embodiments, the system is configured to calculate, collect, process, store, and track investor funding involving investment in general and/or infrastructure. In some embodiments, the system is configured to identify one or more investment which match criteria and/or rules associated with securities law including, but not limited to, (i) the Securities Act of 1933; (ii) the Securities Exchange Act of 1934; (iii) the Investment Company Act of 1940; (iv) the Investment Advisers Act of 1940; (v) Jumpstart Our Business Startups Act (JOBS Act); (vi) CROWDFUND Act; and (vii) State “Blue Sky” laws. In some embodiments, one or more projects comprise investment in general and/or infrastructure investment. In some embodiments, the system is configured to calculate and/or process request for credit enhancement. In some embodiments, the system calculates unused investment funding to calculate additional funding for credit enhancement. In some embodiments, the additional funding is used for infrastructure projects. In some embodiments, the system is configured to incorporate the unused portion of the investment funding to calculate projected available funds to finance and develop infrastructure resulting in creating or preserving jobs. In some embodiments, system provider is investment-grade, serve as ultimate guarantor for investment in general and/or infrastructure investment, creating a well-capitalized vertically integrated entity. In some embodiments, the system provider is investment-grade and provides direct investment and/or credit enhancement for investment and/or infrastructure financing.

In some embodiments, the following one or more steps executed by instructions stored on one or more non-transitory computer readable media. The steps also represent a financial method employed by some embodiments described herein. The numbering does not covey a specific order, each step by itself represents a separate part executed by one or more system processors and/or implemented as one or more financial methods according to some embodiments. The system is configured to automate any step and/or process described in this application, and any step and/or process can be combined and/or incorporated into the steps below according to some embodiments. In some embodiments, the steps are:
1. Identify one or more investment projects that satisfies job creation requirements to recapture one or more EB-5 visas.
2. Identify one or more investment projects that satisfies job creation requirements to process one or more EB-5 visas.
3. Identify one or more investment projects where credit enhancement will increase EB-5 funds by a scaled factor range (e.g., 1.1-20 times EB-5 funds) resulting in enhanced funding.
4. Identify one or more investment projects that can be financed.
5. Identify financial institutions and/or other entities to provide the financing.
6. Request recapture of one or more EB-5 visas.
7. Request processing of one or more EB-5 visas.
8. Identify and/or establish one or more project institutions in which to deposit the EB-5 funds.
9. Accept EB-5 immigrant visa applications and associated funds from foreign immigrant investors and deposit the EB-5 funds into one or more project accounts controlled by the one or more project institutions.
10. Use the EB-5 funds as a guarantee in one or more loan application processes to obtain enhanced funding and/or a line of credit and/or a credit facility within the scaled factor range.
11. Bifurcate the EB-5 funding from the debt financing and/or other financing that is obtained secondary to the EB-5 funding and a result of applying a credit enhancement and/or other enhancement to the EB-5 funding.
12. Use at least a portion of the enhanced funding to provide financing to the one or more investment projects.
13. Use at least a portion of the enhanced funding to provide financing to one or more other projects.

In some embodiments, the “one or more investment projects” as listed in the steps above is a “single investment project”, where the single investment project serves as the basis to recapture all EB-5 visas and/or process EB-5 visas and obtain the enhanced funding.

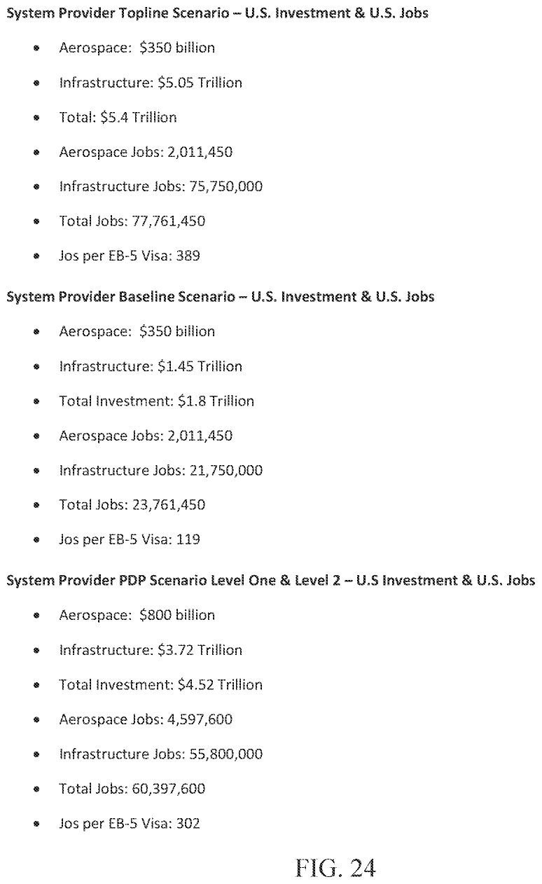

FIG. 24 illustrates an example of the steps applied to a single investment project (i.e., aerospace) to obtain the enhanced funding according to some embodiments. In some embodiments, a single aerospace company is selected as the single investment project. In some embodiments, the following formula is used by the system to determine if the number of jobs created for recaptured unused EB-5 visas:

$$( unused EB - 5 visas ) \times ( jobs created per visa ) = ( total number of created jobs )$$

In some embodiments, for example, in the case of the Topline Scenario listed in FIG. 24:

$$( 200 , 000 ) \times ( 10 ) = ( 2 million )$$

In some embodiments, the system calculates the total capital raised by the recapture based on each immigrant investor visa contribution (e.g., $1.8 million):

$$( \$1 \text{.8} million equivalent dollars ) \times ( unused EB - 5 visas ) = ( total EB - 5 funding )$$

In some embodiments, for example, in the case of the Topline Scenario listed in FIG. 24:

$$( \$1 \text{.8} million ) \times ( 200 , 000 ) = ( \$360 billion )$$

In some embodiments, the system calculates the total number of created jobs and the number of jobs the one or more projects creates to determine the financial needed to execute the one or more projects:

$$( \frac{total number of created jobs needed}{\begin{matrix}single investment project jobs created \\ per \$1 billion dollars equivalent\end{matrix}} ) \times ( \$1 billion dollars equivalent ) = ( financing needed )$$

In some embodiments, for example, in the case of the Topline Scenario listed in FIG. 24:

$$( \frac{2 , 000 , 000}{5 , 747} ) \times ( \$1 billion ) = ( \$348 billion ) ∼ ( \$350 billion )$$

In some embodiments, if the financing needed is less than the total EB-5 funding the system recommends the one or more investment projects investment projects. In some embodiments, as in the Topline Scenario in FIG. 24, a single project is all that is needed to satisfy both the job creation requirement and the limits set by available EB-5 funds.

In some embodiments, the system calculates enhanced funding availability that results from credit enhancement. In some embodiments, the credit enhancement can multiply the EB-5 funds up to a factor of 20. In some embodiments, the FIG. 24 System Provider Topline Scenario illustrates a system analysis assuming a credit enhancement scaled factor of 15. In some embodiments, by using the $360 billion as a guarantee, the system applies for a loan and or line of credit 15 times the total EB-5 funding located in one or more accounts, resulting in enhances funds in the amount of $5.4 trillion. In some embodiments, the formula below is used by the system for this calculation:

$$( total EB - 5 funding ) \times ( credit enhancement scaled factor ) = ( total enhanced funds )$$

In some embodiments, for example, in the case of the Topline Scenario listed in FIG. 24:

$$( \$360 billion ) \times ( 15 ) = ( \$5 \text{.4} trillion )$$

In some embodiments, the system subtracts the total amount of funding needed for the single aerospace project from the total enhanced funds to determine the amount of funds available for other projects:

$$( total enhanced funds ) - ( single project cost ) = ( other project funding )$$

In some embodiments, for example, in the case of the Topline Scenario listed in FIG. 24:

$$( \$5 \text{.4} trillion ) - ( \$350 billion ) = ( \$5 \text{.05} trillion )$$

In some embodiments, the system identifies one or more other projects in which to invest the other project funding. In some embodiments, the system determines the number of jobs created by the one or more other projects per $1 billion dollar equivalent (i.e., equivalent in another currency) based at least in part on one or more of statistics, the Department of Commerce, and/or published studies. In some embodiments, the system provides an enhanced job creation total by using the formula below:

$$( other project funding ) \times ( other project jobs created per billion dollar equivallent spent ) = ( enhanced job creation total )$$

In some embodiments, for example, in the case of the Topline Scenario listed in FIG. 24:

$$( \$5 \text{.05} trillion ) \times ( \frac{15 , 000}{\$1 billion} ) = ( 75 , 750 , 000 )$$

In some embodiments, the system calculates the total job creation resulting from the recapture of used visas by adding the job creation totals together:

$$( investment jobs created ) + ( other jobs created ) = ( total jobs created )$$

In some embodiments, for example, in the case of the Topline Scenario listed in FIG. 24:

$$( 2 , 011 , 450 ) + ( 75 , 750 , 000 ) = ( 77 , 761 , 450 )$$

In some embodiments, the system divides the total jobs created by the number of EB-5 visas used for the investment project to obtain credit enhancement to return a value of actual jobs per EB-5 visa.

$$( \frac{total jobs created}{number of EB - 5 visas used for the investment project} ) = ( actual jobs per EB - 5 visa )$$

In some embodiments, for example, in the case of the Topline Scenario listed in FIG. 24:

$$( \frac{77 , 761 , 450}{200 , 000} ) = ( 389 )$$

In some embodiments, the system gathers the information and or manages the implementation scenarios using one or more portions of the system as described herein. In some embodiments, the system uses a summation of one or more projects in place of single project values described in the examples and equations above.

Referring further to FIG. 24, the system performs the same calculations for the Baseline Scenario as for the Topline Scenario with the exception that the credit enhancement scaled factor is 5 instead of 15 according to some embodiments.

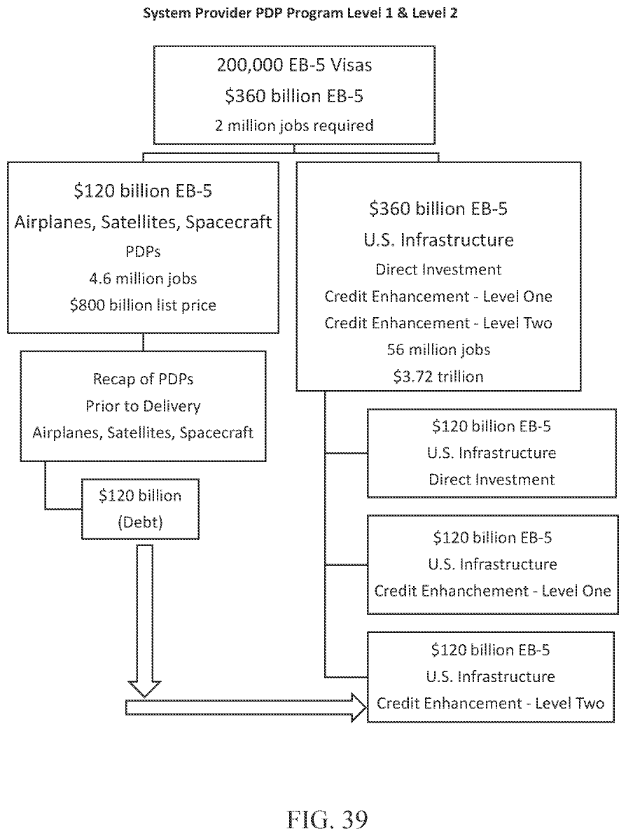

Referring to FIGS. 24 and 39, with reference to the PDP Scenario Level 1 & Level 2, in some embodiments, the system is configured to apply one or more calculation above to projects that require directed investment. In some embodiments, one or more projects require a Pre-Delivery Payment (PDP) in order to begin the manufacturing process. The PDP is a percentage of the list price and/or total cost of the project. In some embodiments, the system subtracts the amount required for the PDP from the total EB-5 funding using the equation:

$$( total EB - 5 funding ) - ( ( PDP ) \times ( List Price ) ) = ( available EB - 5 funding )$$

In some embodiments, for example, in the case of the PDP Scenario listed in FIG. 24:

$$( \$360 billion ) - ( ( 15 \% ) \times ( \$800 billion ) ) = ( \$240 billion )$$

As shown in FIG. 39, this process can be repeated for each EB-5 funded project according to some embodiments. In some embodiments, the available EB-5 funding is then used as the total EB-5 funding for one or more equations and/or calculations as described above, with the results listed in FIGS. 24 and 39.

In some embodiments, in the PDP scenario example, the number of jobs created for airplanes, satellites, and spacecraft is a function of the list price, not the PDP. In some embodiments, the system uses the following equation to determine the job creations from projects that require PDP:

$$( list price ) \times ( PDP project jobs created per billion dollar equivalent spent ) = ( PDP job creation total )$$

In some embodiments, for example, in the case of the PDP Scenario listed in FIG. 24:

$$( \$800 billion ) \times ( \frac{5 , 747}{\$1 billion} ) = ( 4 , 597 , 600 ) ∼ ( 4.6 million )$$

In some embodiments, the Infrastructure project in FIG. 24 also requires an initial direct investment that the system treats as equivalent to a PDP for the purposes of the calculations described above. In some embodiments, credit enhancements are applied to the remaining available EB-5 funding (now equivalent to total EB-5 funding for calculation purposes), so that total enhanced funding, job creation, job creation per EB-5 visa, and/or other metrics can be calculated as previously described.

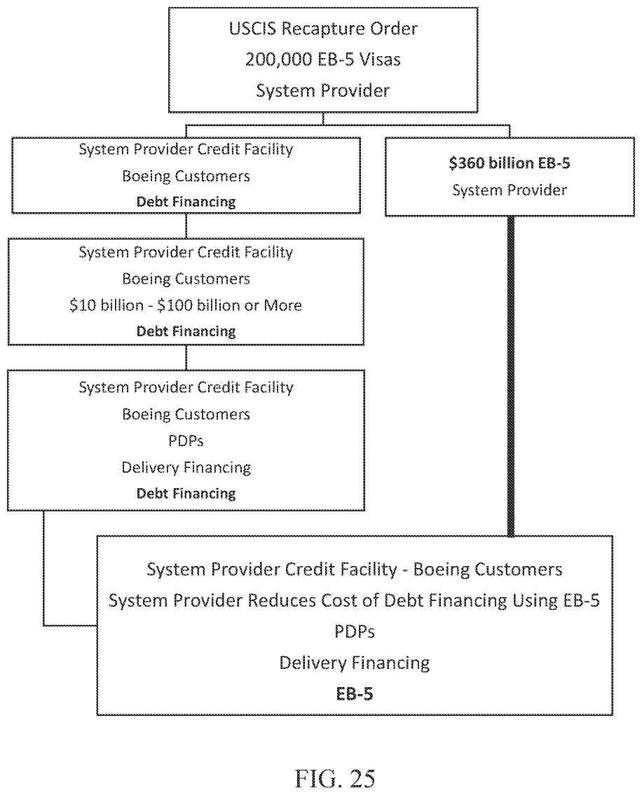

FIG. 25 illustrates one or more steps implemented by the system involving the recapture of unused EB-5 visas for use in subsequent fiscal years according to some embodiments. In some embodiments, the system is configured to process the recapture of unused EB-5 visas (e.g., up to 200,000 unused EB-5 visas) for use in subsequent fiscal years. In some embodiments, the system is configured to collect, process, store, and track EB-5 funding. In some embodiments, the system is configured to identify one or more projects which match criteria and/or rules associated with EB-5 funding. In some embodiments, one or more projects comprise the acquisition of aerospace products manufactured by The Boeing® Company (“Boeing®”). In some embodiments, for example, the system is configured to process the recapture of up to 200,000 unused EB-5 visas for use in subsequent fiscal years utilizing the $1,800,000 EB-5 visa funding amount to raise up to or over $360 billion of EB-5 funding. In some embodiments, the system is configured to calculate and/or process amounts for one or more credit facility for one or more Boeing® customers. In some embodiments, the system is configured to process that EB-5 funding is used to reduce the cost of capital of one or more credit facility. In some embodiments, upon obtaining a USCIS order for the recapture of up to 200,000 unused EB-5 visas for the system provider program, the system is configured to calculate and/or process amounts related to debt financing to fund system provider credit facility for Boeing® customers. In some embodiments, the system provider credit facility is based on the USCIS order to recapture up to or over 200,000 unused EB-5 visas itself and it is not necessary that system provider receives EB-5 funding prior to structuring the system provider credit facility for Boeing® customers. In some embodiments, the system is configured to calculate and/or process that EB-5 funding is used to reduce the cost of capital, including debt financing, for predelivery payments and delivery financing for Boeing® customers involving one or more system provider credit facility for Boeing® customers. In some embodiments, upon obtaining a USCIS order for the recapture of up to 200,000 unused EB-5 visas for the System Provider program, System Provider raises debt financing to fund System Provider Credit Facility for Boeing® customers. In some embodiments, the System Provider Credit Facility is based on the USCIS order to recapture up to or over 200,000 unused EB-5 visas itself and it is not necessary that System Provider receives EB-5 funding prior to structuring the System Provider Credit Facility. In some embodiments, the System Provider EB-5 funding is used to reduce the cost of capital, including debt financing, for predelivery payments and delivery financing for Boeing® customers.

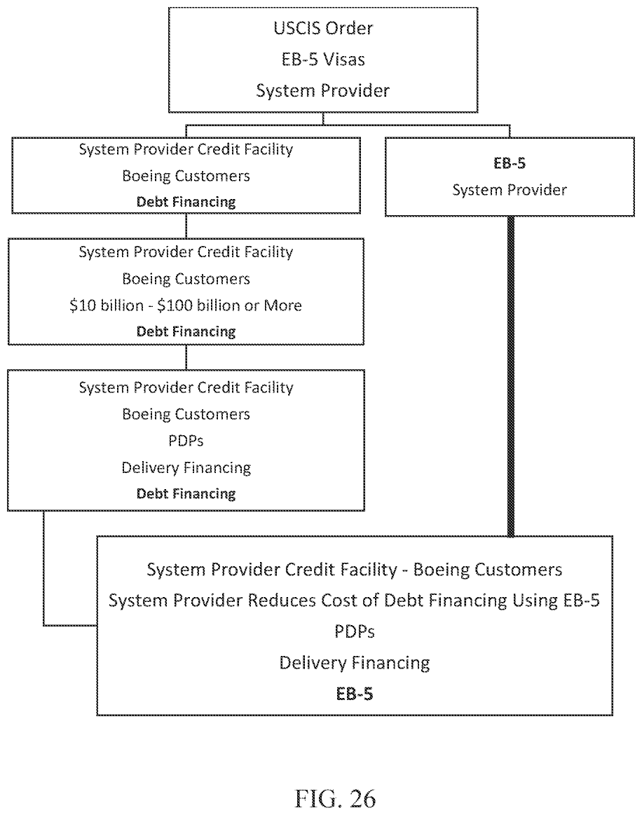

FIG. 26 illustrates one or more steps implemented by the system involving EB-5 visas according to some embodiments. In some embodiments, the system is configured to process the recapture of unused EB-5 visas for use. In some embodiments, the system is configured to collect, process, store, and track EB-5 funding. In some embodiments, the system is configured to identify one or more projects which match criteria and/or rules associated with EB-5 funding. In some embodiments, one or more projects comprise the acquisition of aerospace products manufactured by The Boeing® Company (“Boeing®”). In some embodiments, the system is configured to calculate and/or process amounts for one or more credit facility for one or more Boeing® customers. In some embodiments, the system is configured to process that EB-5 funding to reduce the cost of capital of one or more credit facility. In some embodiments, the system is configured to calculate and/or process amounts related to debt financing to fund system provider credit facility for Boeing® customers. In some embodiments, the system provider credit facility is based on a USCIS order to process EB-5 visas itself and it is not necessary that system provider receives EB-5 funding prior to structuring the system provider credit facility for Boeing® customers. In some embodiments, the system is configured to calculate and/or process that EB-5 funding to reduce the cost of capital, including debt financing, for predelivery payments and delivery financing for Boeing® customers involving one or more system provider credit facility for Boeing® customers. In some embodiments, upon obtaining a USCIS order for EB-5 visas for the system provider program, system provider will raise debt financing to fund a system provider credit facility for Boeing® customers. The system provider credit facility is based on the USCIS order for EB-5 visas itself and it is not necessary that System Provider receives EB-5 funding prior to structuring the system provider credit facility. The System Provider EB-5 funding is used to reduce the cost of capital, including debt financing, for predelivery payments and delivery financing for Boeing® customers.

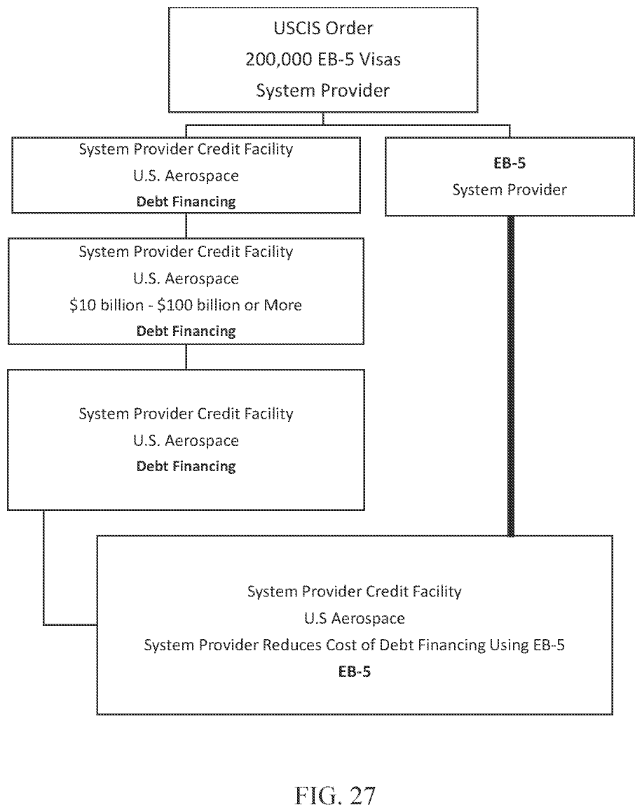

FIG. 27 illustrates one or more steps implemented by the system involving the recapture of unused EB-5 visas for use in subsequent fiscal years according to some embodiments. In some embodiments, the system is configured to process the recapture of unused EB-5 visas (e.g., up to 200,000 unused EB-5 visas) for use in subsequent fiscal years. In some embodiments, the system is configured to collect, process, store, and track EB-5 funding. In some embodiments, the system is configured to identify one or more projects which match criteria and/or rules associated with EB-5 funding. In some embodiments, one or more projects comprise the acquisition of aerospace products. In some embodiments, for example, the system is configured to process the recapture of up to 200,000 unused EB-5 visas for use in subsequent fiscal years utilizing the $1,800,000 EB-5 visa funding amount to raise up to or over $360 billion of EB-5 funding. In some embodiments, the system is configured to calculate and/or process amounts for one or more credit facility for one or more aerospace customers. In some embodiments, the system is configured to process that EB-5 funding is used to reduce the cost of capital of one or more credit facility. In some embodiments, upon obtaining a USCIS order for the recapture of up to 200,000 unused EB-5 visas for the system provider program, the system is configured to calculate and/or process amounts related to debt financing to fund system provider credit facility for aerospace customers. In some embodiments, the system provider credit facility is based on the USCIS order to recapture up to or over 200,000 unused EB-5 visas itself and it is not necessary that system provider receives EB-5 funding prior to structuring the system provider credit facility for aerospace customers. In some embodiments, the system is configured to calculate and/or process that EB-5 funding is used to reduce the cost of capital, including debt financing, for predelivery payments and delivery financing for aerospace customers involving one or more system provider credit facility for aerospace customers. In some embodiments, upon obtaining a USCIS order for EB-5 visas for the System Provider program, system provider raises debt financing to fund System Provider Credit Facility for U.S. Aerospace customers. In some embodiments, the system provider credit facility is based on the USCIS order for EB-5 visas itself and it is not necessary that system provider receives EB-5 funding prior to structuring the system provider credit facility. In some embodiments, the System provider EB-5 funding is used to reduce the cost of capital, including debt financing, for predelivery payments and delivery financing for U.S. Aerospace customers.

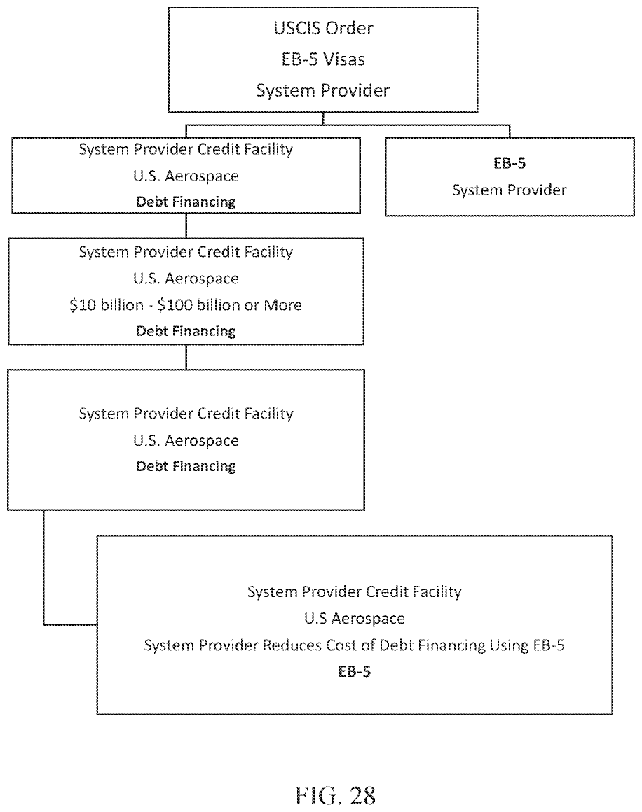

FIG. 28 illustrates one or more steps implemented by the system involving EB-5 visas according to some embodiments. In some embodiments, the system is configured to process the recapture of unused EB-5 visas for use. In some embodiments, the system is configured to collect, process, store, and track EB-5 funding. In some embodiments, the system is configured to identify one or more projects which match criteria and/or rules associated with EB-5 funding. In some embodiments, one or more projects comprise the acquisition of aerospace products. In some embodiments, the system is configured to calculate and/or process amounts for one or more credit facility for one or more aerospace customers. In some embodiments, the system is configured to process that EB-5 funding is used to reduce the cost of capital of one or more credit facility. In some embodiments, the system is configured to calculate and/or process amounts related to debt financing to fund system provider credit facility for aerospace customers. In some embodiments, the system provider credit facility is based on a USCIS order to process EB-5 visas itself and it is not necessary that system provider receives EB-5 funding prior to structuring the system provider credit facility for aerospace customers. In some embodiments, the system is configured to calculate and/or process that EB-5 funding is used to reduce the cost of capital, including debt financing, for predelivery payments and delivery financing for aerospace customers involving one or more system provider credit facility for aerospace customers. In some embodiments, the system provider credit facility is based on the USCIS order for EB-5 visas itself and it is not necessary that system provider receives EB-5 funding prior to structuring the system provider credit facility. In some embodiments, the System provider EB-5 funding is used to reduce the cost of capital, including debt financing, for predelivery payments and delivery financing for U.S. Aerospace customers.

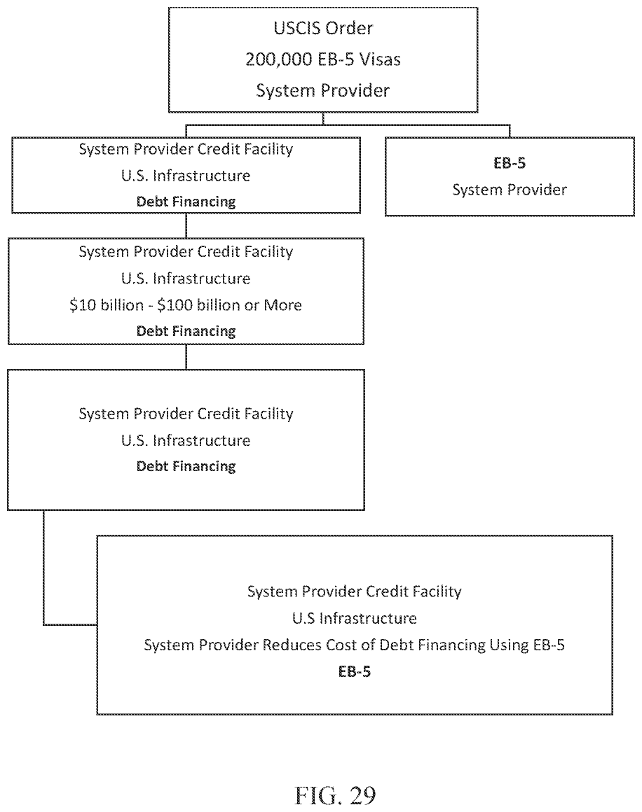

FIG. 29 illustrates one or more steps implemented by the system involving the recapture of unused EB-5 visas for use in subsequent fiscal years according to some embodiments. In some embodiments, the system is configured to process the recapture of unused EB-5 visas (e.g., up to 200,000 unused EB-5 visas) for use in subsequent fiscal years. In some embodiments, the system is configured to collect, process, store, and track EB-5 funding. In some embodiments, the system is configured to identify one or more projects which match criteria and/or rules associated with EB-5 funding. In some embodiments, one or more projects comprise infrastructure. In some embodiments, for example, the system is configured to process the recapture of up to 200,000 unused EB-5 visas for use in subsequent fiscal years utilizing the $1,800,000 EB-5 visa funding amount to raise up to or over $360 billion of EB-5 funding. In some embodiments, the system is configured to calculate and/or process amounts for one or more credit facility for one or more infrastructure project. In some embodiments, the system is configured to process that EB-5 funding is used to reduce the cost of capital of one or more credit facility. In some embodiments, upon obtaining a USCIS order for the recapture of up to 200,000 unused EB-5 visas for the system provider program, the system is configured to calculate and/or process amounts related to debt financing to fund system provider credit facility for one or more infrastructure project. In some embodiments, the system provider credit facility is based on the USCIS order to recapture up to or over 200,000 unused EB-5 visas itself and it is not necessary that system provider receives EB-5 funding prior to structuring the system provider credit facility for one or more infrastructure project. In some embodiments, the system is configured to identify and/or process that EB-5 funding is used to reduce the cost of capital, including debt financing, for one or more infrastructure project. In some embodiments, upon obtaining a USCIS order for EB-5 visas for the system provider program, system provider will raise debt financing to fund system provider credit facility for U.S. infrastructure. In some embodiments, the system provider credit facility is based on the USCIS order for EB-5 visas itself and it is not necessary that the system provider receives EB-5 funding prior to structuring the system provider credit facility. In some embodiments, the system provider EB-5 funding is used to reduce the cost of capital, including debt financing, for U.S. infrastructure.

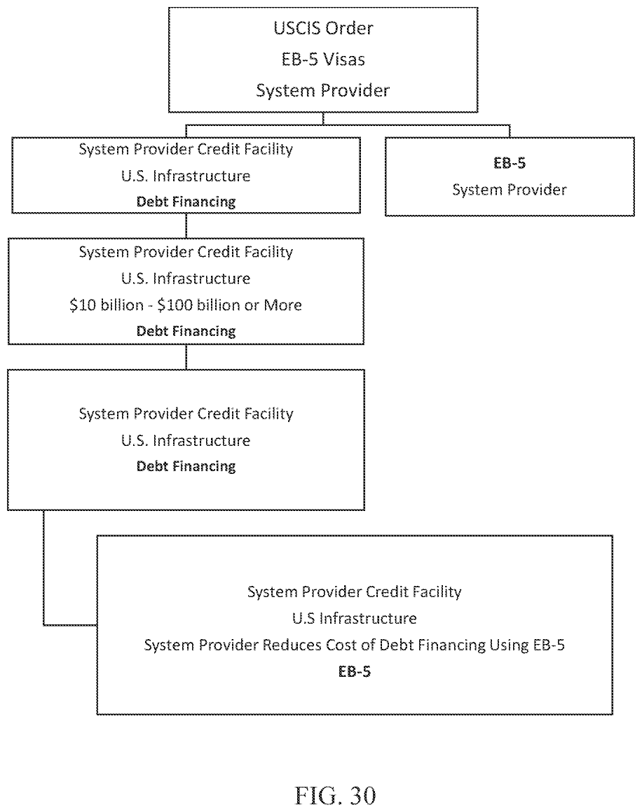

FIG. 30 illustrates one or more steps implemented by the system involving EB-5 visas according to some embodiments. In some embodiments, the system is configured to process the recapture of unused EB-5 visas for use. In some embodiments, the system is configured to collect, process, store, and track EB-5 funding. In some embodiments, the system is configured to identify one or more projects which match criteria and/or rules associated with EB-5 funding. In some embodiments, one or more projects comprise infrastructure. In some embodiments, the system is configured to calculate and/or process amounts for one or more credit facility for one or more infrastructure projects. In some embodiments, the system is configured to process that EB-5 funding is used to reduce the cost of capital of one or more credit facility. In some embodiments, the system is configured to calculate and/or process amounts related to debt financing to fund system provider credit facility for one or more infrastructure projects. In some embodiments, the system provider credit facility is based on a USCIS order to process EB-5 visas itself and it is not necessary that system provider receives EB-5 funding prior to structuring the system provider credit facility for one or more infrastructure projects. In some embodiments, the system is configured to identify that EB-5 funding is used to reduce the cost of capital, including debt financing, for one or more infrastructure projects. In some embodiments, upon obtaining a USCIS order for EB-5 visas for the System provider program, the system provider will raise debt financing to fund the system provider credit facility for U.S. and/or global infrastructure. In some embodiments, the system provider credit facility is based on the USCIS order for EB-5 visas itself and it is not necessary that the system provider receives EB-5 funding prior to structuring the system provider credit facility. In some embodiments, the System Provider EB-5 funding is used to reduce the cost of capital, including debt financing, for U.S. and/or global infrastructure.

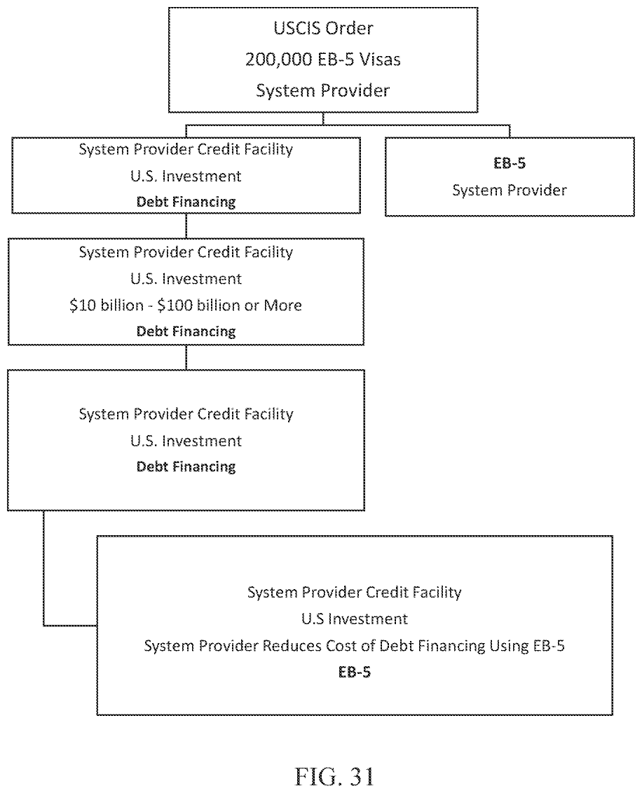

FIG. 31 illustrates one or more steps implemented by the system involving the recapture of unused EB-5 visas for use in subsequent fiscal years according to some embodiments. In some embodiments, the system is configured to process the recapture of unused EB-5 visas (e.g., up to 200,000 unused EB-5 visas) for use in subsequent fiscal years. In some embodiments, the system is configured to collect, process, store, and track EB-5 funding. In some embodiments, the system is configured to identify one or more projects which match criteria and/or rules associated with EB-5 funding. In some embodiments, one or more projects comprise investment. In some embodiments, for example, the system is configured to process the recapture of up to 200,000 unused EB-5 visas for use in subsequent fiscal years utilizing the $1,800,000 EB-5 visa funding amount to raise up to or over $360 billion of EB-5 funding. In some embodiments, the system is configured to calculate and/or process amounts for one or more credit facility for one or more investment. In some embodiments, the system is configured to process that EB-5 funding is used to reduce the cost of capital of one or more credit facility. In some embodiments, upon obtaining a USCIS order for the recapture of up to 200,000 unused EB-5 visas for the system provider program, the system is configured to calculate and/or process amounts related to debt financing to fund system provider credit facility for one or more investment. In some embodiments, the system provider credit facility is based on the USCIS order to recapture up to or over 200,000 unused EB-5 visas itself and it is not necessary that system provider receives EB-5 funding prior to structuring the system provider credit facility for one or more investment. In some embodiments, the system is configured to identify and/or process that EB-5 funding is used to reduce the cost of capital, including debt financing, for one or more investment. In some embodiments, upon obtaining a USCIS order for EB-5 visas for the system provider program, the system provider will raise debt financing to fund the system provider credit facility for U.S. investment. The system provider credit facility is based on the USCIS order for EB-5 visas itself and it is not necessary that the system provider receives EB-5 funding prior to structuring the system provider credit facility. The system provider EB-5 funding is used to reduce the cost of capital, including debt financing, for U.S. investment.

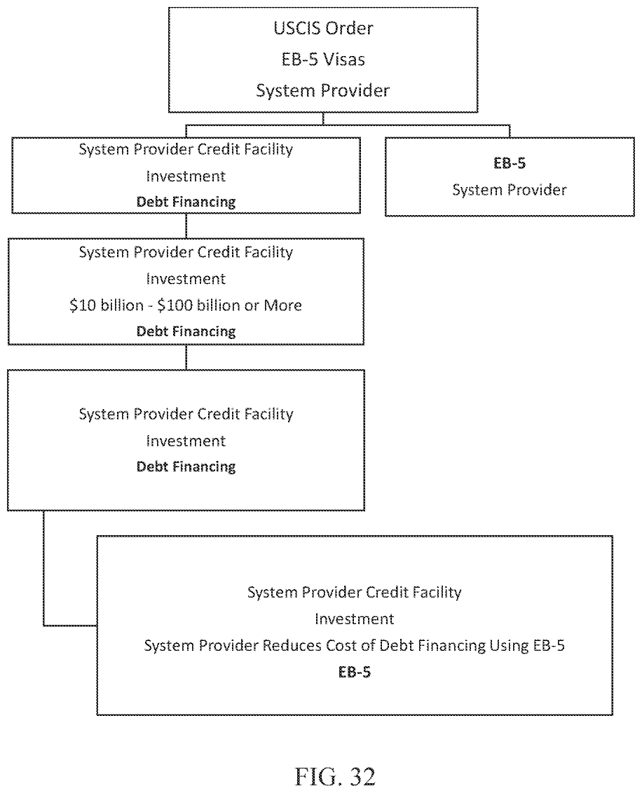

FIG. 32 illustrates one or more steps implemented by the system involving EB-5 visas according to some embodiments. In some embodiments, the system is configured to process the recapture of unused EB-5 visas for use. In some embodiments, the system is configured to collect, process, store, and track EB-5 funding. In some embodiments, the system is configured to identify one or more projects which match criteria and/or rules associated with EB-5 funding. In some embodiments, one or more projects comprise one or more investment. In some embodiments, the system is configured to calculate and/or process amounts for one or more credit facility for one or more investment. In some embodiments, the system is configured to process that EB-5 funding is used to reduce the cost of capital of one or more credit facility. In some embodiments, the system is configured to calculate and/or process amounts related to debt financing to fund system provider credit facility for one or more investment. In some embodiments, the system provider credit facility is based on a USCIS order to process EB-5 visas itself and it is not necessary that system provider receives EB-5 funding prior to structuring the system provider credit facility for one or more investment. In some embodiments, the system is configured to identify and/or process that EB-5 funding is used to reduce the cost of capital, including debt financing, for one or more investment. In some embodiments, upon obtaining a USCIS order for EB-5 visas for the system provider program, system provider raises debt financing to fund system provider credit facility for U.S. and/or global investment. In some embodiments, the system provider credit facility is based on the USCIS order for EB-5 visas itself and it is not necessary that system provider receives EB-5 funding prior to structuring the system provider credit facility. In some embodiments, the system provider EB-5 funding is used to reduce the cost of capital, including debt financing, for U.S. and/or global investment.

FIG. 39 illustrates one or more steps implemented by the system involving EB-5 visas as relates to commercial airplanes, commercial satellites, and/or spacecraft according to some embodiments. In some embodiments, $120 billion of EB-5 funding is levered to finance the acquisition of $800 billion of Commercial Airplanes, Commercial Satellites and Spacecraft at list price, with purchase price to be determined, creating or preserving 4.6 million jobs, providing the baseline jobs to recapture 200,000 EB-5 visas and the requisite 2 million jobs. In some embodiments, FIG. 39 illustrates one or more steps implemented by the system involving EB-5 visas as relates to U.S. Infrastructure direct investment & credit enhancement. In some embodiments, $120 billion of EB-5 funding for U.S. infrastructure direct investment and $240 billion of EB-5 funding for credit enhancement and loan guarantees is levered to raise an aggregate of $3.72 trillion, creating approximately 56 million jobs. In some embodiments, funds directly invested in infrastructure projects by the system assume no debt issuance whereas credit enhancement and loan guarantees assume a ratio of 15:1 as provided by the Partnership to Build America Act (H.R. 2084), May 2013. In some embodiments, jobs support is based on 15,000 jobs per $1 billion in infrastructure investment (U.S. Department of Transportation, Georgetown University, Duke University).

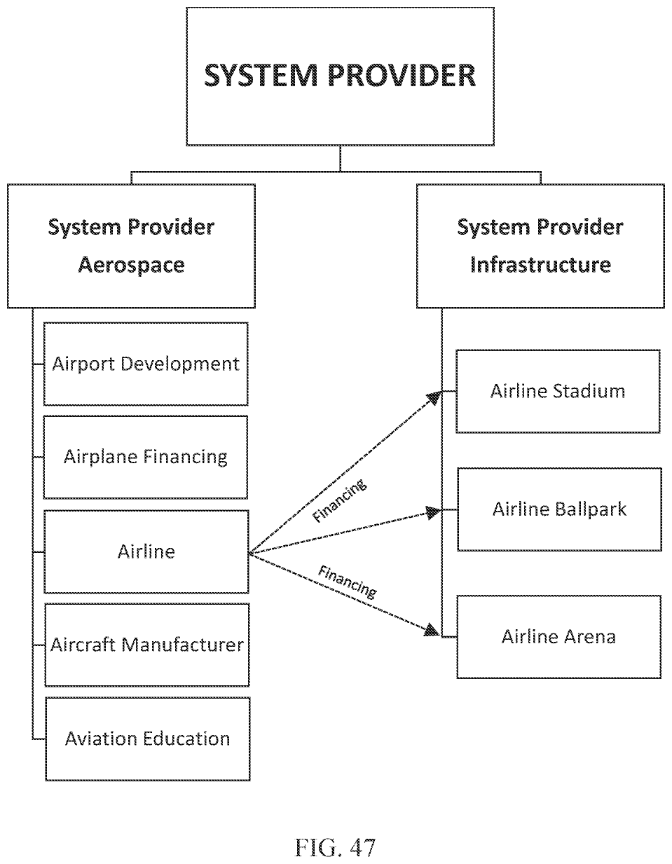

FIG. 47 illustrates one or more steps implemented by the system involving EB-5 visas as relates to the system provider according to some embodiments. In some embodiments, the system provider parent company is investment-grade and serves as ultimate guarantor for aerospace and infrastructure investment, creating a well-capitalized vertically integrated entity.

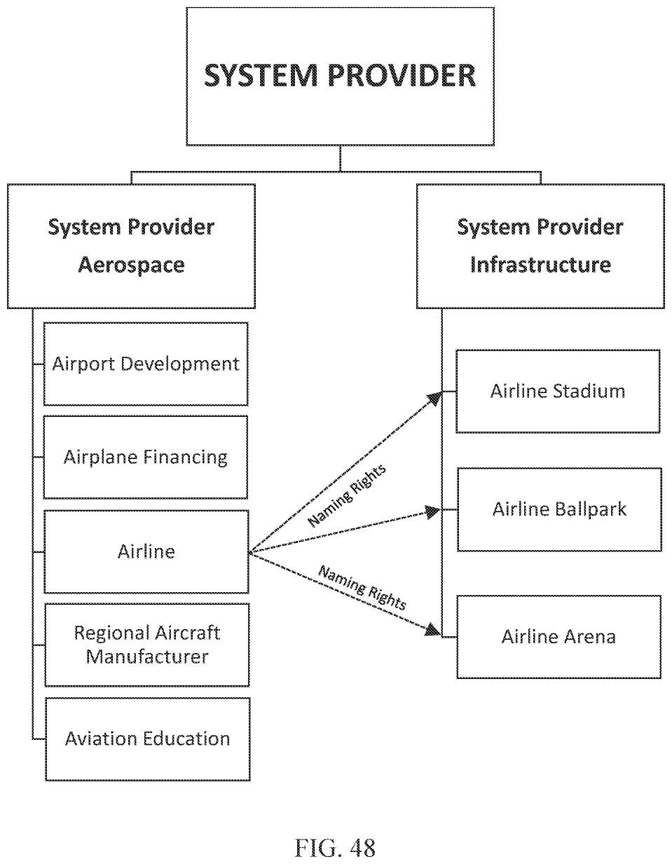

FIG. 48 illustrates one or more steps implemented by the system involving EB-5 visas as relates to the system provider according to some embodiments. In some embodiments, the system provider parent company is investment-grade and serves as ultimate guarantor for aerospace and infrastructure investment, creating a well-capitalized vertically integrated entity.

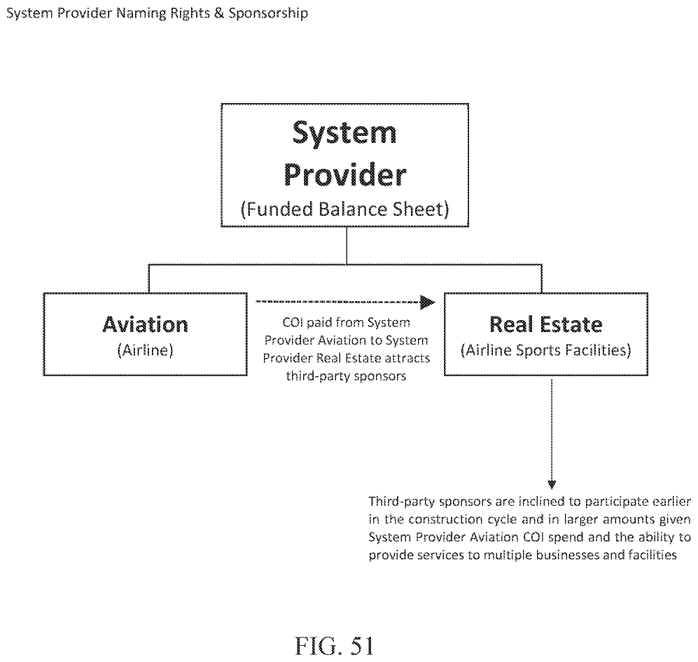

FIG. 51 illustrates one or more steps implemented by the system involving EB-5 visas as relates to the system provider according to some embodiments. In some embodiments, third-party sponsors are inclined to participate earlier in the construction cycle and in larger amounts given System Provider Aviation COI spend and the ability to provide services to multiple businesses and facilities.

The EB-5 Program establishes a path to permanent residency and eventually citizenship for up to 10,000 immigrants (and immediate family members) annually who invest in an existing or new business in the United States and create or preserve at least ten jobs in the United States according to some embodiments. Under this program, immigrants are required to invest $1,800,000 in a qualified United States business; however, if they invest in a business located in specified “targeted employment areas,” the investment threshold is lowered to $900,000 according to some embodiments. A geographic area is classified as a targeted employment area (“TEA”) if it is considered rural or if it is experiencing an unemployment rate at least 150% of the national average (to be reported by each regional center's state of operation) according to some embodiments. For the purposes of this program, a rural area is not part of a metropolitan statistical area (as designated by the Office of Management and Budget) and is outside of any city or town with a population of 20,000 or more according to some embodiments. When immigrant investors apply for visas, they receive a conditional green card contingent on meeting the job creation requirement according to some embodiments. Subsequently, when they prove that they have met the requirement, the conditions are removed according to some embodiments.

The United States Citizenship and Immigration Service (“USCIS”) Employment-Based Fifth Preference Immigrant Investor Program (“EB-5 Program”) battles a poor reputation, largely due to high-profile cases of fraud at regional centers that highlight risks and vulnerabilities for immigrant investors, and a failure to properly regulate the promotion of the program according to some embodiments. Recent allegations of corruption and mismanagement within the United States Department of Homeland Security (“DHS”) have also generated attention and a sense of concern that the program's problems outweigh its benefits according to some embodiments.

The EB-5 Program brings together interests that are often not gracefully coordinated according to some embodiments. The complexity of the application process, varying roles for different institutions, high transaction costs, a cadre of intermediaries, including unregulated brokers working abroad, and often, the inability of the USCIS to effectively administer the program, presents a set of obstacles that may prevent potential investors from using the program and may further erode public confidence according to some embodiments.

Certain members of Congress, commentators and others have expressed concerns with the EB-5 Regional Center program and its ability to facilitate deployment of EB-5 capital including, but not limited to, (1) Credible and predictable long-term United States jobs (certain members of Congress have expressed concern with the often exaggeration and puffery of United States job creation in the EB-5 space and lack of long-term job creation with many EB-5 Regional Centers); (2) Legality of funding and compliance with relevant federal and state securities law, including: (i) the Securities Act of 1933; (ii) the Securities Exchange Act of 1934; (iii) the Investment Company Act of 1940; (iv) the Investment Advisers Act of 1940; (v) Jumpstart Our Business Startups Act (JOBS Act); (vi) CROWDFUND Act; and (vii) State “Blue Sky” laws; and (3) Inadequate return on invested capital and return of invested capital for EB-5 investors (there have been many instances of EB-5 Regional Centers and related businesses not providing a return on invested capital or even a return of invested capital to EB-5 investors) according to some embodiments.

There are up to approximately 200,000 unused EB-5 Visas, from 1990-2020, that can potentially be recaptured in the national interest pursuant to United States law; at $1,800,000 per EB-5 Visa, the recapture of 200,000 unused EB-5 Visas can result in $360 billion of unlevered funding in the national interest; at $900,000 per EB-5 Visa, the recapture of 200,000 unused EB-5 Visas can result in $180 billion of unlevered funding in the national interest; The United States Department of State (“State Department”), in conjunction with DHS, has the administrative authority to recapture unused EB-5 visas in the national interest, within the specific context of immigration law, supported by legal, legislative, regulatory and policy precedent, without the need for an act of Congress or Congressional approval. Moreover, an EB-5 Regional Center application, business plan, and focus on financing and developing infrastructure in the national interest, provides the procedural basis for the United States government to expedite the recapturing of unused EB-5 visas in the national interest according to some embodiments.

It is entirely possible that various non-EB-5 investor visas might come into existence in the United States as a result of revised or new federal laws according to some embodiments. Moreover, examples of non-EB-5 investor visas have been found in recently proposed Congressional legislation, including the RAISE (Reforming American Immigration for Strong Employment) Act according to some embodiments. The RAISE Act is a bill introduced in the United States Senate in 2017 according to some embodiments. Co-sponsored by Republican senators Tom Cotton (Arkansas) and David Perdue (Georgia), the bill seeks to eliminate all employment-based visa categories, including EB-5, in favor of a points system according to some embodiments. The RAISE Act, regardless of its passage, will likely inform the current national conversation involving immigration, including the possible use of employment-based investor visas within a visa points system according to some embodiments. The RAISE Act provides an example of potential investor visas that are not in the current employment-based visa categories, including EB-5, but nonetheless are or can be investor visas according to some embodiments.

It is entirely possible that various non-EB-5 investor visas might come into existence in the United States as a result of existing, revised or new federal laws, including borrowing immigrant visas from non-EB-5 employment-based and family-based category or categories according to some embodiments. It is entirely possible that visas might be borrowed, to be used as immigrant investor visas, from other visa categories including, EB-1, EB-2, EB-3, EB-4, EB-5, Diversity Immigrant Visa program categories, or family-based visa categories according to some embodiments. If so, the potential immigrant investor visas can exceed the up to 200,000 EB-5 visa recapture category or categories according to some embodiments.

The acquisition of Boeing® 737 MAX® Airplanes is intended as a possible option, but one of several, to provide the necessary 2,000,000 jobs for the recapture of approximately 200,000 unused EB-5 Visas according to some embodiments. The recapture of 200,000 unused EB-5 visas will support the preservation or creation of approximately 77,761,450 U.S. jobs and at least 389 jobs per EB-5 Visa (2,011,450 U.S. aerospace jobs and 75,750,000 U.S. infrastructure jobs) according to some embodiments.

An option is to acquire Commercial Airplanes, Commercial Satellites and Spacecraft to finance and develop infrastructure in the United States according to some embodiments.

The invention includes the financing of certain secured transactions in aerospace mobile equipment (movable equipment) (Commercial Airplanes, Commercial Satellites and Spacecraft) as a basis and structure to finance certain types of infrastructure in the United States according to some embodiments.

The invention, including and through cross-sector investments, designated aircraft financing and air transport services (“Aviation”), commercial space development (“Space”) and infrastructure development (“Infrastructure”), includes a financing mechanism to facilitate the acquisition and utilization of Commercial Airplanes, Commercial Satellites and Spacecraft to finance and develop infrastructure in the United States according to some embodiments. Further, the ability to utilize a funded balance sheet and coordinate investments across multiple interrelated verticals enables the invention to mitigate low-equity returns and financing risk according to some embodiments.

USCIS will expedite either Form I-924, “Application For Regional Center Under the Immigrant Investor Pilot Program” or Form I-526, Immigration Petition by Alien Entrepreneur if the application meets the USCIS “expedite criteria” according to some embodiments. The expedite criteria have included: (1) Severe financial loss to a company or individual; (2) Extreme emergent situation; (3) Humanitarian situation; (4) Nonprofit status of a requesting organization in furtherance of the cultural or social interests of the United States; (5) Department of Defense or national interest situation; (6) USCIS error; and (7) Compelling interest of USCIS according to some embodiments.

Current USCIS expedite criteria include (1) Severe financial loss to a company (severe financial loss to a company means the company would be at risk of failing) or person (the need to obtain employment authorization, standing alone, without evidence of other compelling factors, does not warrant expedited treatment), provided that the need for urgent action is not the result of the petitioner's or applicant's failure: (i) to file the benefit request or the request to expedite in a reasonable time frame; or (ii) to respond to any requests for additional evidence in a reasonably timely manner; (2) Urgent humanitarian reasons; (3) Compelling U.S. Government interests (such as urgent cases for the Department of Defense or DHS, or other public safety or national security interests); or (4) Clear USCIS error according to some embodiments.

USCIS has granted “blanket expedite” for regional center projects with multiple investors with identical business plans. In such instances, if a USCIS expedite is granted for an initial I-526 petition, the expedite may be granted for all subsequent I-526 petitions according to some embodiments.

Compelling U.S. Government interests (previously described as Department of Defense or national interest situation) expedite requests have been successful for EB-5 purposes. If the project has some element of national security or is in the national interest (such as an infrastructure project), USCIS will expedite the application if the expedite request is supported by another federal government agency or sometimes a State according to some embodiments. This requires having another federal agency or sometimes a State involved in the expedite request by writing letters of support and also contacting USCIS on the applicant's behalf according to some embodiments. This criteria is generally submitted with detailed evidence of why the project is a compelling U.S. Government interest including, for example, letters from a federal agency or State supporting the expedite request according to some embodiments.

Compelling U.S. Government interests (previously described as Department of Defense or national interest situation) expedite requests have been successful for EB-5 purposes. If the project has some element of national security or is in the national interest (such as an infrastructure project), USCIS will expedite the application if the expedite request is supported by another federal government agency, or sometimes a State according to some embodiments. This requires having another federal agency or State involved in the expedite request by writing letters of support, and also contacting USCIS on the applicant's behalf according to some embodiments. These criteria also must be submitted with detailed evidence of why the project is in the national interest, along with the letters from the other federal agency or State supporting the expedite request according to some embodiments.

The State Department, in conjunction with DHS, potentially has the administrative authority to recapture unused EB-5 visas in the national interest, within the specific context of immigration law, supported by legal, legislative, regulatory and policy precedent, without the need for an act of Congress or Congressional approval according to some embodiments. A business plan focused on financing and developing infrastructure in the national interest, potentially provides the procedural basis for the United States government to expedite the recapturing of unused EB-5 visas in the national interest according to some embodiments.

According to a 2005 report by the United States Government Accountability Office (“GAO”), only 6,024 visas under the EB-5 category were issued from 1992 through 2004, despite the law's allocation of 10,000 visas per year and an aggregate of 130,000 EB-5 Visas from 1992 through 2004 according to some embodiments. (“Immigrant Investors: Small Number of Participants Attributed to Pending Regulations and Other Factors”, GAO-05-256: Published: Apr. 1, 2005). From 2005 until 2020, there are up to 80,000 unused EB-5 Visas (State Department and Fragomen, Del Rey, Bernsen & Loewy LLP) according to some embodiments.

The recapture of EB-5 Visas can potentially be accomplished through administrative action involving the State Department and DHS according to some embodiments. Congressional action may be required, but not necessarily, and even not necessarily, to (i) exclude dependents from the Immigrant Visa Quota for Recaptured EB-5 Visas and/or; (ii) increase the amount of employment-based investor visas issued annually by the State Department according to some embodiments.

### Presidential Executive Power and Immigration Law:

Federal separation of powers divides power among the executive, legislative, and judicial branches as distinct departments of the United States government according to some embodiments. In the immigration context, the legislative branch has been vested with making laws related to immigration, the executive with its enforcement, and the judicial with its review according to some embodiments.

Recent developments involving President Donald Trump and President Barack Obama involving immigration law have drawn renewed attention to Presidential power to shape the substance of immigration law, including through the exercise of enforcement power, whether any limits exist on this central source of executive authority, and the related distribution of immigration lawmaking authority between the President and Congress according to some embodiments.

Presidential immigration law is ascendant according to some embodiments. The dominant policymaking role long played by the President, combined with the twentieth-century rise of what certain commentators call “de facto delegation”, have produced an immigration regime in which the President has significant responsibility for (not just power over) rules for screening immigrants that are allowed to enter the United States according to some embodiments. For example, see Adam B. Cox & Cristina M. Rodriguez, The President and Immigration Law, 119 Yale L. J. 458 (2009) and The President and Immigration Law Redux, 125 Yale L. J. 325 (2015) which provide a historical account of the distribution of immigration lawmaking authority between the President and Congress; the core claim of these articles is that a series of twentieth-century developments, including constitutional, historical, and institutional, have, as a functional matter, given the President tremendous power over the immigrant-screening system: power to determine which immigrants would be permitted to remain in the United States, which would be forced to leave, and which would be allowed to enter according to some embodiments. The President and Immigration Law and The President and Immigration Law Redux label this constellation of developments “de facto delegation” and argue that it constitutes one of the most important features of modern American immigration law according to some embodiments. Moreover, the Executive Branch has actually helped construct an immigration system over time as it has wielded its enforcement power and decided how to put the Immigration and Nationality Act (“INA”) and its statutory framework into effect, a process that has entailed considerable executive policymaking dynamically related to, but still separate from, congressional policy according to some embodiments.

The President of the United States has numerous powers, including those explicitly granted by Article II of the United States Constitution, implied powers, powers granted by Acts of Congress, and the influence and soft power that comes from being President of the United States of America according to some embodiments. Within the executive branch itself, the President has broad powers to manage national affairs and the workings of the government according to some embodiments. The President can issue rules, regulations, and instructions called executive orders, which have the binding force of law upon federal agencies but do not require congressional approval according to some embodiments. They are, however, subject to judicial review and interpretation according to some embodiments.

The modern structure of immigration law has enabled the President to exert considerable control over immigration law's core question according to some embodiments: which types of noncitizens, and how many, should be permitted to enter and reside in the United States? Whether Congress intended for the President to have such freedom is not certain according to some embodiments. What is certain, however, is that the President has considerable authority as it relates to immigration according to some embodiments. There is ample legal scholarship and commentary supporting the power of the President in the immigration context according to some embodiments.

President Obama's November 2014 Executive Action on Immigration and EB-5 Recapture according to some embodiments:

The President of the United States potentially has “de facto delegation” and can direct the State Department and DHS to recapture unused EB-5 visas in the national interest based on federal administrative law, within the specific context of immigration law, without the need for an act of Congress or Congressional approval according to some embodiments. This conclusion is based on the following according to some embodiments:

On Nov. 20, 2014, President Obama announced sweeping executive reforms of immigration law (President Barack Obama, Remarks by the President in Address to the Nation on Immigration (Nov. 20, 2014)), and on Nov. 21, 2014, the President issued a memorandum for the heads of executive departments and agencies on the subject of modernizing and streamlining the United States immigrant and nonimmigrant visa system for the 21st century (“Presidential Memorandum—Modernizing and Streamlining the United States Immigrant Visa System for the 21st Century, dated Nov. 21, 2014”) (Presidential Memorandum”) according to some embodiments. The Presidential Memorandum directs the Secretaries of State and Homeland Security, in consultation with various other cabinet secretaries and the White House, to make recommendations to streamline and improve the nation's legal immigration system according to some embodiments.

According to the Presidential Memorandum, such efforts should focus on reducing Government costs, improving services for applicants, reducing burdens on employers, and combatting waste, fraud, and abuse in the system, while safeguarding the interests of American workers according to some embodiments. The Presidential Memorandum was accompanied by, and implemented through, a series of memoranda issued by United States Secretary of Homeland Security Jeh Charles Johnson See Fixing Our Broken Immigration System Through Executive Action—Key Facts, United States Dep't of Homeland Security (Aug. 19, 2015, including Policies Supporting United States High Skilled Businesses and Workers United States Department of Homeland Security (DHS) Secretary, Jeh Charles Johnson, Memorandum, (Policies Supporting United States High-Skilled Businesses and Workers, Nov. 20, 2014 (“Johnson Memorandum”)), which is directly relevant to the recapture of unused EB-5 visas according to some embodiments. The Johnson Memorandum underscores the need to ensure that all available immigrant visas are used each year and that the current backlog and lengthy wait times for immigrant visas should be addressed through full and fair visa allocation, as well as through recapture according to some embodiments.

Additionally, in the Johnson Memorandum, the Secretary directs USCIS to issue guidance or regulations to clarify the standard by which a national interest waiver can be granted, with the aim of promoting its greater use for the benefit of the U.S. economy according to some embodiments.

In addition to President Obama's November 2014 executive action on immigration, there is ample legal, legislative, regulatory, and policy precedent to support the position that unused immigrant visa numbers should be recaptured for use in subsequent fiscal years according to some embodiments. This measure would realize the intent of Congress, represent a proper exercise of Executive authority, and substantively address existing immigrant visa backlogs without negatively impacting United States workers according to some embodiments. Moreover, the current statutory framework allows and, indeed, requires the full and fair allocation of all available immigrant visa numbers; such an initiative would effect Congressional intent, relieve long-standing immigrant visa backlogs, and responsibly align visa demand with visa availability (Please see “Response to Request for Information (RFI) of Dec. 30, 2014” regarding “Streamlining the Legal Immigration System” and “Full and Fair Allocation of Immigrant Visas Through Use of All Available Visas, and the Recapture of Unused Visa Numbers During Subsequent Fiscal Years” prepared by Laura Foote Reiff of Greenberg Traurig, LLP) according to some embodiments.

There are many opportunities for investment in America's technology and industrial businesses according to some embodiments. The United States aerospace sector is rapidly growing to meet the worldwide demand for new commercial aircraft and aviation products according to some embodiments. The two largest manufacturers of commercial airplanes are The Boeing® Company, which manufactures commercial airplanes under its Boeing® Commercial Airplanes division, and Airbus SER, which manufactures commercial airplanes under its Airbus Commercial Aircraft® division. The largest commercial airplanes are wide-body jets according to some embodiments. These aircraft are frequently called twin-aisle aircraft because they generally have two separate aisles running from the front to the back of the passenger cabin according to some embodiments. These aircraft are usually used for long-haul flights between airline hubs and major cities with many passengers according to some embodiments. A smaller, more common class of commercial airplanes is the narrow-body or single-aisle aircraft according to some embodiments. These smaller commercial airplanes are generally used for short to medium-distance flights with fewer passengers than their wide-body counterparts according to some embodiments.

Regional commercial airplanes typically seat fewer than 100 passengers and may be powered by turbofans or turboprops according to some embodiments. These commercial airplanes are the non-mainline counterparts to the larger aircraft operated by the major carriers, legacy carriers, and flag carriers, and are used to feed traffic into the large airline hubs. These regional routes then form the spokes of a hub-and-spoke air transport model according to some embodiments.

The lightest (light aircraft) of short-haul regional feeder commercial airplane type aircraft that carry 19 or fewer passenger seats are called commuter aircraft, commuterliners, feederliners, and air taxis, depending on their size, engines, how they are marketed, region of the world, and seating configurations according to some embodiments. The Beechcraft 1900, for example, has only 19 seats according to some embodiments.

Since 2010, The Boeing® Company has increased production 56 percent to meet the strong demand for commercial airplanes according to some embodiments. Boeing® and its subsidiaries had over 148,750 employees working in 49 states as of Dec. 31, 2015 according to some embodiments. In the past 12 months, Boeing® paid nearly $50 billion to more than 13,600 businesses, supporting an additional 1.5 million supplier-related jobs across the country according to some embodiments. These businesses include production suppliers and non-production vendors, as well as subsidiaries of companies to which Boeing® made other payments according to some embodiments. According to the Department of Commerce, the United States gains 5,747 domestic jobs for each $1 billion spent on the manufacturing of commercial airplanes and commercial satellites according to some embodiments.

Air travel volume has more than doubled in the past 15 years in response to a growing global economy according to some embodiments. In 2018, Boeing® and Airbus® delivered a combined estimated total of $130b worth of aircraft and this amount is expected to rise to $185b by 2021 according to some embodiments. Airlines typically operate on low margins and, as a result, look to external sources to raise funding to replenish their fleet according to some embodiments.

Leasing agents have become a core part of the aviation industry according to some embodiments. Leasing reduces the initial capital outlay for airlines, provides access to the latest technologies and models, and allows airlines to flex the size of their feet to mirror demand. In 2018, approximately 40% of demand for funding came from lessors according to some embodiments.

Airlines and lessors benefit from a diverse funding landscape, with capital provided by banks, through export credit agencies and capital market entities such as insurance companies, pension schemes and investment funds according to some embodiments.

Historically, commercial banks have been one of the main sources of finance to the aviation market according to some embodiments. However, the development of innovative capital market products has enticed new investors into the space over the past few years according to some embodiments. The proposed Basel IV regulations could increase the amount of capital banks are required to hold against aviation (and other long-duration illiquid) assets and, therefore, could act to reduce banks' participation in the market (in areas where the Basel accords are ratified) according to some embodiments.

Export Credit Agencies (ECAs) and, on occasion, manufacturers also provide finance. ECAs are quasi-governmental institutions that guarantee loans to purchase products manufactured domestically in a bid to increase exports according to some embodiments. These loans became popular following the 2008 financial crisis, as they allowed access to relatively cheap finance at a time when bank lending was scarce according to some embodiments. Since then, these loans have become less popular as the prescribed terms (as set out in Aircraft Sector Understanding) have become less competitive in comparison to other sources of funding according to some embodiments.

Securitizations of commercial airplanes leases are an important source of capital for the financing of commercial airplanes according to some embodiments. Such financing provides entities involved in commercial airplane financing access to United States and foreign capital markets, thereby opening up significant new sources of capital for the commercial airplanes financing according to some embodiments. Commercial airplane financing involves at least two basic structures for securitizing airplane leases according to some embodiments: (i) enhanced equipment trust certificate (“EETC”) securitization under United States Bankruptcy Code Section 1110 and the Cape Town Convention on International Interests in Mobile Equipment (“Cape Town Convention”); and (ii) portfolio securitization according to some embodiments.

Through United States Bankruptcy Code Section 1110 and the Cape Town Convention, airplane securitizations are subject to United States and international law, resulting in a well-established financing market that allows for favorable leverage to be raised based upon the underlying airplane asset according to some embodiments. For example, United Airlines and American Airlines were able to lever respective EETC financings at securitization at 2.4× and 2.6× debt-to-equity ratio resulting in 71% and 73% debt-to-capitalization according to some embodiments. As a comparison, the overall shipbuilding & marine industry had a 0.5× debt-to-equity ratio resulting less than 35% debt-to-capitalization according to some embodiments.

EETC and Cape Town Convention securitizations enhance the creditworthiness of traditional equipment trust certificates secured by lease receivables and leased airplanes according to some embodiments. EETC and Cape Town Convention securitizations allow for favorable leverage and experienced a resurgence in 2015 and 2016 according to some embodiments. In contrast to the EETC and Cape Town Convention structure, a portfolio securitization relies on a diversified portfolio of assets according to some embodiments. Rather than enhancing a single corporate credit, the ratings of the debt securities issued in a portfolio securitization are based on the existence of diversified assets and the projected residual values of the assets, including of airplanes, in the portfolio according to some embodiments. The combination of long-lived physical assets in the form of Boeing Commercial Airplanes®; legal protection supported by United States Bankruptcy Code Section 1110 and the Cape Town Convention; Boeing Commercial Airplanes® securitization based on EETC securitization; and international usage of Boeing Commercial Airplanes®, provides EB-5 investors a level of comfort on both the return of and the return on “at-risk” invested capital according to some embodiments.

A “Pooled Aircraft Lease Securitization” (Aircraft Lease Asset-Backed Security (ABS)) represents one way for the aviation industry (specifically, an operating lessor) to fund itself through the capital markets according to some embodiments. Operating leasing has continued to develop since 1973 when the International Lease Finance Corporation offered the first operating lease to Aerovías de México, S.A. de C.V. (operating as Aeroméxico) according to some embodiments. Today, according to Boeing Capital Corporation® (BCC), aircraft lessors own more than 40% of all aircraft in service according to some embodiments. To preserve capital, many airlines are less interested in purchasing aircraft; however, these same airlines desire a modern fleet-operating leases provide a straightforward solution to address both objectives according to some embodiments. They provide greater fleet management flexibility and allow airlines to change or upgrade aircraft types in a relatively short time period according to some embodiments. A sale and leaseback transaction through a lease with a lessor has become a popular financial tool for airlines according to some embodiments. An airline can use previously designated delivery slots with the original equipment manufacturers (OEMs) while enabling the release of equity back into the airline, thereby strengthening cash reserves and improving balance-sheet liquidity according to some embodiments.

### Securities Law According to Some Embodiments:

The EB-5 employment-creation immigrant visa category, especially its more popular regional center pilot program, is on the rise as a favored form of United States immigration for wealthy foreign nationals according to some embodiments. The EB-5 regional center program requires no labor market test to prove the unavailability of United States workers; no anchor relative in the United States to petition on the immigrant's behalf; no claim of extraordinary or exceptional ability; no fear of persecution in the homeland; no business to manage directly on a day-today basis; or job to perform for a sponsor according to some embodiments. The category instead allows conditional and permanent resident status by investing lawfully acquired funds (at least $900,000 within a rural area or one of high unemployment, or $1,800,000 anywhere else) in a regional center approved by United States Citizenship and Immigration Services (USCIS) according to some embodiments. To qualify, each investor must directly or indirectly through the regional center create ten full-time jobs in the United States according to some embodiments.

From the investor's point of view, he or she is provided with offering materials from the regional center, such as a private placement memorandum and subscription agreement, and asked to sign the subscription agreement and deposit his money usually into an escrow account or an account controlled by the regional center according to some embodiments. An investor, his or her immigration counsel, and/or perhaps even some principals within a regional center may not fully understand the function of those offering documents according to some embodiments. The purpose of this article is to provide insight regarding the securities law requirements governing regional center offerings according to some embodiments.

When a regional center forms a limited partnership or limited liability company in which the EB-5 investor would become a limited partner (or member, in the case of a limited liability company), the regional center is offering an EB-5 investor a security according to some embodiments. Therefore, a regional center must comply with federal and state laws in conducting the offering of securities according to some embodiments. Given that the main focus of an EB-5 investment for the investor is obtaining permanent residency in the United States, investors may not recognize or consider that a regional center is offering a security according to some embodiments. More importantly, EB-5 investors most likely will have no idea what the implications are if a regional center tells them they are being offered or sold a security according to some embodiments. Some regional centers may themselves not be fully aware of these implications according to some embodiments.

Moreover, foreign investors, given their likely unfamiliarity with United States law, may not understand that state and federal securities laws are designed to protect investors, provide accurate information about potential investments, and punish unscrupulous persons or entities that violate these laws and ultimately injure owners of securities and harm financial markets according to some embodiments. These investor concerns and protections may seem unimportant at the outset when the primary focus is on obtaining permanent resident status according to some embodiments. Still, investors should recognize that not every investment is safe; not every investment in a regional center will ultimately result in green card status and produce a profit; and not every professional who offers to help investors through the process has the necessary expertise according to some embodiments. One major form of investor protection is to sue for a return of the investment, but this recourse does not help the EB-5 investor achieve permanent resident status according to some embodiments.

What then is a security according to some embodiments? The Securities Act of 1933, as amended (the “Securities Act”) defines “security” quite broadly according to some embodiments. It includes any note, stock, bond, “investment contract” or, in general, any interest or instrument commonly known as a “security” according to some embodiments. An “investment contract” is made when a person (i) invests money, (ii) in a common enterprise, (iii) with an expectation of profit, (iv) to be earned solely from the effort of others according to some embodiments. The United States Securities and Exchange Commission (“SEC”) has determined that interests in a limited partnership are an investment contract, and therefore, a security according to some embodiments. Though there have been disputes over whether a membership interest in a limited liability company is also a security, the SEC has considered limited liability company interests to be securities according to some embodiments. In fact, if a limited liability company offers unregistered interests in a limited liability company to many investors, it can expect that the SEC will initiate an action against it asserting that the membership interests are securities according to some embodiments.

The Securities Act requires that all securities sold must be registered with the SEC, unless exempted by its rules according to some embodiments. Rule 506 of Regulation D promulgated under the Securities Act provides the exemptions to the registration rules that regional centers typically use to avoid the burdensome and expensive process of registering the securities to be offered and sold to EB-5 investors according to some embodiments.

Even though the EB-5 program is designed to provide a path for immigrant investors to obtain a visa, EB-5 financing involves the offer and sale of securities and must be analyzed like any other securities offering according to some embodiments. Issuers and their counsel should consider the various securities laws that impact an EB-5 securities offering. In addition to state “blue sky” laws if the offering is also made in the United States, these laws include: (1) The Securities Act of 1933 (see The Securities Act); (2) The Securities Exchange Act of 1934 (see The Securities Exchange Act); (3) The Investment Company Act of 1940 (see The Investment Company Act); (4) The JOBS Act (See The JOBS ACT); and (5) The CROWDFUND Act (See The CROWDFUND Act) according to some embodiments.

The Jumpstart Our Business Startups Act, or JOBS Act, is a law intended to encourage funding of small businesses in the United States by easing many of the country's securities regulations according to some embodiments. It passed with bipartisan support and was signed into law by President Barack Obama on Apr. 5, 2012 according to some embodiments. Title III, also known as the CROWDFUND Act, has drawn the most public attention because it creates a way for companies to use crowdfunding to issue securities, something that was not previously permitted according to some embodiments. Title II went into effect on Sep. 23, 2013. On Oct. 30, 2015, the SEC adopted final rules allowing Title III equity crowdfunding according to some embodiments. These rules went into effect on May 16, 2016. Other titles of the Act had previously become effective in the years since the Act's passage according to some embodiments.

It is desirable to develop an investor visa funding program including, but not limited to, EB-5, that allows for the aggregation of investor visa funding including, but not limited to, EB-5, for investment, funding and compliance with relevant securities law according to some embodiments.

### Long-Lived Assets According to Some Embodiments:

A long-lived asset is any asset that a business expects to retain for at least one year according to some embodiments. This definition can be broadened to include any asset that is expected to be retained for more than one accounting period according to some embodiments. Once acquired, the cost of a long-lived asset is usually depreciated (for tangible assets) or amortized (for intangible assets) over the expected useful life of the asset according to some embodiments. This is done to match the ongoing use of the asset with the economic benefits derived from it. This depreciation or amortization may be accelerated if use of the asset is expected to occur primarily in the earlier stages of its useful life, though such acceleration can also be used to defer tax payments according to some embodiments.

### Infrastructure According to Some Embodiments:

The United States and much of the world is at a crossroads according to some embodiments. Deteriorating infrastructure is impeding our ability to compete in the thriving global economy, and improvements are necessary to ensure our country is built for the future according to some embodiments. While we have made some progress, reversing the trajectory after decades of underinvestment in our infrastructure requires transformative action from Congress, states, infrastructure owners, and the American people according to some embodiments. That is why every four years, America's civil engineers provide a comprehensive assessment of the nation's 16 major infrastructure categories in the American Society of Civil Engineers (ASCE) Infrastructure Report Card according to some embodiments. Using a simple A to F school report card format, the Report Card examines current infrastructure conditions and needs, assigning grades and making recommendations to raise them; the ASCE Infrastructure Report Card for 2017 is a D+ according to some embodiments.

Infra- means “below;” so the infrastructure is the “underlying structure” of a country and its economy, the fixed installations that it needs to function according to some embodiments. These include roads, bridges, dams, the water and sewer systems, railways and subways, airports, and harbors according to some embodiments. These are generally government-built and publicly owned according to some embodiments. Some people also speak about such things as the intellectual infrastructure or the infrastructure of science research, but the meaning of such notions can be extremely vague according to some embodiments.

Infrastructure refers to the fundamental facilities and systems serving a country, city, or other area, including the services and facilities necessary for its economy to function according to some embodiments. Infrastructure is composed of public and private physical improvements such as roads, bridges, tunnels, water supply, sewers, electrical grids, and telecommunications (including Internet connectivity and broadband speeds) according to some embodiments. In general, it has also been defined as “the physical components of interrelated systems providing commodities and services essential to enable, sustain, or enhance societal living conditions” according to some embodiments.

There are two general types of ways to view infrastructure, hard or soft according to some embodiments. Hard infrastructure refers to the physical networks necessary for the functioning of a modern industry. This includes roads, bridges, railways, etc. according to some embodiments. Soft infrastructure refers to all the institutions that maintain the economic, health, social, and cultural standards of a country according to some embodiments. This includes educational programs, official statistics, parks and recreational facilities, law enforcement agencies, and emergency services according to some embodiments.

The word infrastructure has been used in English since 1887 and in French since 1875, originally meaning “The installations that form the basis for any operation or system” according to some embodiments. The word was imported from French, where it means subgrade, the native material underneath a constructed pavement or railway according to some embodiments. The word is a combination of the Latin prefix “infra”, meaning “below” and many of these constructions are underground, for example, tunnels, water and gas systems, and railways according to some embodiments. The army use of the term achieved currency in the United States after the formation of NATO in the 1940s, and by 1970 was adopted by urban planners in its modern civilian sense according to some embodiments.

Infrastructure Finance according to some embodiments:

Infrastructure development lies at the nexus of economic growth, productive investment, job creation, and poverty reduction according to some embodiments. Financing the huge infrastructure investment gaps in the United States and globally, including in Emerging Market Economies (EMEs), (an estimated $1.3 trillion per year), is critical to sustained economic, sociopolitical and sociocultural development according to some embodiments.

On one hand, the infrastructure needs exceed sources of traditional funding. On the other hand, the traditional sources may even contract due to reduced fiscal and donor resources as well as tighter United States and international banking regulations according to some embodiments. The United States and international development community acknowledges the increasing need for enhanced participation of the private sector, especially as long-term financier, in infrastructure projects according to some embodiments. In light of the Maximizing Financing for Development (MFD) strategy, for example, the goal is to deliver infrastructure projects by reducing the reliance on public funds (i.e. taxpayers' money), either for immediate financing or future repayment, and mobilizing greater amount of commercial financing according to some embodiments. One key metric of success under the strategy would be the MFD multiplier (defined as the ratio of commercial finance to public funds) in the context of infrastructure finance according to some embodiments.

### Infrastructure Funding in the United States According to Some Embodiments:

Federal infrastructure investment in the United States is receiving a great deal of attention, largely about money according to some embodiments: how to finance capital investment, operations, and maintenance according to some embodiments. Less discussed but very important is modernizing federal policy to support the mature and urban-centered economy of the United States, rather than the economy it had when most of the terms of federal engagement were set according to some embodiments. There is a need to identify current trends in infrastructure spending and finance and to propose improvements in federal infrastructure policy according to some embodiments. There is a need to modernize federal policies related to infrastructure funding, finance, and project selection according to some embodiments. Modernization should recognize the centrality of regional initiatives that transcend local government and state boundaries and should encourage distinct types of financing, such as public, private, and public-private partnerships according to some embodiments. Poorly targeted investment comes from poorly designed policy according to some embodiments. Inadequate maintenance often is a symptom of failure of management and governance according to some embodiments. More money will help, but it is not nearly enough according to some embodiments.

Traditionally, infrastructure investments have been financed with public funds. Governments were the main actor in this field, given the inherent public good nature of infrastructure and the positive externalities often generated by such facilities according to some embodiments. However, public deficits, increased public debt to GDP ratios and, at times, the inability of the public sector to deliver efficient investment spending, have in many economies led to a reduction in the level of public funds allocated to infrastructure according to some embodiments. Budgetary pressures have been compounded in some cases by the need to repair bank balance sheets and rebuild capital and liquidity buffers, owing in part to strengthened prudential regulation in the banking sector according to some embodiments. Consequently, it is increasingly acknowledged that alternative sources of financing are needed to support infrastructure development according to some embodiments. In this context, much attention is being focused on the institutional investor sector, given the long-term nature of the liabilities for many types of institutional investors and their corresponding need for suitable long-term assets according to some embodiments. For several reasons, including a lack of familiarity with infrastructure investments, institutional investors at present allocate a very small fraction of their investments to infrastructure assets according to some embodiments. These investors have traditionally invested in infrastructure through listed companies and fixed income instruments according to some embodiments.

Infrastructure can be financed using different capital channels and involve different financial structures and instruments according to some embodiments. Some, like listed stocks and bonds, are market-based instruments with well-established regulatory frameworks according to some embodiments. Banks have traditionally been providers of infrastructure loans according to some embodiments. Efforts are underway to develop new financial instruments and techniques for infrastructure finance according to some embodiments. These efforts appear to be having some success according to some embodiments. Data indicate, for example, that developments in the equity market for investments in infrastructure are promising and that the creation of a liquid market for project bonds can be a good complement to syndicated loans for project finance according to some embodiments. Done properly, the securitization of bank loans could help support lending and diversify risks, while also assisting in the development of transparent capital market instruments according to some embodiments. Many investors nonetheless perceive a lack of appropriate financing structures according to some embodiments. Only the largest investors have the capacity to invest directly in infrastructure projects according to some embodiments.

Smaller pension funds require pooled investment vehicles according to some embodiments. Collective investment vehicles have been available, such as infrastructure funds, but problems with high fees, potential mismatches between asset life and fund vehicle, and extensive leverage mean that these investment options may not be suitable for all investors according to some embodiments. Yet the market is evolving to address some of the concerns according to some embodiments. Several newer unlisted equity funds in the market are offering longer investment terms according to some embodiments. Infrastructure financing can present challenges owing to the nature of infrastructure assets according to some embodiments.

The following are some common characteristics of infrastructure assets that differentiate them from other assets according to some embodiments: (1) Capital intensity and longevity: Capital intensity, high up-front costs, lack of liquidity and a long asset life generate substantial financing requirements and a need for dedicated resources on the part of investors to understand the risks involved and to manage them according to some embodiments. Infrastructure projects may not generate positive cash flows in the early phases, which may be characterized by high risks and costs due to pre-development and construction; yet they tend to produce stable cash flows once the infrastructure facility moves into the operational phase according to some embodiments. Some infrastructure assets, where users do not pay for services, do not generate cash flows at all, requiring government intervention to create investment value according to some embodiments. (2) Economies of scale and externalities: Infrastructure often comprises natural monopolies such as highways or water supply which exhibit increasing returns to scale and can generate social benefits according to some embodiments. While the direct payoffs to an owner of an infrastructure project may be inadequate for costs to be covered, the indirect externalities can still be beneficial for the economy according to some embodiments. Such social benefits are fundamentally difficult to measure according to some embodiments. Even if they can be measured, charging for them may not be feasible or desirable according to some embodiments. (3) Heterogeneity, complexity and presence of many parties according to some embodiments. Infrastructure facilities tend to be heterogeneous and unique in their nature, with complex legal arrangements structured to ensure proper distribution of payoffs and risk-sharing to align the incentives of all parties according to some embodiments. The uniqueness of infrastructure projects in terms of the services they provide and their structure and potential complexity makes infrastructure investments less liquid according to some embodiments. (4) Opaqueness: Infrastructure projects tend to lack transparency due to opaque and diverse structures according to some embodiments. This also applies to Public Private Partnerships (PPP) models according to some embodiments. The information required by investors to assess these risk-structures and the infrastructure market in general is lacking or highly scattered, creating uncertainty according to some embodiments. The lack of a clear benchmark for measuring investment performance is also seen by many investors as one of the main barriers to infrastructure investment according to some embodiments. The lack of transparency and adequate data increase risks for those engaging in infrastructure financing according to some embodiments. The potentially large information asymmetries that may exist in infrastructure, along with the long-term nature of infrastructure investment, may lead parties to deviate ex post from ex ante decisions, a risk which among others may impede private financing according to some embodiments.

To attract institutional investors to the full spectrum of infrastructure assets, such assets need to be structured as attractive investment opportunities, providing risk-return profiles that match investors' return expectations and liability structures according to some embodiments. Some projects are clearly and unequivocally commercially viable and these projects are typically able to attract private sector finance according to some embodiments. However, for other projects where the rate of return may be insufficient to compensate private sector investors for the level and/or character of risk, various risk mitigation techniques and incentives may be employed to manage risks and/or enhance returns according to some embodiments. Any government intervention to these ends may, however, generate unintended consequences, such as moral hazard and market distortions, which should be addressed ex ante in policy design to the extent possible according to some embodiments. Generally, the expected benefits of providing risk mitigation should be balanced against their costs, and their provision should serve to supplement market-based approaches to infrastructure finance according to some embodiments. This report provides a structured framework for understanding the range of instruments and vehicles for infrastructure finance along with risk mitigation measures and incentives that may be used to support such financing according to some embodiments. By providing a structured overview and description of instruments and incentives for infrastructure finance, it can serve as a starting point for further discussion and analysis of infrastructure financing and related challenges, including the development of analysis on the advantages and disadvantages of these instruments and incentives and guidance on the assorted options for their use according to some embodiments.

### Infrastructure Credit Enhancement:

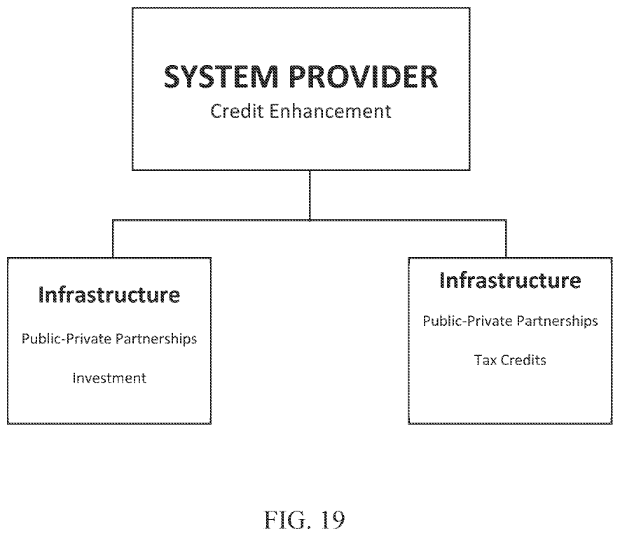

Referring to at least FIG. 19, credit enhancement instruments can be loosely defined as financial instruments that transfer a certain type of project risk from the project to creditworthy third parties who are better placed to mitigate them according to some embodiments. Credit and liquidity support investors, bond buyers and lenders typically look for highly rated investment grade cash generating assets to reduce the chances of losing money according to some embodiments. A common funding model uses credit enhancement products to reduce credit risk and subsequently obtain more attractive financing terms and interest rates according to some embodiments. For example, a properly structured transaction with a sound credit enhancement can reduce the loan interest rate by 50% or more according to some embodiments. In such a case, the typical form of security is a guarantee from an investment grade rated corporate or sovereign entity sponsoring the project or other third-party guarantees according to some embodiments.

In some cases, such a guarantee is a letter of credit issued or confirmed by highly rated international banks to provide liquidity and assurance that payments are not missed or delayed according to some embodiments. A bank letter of credit normally costs between 0.75% and 2.00% per annum depending upon the risk associated with the project and sponsors financial strength according to some embodiments. Banks in all parts of the world commonly issue letters of credit according to some embodiments. International rating agencies such as Moody's, Standard & Poor, Fitch and AM Best rate entities based on how likely they are to default on their obligations. Investment grade is from BBB-to AAA ratings according to some embodiments.

There are many factors determining these ratings depending on the type of entity according to some embodiments. Most institutional investors concerned about risk place reliance on such ratings in selecting investments according to some embodiments. Most infrastructure finance relies on the project cashflows as opposed to credit ratings as these are typically not rated according to some embodiments. Some investors, in addition to requiring a project or entity to have quality cashflows to service the funding, credit quality and liquidity in the event of payment delays are also key considerations according to some embodiments. Credit and liquidity enhancement can be achieved through a letter of credit according to some embodiments.

This tends to lower costs of funding significantly compared to traditional project financing, and introduces flexibility in funding structures, including ability to do very long-term loans and 100% funding into projects according to some embodiments. Such form of funding is important for accelerated and sustainable infrastructure investment according to some embodiments. Letters of credit as security to financing a letter of credit is an undertaking, usually on the part of a bank (the “issuer”) at the request of one of its customers, to pay a named beneficiary a specified amount of money in terms of conditions specified in the letter of credit according to some embodiments.

Fundamental to a letter of credit transaction is that the undertaking of the issuer is independent of the obligations between its customer (the “account party”) and the beneficiary of the letter of credit, typically the account party's vendor or lender according to some embodiments. It is like an insurance policy issued by a bank if the bank customer defaults on its financial obligation according to some embodiments. Standby letters of credit (“SBLC”) are typically intended as security for the account party's performance or payment obligations under its contract with the beneficiary according to some embodiments.

SBLCs are not expected to be drawn upon except in the case of a default or breach by the account party according to some embodiments. They function much like insurance policies that pay upon predefined events and claims according to some embodiments.

On the other hand, commercial letters of credit are typically issued for the account of a purchaser and are intended to be drawn upon as the means of payment for the goods sold according to some embodiments. These instruments are commonly used in short term trade finance according to some embodiments.

One such instrument commonly used in infrastructure finance provides security such that it is drawn upon by the beneficiary in the event of default or delayed payments according to some embodiments. The full amount covered is never intended to be drawn in full at once and this is usually reflected in the wording according to some embodiments. Although the full amount must be stated in the instrument, it must only cover shortfalls and missed payments according to some embodiments.

Such instruments provide credit enhancement for debt or financial obligations including leases, payment contracts and are issued for the account of the borrower for the benefit of the lender or credit provider, or a third-party trustee for the creditors/lenders according to some embodiments. This will prevent a loan or financial obligation from technically going into default according to some embodiments. They provide the primary source of payment of the principal and interest on the debt according to some embodiments. Because the credit of the bank issuing such an instrument is better than that of the borrower, the borrower is generally able to obtain a significantly lower interest rate, long term loans and more flexible financing terms according to some embodiments.

This type of letter of credit is more appropriate in project and infrastructure financings, government supported financings and by large multinational corporations and non-profit institutions according to some embodiments. International financing with letter of credit support letters of credit are long standing proven banking instruments for institutional financial transactions in the United States and North America for more than three decades, especially with government, complex project financings and municipal financings according to some embodiments.

### Infrastructure Loan Guarantees According to Some Embodiments:

The United States private guarantee market offers highly developed forms of credit enhancement according to some embodiments. A particularly important element is the upgrading of bond ratings according to some embodiments. Under this system the issuer or the underwriter of a security purchases a financial guarantee to insure the timely payment of principal and interest in the event of the issuer's default according to some embodiments. As a result, the bond's rating is enhanced—typically to AAA thereby lowering the issuer's borrowing costs according to some embodiments.

The United States private guarantee market is very well developed and is often used to guarantee public municipal bonds that are used to fund infrastructure projects according to some embodiments. An interesting feature of the system is that upgrading bond ratings makes them a feasible alternative to bank loans according to some embodiments. This gives an opportunity for institutional investors as well as small investors to participate in the financing of infrastructures according to some embodiments. Especially small investors might prefer the security of bonds to possible larger yields from other less stable investments according to some embodiments. The participation in financing might in turn introduce a degree of cooperation between these investors and the banking sector according to some embodiments. Another advantage is that the enhancement of credit gives the possibility of matching timeframes between investor and the project to be financed according to some embodiments. A drawback of the American system is the limited competition due to the fact that the financial guarantees are typically sold by bank consortia according to some embodiments. In addition to the rather uniform municipal bond insurance market there is also a far more complex and diverse corporate financial guarantee market according to some embodiments.

Experience from the United States market indicates that often the main economic value to the debt issuer is not the assumption of default risk, but assurance of improved market liquidity, lower borrowing costs, collateral monitoring services or avoidance of regulations affecting issuers or purchasers of debt securities according to some embodiments. Furthermore, the banks are also using such financing to manage their balance sheets according to some embodiments.

All in all, the American system offers an interesting way of widening the possible sources of financing according to some embodiments. In Europe the financial guarantee industry is only just starting and is far smaller in scale than in the United States community facility could help develop this market benefitting from the United States experience according to some embodiments.

### High-Speed Rail According to Some Embodiments:

High-speed rail (HSR) is a type of rail transport that operates significantly faster than traditional rail traffic, using an integrated system of specialized rolling stock and dedicated tracks according to some embodiments. While there is no single standard that applies worldwide, new lines in excess of 250 kilometers per hour (160 mph) and existing lines in excess of 200 kilometers per hour (120 mph) are widely considered to be high-speed, with some extending the definition to include lower speeds in areas for which these speeds still represent significant improvements according to some embodiments. The first such system began operations in Japan in 1964 and was widely known as the bullet train. High-speed trains normally operate on standard gauge tracks of continuously welded rail on grade-separated right-of-way that incorporates a large turning radius in its design according to some embodiments.

Many countries have developed high-speed rail to connect major cities, including Austria, Belgium, China, Finland, France, Germany, Ireland, Italy, Japan, Morocco, the Netherlands, Poland, Portugal, Russia, Saudi Arabia, South Korea, Spain, Sweden, Taiwan, Turkey, the United Kingdom, and Uzbekistan according to some embodiments. Only in Europe does HSR cross international borders according to some embodiments. China had 29,000 kilometers (18,000 mi) of HSR as of December 2018, accounting for two-thirds of the world's total according to some embodiments.

### Smart Grid According to Some Embodiments:

A smart grid is an electricity supply network that uses digital communications technology to detect and react to local changes in usage according to some embodiments.

A smart grid is an electrical grid which includes a variety of operation and energy measures including smart meters, smart appliances, renewable energy resources, and energy efficient resources according to some embodiments. Electronic power conditioning and control of the production and distribution of electricity are important aspects of the smart grid according to some embodiments.

Smart grid policy is organized in Europe as Smart Grid European Technology Platform according to some embodiments. Policy in the United States is described in 42 U.S.C. chapter. 152, subchapter. IX § 17381 according to some embodiments.

Roll-out of smart grid technology also implies a fundamental re-engineering of the electricity services industry, although typical usage of the term is focused on the technical infrastructure according to some embodiments.

### 5G According to Some Embodiments:

5G is the new generation of radio systems and network architecture that will deliver extreme broadband, ultra-robust, low latency connectivity and massive networking for human beings and the “Internet of Things” according to some embodiments. 5G will combine existing “Radio Access Technologies” (RATs) in both licensed and unlicensed bands, and it will add novel RATs optimized for specific bands and deployments, scenarios and use cases. 5G will also implement a radically new network architecture based on “Network Function Virtualization” (NFV) and “Software Defined Networking” (SDN) technologies according to some embodiments. Programmability is central to achieving the hyper-flexibility that operators will need to support the new communications demands placed on them from a wide array of users, machines, companies from different industries and other organizations such as municipalities. 5G networks will have to be programmable, software driven and managed holistically to enable a diverse and profitable range of services. 5G is a door opener for new possibilities and use cases, many of which are as yet unknown according to some embodiments.

### 5G Spectrum and Coverage Implications According to Some Embodiments:

While there are a number of spectrum bands which could potentially be used in meeting some of the 5G requirements identified to date, there is currently a substantial focus on higher frequency radio spectrum according to some embodiments. Operators, vendors and academia are combining efforts to explore technical solutions for 5G that could use frequencies above 6 GHz and reportedly as high as 300 GHz according to some embodiments. However, most higher frequency bands offer smaller cell radiuses and therefore achieving widespread coverage using a traditional network topology model is challenging according to some embodiments. The use of bands higher than 6 GHz will likely require operators to invest in an entirely new radio access network (RAN) since it will have fundamentally different masthead requirements according to some embodiments. Given the level of infrastructure required to achieve the desired network topology, operators may be forced to rethink their existing business models according to some embodiments. New technology is rarely an inexpensive option, and the nature of the new technology that is required in the radio network makes it very power-intensive, hence counter to the stated requirement for significant reduction in overall network power consumption according to some embodiments. A need exists to address 5G spectrum coverage implications by delivering 5G telecommunications and Internet services to everyone in the world via low cost micro-satellites combined with industry leading ground-based terrestrial 5G mobile communications systems according to some embodiments.

### 5G and Space Internet According to Some Embodiments:

There is a need to develop and implement a Space Internet and single-block secure 5G network in the United States and globally to make 5G telecommunications and Internet services available and affordable to everyone in the world via low cost micro-satellites and industry leading terrestrial 5G mobile communications systems according to some embodiments. There is a need to develop a Space Internet and satellite-provided telecommunications and broadband services, inclusive of (i) spacecraft launch capability; (ii) satellite deployment capability; (iii) global telecommunications products and services; and (iv) digital technology products and services, to provide 5G telecommunications and digital technology to consumers, corporations, governments and other entities on a global basis according to some embodiments. Combining 5G terrestrial communication services with the Space Internet and satellite-provided telecommunications and broadband services provides a credible opportunity to disrupt and transform telecommunications and digital technology in United States and on a global basis according to some embodiments. Moreover, the Space Internet and satellite-provided telecommunications and broadband services are areas with tremendous growth potential as almost two-thirds of the global population currently does not have access to the Internet, wired or wireless; this growth potential expands exponentially with the application of 5G to global telecommunications, the “Internet of People”, the “Internet of Everything”, and the “Internet of Things” according to some embodiments.

There is a recognition that 4,600 micro-satellites operating at data rates in excess of Tb/s in Low-Earth Orbit (LEO) can provide overall capacity of one Zettabyte/month or 200 GB/month for 5 billion users worldwide with signal latencies comparable to those offered by ground-based systems according to some embodiments. These ultra-high data rates are enabled by a multi-comm-core approach which enables using tens of GHz millimeter wave spectrum in the 10 GHz to 275 GHz frequency range according to some embodiments. A potential spectrum availability of over 100 GHz has been identified which includes 57.75 GHz for uplink, 56.2 GHz for downlink and 38.75 GHz for inter-satellite communication according to some embodiments. With 5G mobile communications and next generation Wi-Fi expected to use millimeter wave spectrum, it is possible to develop a single wireless technology for satellite, cellular and Wi-Fi access as well as for back-haul communications to take advantage of scale and further reduce costs according to some embodiments. For example, the techniques developed for 5G millimeter wave mobile communication, such as antenna-arrays based multi-beam communication, beam-steering and beam tracking, can be applied to satellites in the LEO orbit which appear mobile to ground-based stationary and mobile systems and vice versa according to some embodiments.

### Water Supply System or Water Supply Network According to Some Embodiments:

A water supply system or water supply network is a system of engineered hydrologic and hydraulic components which provide water supply according to some embodiments. A water supply system typically includes: (1) A drainage basin (see water purification-sources of drinking water); (2) A raw water collection point (above or below ground) where the water accumulates, such as a lake, a river, or groundwater from an underground aquifer. Raw water may be transferred using uncovered ground-level aqueducts, covered tunnels or underground water pipes to water purification facilities; (3) Water purification facilities. Treated water is transferred using water pipes (usually underground); (4) Water storage facilities such as reservoirs, water tanks, or water towers according to some embodiments. Smaller water systems may store the water in cisterns or pressure vessels according to some embodiments. Tall buildings may also need to store water locally in pressure vessels in order for the water to reach the upper floors; (5) Additional water pressurizing components such as pumping stations may need to be situated at the outlet of underground or above ground reservoirs or cisterns (if gravity flow is impractical); (6) A pipe network for distribution of water to the consumers (which may be private houses or industrial, commercial or institution establishments) and other usage points (such as fire hydrants); (7) Connections to the sewers (underground pipes, or aboveground ditches in some developing countries) are generally found downstream of the water consumers, but the sewer system is considered to be a separate system, rather than part of the water supply system according to some embodiments.

### Port According to Some Embodiments:

A port is a maritime commercial facility which may comprise one or more wharves where ships may dock to load and discharge passengers and cargo according to some embodiments. Although usually situated on a sea coast or estuary, some ports, such as Hamburg, Manchester and Duluth, are many miles inland, with access from the sea via river or canal according to some embodiments.

Today, by far the greatest growth in port development is in Asia, the continent with some of the world's largest and busiest ports, such as Singapore and the Chinese ports of Shanghai and Ningbo-Zhoushan according to some embodiments.

### Airport According to Some Embodiments:

An airport is an aerodrome with extended facilities, mostly for commercial air transport. Airports often have facilities to store and maintain aircraft, and a control tower according to some embodiments. An airport consists of a landing area, which comprises an aerially accessible open space including at least one operationally active surface such as a runway for a plane to take off or a helipad, and often includes adjacent utility buildings such as control towers, hangars and terminals according to some embodiments. Larger airports may have airport aprons, taxiway bridges, air traffic control centers, passenger facilities such as restaurants and lounges, and emergency services. In some countries, the US in particular, they also typically have one or more fixed-base operators, serving general aviation according to some embodiments.

An airport solely serving helicopters is called a heliport according to some embodiments. An airport for use by seaplanes and amphibious aircraft is called a seaplane base. Such a base typically includes a stretch of open water for takeoffs and landings, and seaplane docks for tying-up according to some embodiments.

An international airport has additional facilities for customs and passport control as well as incorporating all the aforementioned elements according to some embodiments. Such airports rank among the most complex and largest of all built typologies with 15 of the top 50 buildings by floor area being airport terminals according to some embodiments.

### Inland Port According to Some Embodiments:

An inland port is a port on an inland waterway, such as a river, lake, or canal, which may or may not be connected to the sea according to some embodiments. The term “inland port” is also used to refer to a dry port, which is an inland extension of a seaport, usually connected by rail to the docks according to some embodiments. This article covers only ports that are covered by the first definition according to some embodiments.

### Sports Venue According to Some Embodiments:

A sports venue is a building, structure, or place in which a sporting competition is held according to some embodiments.

A stadium (plural stadiums or stadia), sports venue, is a place or venue for (mostly) outdoor sports, concerts, or other events and consists of a field or stage either partly or surrounded by a tiered structure designed to allow spectators to stand or sit and view the event according to some embodiments. Many stadiums with a capacity of at least 10,000 are used for association football according to some embodiments. Other popular stadium sports include American football, gridiron football, baseball, cricket, the distinct types of rugby, field lacrosse, bandy, and bullfighting. Many large sports venues are also used for concerts according to some embodiments.

An arena, a sports venue, is an enclosed area, often circular or oval-shaped, designed to showcase theatre, musical performances, or sporting events according to some embodiments. It is composed of a large open space surrounded on most or all sides by tiered seating for spectators, and may be covered by a roof according to some embodiments. The key feature of an arena is that the event space is the lowest point, allowing maximum visibility according to some embodiments. Arenas are usually designed to accommodate many spectators according to some embodiments.

A baseball park, also known as a ballpark or diamond, is a sports venue where baseball is played according to some embodiments. A baseball park consists of the playing field and the surrounding spectator seating according to some embodiments. While the diamond and the areas denoted by white painted lines adhere to strict rules, guidelines for the rest of the field are flexible according to some embodiments.

The term “ballpark” sometimes refers either to the entire structure, or sometimes to just the playing field according to some embodiments. A home run where the player makes it around the bases, and back to home plate, without the ball leaving the playing field is typically called an “inside-the-park” home run according to some embodiments. Sometimes a home run ball passing over an outfield fence (when hit by a batter) is said to have been hit “out of the ballpark”, but that phrase more often refers to a home run ball that cleared the stands, landing outside the building according to some embodiments. The playing field is most often called the “ballfield”, though the term is often used interchangeably with “ballpark” when referring to a small local or youth league facility according to some embodiments.

### Islamic Finance According to Some Embodiments:

Islamic banking or Islamic finance or sharia-compliant finance is banking or financing activity that complies with Sharia (Islamic law) and its practical application through the development of Islamic economics according to some embodiments. Some of the modes of Islamic banking/finance include Mudarabah (profit-sharing and loss-bearing), Wadiah (safekeeping), Musharaka (joint venture), Murabahah (cost-plus), and Ijara (leasing) according to some embodiments.

Shari'ah-compliant investments are generally geared towards low-debt, nonfinancial, and socially ethical assets according to some embodiments. Islamic financial institutions are primarily known for being involved in the following industries according to some embodiments: information technology, software and computers, electronics, engineering, telecom, chemicals, pharmaceuticals and biotechnology, oil/gas, utilities, mining, airlines, shipping, automobiles, and construction according to some embodiments.

Islamic banking or Islamic finance or sharia-compliant finance is distinct from Zakat according to some embodiments.

### Zakat According to Some Embodiments:

Zakat which is a form of alms-giving treated in Islam as a religious obligation or tax, which, by Quranic ranking, is next after prayer (salat) in importance according to some embodiments. As one of the Five Pillars of Islam, zakat is a religious obligation for all Muslims who meet the necessary criteria of wealth according to some embodiments. It is a mandatory charitable contribution, often considered to be a tax according to some embodiments.

### Donation According to Some Embodiments:

A donation is a gift for charity, humanitarian aid, or to benefit a cause according to some embodiments. A donation may take various forms, including money, alms, services, or goods such as clothing, toys, food, or vehicles according to some embodiments. A donation may satisfy medical needs such as blood or organs for transplant according to some embodiments. Charitable donations of goods or services are also called gifts in kind according to some embodiments.

### Crowd Funding According to Some Embodiments:

Crowdfunding is the practice of funding a project or venture by raising small amounts of money from a large number of people, typically via the Internet according to some embodiments. Crowdfunding is a form of crowdsourcing and alternative finance according to some embodiments. In 2015, over US$34 billion was raised worldwide by crowdfunding. Although similar concepts can also be executed through mail-order subscriptions, benefit events, and other methods, the term crowdfunding refers to Internet-mediated registries according to some embodiments. This modern crowdfunding model is generally based on three types of actors: the project initiator who proposes the idea or project to be funded, individuals or groups who support the idea, and a moderating organization (the “platform”) that brings the parties together to launch the idea according to some embodiments. Crowdfunding has been used to fund a wide range of for-profit, entrepreneurial ventures such as artistic and creative projects, medical expenses, travel, and community-oriented social entrepreneurship projects according to some embodiments.

### Infrastructure Financing Lease-Based Model (Infrastructure Financing Rent-Based Model) According to Some Embodiments:

Deriving revenues through the leasing model typically involves three parties: the seller, the buyer (lessee) and the financier (lessor) according to some embodiments. In exchange for payment, ownership of an item (usually equipment) is transferred from the seller to the lessor according to some embodiments. The lessee then contracts with the lessor for the use of the item in exchange for a periodic fee according to some embodiments. The seller may or may not retake ownership of the item once the leasing contract has ended according to some embodiments. Leasing arrangements occur most frequently in transactions involving the exchange of costly physical goods according to some embodiments. Clean technology and medical devices are two markets in which leasing arrangements for the use of equipment are common according to some embodiments. “Big-ticket items” such as capital equipment, medical diagnostic equipment and devices, manufacturing equipment, and physical infrastructure are examples of goods that may generate income through leasing arrangements according to some embodiments. Customer relationships in the leasing revenue model according to some embodiments. Because of their long duration, leasing arrangements create ongoing relationships between sellers and lessors according to some embodiments. Often a service agreement will exist alongside the leasing arrangement requiring the seller to provide support to the lessor throughout the term of the contract according to some embodiments. Leasing revenues can help the seller meet the need for early customers and early revenues, but leasing comes at the cost of full revenue potential since revenues are split between the seller and the lessor according to some embodiments. Operating with leasing revenue requires salespeople to focus on generating repeat sales in the form of lease renewals or expanded leasing arrangements according to some embodiments. Also important is the cost of financing, since leasing of technology typically requires the participation of a financial backer according to some embodiments.

Leasing is a useful model for expanding markets because it enables the sale of expensive items, goods or services to customers who do not want to assume the risk of an outright purchase, or cannot afford to pay a large up-front sum according to some embodiments. On the other hand, the high transaction and processing costs associated with leasing means that it is often only an appropriate model for high-value items according to some embodiments. Leasing agreements can also be complex and require that all parties have a clear understanding of the ownership and payment obligations when a leasing contract is terminated early or is broken according to some embodiments.

### Investment According to Some Embodiments:

Some embodiments of the invention comprise a computer-implemented method that includes at least according to some embodiments: specifically programming at least one computer system or a portion of at least one computer system to perform at least one of the following according to some embodiments: aggregate immigrant investor visas and/or immigrant investor visa funding including, but not limited to, EB-5 for investment; aggregate recaptured immigrant investor visas including, but not limited to, recaptured EB-5 for investment; aggregate unused immigrant investor visas including, but not limited to, unused EB-5 for investment according to some embodiments.

Some embodiments of the invention comprise a computer-implemented method that includes at least specifically programming at least one computer system or a portion of at least one computer system to perform at least one of the following: aggregate immigrant investor visas and/or immigrant investor visa funding including, but not limited to, EB-5, for the purposes of: investment; immigrant investor visa automated application processing; immigrant investor visa automated legal processing; immigrant investor visa automated expedited processing; immigrant investor visa automated authentication of source of funds processing; immigrant investor visa automated background check processing; immigrant investor visa automated national security related screening and processing; immigrant investor visa automated processing of visas including, but not limited to, EB-5 visas; immigrant investor visa automated processing of recaptured visas including, but not limited to, recaptured EB-5 visas; immigrant investor visa automated processing of unused visas including, but not limited to, unused EB-5 visas; automated processing of investment; automated processing of credit enhancement; and automated processing of loan guarantees and other types of financing.

Some embodiments of the invention comprise a method for aggregate funding including, but not limited to, immigrant investor visa funding including, but not limited to, EB-5 funding for investment: Step 1: aggregate immigrant investor visa funding including, but not limited to, EB-5 funding for investment; Step 2: aggregate funding to be used as credit enhancement; Step 3: aggregate funding to be used in and for guarantor loans.

Some embodiments of the invention comprise a method for aggregate immigrant investor visa funding including, but not limited to, EB-5 funding for investment: Step 1: aggregate immigrant investor visa funding including, but not limited to, EB-5 funding for investment; Step 2: aggregate immigrant investor visa funding including, but not limited to, EB-5 funding for credit enhancement; Step 3: aggregate immigrant investor visa funding including, but not limited to EB-5 funding for guarantor loans.

Some embodiments of the invention comprise a computer-implemented method that includes at least specifically programming at least one computer system or a portion of at least one computer system to perform at least one of the following: aggregate immigrant investor visas and/or immigrant investor visa funding including, but not limited to, EB-5, for the purposes of: investment; immigrant investor visa automated application processing; immigrant investor visa automated legal processing; immigrant investor visa automated processing of recaptured visas including, but not limited to, recaptured EB-5 visas; immigrant investor visa automated processing of unused visas including, but not limited to, unused EB-5 visas; immigrant investor visa automated expedited processing; immigrant investor visa automated authentication of source of funds processing; immigrant investor visa automated background check processing; immigrant investor visa automated national security related screening and processing; automated processing of investment; automated processing of credit enhancement; and automated processing of loan guarantees.

### Investment and Immigration Investor Visas/EB-5 According to Some Embodiments:

Some embodiments of the invention comprise a computer-implemented method that includes at least: specifically programming at least one computer system or a portion of at least one computer system to perform at least one of the following: aggregate immigrant investor visas and/or immigrant investor visa funding including, but not limited to, EB-5 for investment; aggregate immigrant investor visas and/or immigrant investor visa funding including, but not limited to, EB-5 for credit enhancement; aggregate immigrant investor visas and/or immigrant investor visa funding including, but not limited to, EB-5 for guarantor loans; aggregate immigrant investor visas and/or immigrant investor visa funding including, but not limited to, EB-5 for infrastructure leasing.

### Investment and Recaptured Immigration Investor Visas/Recaptured EB-5 According to Some Embodiments:

Some embodiments of the invention comprise a computer-implemented method that includes at least: specifically programming at least one computer system or a portion of at least one computer system to perform at least one of the following: aggregate recaptured immigrant investor visas for use in subsequent fiscal years including, but not limited to, recaptured EB-5 visas for investment; aggregate recaptured immigrant investor visas including, but not limited to, recaptured EB-5 visas for credit enhancement; aggregate recaptured immigrant investor visas including, but not limited to, recaptured EB-5 visas for guarantor loans; aggregate recaptured immigrant investor visas including, but not limited to, recaptured EB-5 visas for infrastructure leasing.

### Investment and Unused Immigration Investor Visas/Unused EB-5 According to Some Embodiments:

Some embodiments of the invention comprise a computer-implemented method that includes at least: specifically programming at least one computer system or a portion of at least one computer system to perform at least one of the following: aggregate unused immigrant investor visas including, but not limited to, unused EB-5 visas for investment; aggregate unused immigrant investor visas including, but not limited to, unused EB-5 visas for credit enhancement; aggregate unused immigrant investor visas including, but not limited to, unused EB-5 visas for guarantor loans; aggregate unused immigrant investor visas including, but not limited to, unused EB-5 visas for infrastructure leasing.

### Aircraft According to Some Embodiments:

Some embodiments of the invention comprise a computer-implemented method that includes at least: specifically programming at least one computer system or a portion of at least one computer system to perform at least one of the following: aggregate immigrant investor visas and/or immigrant investor visa funding including, but not limited to, EB-5 visas for investment in aircraft; aggregate recaptured immigrant investor visas including, but not limited to, recaptured EB-5 visas for investment in aircraft; aggregate unused immigrant investor visas including, but not limited to, unused EB-5 visas for investment in aircraft.

Some embodiments of the invention comprise a computer-implemented method that includes at least specifically programming at least one computer system or a portion of at least one computer system to perform at least one of the following: aggregate immigrant investor visas and/or immigrant investor visa funding including, but not limited to, EB-5 visas, for the purposes of: investment in aircraft; immigrant investor visa automated application processing; immigrant investor visa automated legal processing; immigrant investor visa automated expedited processing; immigrant investor visa automated authentication of source of funds processing; immigrant investor visa automated background check processing; immigrant investor visa automated national security related screening and processing; immigrant investor visa automated processing of visas including, but not limited to, EB-5 visas; immigrant investor visa automated processing of recaptured visas including, but not limited to, recaptured EB-5 visas; immigrant investor visa automated processing of unused visas including, but not limited to, unused EB-5 visas; automated processing of investment; automated processing of credit enhancement; and automated processing of loan guarantees and other types of financing.

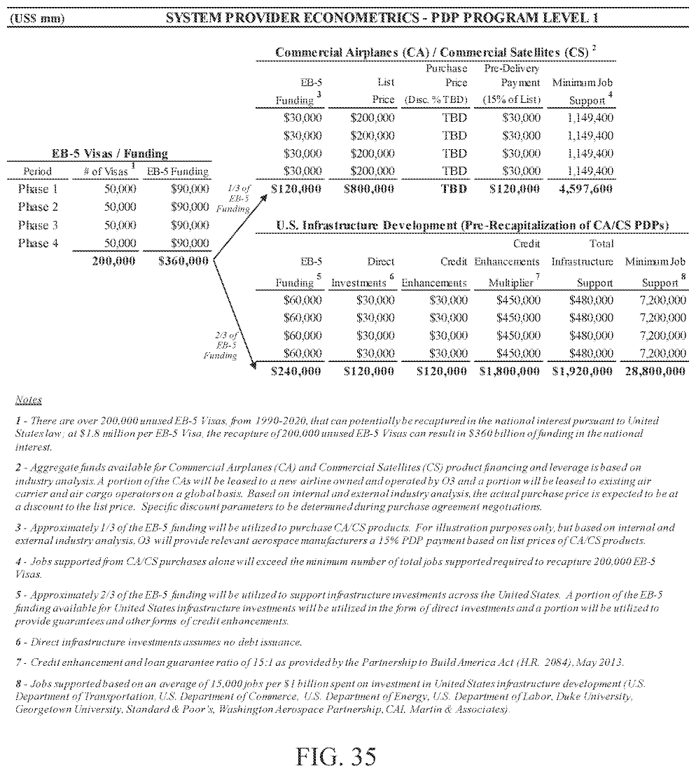

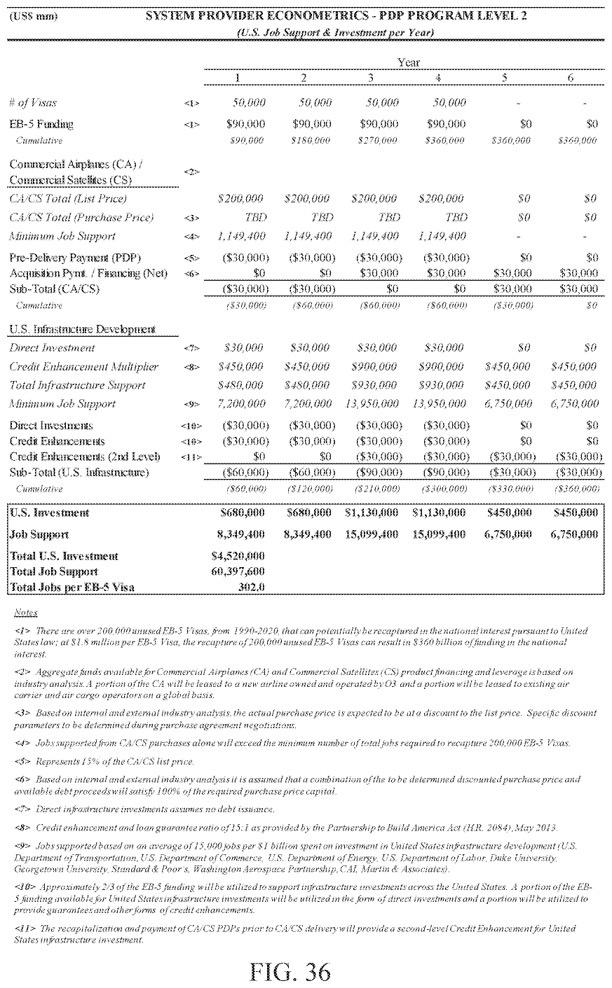

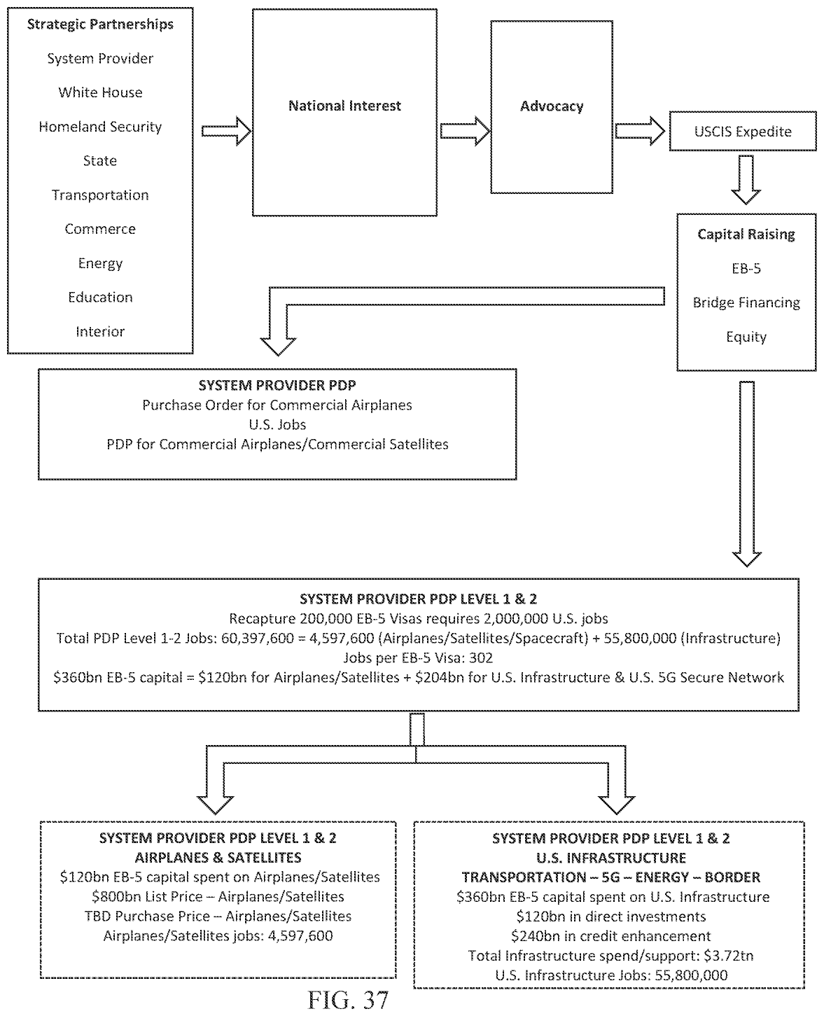

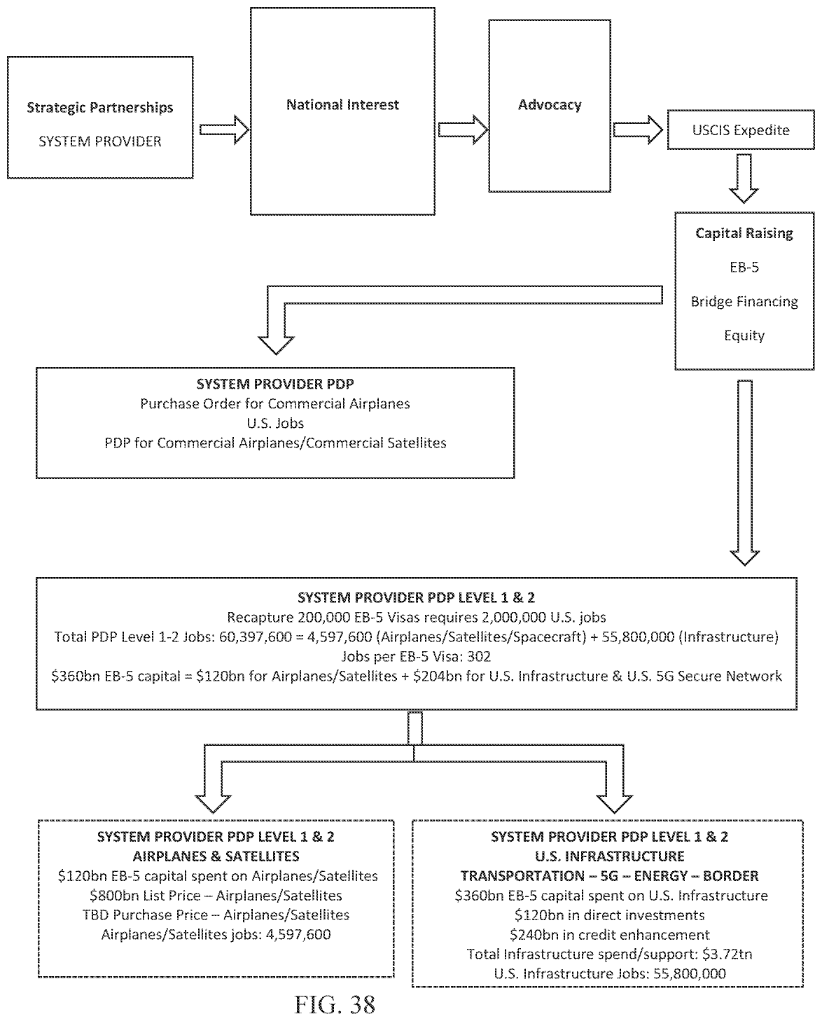

Referring to at least FIG. 16 and FIGS. 35-38, some embodiments of the invention comprise a method for aggregate funding including, but not limited to, immigrant investor visa funding including, but not limited to, EB-5 funding for investment: Step 1: aggregate immigrant investor visa funding including, but not limited to, EB-5 funding for investment in aircraft; Step 2: aggregate immigrant investor visa funding including, but not limited to EB-5 funding, to be used as a pre-delivery payment (hereafter “PDP”) for investment in aircraft; Step 3: aggregate immigrant investor visa funding including, but not limited to, EB-5 funding for investment; Step 4: aggregate funding to be used as credit enhancement; Step 5: aggregate funding to be used in and for guarantor loans.

Some embodiments of the invention comprise a computer-implemented method that includes at least specifically programming at least one computer system or a portion of at least one computer system to perform at least one of the following: aggregate immigrant investor visas and/or immigrant investor visa funding including, but not limited to, EB-5, for the purposes of: investment in aircraft; immigrant investor visa automated application processing; immigrant investor visa automated legal processing; immigrant investor visa automated processing of recaptured visas including, but not limited to, recaptured EB-5 visas; immigrant investor visa automated processing of unused visas including, but not limited to, unused EB-5 visas; immigrant investor visa automated expedited processing; immigrant investor visa automated authentication of source of funds processing; immigrant investor visa automated background check processing; immigrant investor visa automated national security related screening and processing; automated processing of investment related to aircraft; automated processing of credit enhancement related to aircraft; and automated processing of loan guarantees related to aircraft.

### Airplanes and Immigration Investor Visas/EB-5 According to Some Embodiments:

Some embodiments of the invention comprise a computer-implemented method that includes at least: specifically programming at least one computer system or a portion of at least one computer system to perform at least one of the following: aggregate immigrant investor visas and/or immigrant investor visa funding including, but not limited to, EB-5 for investment in aircraft; aggregate immigrant investor visas and/or immigrant investor visa funding including, but not limited to, EB-5 for credit enhancement; aggregate immigrant investor visas and/or immigrant investor visa funding including, but not limited to, EB-5 for guarantor loans.

### Airplanes and Recaptured Immigration Investor Visas/Recaptured EB-5 According to Some Embodiments:

Some embodiments of the invention comprise a computer-implemented method that includes at least: specifically programming at least one computer system or a portion of at least one computer system to perform at least one of the following: aggregate recaptured immigrant investor visas including, but not limited to, recaptured EB-5 for investment in aircraft; aggregate recaptured immigrant investor visas including, but not limited to, recaptured EB-5 for credit enhancement; aggregate recaptured immigrant investor visas including, but not limited to, recaptured EB-5 for guarantor loans.

### Airplanes and Unused Immigration Investor Visas/Unused EB-5 According to Some Embodiments:

Some embodiments of the invention comprise a computer-implemented method that includes at least: specifically programming at least one computer system or a portion of at least one computer system to perform at least one of the following: aggregate unused immigrant investor visas including, but not limited to, unused EB-5 for investment in aircraft; aggregate unused immigrant investor visas including, but not limited to, unused EB-5 for credit enhancement; aggregate unused immigrant investor visas including, but not limited to, unused EB-5 for guarantor loans.

### Satellites According to Some Embodiments:

Some embodiments of the invention comprise a computer-implemented method that includes at least: specifically programming at least one computer system or a portion of at least one computer system to perform at least one of the following: aggregate immigrant investor visas and/or immigrant investor visa funding including, but not limited to, EB-5 for investment in satellites; aggregate recaptured immigrant investor visas including, but not limited to, recaptured EB-5 for investment in satellites; aggregate unused immigrant investor visas including, but not limited to, unused EB-5 for investment in satellites.

Some embodiments of the invention comprise a computer-implemented method that includes at least specifically programming at least one computer system or a portion of at least one computer system to perform at least one of the following: aggregate immigrant investor visas and/or immigrant investor visa funding including, but not limited to, EB-5, for the purposes of: investment in satellites; immigrant investor visa automated application processing; immigrant investor visa automated legal processing; immigrant investor visa automated expedited processing; immigrant investor visa automated authentication of source of funds processing; immigrant investor visa automated background check processing; immigrant investor visa automated national security related screening and processing; immigrant investor visa automated processing of visas including, but not limited to, EB-5 visas; immigrant investor visa automated processing of recaptured visas including, but not limited to, recaptured EB-5 visas; immigrant investor visa automated processing of unused visas including, but not limited to, unused EB-5 visas; automated processing of investment; automated processing of credit enhancement; and automated processing of loan guarantees and other types of financing.

Referring to at least FIG. 1 and FIGS. 12-16, some embodiments of the invention comprise a method to aggregate funding including, but not limited to, immigrant investor visa funding including, but not limited to, EB-5 funding for investment: Step 1: aggregate immigrant investor visa funding including, but not limited to, EB-5 funding for investment in satellites; Step 2: aggregate immigrant investor visa funding including, but not limited to EB-5 funding, to be used as a PDP for investment in satellites; Step 3: aggregate immigrant investor visa funding including, but not limited to, EB-5 funding for investment; Step 4: aggregate funding to be used as credit enhancement; Step 5: aggregate funding to be used in and for guarantor loans.

Some embodiments of the invention comprise a computer-implemented method that includes at least specifically programming at least one computer system or a portion of at least one computer system to perform at least one of the following: aggregate immigrant investor visas and/or immigrant investor visa funding including, but not limited to, EB-5, for the purposes of: investment in satellites; immigrant investor visa automated application processing; immigrant investor visa automated legal processing; immigrant investor visa automated processing of recaptured visas including, but not limited to, recaptured EB-5 visas; immigrant investor visa automated processing of unused visas including, but not limited to, unused EB-5 visas; immigrant investor visa automated expedited processing; immigrant investor visa automated authentication of source of funds processing; immigrant investor visa automated background check processing; immigrant investor visa automated national security related screening and processing; automated processing of investment related to satellites; automated processing of credit enhancement related to satellites; and automated processing of loan guarantees related to satellites.

### Satellites and Immigration Investor Visas/EB-5 According to Some Embodiments:

Some embodiments of the invention comprise a computer-implemented method that includes at least: specifically programming at least one computer system or a portion of at least one computer system to perform at least one of the following: aggregate immigrant investor visas and/or immigrant investor visa funding including, but not limited to, EB-5 for investment in satellites; aggregate immigrant investor visas and/or immigrant investor visa funding including, but not limited to, EB-5 for credit enhancement; aggregate immigrant investor visas and/or immigrant investor visa funding including, but not limited to, EB-5 for guarantor loans.

### Satellites and Recaptured Immigration Investor Visas/Recaptured EB-5 According to Some Embodiments:

Some embodiments of the invention comprise a computer-implemented method that includes at least: specifically programming at least one computer system or a portion of at least one computer system to perform at least one of the following: aggregate recaptured immigrant investor visas including, but not limited to, recaptured EB-5 for investment in satellites; aggregate recaptured immigrant investor visas including, but not limited to, recaptured EB-5 for credit enhancement; aggregate recaptured immigrant investor visas including, but not limited to, recaptured EB-5 for guarantor loans.

### Satellites and Unused Immigration Investor Visas/Unused EB-5 According to Some Embodiments:

Some embodiments of the invention comprise a computer-implemented method that includes at least: specifically programming at least one computer system or a portion of at least one computer system to perform at least one of the following: aggregate unused immigrant investor visas including, but not limited to, unused EB-5 for investment in satellites; aggregate unused immigrant investor visas including, but not limited to, unused EB-5 for credit enhancement; aggregate unused immigrant investor visas including, but not limited to, unused EB-5 for guarantor loans.

### Spacecraft According to Some Embodiments:

Some embodiments of the invention comprise a computer-implemented method that includes at least: specifically programming at least one computer system or a portion of at least one computer system to perform at least one of the following: aggregate immigrant investor visas and/or immigrant investor visa funding including, but not limited to, EB-5 for investment in spacecraft; aggregate recaptured immigrant investor visas including, but not limited to, recaptured EB-5 for investment in spacecraft; aggregate unused immigrant investor visas including, but not limited to, unused EB-5 for investment in spacecraft.

Some embodiments of the invention comprise a computer-implemented method that includes at least specifically programming at least one computer system or a portion of at least one computer system to perform at least one of the following: aggregate immigrant investor visas and/or immigrant investor visa funding including, but not limited to, EB-5, for the purposes of: investment in spacecraft; immigrant investor visa automated application processing; immigrant investor visa automated legal processing; immigrant investor visa automated expedited processing; immigrant investor visa automated authentication of source of funds processing; immigrant investor visa automated background check processing; immigrant investor visa automated national security related screening and processing; immigrant investor visa automated processing of visas including, but not limited to, EB-5 visas; immigrant investor visa automated processing of recaptured visas including, but not limited to, recaptured EB-5 visas; immigrant investor visa automated processing of unused visas including, but not limited to, unused EB-5 visas; automated processing of investment; automated processing of credit enhancement; and automated processing of loan guarantees and other types of financing.

Some embodiments of the invention comprise a method for aggregate funding including, but not limited to, immigrant investor visa funding including, but not limited to, EB-5 funding for investment: Step 1: aggregate immigrant investor visa funding including, but not limited to, EB-5 funding for investment in spacecraft; Step 2: aggregate immigrant investor visa funding including, but not limited to EB-5 funding, to be used as a PDP for investment in spacecraft; Step 3: aggregate immigrant investor visa funding including, but not limited to, EB-5 funding for investment; Step 4: aggregate funding to be used as credit enhancement; Step 5: aggregate funding to be used in and for guarantor loans.

Some embodiments of the invention comprise a computer-implemented method that includes at least specifically programming at least one computer system or a portion of at least one computer system to perform at least one of the following: aggregate immigrant investor visas and/or immigrant investor visa funding including, but not limited to, EB-5, for the purposes of: investment in spacecraft; immigrant investor visa automated application processing; immigrant investor visa automated legal processing; immigrant investor visa automated processing of recaptured visas including, but not limited to, recaptured EB-5 visas; immigrant investor visa automated processing of unused visas including, but not limited to, unused EB-5 visas; immigrant investor visa automated expedited processing; immigrant investor visa automated authentication of source of funds processing; immigrant investor visa automated background check processing; immigrant investor visa automated national security related screening and processing; automated processing of investment related to spacecraft; automated processing of credit enhancement related to spacecraft; and automated processing of loan guarantees related to spacecraft.

### Spacecraft and Immigration Investor Visas/EB-5 According to Some Embodiments:

Some embodiments of the invention comprise a computer-implemented method that includes at least: specifically programming at least one computer system or a portion of at least one computer system to perform at least one of the following: aggregate immigrant investor visas and/or immigrant investor visa funding including, but not limited to, EB-5 for investment in spacecraft; aggregate immigrant investor visas and/or immigrant investor visa funding including, but not limited to, EB-5 for credit enhancement; aggregate immigrant investor visas and/or immigrant investor visa funding including, but not limited to, EB-5 for guarantor loans.

### Spacecraft and Recaptured Immigration Investor Visas/Recaptured EB-5 According to Some Embodiments:

Some embodiments of the invention comprise a computer-implemented method that includes at least: specifically programming at least one computer system or a portion of at least one computer system to perform at least one of the following: aggregate recaptured immigrant investor visas including, but not limited to, recaptured EB-5 for investment in spacecraft; aggregate recaptured immigrant investor visas including, but not limited to, recaptured EB-5 for credit enhancement; aggregate recaptured immigrant investor visas including, but not limited to, recaptured EB-5 for guarantor loans.

### Spacecraft and Unused Immigration Investor Visas/Unused EB-5 According to Some Embodiments:

Some embodiments of the invention comprise a computer-implemented method that includes at least: specifically programming at least one computer system or a portion of at least one computer system to perform at least one of the following: aggregate unused immigrant investor visas including, but not limited to, unused EB-5 for investment in spacecraft; aggregate unused immigrant investor visas including, but not limited to, unused EB-5 for credit enhancement; aggregate unused immigrant investor visas including, but not limited to, unused EB-5 for guarantor loans.

### Commercial Aviation According to Some Embodiments:

Some embodiments of the invention comprise a computer-implemented method that includes at least: specifically programming at least one computer system or a portion of at least one computer system to perform at least one of the following: aggregate immigrant investor visas and/or immigrant investor visa funding including, but not limited to, EB-5 for investment in commercial aviation; aggregate recaptured immigrant investor visas including, but not limited to, recaptured EB-5 for investment in commercial aviation; aggregate unused immigrant investor visas including, but not limited to, unused EB-5 for investment in commercial aviation.

Some embodiments of the invention comprise a computer-implemented method that includes at least specifically programming at least one computer system or a portion of at least one computer system to perform at least one of the following: aggregate immigrant investor visas and/or immigrant investor visa funding including, but not limited to, EB-5, for the purposes of: investment in commercial aviation; immigrant investor visa automated application processing; immigrant investor visa automated legal processing; immigrant investor visa automated expedited processing; immigrant investor visa automated authentication of source of funds processing; immigrant investor visa automated background check processing; immigrant investor visa automated national security related screening and processing; immigrant investor visa automated processing of visas including, but not limited to, EB-5 visas; immigrant investor visa automated processing of recaptured visas including, but not limited to, recaptured EB-5 visas; immigrant investor visa automated processing of unused visas including, but not limited to, unused EB-5 visas; automated processing of investment; automated processing of credit enhancement; and automated processing of loan guarantees and other types of financing.

Some embodiments of the invention comprise a method for aggregate funding including, but not limited to, immigrant investor visa funding including, but not limited to, EB-5 funding for investment: Step 1: aggregate immigrant investor visa funding including, but not limited to, EB-5 funding for investment in commercial aviation; Step 2: aggregate immigrant investor visa funding including, but not limited to EB-5 funding, to be used as a PDP for investment in commercial aviation; Step 3: aggregate immigrant investor visa funding including, but not limited to, EB-5 funding for investment; Step 4: aggregate funding to be used as credit enhancement; Step 5: aggregate funding to be used in and for guarantor loans.

Some embodiments of the invention comprise a computer-implemented method that includes at least specifically programming at least one computer system or a portion of at least one computer system to perform at least one of the following: aggregate immigrant investor visas and/or immigrant investor visa funding including, but not limited to, EB-5, for the purposes of: investment in commercial aviation; immigrant investor visa automated application processing; immigrant investor visa automated legal processing; immigrant investor visa automated processing of recaptured visas including, but not limited to, recaptured EB-5 visas; immigrant investor visa automated processing of unused visas including, but not limited to, unused EB-5 visas; immigrant investor visa automated expedited processing; immigrant investor visa automated authentication of source of funds processing; immigrant investor visa automated background check processing; immigrant investor visa automated national security related screening and processing; automated processing of investment related to commercial aviation; automated processing of credit enhancement related to commercial aviation; and automated processing of loan guarantees related to commercial aviation.

### Commercial Aviation and Immigration Investor Visas/EB-5 According to Some Embodiments:

Some embodiments of the invention comprise a computer-implemented method that includes at least: specifically programming at least one computer system or a portion of at least one computer system to perform at least one of the following: aggregate immigrant investor visas and/or immigrant investor visa funding including, but not limited to, EB-5 for investment in commercial aviation; aggregate immigrant investor visas and/or immigrant investor visa funding including, but not limited to, EB-5 for credit enhancement; aggregate immigrant investor visas and/or immigrant investor visa funding including, but not limited to, EB-5 for guarantor loans.

### Commercial Aviation and Recaptured Immigration Investor Visas/Recaptured EB-5 According to Some Embodiments:

Some embodiments of the invention comprise a computer-implemented method that includes at least: specifically programming at least one computer system or a portion of at least one computer system to perform at least one of the following: aggregate recaptured immigrant investor visas including, but not limited to, recaptured EB-5 for investment in commercial aviation; aggregate recaptured immigrant investor visas including, but not limited to, recaptured EB-5 for credit enhancement; aggregate recaptured immigrant investor visas including, but not limited to, recaptured EB-5 for guarantor loans.

### Commercial Aviation and Unused Immigration Investor Visas/Unused EB-5 According to Some Embodiments:

Some embodiments of the invention comprise a computer-implemented method that includes at least: specifically programming at least one computer system or a portion of at least one computer system to perform at least one of the following: aggregate unused immigrant investor visas including, but not limited to, unused EB-5 for investment in commercial aviation; aggregate unused immigrant investor visas including, but not limited to, unused EB-5 for credit enhancement; aggregate unused immigrant investor visas including, but not limited to, unused EB-5 for guarantor loans.

### Aerospace According to Some Embodiments:

Some embodiments of the invention comprise a computer-implemented method that includes at least: specifically programming at least one computer system or a portion of at least one computer system to perform at least one of the following: aggregate immigrant investor visas and/or immigrant investor visa funding including, but not limited to, EB-5 for investment in aerospace; aggregate recaptured immigrant investor visas including, but not limited to, recaptured EB-5 for investment in aerospace; aggregate unused immigrant investor visas including, but not limited to, unused EB-5 for investment in aerospace.

Some embodiments of the invention comprise a computer-implemented method that includes at least specifically programming at least one computer system or a portion of at least one computer system to perform at least one of the following: aggregate immigrant investor visas and/or immigrant investor visa funding including, but not limited to, EB-5, for the purposes of: investment in aerospace; immigrant investor visa automated application processing; immigrant investor visa automated legal processing; immigrant investor visa automated expedited processing; immigrant investor visa automated authentication of source of funds processing; immigrant investor visa automated background check processing; immigrant investor visa automated national security related screening and processing; immigrant investor visa automated processing of visas including, but not limited to, EB-5 visas; immigrant investor visa automated processing of recaptured visas including, but not limited to, recaptured EB-5 visas; immigrant investor visa automated processing of unused visas including, but not limited to, unused EB-5 visas; automated processing of investment; automated processing of credit enhancement; and automated processing of loan guarantees and other types of financing.

Some embodiments of the invention comprise a method for aggregate funding including, but not limited to, immigrant investor visa funding including, but not limited to, EB-5 funding for investment: Step 1: aggregate immigrant investor visa funding including, but not limited to, EB-5 funding for investment in aerospace; Step 2: aggregate immigrant investor visa funding including, but not limited to EB-5 funding, to be used as a PDP for investment in aerospace; Step 3: aggregate immigrant investor visa funding including, but not limited to, EB-5 funding for investment; Step 4: aggregate funding to be used as credit enhancement; Step 5: aggregate funding to be used in and for guarantor loans.

Some embodiments of the invention comprise a computer-implemented method that includes at least specifically programming at least one computer system or a portion of at least one computer system to perform at least one of the following: aggregate immigrant investor visas and/or immigrant investor visa funding including, but not limited to, EB-5, for the purposes of: investment in aerospace; immigrant investor visa automated application processing; immigrant investor visa automated legal processing; immigrant investor visa automated processing of recaptured visas including, but not limited to, recaptured EB-5 visas; immigrant investor visa automated processing of unused visas including, but not limited to, unused EB-5 visas; immigrant investor visa automated expedited processing; immigrant investor visa automated authentication of source of funds processing; immigrant investor visa automated background check processing; immigrant investor visa automated national security related screening and processing; automated processing of investment related to aerospace; automated processing of credit enhancement related to aerospace; and automated processing of loan guarantees related to aerospace.

### Aerospace and Immigration Investor Visas/EB-5 According to Some Embodiments:

Some embodiments of the invention comprise a computer-implemented method that includes at least: specifically programming at least one computer system or a portion of at least one computer system to perform at least one of the following: aggregate immigrant investor visas and/or immigrant investor visa funding including, but not limited to, EB-5 for investment in aerospace; aggregate immigrant investor visas and/or immigrant investor visa funding including, but not limited to, EB-5 for credit enhancement; aggregate immigrant investor visas and/or immigrant investor visa funding including, but not limited to, EB-5 for guarantor loans.

### Aerospace and Recaptured Immigration Investor Visas/Recaptured EB-5 According to Some Embodiments:

Some embodiments of the invention comprise a computer-implemented method that includes at least: specifically programming at least one computer system or a portion of at least one computer system to perform at least one of the following: aggregate recaptured immigrant investor visas including, but not limited to, recaptured EB-5 for investment in aerospace; aggregate recaptured immigrant investor visas including, but not limited to, recaptured EB-5 for credit enhancement; aggregate recaptured immigrant investor visas including, but not limited to, recaptured EB-5 for guarantor loans.

### Aerospace and Unused Immigration Investor Visas/Unused EB-5 According to Some Embodiments:

Some embodiments of the invention comprise a computer-implemented method that includes at least: specifically programming at least one computer system or a portion of at least one computer system to perform at least one of the following: aggregate unused immigrant investor visas including, but not limited to, unused EB-5 for investment in aerospace; aggregate unused immigrant investor visas including, but not limited to, unused EB-5 for credit enhancement; aggregate unused immigrant investor visas including, but not limited to, unused EB-5 for guarantor loans.

### Infrastructure According to Some Embodiments:

Some embodiments of the invention comprise a computer-implemented method that includes at least: specifically programming at least one computer system or a portion of at least one computer system to perform at least one of the following: aggregate immigrant investor visas and/or immigrant investor visa funding including, but not limited to, EB-5 for investment in infrastructure; aggregate recaptured immigrant investor visas including, but not limited to, recaptured EB-5 for investment in infrastructure; aggregate unused immigrant investor visas including, but not limited to, unused EB-5 for investment in infrastructure.

Some embodiments of the invention comprise a computer-implemented method that includes at least specifically programming at least one computer system or a portion of at least one computer system to perform at least one of the following: aggregate immigrant investor visas and/or immigrant investor visa funding including, but not limited to, EB-5, for the purposes of: investment in infrastructure; immigrant investor visa automated application processing; immigrant investor visa automated legal processing; immigrant investor visa automated expedited processing; immigrant investor visa automated authentication of source of funds processing; immigrant investor visa automated background check processing; immigrant investor visa automated national security related screening and processing; immigrant investor visa automated processing of visas including, but not limited to, EB-5 visas; immigrant investor visa automated processing of recaptured visas including, but not limited to, recaptured EB-5 visas; immigrant investor visa automated processing of unused visas including, but not limited to, unused EB-5 visas; automated processing of investment; automated processing of credit enhancement; and automated processing of loan guarantees and other types of financing.

Some embodiments of the invention comprise a method for aggregate funding including, but not limited to, immigrant investor visa funding including, but not limited to, EB-5 funding for investment: Step 1: aggregate immigrant investor visa funding including, but not limited to, EB-5 funding for investment in infrastructure; Step 2: aggregate immigrant investor visa funding including, but not limited to EB-5 funding, to be used as a PDP for investment in infrastructure; Step 3: aggregate immigrant investor visa funding including, but not limited to, EB-5 funding for investment; Step 4: aggregate funding to be used as credit enhancement; Step 5: aggregate funding to be used in and for guarantor loans.

Some embodiments of the invention comprise a computer-implemented method that includes at least specifically programming at least one computer system or a portion of at least one computer system to perform at least one of the following: aggregate immigrant investor visas and/or immigrant investor visa funding including, but not limited to, EB-5, for the purposes of: investment in infrastructure; immigrant investor visa automated application processing; immigrant investor visa automated legal processing; immigrant investor visa automated processing of recaptured visas including, but not limited to, recaptured EB-5 visas; immigrant investor visa automated processing of unused visas including, but not limited to, unused EB-5 visas; immigrant investor visa automated expedited processing; immigrant investor visa automated authentication of source of funds processing; immigrant investor visa automated background check processing; immigrant investor visa automated national security related screening and processing; automated processing of investment related to infrastructure; automated processing of credit enhancement related to infrastructure; and automated processing of loan guarantees related to infrastructure.

### Infrastructure and Immigration Investor Visas/EB-5 According to Some Embodiments:

Some embodiments of the invention comprise a computer-implemented method that includes at least: specifically programming at least one computer system or a portion of at least one computer system to perform at least one of the following: aggregate immigrant investor visas and/or immigrant investor visa funding including, but not limited to, EB-5 for investment in infrastructure; aggregate immigrant investor visas and/or immigrant investor visa funding including, but not limited to, EB-5 for credit enhancement; aggregate immigrant investor visas and/or immigrant investor visa funding including, but not limited to, EB-5 for guarantor loans; aggregate immigrant investor visas and/or immigrant investor visa funding including, but not limited to, EB-5 for infrastructure leasing.

### Infrastructure and Recaptured Immigration Investor Visas/Recaptured EB-5 According to Some Embodiments:

Some embodiments of the invention comprise a computer-implemented method that includes at least: specifically programming at least one computer system or a portion of at least one computer system to perform at least one of the following: aggregate recaptured immigrant investor visas including, but not limited to, recaptured EB-5 for investment in infrastructure; aggregate recaptured immigrant investor visas including, but not limited to, recaptured EB-5 for credit enhancement; aggregate recaptured immigrant investor visas including, but not limited to, recaptured EB-5 for guarantor loans; aggregate recaptured immigrant investor visas including, but not limited to, recaptured EB-5 for infrastructure leasing.

### Infrastructure and Unused Immigration Investor Visas/Unused EB-5 According to Some Embodiments:

Some embodiments of the invention comprise a computer-implemented method that includes at least: specifically programming at least one computer system or a portion of at least one computer system to perform at least one of the following: aggregate unused immigrant investor visas including, but not limited to, unused EB-5 for investment in infrastructure; aggregate unused immigrant investor visas including, but not limited to, unused EB-5 for credit enhancement; aggregate unused immigrant investor visas including, but not limited to, unused EB-5 for guarantor loans; aggregate unused immigrant investor visas including, but not limited to, unused EB-5 for infrastructure leasing.

### Real Estate According to Some Embodiments:

Some embodiments of the invention comprise a computer-implemented method that includes at least: specifically programming at least one computer system or a portion of at least one computer system to perform at least one of the following: aggregate immigrant investor visas and/or immigrant investor visa funding including, but not limited to, EB-5 for investment in real estate; aggregate recaptured immigrant investor visas including, but not limited to, recaptured EB-5 for investment in real estate; aggregate unused immigrant investor visas including, but not limited to, unused EB-5 for investment in real estate.

Some embodiments of the invention comprise a computer-implemented method that includes at least specifically programming at least one computer system or a portion of at least one computer system to perform at least one of the following: aggregate immigrant investor visas and/or immigrant investor visa funding including, but not limited to, EB-5, for the purposes of: investment in real estate; immigrant investor visa automated application processing; immigrant investor visa automated legal processing; immigrant investor visa automated expedited processing; immigrant investor visa automated authentication of source of funds processing; immigrant investor visa automated background check processing; immigrant investor visa automated national security related screening and processing; immigrant investor visa automated processing of visas including, but not limited to, EB-5 visas; immigrant investor visa automated processing of recaptured visas including, but not limited to, recaptured EB-5 visas; immigrant investor visa automated processing of unused visas including, but not limited to, unused EB-5 visas; automated processing of investment; automated processing of credit enhancement; and automated processing of loan guarantees and other types of financing.

Some embodiments of the invention comprise a method for aggregate funding including, but not limited to, immigrant investor visa funding including, but not limited to, EB-5 funding for investment: Step 1: aggregate immigrant investor visa funding including, but not limited to, EB-5 funding for investment in real estate; Step 2: aggregate immigrant investor visa funding including, but not limited to EB-5 funding, to be used as a PDP for investment in real estate; Step 3: aggregate immigrant investor visa funding including, but not limited to, EB-5 funding for investment; Step 4: aggregate funding to be used as credit enhancement; Step 5: aggregate funding to be used in and for guarantor loans.

Some embodiments of the invention comprise a computer-implemented method that includes at least specifically programming at least one computer system or a portion of at least one computer system to perform at least one of the following: aggregate immigrant investor visas and/or immigrant investor visa funding including, but not limited to, EB-5, for the purposes of: investment in real estate; immigrant investor visa automated application processing; immigrant investor visa automated legal processing; immigrant investor visa automated processing of recaptured visas including, but not limited to, recaptured EB-5 visas; immigrant investor visa automated processing of unused visas including, but not limited to, unused EB-5 visas; immigrant investor visa automated expedited processing; immigrant investor visa automated authentication of source of funds processing; immigrant investor visa automated background check processing; immigrant investor visa automated national security related screening and processing; automated processing of investment related to real estate; automated processing of credit enhancement related to real estate; and automated processing of loan guarantees related to real estate.

### Real Estate and Immigration Investor Visas/EB-5 According to Some Embodiments:

Some embodiments of the invention comprise a computer-implemented method that includes at least: specifically programming at least one computer system or a portion of at least one computer system to perform at least one of the following: aggregate immigrant investor visas and/or immigrant investor visa funding including, but not limited to, EB-5 for investment in real estate; aggregate immigrant investor visas and/or immigrant investor visa funding including, but not limited to, EB-5 for credit enhancement; aggregate immigrant investor visas and/or immigrant investor visa funding including, but not limited to, EB-5 for guarantor loans; aggregate immigrant investor visas and/or immigrant investor visa funding including, but not limited to, EB-5 for real estate leasing.

### Real Estate and Recaptured Immigration Investor Visas/Recaptured EB-5 According to Some Embodiments:

Some embodiments of the invention comprise a computer-implemented method that includes at least: specifically programming at least one computer system or a portion of at least one computer system to perform at least one of the following: aggregate recaptured immigrant investor visas including, but not limited to, recaptured EB-5 for investment in real estate; aggregate recaptured immigrant investor visas including, but not limited to, recaptured EB-5 for credit enhancement; aggregate recaptured immigrant investor visas including, but not limited to, recaptured EB-5 for guarantor loans; aggregate recaptured immigrant investor visas including, but not limited to, recaptured EB-5 for real estate leasing.

### Real Estate and Unused Immigration Investor Visas/Unused EB-5 According to Some Embodiments:

Some embodiments of the invention comprise a computer-implemented method that includes at least: specifically programming at least one computer system or a portion of at least one computer system to perform at least one of the following: aggregate unused immigrant investor visas including, but not limited to, unused EB-5 for investment in real estate; aggregate unused immigrant investor visas including, but not limited to, unused EB-5 for credit enhancement; aggregate unused immigrant investor visas including, but not limited to, unused EB-5 for guarantor loans; aggregate unused immigrant investor visas including, but not limited to, unused EB-5 for real estate leasing.

### Information Technology Software According to Some Embodiments:

Some embodiments of the invention comprise a computer-implemented method that includes at least: specifically programming at least one computer system or a portion of at least one computer system to perform at least one of the following: aggregate immigrant investor visas and/or immigrant investor visa funding including, but not limited to, EB-5 for investment in information technology software; aggregate recaptured immigrant investor visas including, but not limited to, recaptured EB-5 for investment in information technology software; aggregate unused immigrant investor visas including, but not limited to, unused EB-5 for investment in information technology software.

Some embodiments of the invention comprise a computer-implemented method that includes at least specifically programming at least one computer system or a portion of at least one computer system to perform at least one of the following: aggregate immigrant investor visas and/or immigrant investor visa funding including, but not limited to, EB-5, for the purposes of: investment in information technology software; immigrant investor visa automated application processing; immigrant investor visa automated legal processing; immigrant investor visa automated expedited processing; immigrant investor visa automated authentication of source of funds processing; immigrant investor visa automated background check processing; immigrant investor visa automated national security related screening and processing; immigrant investor visa automated processing of visas including, but not limited to, EB-5 visas; immigrant investor visa automated processing of recaptured visas including, but not limited to, recaptured EB-5 visas; immigrant investor visa automated processing of unused visas including, but not limited to, unused EB-5 visas; automated processing of investment; automated processing of credit enhancement; and automated processing of loan guarantees and other types of financing.

Some embodiments of the invention comprise a method for aggregate funding including, but not limited to, immigrant investor visa funding including, but not limited to, EB-5 funding for investment: Step 1: aggregate immigrant investor visa funding including, but not limited to, EB-5 funding for investment in information technology software; Step 2: aggregate immigrant investor visa funding including, but not limited to EB-5 funding, to be used as a PDP for investment in information technology software; Step 3: aggregate immigrant investor visa funding including, but not limited to, EB-5 funding for investment; Step 4: aggregate funding to be used as credit enhancement; Step 5: aggregate funding to be used in and for guarantor loans.

Some embodiments of the invention comprise a computer-implemented method that includes at least specifically programming at least one computer system or a portion of at least one computer system to perform at least one of the following: aggregate immigrant investor visas and/or immigrant investor visa funding including, but not limited to, EB-5, for the purposes of: investment in information technology software; immigrant investor visa automated application processing; immigrant investor visa automated legal processing; immigrant investor visa automated processing of recaptured visas including, but not limited to, recaptured EB-5 visas; immigrant investor visa automated processing of unused visas including, but not limited to, unused EB-5 visas; immigrant investor visa automated expedited processing; immigrant investor visa automated authentication of source of funds processing; immigrant investor visa automated background check processing; immigrant investor visa automated national security related screening and processing; automated processing of investment related to information technology software; automated processing of credit enhancement related to information technology software; and automated processing of loan guarantees related to information technology software.

### Information Technology Software and Immigration Investor Visas/EB-5 According to Some Embodiments:

Some embodiments of the invention comprise a computer-implemented method that includes at least: specifically programming at least one computer system or a portion of at least one computer system to perform at least one of the following: aggregate immigrant investor visas and/or immigrant investor visa funding including, but not limited to, EB-5 for investment in information technology software; aggregate immigrant investor visas and/or immigrant investor visa funding including, but not limited to, EB-5 for credit enhancement; aggregate immigrant investor visas and/or immigrant investor visa funding including, but not limited to, EB-5 for guarantor loans.

### Information Technology Software and Recaptured Immigration Investor Visas/Recaptured EB-5 According to Some Embodiments:

Some embodiments of the invention comprise a computer-implemented method that includes at least: specifically programming at least one computer system or a portion of at least one computer system to perform at least one of the following: aggregate recaptured immigrant investor visas including, but not limited to, recaptured EB-5 for investment in information technology software; aggregate recaptured immigrant investor visas including, but not limited to, recaptured EB-5 for credit enhancement; aggregate recaptured immigrant investor visas including, but not limited to, recaptured EB-5 for guarantor loans.

### Information Technology Software and Unused Immigration Investor Visas/Unused EB-5 According to Some Embodiments:

Some embodiments of the invention comprise a computer-implemented method that includes at least: specifically programming at least one computer system or a portion of at least one computer system to perform at least one of the following: aggregate unused immigrant investor visas including, but not limited to, unused EB-5 for investment in information technology software; aggregate unused immigrant investor visas including, but not limited to, unused EB-5 for credit enhancement; aggregate unused immigrant investor visas including, but not limited to, unused EB-5 for guarantor loans.

### Information Technology Hardware According to Some Embodiments:

Some embodiments of the invention comprise a computer-implemented method that includes at least: specifically programming at least one computer system or a portion of at least one computer system to perform at least one of the following: aggregate immigrant investor visas and/or immigrant investor visa funding including, but not limited to, EB-5 for investment in information technology hardware; aggregate recaptured immigrant investor visas including, but not limited to, recaptured EB-5 for investment in information technology hardware; aggregate unused immigrant investor visas including, but not limited to, unused EB-5 for investment in information technology hardware.

Some embodiments of the invention comprise a computer-implemented method that includes at least specifically programming at least one computer system or a portion of at least one computer system to perform at least one of the following: aggregate immigrant investor visas and/or immigrant investor visa funding including, but not limited to, EB-5, for the purposes of: investment in information technology hardware; immigrant investor visa automated application processing; immigrant investor visa automated legal processing; immigrant investor visa automated expedited processing; immigrant investor visa automated authentication of source of investor visa automated national security related screening and processing; immigrant investor visa automated processing of visas including, but not limited to, EB-5 visas; immigrant investor visa automated processing of recaptured visas including, but not limited to, recaptured EB-5 visas; immigrant investor visa automated processing of unused visas including, but not limited to, unused EB-5 visas; automated processing of investment; automated processing of credit enhancement; and automated processing of loan guarantees and other types of financing.

Some embodiments of the invention comprise a method for aggregate funding including, but not limited to, immigrant investor visa funding including, but not limited to, EB-5 funding for investment: Step 1: aggregate immigrant investor visa funding including, but not limited to, EB-5 funding for investment in information technology hardware; Step 2: aggregate immigrant investor visa funding including, but not limited to EB-5 funding, to be used as a PDP for investment in information technology hardware; Step 3: aggregate immigrant investor visa funding including, but not limited to, EB-5 funding for investment; Step 4: aggregate funding to be used as credit enhancement; Step 5: aggregate funding to be used in and for guarantor loans.

Some embodiments of the invention comprise a computer-implemented method that includes at least specifically programming at least one computer system or a portion of at least one computer system to perform at least one of the following: aggregate immigrant investor visas and/or immigrant investor visa funding including, but not limited to, EB-5, for the purposes of: investment in information technology hardware; immigrant investor visa automated application processing; immigrant investor visa automated legal processing; immigrant investor visa automated processing of recaptured visas including, but not limited to, recaptured EB-5 visas; immigrant investor visa automated processing of unused visas including, but not limited to, unused EB-5 visas; immigrant investor visa automated expedited processing; immigrant investor visa automated authentication of source of funds processing; immigrant investor visa automated background check processing; immigrant investor visa automated national security related screening and processing; automated processing of investment related to information technology hardware; automated processing of credit enhancement related to information technology hardware; and automated processing of loan guarantees related to information technology hardware.

### Information Technology Hardware and Immigration Investor Visas/EB-5 According to Some Embodiments:

Some embodiments of the invention comprise a computer-implemented method that includes at least: specifically programming at least one computer system or a portion of at least one computer system to perform at least one of the following: aggregate immigrant investor visas and/or immigrant investor visa funding including, but not limited to, EB-5 for investment in information technology hardware; aggregate immigrant investor visas and/or immigrant investor visa funding including, but not limited to, EB-5 for credit enhancement; aggregate immigrant investor visas and/or immigrant investor visa funding including, but not limited to, EB-5 for guarantor loans.

### Information Technology Hardware and Recaptured Immigration Investor Visas/Recaptured EB-5 According to Some Embodiments:

Some embodiments of the invention comprise a computer-implemented method that includes at least: specifically programming at least one computer system or a portion of at least one computer system to perform at least one of the following: aggregate recaptured immigrant investor visas including, but not limited to, recaptured EB-5 for investment in information technology hardware; aggregate recaptured immigrant investor visas including, but not limited to, recaptured EB-5 for credit enhancement; aggregate recaptured immigrant investor visas including, but not limited to, recaptured EB-5 for guarantor loans.

### Information Technology Hardware and Unused Immigration Investor Visas/Unused EB-5 According to Some Embodiments:

Some embodiments of the invention comprise a computer-implemented method that includes at least: specifically programming at least one computer system or a portion of at least one computer system to perform at least one of the following: aggregate unused immigrant investor visas including, but not limited to, unused EB-5 for investment in information technology hardware; aggregate unused immigrant investor visas including, but not limited to, unused EB-5 for credit enhancement; aggregate unused immigrant investor visas including, but not limited to, unused EB-5 for guarantor loans.

### Telecommunications According to Some Embodiments:

Some embodiments of the invention comprise a computer-implemented method that includes at least: specifically programming at least one computer system or a portion of at least one computer system to perform at least one of the following: aggregate immigrant investor visas and/or immigrant investor visa funding including, but not limited to, EB-5 for investment in telecommunications; aggregate recaptured immigrant investor visas including, but not limited to, recaptured EB-5 for investment in telecommunications; aggregate unused immigrant investor visas including, but not limited to, unused EB-5 for investment in telecommunications.

Some embodiments of the invention comprise a computer-implemented method that includes at least specifically programming at least one computer system or a portion of at least one computer system to perform at least one of the following: aggregate immigrant investor visas and/or immigrant investor visa funding including, but not limited to, EB-5, for the purposes of: investment in telecommunications; immigrant investor visa automated application processing; immigrant investor visa automated legal processing; immigrant investor visa automated expedited processing; immigrant investor visa automated authentication of source of funds processing; immigrant investor visa automated background check processing; immigrant investor visa automated national security related screening and processing; immigrant investor visa automated processing of visas including, but not limited to, EB-5 visas; immigrant investor visa automated processing of recaptured visas including, but not limited to, recaptured EB-5 visas; immigrant investor visa automated processing of unused visas including, but not limited to, unused EB-5 visas; automated processing of investment; automated processing of credit enhancement; and automated processing of loan guarantees and other types of financing.

Some embodiments of the invention comprise a method for aggregate funding including, but not limited to, immigrant investor visa funding including, but not limited to, EB-5 funding for investment: Step 1: aggregate immigrant investor visa funding including, but not limited to, EB-5 funding for investment in telecommunications; Step 2: aggregate immigrant investor visa funding including, but not limited to EB-5 funding, to be used as a PDP for investment in telecommunications; Step 3: aggregate immigrant investor visa funding including, but not limited to, EB-5 funding for investment; Step 4: aggregate funding to be used as credit enhancement; Step 5: aggregate funding to be used in and for guarantor loans.

Some embodiments of the invention comprise a computer-implemented method that includes at least specifically programming at least one computer system or a portion of at least one computer system to perform at least one of the following: aggregate immigrant investor visas and/or immigrant investor visa funding including, but not limited to, EB-5, for the purposes of: investment in telecommunications; immigrant investor visa automated application processing; immigrant investor visa automated legal processing; immigrant investor visa automated processing of recaptured visas including, but not limited to, recaptured EB-5 visas; immigrant investor visa automated processing of unused visas including, but not limited to, unused EB-5 visas; immigrant investor visa automated expedited processing; immigrant investor visa automated authentication of source of funds processing; immigrant investor visa automated background check processing; immigrant investor visa automated national security related screening and processing; automated processing of investment related to telecommunications; automated processing of credit enhancement related to telecommunications; and automated processing of loan guarantees related to telecommunications.

### Telecommunications and Immigration Investor Visas/EB-5 According to Some Embodiments:

Some embodiments of the invention comprise a computer-implemented method that includes at least: specifically programming at least one computer system or a portion of at least one computer system to perform at least one of the following: aggregate immigrant investor visas and/or immigrant investor visa funding including, but not limited to, EB-5 for investment in telecommunications; aggregate immigrant investor visas and/or immigrant investor visa funding including, but not limited to, EB-5 for credit enhancement; aggregate immigrant investor visas and/or immigrant investor visa funding including, but not limited to, EB-5 for guarantor loans.

### Telecommunications and Recaptured Immigration Investor Visas/Recaptured EB-5 According to Some Embodiments:

Some embodiments of the invention comprise a computer-implemented method that includes at least: specifically programming at least one computer system or a portion of at least one computer system to perform at least one of the following: aggregate recaptured immigrant investor visas including, but not limited to, recaptured EB-5 for investment in telecommunications; aggregate recaptured immigrant investor visas including, but not limited to, recaptured EB-5 for credit enhancement; aggregate recaptured immigrant investor visas including, but not limited to, recaptured EB-5 for guarantor loans.

### Telecommunications and Unused Immigration Investor Visas/Unused EB-5 According to Some Embodiments:

Some embodiments of the invention comprise a computer-implemented method that includes at least: specifically programming at least one computer system or a portion of at least one computer system to perform at least one of the following: aggregate unused immigrant investor visas including, but not limited to, unused EB-5 for investment in telecommunications; aggregate unused immigrant investor visas including, but not limited to, unused EB-5 for credit enhancement; aggregate unused immigrant investor visas including, but not limited to, unused EB-5 for guarantor loans.

### Airplanes, Satellites, Spacecraft and Infrastructure According to Some Embodiments:

Some embodiments of the invention comprise a computer-implemented method that includes at least: specifically programming at least one computer system or a portion of at least one computer system to perform at least one of the following: aggregate immigrant investor visas and/or immigrant investor visa funding including, but not limited to, EB-5 to finance aircraft and/or satellites and/or spacecraft to finance infrastructure; aggregate recaptured immigrant investor visas including, but not limited to, recaptured EB-5 to finance aircraft and/or satellites and/or spacecraft to finance infrastructure; aggregate unused immigrant investor visas including, but not limited to, unused EB-5 finance aircraft and/or satellites and/or spacecraft to finance infrastructure.

Some embodiments of the invention comprise a computer-implemented method that includes at least specifically programming at least one computer system or a portion of at least one computer system to perform at least one of the following: aggregate immigrant investor visas and/or immigrant investor visa funding including, but not limited to, EB-5, for the purposes of: financing aircraft and/or satellites and/or spacecraft to finance infrastructure; immigrant investor visa automated application processing; immigrant investor visa automated legal processing; immigrant investor visa automated expedited processing; immigrant investor visa automated authentication of source of funds processing; immigrant investor visa automated background check processing; immigrant investor visa automated national security related screening and processing; immigrant investor visa automated processing of visas including, but not limited to, EB-5 visas; immigrant investor visa automated processing of recaptured visas including, but not limited to, recaptured EB-5 visas; immigrant investor visa automated processing of unused visas including, but not limited to, unused EB-5 visas; automated processing of investment; automated processing of credit enhancement; and automated processing of loan guarantees and other types of financing.

Some embodiments of the invention comprise a method for aggregate funding including, but not limited to, immigrant investor visa funding including, but not limited to, EB-5 funding for investment: Step 1: aggregate immigrant investor visa funding including, but not limited to, EB-5 funding to finance aircraft and/or satellites and/or spacecraft to finance infrastructure; Step 2: aggregate immigrant investor visa funding including, but not limited to EB-5 funding, to be used as a PDP for investment in aircraft and/or satellites and/or spacecraft; Step 3: aggregate immigrant investor visa funding including, but not limited to, EB-5 funding to finance aircraft and/or satellites and/or spacecraft to finance infrastructure; Step 4: aggregate funding to be used as credit enhancement; Step 5: aggregate funding to be used in and for guarantor loans.

Some embodiments of the invention comprise a computer-implemented method that includes at least specifically programming at least one computer system or a portion of at least one computer system to perform at least one of the following: aggregate immigrant investor visas and/or immigrant investor visa funding including, but not limited to, EB-5, for the purposes of: financing aircraft and/or satellites and/or spacecraft to finance infrastructure; immigrant investor visa automated application processing; immigrant investor visa automated legal processing; immigrant investor visa automated processing of recaptured visas including, but not limited to, recaptured EB-5 visas; immigrant investor visa automated processing of unused visas including, but not limited to, unused EB-5 visas; immigrant investor visa automated expedited processing; immigrant investor visa automated authentication of source of funds processing; immigrant investor visa automated background check processing; immigrant investor visa automated national security related screening and processing; automated processing of investment related to infrastructure; automated processing of credit enhancement related to infrastructure; and automated processing of loan guarantees related to infrastructure.

### Airplanes, Satellites, Spacecraft and Infrastructure and Immigration Investor Visas/EB-5 According to Some Embodiments:

Some embodiments of the invention comprise a computer-implemented method that includes at least: specifically programming at least one computer system or a portion of at least one computer system to perform at least one of the following: aggregate immigrant investor visas and/or immigrant investor visa funding including, but not limited to, EB-5 to finance aircraft and/or satellites and/or spacecraft to finance infrastructure; aggregate immigrant investor visas and/or immigrant investor visa funding including, but not limited to, EB-5 for credit enhancement; aggregate immigrant investor visas and/or immigrant investor visa funding including, but not limited to, EB-5 for guarantor loans; aggregate immigrant investor visas and/or immigrant investor visa funding including, but not limited to, EB-5 for infrastructure leasing.

### Airplanes, Satellites, Spacecraft and Infrastructure and Recaptured Immigration Investor Visas/Recaptured EB-5 According to Some Embodiments:

Some embodiments of the invention comprise a computer-implemented method that includes at least: specifically programming at least one computer system or a portion of at least one computer system to perform at least one of the following: aggregate recaptured immigrant investor visas including, but not limited to, recaptured EB-5 to finance aircraft and/or satellites and/or spacecraft to finance infrastructure; aggregate recaptured immigrant investor visas including, but not limited to, recaptured EB-5 for credit enhancement; aggregate recaptured immigrant investor visas including, but not limited to, recaptured EB-5 for guarantor loans; aggregate recaptured immigrant investor visas including, but not limited to, recaptured EB-5 for infrastructure leasing.

### Airplanes, Satellites, Spacecraft and Infrastructure and Unused Immigration Investor Visas/Unused EB-5 According to Some Embodiments:

Some embodiments of the invention comprise a computer-implemented method that includes at least: specifically programming at least one computer system or a portion of at least one computer system to perform at least one of the following: aggregate unused immigrant investor visas including, but not limited to, unused EB-5 to finance aircraft and/or satellites and/or spacecraft to finance infrastructure; aggregate unused immigrant investor visas including, but not limited to, unused EB-5 for credit enhancement; aggregate unused immigrant investor visas including, but not limited to, unused EB-5 for guarantor loans; aggregate unused immigrant investor visas including, but not limited to, unused EB-5 for infrastructure leasing.

### High-Speed Rail According to Some Embodiments:

Some embodiments of the invention comprise a computer-implemented method that includes at least: specifically programming at least one computer system or a portion of at least one computer system to perform at least one of the following: aggregate immigrant investor visas and/or immigrant investor visa funding including, but not limited to, EB-5 for investment in high-speed rail; aggregate recaptured immigrant investor visas including, but not limited to, recaptured EB-5 for investment in high-speed rail; aggregate unused immigrant investor visas including, but not limited to, unused EB-5 for investment in high-speed rail.

Some embodiments of the invention comprise a computer-implemented method that includes at least specifically programming at least one computer system or a portion of at least one computer system to perform at least one of the following: aggregate immigrant investor visas and/or immigrant investor visa funding including, but not limited to, EB-5, for the purposes of: investment in high-speed rail; immigrant investor visa automated application processing; immigrant investor visa automated legal processing; immigrant investor visa automated expedited processing; immigrant investor visa automated authentication of source of funds processing; immigrant investor visa automated background check processing; immigrant investor visa automated national security related screening and processing; immigrant investor visa automated processing of visas including, but not limited to, EB-5 visas; immigrant investor visa automated processing of recaptured visas including, but not limited to, recaptured EB-5 visas; immigrant investor visa automated processing of unused visas including, but not limited to, unused EB-5 visas; automated processing of investment; automated processing of credit enhancement; and automated processing of loan guarantees and other types of financing.

Some embodiments of the invention comprise a method for aggregate funding including, but not limited to, immigrant investor visa funding including, but not limited to, EB-5 funding for investment: Step 1: aggregate immigrant investor visa funding including, but not limited to, EB-5 funding for investment in high-speed rail; Step 2: aggregate immigrant investor visa funding including, but not limited to EB-5 funding, to be used as a PDP for investment in high-speed rail; Step 3: aggregate immigrant investor visa funding including, but not limited to, EB-5 funding for investment; Step 4: aggregate funding to be used as credit enhancement; Step 5: aggregate funding to be used in and for guarantor loans.

Some embodiments of the invention comprise a computer-implemented method that includes at least specifically programming at least one computer system or a portion of at least one computer system to perform at least one of the following: aggregate immigrant investor visas and/or immigrant investor visa funding including, but not limited to, EB-5, for the purposes of: investment in high-speed rail; immigrant investor visa automated application processing; immigrant investor visa automated legal processing; immigrant investor visa automated processing of recaptured visas including, but not limited to, recaptured EB-5 visas; immigrant investor visa automated processing of unused visas including, but not limited to, unused EB-5 visas; immigrant investor visa automated expedited processing; immigrant investor visa automated authentication of source of funds processing; immigrant investor visa automated background check processing; immigrant investor visa automated national security related screening and processing; automated processing of investment related to high-speed rail; automated processing of credit enhancement related to high-speed rail; and automated processing of loan guarantees related to high-speed rail.

### High Speed-Rail and Immigration Investor Visas/EB-5 According to Some Embodiments:

Some embodiments of the invention comprise a computer-implemented method that includes at least: specifically programming at least one computer system or a portion of at least one computer system to perform at least one of the following: aggregate immigrant investor visas and/or immigrant investor visa funding including, but not limited to, EB-5 for investment in high-speed rail; aggregate immigrant investor visas and/or immigrant investor visa funding including, but not limited to, EB-5 for credit enhancement; aggregate immigrant investor visas and/or immigrant investor visa funding including, but not limited to, EB-5 for guarantor loans.

### High Speed-Rail and Recaptured Immigration Investor Visas/Recaptured EB-5 According to Some Embodiments:

Some embodiments of the invention comprise a computer-implemented method that includes at least: specifically programming at least one computer system or a portion of at least one computer system to perform at least one of the following: aggregate recaptured immigrant investor visas including, but not limited to, recaptured EB-5 for investment in high-speed rail; aggregate recaptured immigrant investor visas including, but not limited to, recaptured EB-5 for credit enhancement; aggregate recaptured immigrant investor visas including, but not limited to, recaptured EB-5 for guarantor loans.

### High Speed-Rail and Unused Immigration Investor Visas/Unused EB-5 According to Some Embodiments:

Some embodiments of the invention comprise a computer-implemented method that includes at least: specifically programming at least one computer system or a portion of at least one computer system to perform at least one of the following: aggregate unused immigrant investor visas including, but not limited to, unused EB-5 for investment in high-speed rail; aggregate unused immigrant investor visas including, but not limited to, unused EB-5 for credit enhancement; aggregate unused immigrant investor visas including, but not limited to, unused EB-5 for guarantor loans.

### Smart Grid According to Some Embodiments:

Some embodiments of the invention comprise a computer-implemented method that includes at least: specifically programming at least one computer system or a portion of at least one computer system to perform at least one of the following: aggregate immigrant investor visas and/or immigrant investor visa funding including, but not limited to, EB-5 for investment in smart grid; aggregate recaptured immigrant investor visas including, but not limited to, recaptured EB-5 for investment in smart grid; aggregate unused immigrant investor visas including, but not limited to, unused EB-5 for investment in smart grid.

Some embodiments of the invention comprise a computer-implemented method that includes at least specifically programming at least one computer system or a portion of at least one computer system to perform at least one of the following: aggregate immigrant investor visas and/or immigrant investor visa funding including, but not limited to, EB-5, for the purposes of: investment in smart grid; immigrant investor visa automated application processing; immigrant investor visa automated legal processing; immigrant investor visa automated expedited processing; immigrant investor visa automated authentication of source of funds processing; immigrant investor visa automated background check processing; immigrant investor visa automated national security related screening and processing; immigrant investor visa automated processing of visas including, but not limited to, EB-5 visas; immigrant investor visa automated processing of recaptured visas including, but not limited to, recaptured EB-5 visas; immigrant investor visa automated processing of unused visas including, but not limited to, unused EB-5 visas; automated processing of investment; automated processing of credit enhancement; and automated processing of loan guarantees and other types of financing.

Some embodiments of the invention comprise a method for aggregate funding including, but not limited to, immigrant investor visa funding including, but not limited to, EB-5 funding for investment: Step 1: aggregate immigrant investor visa funding including, but not limited to, EB-5 funding for investment in smart grid; Step 2: aggregate immigrant investor visa funding including, but not limited to EB-5 funding, to be used as a PDP for investment in smart grid; Step 3: aggregate immigrant investor visa funding including, but not limited to, EB-5 funding for investment; Step 4: aggregate funding to be used as credit enhancement; Step 5: aggregate funding to be used in and for guarantor loans.

Some embodiments of the invention comprise a computer-implemented method that includes at least specifically programming at least one computer system or a portion of at least one computer system to perform at least one of the following: aggregate immigrant investor visas and/or immigrant investor visa funding including, but not limited to, EB-5, for the purposes of: investment in smart grid; immigrant investor visa automated application processing; immigrant investor visa automated legal processing; immigrant investor visa automated processing of recaptured visas including, but not limited to, recaptured EB-5 visas; immigrant investor visa automated processing of unused visas including, but not limited to, unused EB-5 visas; immigrant investor visa automated expedited processing; immigrant investor visa automated authentication of source of funds processing; immigrant investor visa automated background check processing; immigrant investor visa automated national security related screening and processing; automated processing of investment related to smart grid; automated processing of credit enhancement related to smart grid; and automated processing of loan guarantees related to smart grid.

### Smart Grid and Immigration Investor Visas/EB-5 According to Some Embodiments:

Some embodiments of the invention comprise a computer-implemented method that includes at least: specifically programming at least one computer system or a portion of at least one computer system to perform at least one of the following: aggregate immigrant investor visas and/or immigrant investor visa funding including, but not limited to, EB-5 for investment in smart grid; aggregate immigrant investor visas and/or immigrant investor visa funding including, but not limited to, EB-5 for credit enhancement; aggregate immigrant investor visas and/or immigrant investor visa funding including, but not limited to, EB-5 for guarantor loans.

### Smart Grid and Recaptured Immigration Investor Visas/Recaptured EB-5 According to Some Embodiments:

Some embodiments of the invention comprise a computer-implemented method that includes at least: specifically programming at least one computer system or a portion of at least one computer system to perform at least one of the following: aggregate recaptured immigrant investor visas including, but not limited to, recaptured EB-5 for investment in smart grid; aggregate recaptured immigrant investor visas including, but not limited to, recaptured EB-5 for credit enhancement; aggregate recaptured immigrant investor visas including, but not limited to, recaptured EB-5 for guarantor loans.

### Smart Grid and Unused Immigration Investor Visas/Unused EB-5 According to Some Embodiments:

Some embodiments of the invention comprise a computer-implemented method that includes at least: specifically programming at least one computer system or a portion of at least one computer system to perform at least one of the following: aggregate unused immigrant investor visas including, but not limited to, unused EB-5 for investment in smart grid; aggregate unused immigrant investor visas including, but not limited to, unused EB-5 for credit enhancement; aggregate unused immigrant investor visas including, but not limited to, unused EB-5 for guarantor loans.

### 5G According to Some Embodiments:

Some embodiments of the invention comprise a computer-implemented method that includes at least: specifically programming at least one computer system or a portion of at least one computer system to perform at least one of the following: aggregate immigrant investor visas and/or immigrant investor visa funding including, but not limited to, EB-5 for investment in 5G; aggregate recaptured immigrant investor visas including, but not limited to, recaptured EB-5 for investment in 5G; aggregate unused immigrant investor visas including, but not limited to, unused EB-5 for investment in 5G.

Some embodiments of the invention comprise a computer-implemented method that includes at least specifically programming at least one computer system or a portion of at least one computer system to perform at least one of the following: aggregate immigrant investor visas and/or immigrant investor visa funding including, but not limited to, EB-5, for the purposes of: investment in 5G; immigrant investor visa automated application processing; immigrant investor visa automated legal processing; immigrant investor visa automated expedited processing; immigrant investor visa automated authentication of source of funds processing; immigrant investor visa automated background check processing; immigrant investor visa automated national security related screening and processing; immigrant investor visa automated processing of visas including, but not limited to, EB-5 visas; immigrant investor visa automated processing of recaptured visas including, but not limited to, recaptured EB-5 visas; immigrant investor visa automated processing of unused visas including, but not limited to, unused EB-5 visas; automated processing of investment; automated processing of credit enhancement; and automated processing of loan guarantees and other types of financing.

Some embodiments of the invention comprise a method for aggregate funding including, but not limited to, immigrant investor visa funding including, but not limited to, EB-5 funding for investment: Step 1: aggregate immigrant investor visa funding including, but not limited to, EB-5 funding for investment in 5G; Step 2: aggregate immigrant investor visa funding including, but not limited to EB-5 funding, to be used as a PDP for investment in 5G; Step 3: aggregate immigrant investor visa funding including, but not limited to, EB-5 funding for investment; Step 4: aggregate funding to be used as credit enhancement; Step 5: aggregate funding to be used in and for guarantor loans.

Some embodiments of the invention comprise a computer-implemented method that includes at least specifically programming at least one computer system or a portion of at least one computer system to perform at least one of the following: aggregate immigrant investor visas and/or immigrant investor visa funding including, but not limited to, EB-5, for the purposes of: investment in 5G; immigrant investor visa automated application processing; immigrant investor visa automated legal processing; immigrant investor visa automated processing of recaptured visas including, but not limited to, recaptured EB-5 visas; immigrant investor visa automated processing of unused visas including, but not limited to, unused EB-5 visas; immigrant investor visa automated expedited processing; immigrant investor visa automated authentication of source of funds processing; immigrant investor visa automated background check processing; immigrant investor visa automated national security related screening and processing; automated processing of investment related to 5G; automated processing of credit enhancement related to 5G; and automated processing of loan guarantees related to 5G.

### 5G and Immigration Investor Visas/EB-5 According to Some Embodiments:

Some embodiments of the invention comprise a computer-implemented method that includes at least: specifically programming at least one computer system or a portion of at least one computer system to perform at least one of the following: aggregate immigrant investor visas and/or immigrant investor visa funding including, but not limited to, EB-5 for investment in 5G; aggregate immigrant investor visas and/or immigrant investor visa funding including, but not limited to, EB-5 for credit enhancement; aggregate immigrant investor visas and/or immigrant investor visa funding including, but not limited to, EB-5 for guarantor loans according to some embodiments.

### 5G and Recaptured Immigration Investor Visas/Recaptured EB-5 According to Some Embodiments:

Some embodiments of the invention comprise a computer-implemented method that includes at least: specifically programming at least one computer system or a portion of at least one computer system to perform at least one of the following: aggregate recaptured immigrant investor visas including, but not limited to, recaptured EB-5 for investment in 5G; aggregate recaptured immigrant investor visas including, but not limited to, recaptured EB-5 for credit enhancement; aggregate recaptured immigrant investor visas including, but not limited to, recaptured EB-5 for guarantor loans.

### 5G and Unused Immigration Investor Visas/Unused EB-5 According to Some Embodiments:

Some embodiments of the invention comprise a computer-implemented method that includes at least: specifically programming at least one computer system or a portion of at least one computer system to perform at least one of the following: aggregate unused immigrant investor visas including, but not limited to, unused EB-5 for investment in 5G; aggregate unused immigrant investor visas including, but not limited to, unused EB-5 for credit enhancement; aggregate unused immigrant investor visas including, but not limited to, unused EB-5 for guarantor loans.

### Space Internet According to Some Embodiments:

Some embodiments of the invention comprise a computer-implemented method that includes at least: specifically programming at least one computer system or a portion of at least one computer system to perform at least one of the following: aggregate immigrant investor visas and/or immigrant investor visa funding including, but not limited to, EB-5 for investment in Space Internet; aggregate recaptured immigrant investor visas including, but not limited to, recaptured EB-5 for investment in Space Internet; aggregate unused immigrant investor visas including, but not limited to, unused EB-5 for investment in Space Internet.

Some embodiments of the invention comprise a computer-implemented method that includes at least specifically programming at least one computer system or a portion of at least one computer system to perform at least one of the following: aggregate immigrant investor visas and/or immigrant investor visa funding including, but not limited to, EB-5, for the purposes of: investment in Space Internet; immigrant investor visa automated application processing; immigrant investor visa automated legal processing; immigrant investor visa automated expedited processing; immigrant investor visa automated authentication of source of funds processing; immigrant investor visa automated background check processing; immigrant investor visa automated national security related screening and processing; immigrant investor visa automated processing of visas including, but not limited to, EB-5 visas; immigrant investor visa automated processing of recaptured visas including, but not limited to, recaptured EB-5 visas; immigrant investor visa automated processing of unused visas including, but not limited to, unused EB-5 visas; automated processing of investment; automated processing of credit enhancement; and automated processing of loan guarantees and other types of financing.

Some embodiments of the invention comprise a method for aggregate funding including, but not limited to, immigrant investor visa funding including, but not limited to, EB-5 funding for investment: Step 1: aggregate immigrant investor visa funding including, but not limited to, EB-5 funding for investment in Space Internet; Step 2: aggregate immigrant investor visa funding including, but not limited to EB-5 funding, to be used as a PDP for investment in Space Internet; Step 3: aggregate immigrant investor visa funding including, but not limited to, EB-5 funding for investment; Step 4: aggregate funding to be used as credit enhancement; Step 5: aggregate funding to be used in and for guarantor loans.

Some embodiments of the invention comprise a computer-implemented method that includes at least specifically programming at least one computer system or a portion of at least one computer system to perform at least one of the following: aggregate immigrant investor visas and/or immigrant investor visa funding including, but not limited to, EB-5, for the purposes of: investment in Space Internet; immigrant investor visa automated application processing; immigrant investor visa automated legal processing; immigrant investor visa automated processing of recaptured visas including, but not limited to, recaptured EB-5 visas; immigrant investor visa automated processing of unused visas including, but not limited to, unused EB-5 visas; immigrant investor visa automated expedited processing; immigrant investor visa automated authentication of source of funds processing; immigrant investor visa automated background check processing; immigrant investor visa automated national security related screening and processing; automated processing of investment related to Space Internet; automated processing of credit enhancement related to Space Internet; and automated processing of loan guarantees related to Space Internet.

### Space Internet and Immigration Investor Visas/EB-5 According to Some Embodiments:

Some embodiments of the invention comprise a computer-implemented method that includes at least: specifically programming at least one computer system or a portion of at least one computer system to perform at least one of the following: aggregate immigrant investor visas and/or immigrant investor visa funding including, but not limited to, EB-5 for investment in Space Internet; aggregate immigrant investor visas and/or immigrant investor visa funding including, but not limited to, EB-5 for credit enhancement; aggregate immigrant investor visas and/or immigrant investor visa funding including, but not limited to, EB-5 for guarantor loans.

### Space Internet and Recaptured Immigration Investor Visas/Recaptured EB-5 According to Some Embodiments:

Some embodiments of the invention comprise a computer-implemented method that includes at least: specifically programming at least one computer system or a portion of at least one computer system to perform at least one of the following: aggregate recaptured immigrant investor visas including, but not limited to, recaptured EB-5 for investment in Space Internet; aggregate recaptured immigrant investor visas including, but not limited to, recaptured EB-5 for credit enhancement; aggregate recaptured immigrant investor visas including, but not limited to, recaptured EB-5 for guarantor loans.

### Space Internet and Unused Immigration Investor Visas/Unused EB-5 According to Some Embodiments:

Some embodiments of the invention comprise a computer-implemented method that includes at least: specifically programming at least one computer system or a portion of at least one computer system to perform at least one of the following: aggregate unused immigrant investor visas including, but not limited to, unused EB-5 for investment in Space Internet; aggregate unused immigrant investor visas including, but not limited to, unused EB-5 for credit enhancement; aggregate unused immigrant investor visas including, but not limited to, unused EB-5 for guarantor loans.

### Water Supply System or Water Supply Network According to Some Embodiments:

Some embodiments of the invention comprise a computer-implemented method that includes at least: specifically programming at least one computer system or a portion of at least one computer system to perform at least one of the following: aggregate immigrant investor visas and/or immigrant investor visa funding including, but not limited to, EB-5 for investment in water supply system or water supply network; aggregate recaptured immigrant investor visas including, but not limited to, recaptured EB-5 for investment in water supply system or water supply network; aggregate unused immigrant investor visas including, but not limited to, unused EB-5 for investment in water supply system or water supply network.

Some embodiments of the invention comprise a computer-implemented method that includes at least specifically programming at least one computer system or a portion of at least one computer system to perform at least one of the following: aggregate immigrant investor visas and/or immigrant investor visa funding including, but not limited to, EB-5, for the purposes of: investment in water supply system or water supply network; immigrant investor visa automated application processing; immigrant investor visa automated legal processing; immigrant investor visa automated expedited processing; immigrant investor visa automated authentication of source of funds processing; immigrant investor visa automated background check processing; immigrant investor visa automated national security related screening and processing; immigrant investor visa automated processing of visas including, but not limited to, EB-5 visas; immigrant investor visa automated processing of recaptured visas including, but not limited to, recaptured EB-5 visas; immigrant investor visa automated processing of unused visas including, but not limited to, unused EB-5 visas; automated processing of investment; automated processing of credit enhancement; and automated processing of loan guarantees and other types of financing.

Some embodiments of the invention comprise a method for aggregate funding including, but not limited to, immigrant investor visa funding including, but not limited to, EB-5 funding for investment: Step 1: aggregate immigrant investor visa funding including, but not limited to, EB-5 funding for investment in water supply system or water supply network; Step 2: aggregate immigrant investor visa funding including, but not limited to EB-5 funding, to be used as a PDP for investment in water supply system or water supply network; Step 3: aggregate immigrant investor visa funding including, but not limited to, EB-5 funding for investment; Step 4: aggregate funding to be used as credit enhancement; Step 5: aggregate funding to be used in and for guarantor loans.

Some embodiments of the invention comprise a computer-implemented method that includes at least specifically programming at least one computer system or a portion of at least one computer system to perform at least one of the following: aggregate immigrant investor visas and/or immigrant investor visa funding including, but not limited to, EB-5, for the purposes of: investment in water supply system or water supply network; immigrant investor visa automated application processing; immigrant investor visa automated legal processing; immigrant investor visa automated processing of recaptured visas including, but not limited to, recaptured EB-5 visas; immigrant investor visa automated processing of unused visas including, but not limited to, unused EB-5 visas; immigrant investor visa automated expedited processing; immigrant investor visa automated authentication of source of funds processing; immigrant investor visa automated background check processing; immigrant investor visa automated national security related screening and processing; automated processing of investment related to water supply system or water supply network; automated processing of credit enhancement related to water supply system or water supply network; and automated processing of loan guarantees related to water supply system or water supply network.

### Water Supply System or Water Supply Network and Immigration Investor Visas/EB-5 According to Some Embodiments:

Some embodiments of the invention comprise a computer-implemented method that includes at least: specifically programming at least one computer system or a portion of at least one computer system to perform at least one of the following: aggregate immigrant investor visas and/or immigrant investor visa funding including, but not limited to, EB-5 for investment in water supply system or water supply network; aggregate immigrant investor visas and/or immigrant investor visa funding including, but not limited to, EB-5 for credit enhancement; aggregate immigrant investor visas and/or immigrant investor visa funding including, but not limited to, EB-5 for guarantor loans.

### Water Supply System or Water Supply Network and Recaptured Immigration Investor Visas/Recaptured EB-5 According to Some Embodiments:

Some embodiments of the invention comprise a computer-implemented method that includes at least: specifically programming at least one computer system or a portion of at least one computer system to perform at least one of the following: aggregate recaptured immigrant investor visas including, but not limited to, recaptured EB-5 for investment in water supply system or water supply network; aggregate recaptured immigrant investor visas including, but not limited to, recaptured EB-5 for credit enhancement; aggregate recaptured immigrant investor visas including, but not limited to, recaptured EB-5 for guarantor loans.

### Water Supply System or Water Supply Network and Unused Immigration Investor Visas/Unused EB-5 According to Some Embodiments:

Some embodiments of the invention comprise a computer-implemented method that includes at least: specifically programming at least one computer system or a portion of at least one computer system to perform at least one of the following: aggregate unused immigrant investor visas including, but not limited to, unused EB-5 for investment in water supply system or water supply network; aggregate unused immigrant investor visas including, but not limited to, unused EB-5 for credit enhancement; aggregate unused immigrant investor visas including, but not limited to, unused EB-5 for guarantor loans.

### Water Infrastructure According to Some Embodiments:

Some embodiments of the invention comprise a computer-implemented method that includes at least: specifically programming at least one computer system or a portion of at least one computer system to perform at least one of the following: aggregate immigrant investor visas and/or immigrant investor visa funding including, but not limited to, EB-5 for investment in water infrastructure; aggregate recaptured immigrant investor visas including, but not limited to, recaptured EB-5 for investment in water infrastructure; aggregate unused immigrant investor visas including, but not limited to, unused EB-5 for investment in water infrastructure.

Some embodiments of the invention comprise a computer-implemented method that includes at least specifically programming at least one computer system or a portion of at least one computer system to perform at least one of the following: aggregate immigrant investor visas and/or immigrant investor visa funding including, but not limited to, EB-5, for the purposes of: investment in water infrastructure; immigrant investor visa automated application processing; immigrant investor visa automated legal processing; immigrant investor visa automated expedited processing; immigrant investor visa automated authentication of source of funds processing; immigrant investor visa automated background check processing; immigrant investor visa automated national security related screening and processing; immigrant investor visa automated processing of visas including, but not limited to, EB-5 visas; immigrant investor visa automated processing of recaptured visas including, but not limited to, recaptured EB-5 visas; immigrant investor visa automated processing of unused visas including, but not limited to, unused EB-5 visas; automated processing of investment; automated processing of credit enhancement; and automated processing of loan guarantees and other types of financing.

Some embodiments of the invention comprise a method for aggregate funding including, but not limited to, immigrant investor visa funding including, but not limited to, EB-5 funding for investment: Step 1: aggregate immigrant investor visa funding including, but not limited to, EB-5 funding for investment in water infrastructure; Step 2: aggregate immigrant investor visa funding including, but not limited to EB-5 funding, to be used as a PDP for investment in water infrastructure; Step 3: aggregate immigrant investor visa funding including, but not limited to, EB-5 funding for investment; Step 4: aggregate funding to be used as credit enhancement; Step 5: aggregate funding to be used in and for guarantor loans.

Some embodiments of the invention comprise a computer-implemented method that includes at least specifically programming at least one computer system or a portion of at least one computer system to perform at least one of the following: aggregate immigrant investor visas and/or immigrant investor visa funding including, but not limited to, EB-5, for the purposes of: investment in water infrastructure; immigrant investor visa automated application processing; immigrant investor visa automated legal processing; immigrant investor visa automated processing of recaptured visas including, but not limited to, recaptured EB-5 visas; immigrant investor visa automated processing of unused visas including, but not limited to, unused EB-5 visas; immigrant investor visa automated expedited processing; immigrant investor visa automated authentication of source of funds processing; immigrant investor visa automated background check processing; immigrant investor visa automated national security related screening and processing; automated processing of investment related to water infrastructure; automated processing of credit enhancement related to water infrastructure; and automated processing of loan guarantees related to water infrastructure.

### Water Infrastructure and Immigration Investor Visas/EB-5 According to Some Embodiments:

Some embodiments of the invention comprise a computer-implemented method that includes at least: specifically programming at least one computer system or a portion of at least one computer system to perform at least one of the following: aggregate immigrant investor visas and/or immigrant investor visa funding including, but not limited to, EB-5 for investment in water infrastructure; aggregate immigrant investor visas and/or immigrant investor visa funding including, but not limited to, EB-5 for credit enhancement; aggregate immigrant investor visas and/or immigrant investor visa funding including, but not limited to, EB-5 for guarantor loans.

### Water Infrastructure and Recaptured Immigration Investor Visas/Recaptured EB-5 According to Some Embodiments:

Some embodiments of the invention comprise a computer-implemented method that includes at least: specifically programming at least one computer system or a portion of at least one computer system to perform at least one of the following: aggregate recaptured immigrant investor visas including, but not limited to, recaptured EB-5 for investment in water infrastructure; aggregate recaptured immigrant investor visas including, but not limited to, recaptured EB-5 for credit enhancement; aggregate recaptured immigrant investor visas including, but not limited to, recaptured EB-5 for guarantor loans.

### Water Infrastructure and Unused Immigration Investor Visas/Unused EB-5 According to Some Embodiments:

Some embodiments of the invention comprise a computer-implemented method that includes at least: specifically programming at least one computer system or a portion of at least one computer system to perform at least one of the following: aggregate unused immigrant investor visas including, but not limited to, unused EB-5 for investment in water infrastructure; aggregate unused immigrant investor visas including, but not limited to, unused EB-5 for credit enhancement; aggregate unused immigrant investor visas including, but not limited to, unused EB-5 for guarantor loans.

### Airport Infrastructure According to Some Embodiments:

Some embodiments of the invention comprise a computer-implemented method that includes at least: specifically programming at least one computer system or a portion of at least one computer system to perform at least one of the following: aggregate immigrant investor visas and/or immigrant investor visa funding including, but not limited to, EB-5 for investment in airport infrastructure; aggregate recaptured immigrant investor visas including, but not limited to, recaptured EB-5 for investment in airport infrastructure; aggregate unused immigrant investor visas including, but not limited to, unused EB-5 for investment in airport infrastructure.

Some embodiments of the invention comprise a computer-implemented method that includes at least specifically programming at least one computer system or a portion of at least one computer system to perform at least one of the following: aggregate immigrant investor visas and/or immigrant investor visa funding including, but not limited to, EB-5, for the purposes of: investment in airport infrastructure; immigrant investor visa automated application processing; immigrant investor visa automated legal processing; immigrant investor visa automated expedited processing; immigrant investor visa automated authentication of source of funds processing; immigrant investor visa automated background check processing; immigrant investor visa automated national security related screening and processing; immigrant investor visa automated processing of visas including, but not limited to, EB-5 visas; immigrant investor visa automated processing of recaptured visas including, but not limited to, recaptured EB-5 visas; immigrant investor visa automated processing of unused visas including, but not limited to, unused EB-5 visas; automated processing of investment; automated processing of credit enhancement; and automated processing of loan guarantees and other types of financing.

Some embodiments of the invention comprise a method for aggregate funding including, but not limited to, immigrant investor visa funding including, but not limited to, EB-5 funding for investment: Step 1: aggregate immigrant investor visa funding including, but not limited to, EB-5 funding for investment in airport infrastructure; Step 2: aggregate immigrant investor visa funding including, but not limited to EB-5 funding, to be used as a PDP for investment in airport infrastructure; Step 3: aggregate immigrant investor visa funding including, but not limited to, EB-5 funding for investment; Step 4: aggregate funding to be used as credit enhancement; Step 5: aggregate funding to be used in and for guarantor loans.

Some embodiments of the invention comprise a computer-implemented method that includes at least specifically programming at least one computer system or a portion of at least one computer system to perform at least one of the following: aggregate immigrant investor visas and/or immigrant investor visa funding including, but not limited to, EB-5, for the purposes of: investment in airport infrastructure; immigrant investor visa automated application processing; immigrant investor visa automated legal processing; immigrant investor visa automated processing of recaptured visas including, but not limited to, recaptured EB-5 visas; immigrant investor visa automated processing of unused visas including, but not limited to, unused EB-5 visas; immigrant investor visa automated expedited processing; immigrant investor visa automated authentication of source of funds processing; immigrant investor visa automated background check processing; immigrant investor visa automated national security related screening and processing; automated processing of investment related to airport infrastructure; automated processing of credit enhancement related to airport infrastructure; and automated processing of loan guarantees related to airport infrastructure.

### Airport Infrastructure and Immigration Investor Visas/EB-5 According to Some Embodiments:

Some embodiments of the invention comprise a computer-implemented method that includes at least: specifically programming at least one computer system or a portion of at least one computer system to perform at least one of the following: aggregate immigrant investor visas and/or immigrant investor visa funding including, but not limited to, EB-5 for investment in airport infrastructure; aggregate immigrant investor visas and/or immigrant investor visa funding including, but not limited to, EB-5 for credit enhancement; aggregate immigrant investor visas and/or immigrant investor visa funding including, but not limited to, EB-5 for guarantor loans.

### Airport Infrastructure Airport Infrastructure and Recaptured Immigration Investor Visas/Recaptured EB-5 According to Some Embodiments:

Some embodiments of the invention comprise a computer-implemented method that includes at least: specifically programming at least one computer system or a portion of at least one computer system to perform at least one of the following: aggregate recaptured immigrant investor visas including, but not limited to, recaptured EB-5 for investment in airport infrastructure; aggregate recaptured immigrant investor visas including, but not limited to, recaptured EB-5 for credit enhancement; aggregate recaptured immigrant investor visas including, but not limited to, recaptured EB-5 for guarantor loans.

### Airport Infrastructure and Unused Immigration Investor Visas/Unused EB-5 According to Some Embodiments:

Some embodiments of the invention comprise a computer-implemented method that includes at least: specifically programming at least one computer system or a portion of at least one computer system to perform at least one of the following: aggregate unused immigrant investor visas including, but not limited to, unused EB-5 for investment in airport infrastructure; aggregate unused immigrant investor visas including, but not limited to, unused EB-5 for credit enhancement; aggregate unused immigrant investor visas including, but not limited to, unused EB-5 for guarantor loans.

### Port Infrastructure According to Some Embodiments:

Some embodiments of the invention comprise a computer-implemented method that includes at least: specifically programming at least one computer system or a portion of at least one computer system to perform at least one of the following: aggregate immigrant investor visas and/or immigrant investor visa funding including, but not limited to, EB-5 for investment in port infrastructure; aggregate recaptured immigrant investor visas including, but not limited to, recaptured EB-5 for investment in port infrastructure; aggregate unused immigrant investor visas including, but not limited to, unused EB-5 for investment in port infrastructure.

Some embodiments of the invention comprise a computer-implemented method that includes at least specifically programming at least one computer system or a portion of at least one computer system to perform at least one of the following: aggregate immigrant investor visas and/or immigrant investor visa funding including, but not limited to, EB-5, for the purposes of: investment in port infrastructure; immigrant investor visa automated application processing; immigrant investor visa automated legal processing; immigrant investor visa automated expedited processing; immigrant investor visa automated authentication of source of funds processing; immigrant investor visa automated background check processing; immigrant investor visa automated national security related screening and processing; immigrant investor visa automated processing of visas including, but not limited to, EB-5 visas; immigrant investor visa automated processing of recaptured visas including, but not limited to, recaptured EB-5 visas; immigrant investor visa automated processing of unused visas including, but not limited to, unused EB-5 visas; automated processing of investment; automated processing of credit enhancement; and automated processing of loan guarantees and other types of financing.

Some embodiments of the invention comprise a method for aggregate funding including, but not limited to, immigrant investor visa funding including, but not limited to, EB-5 funding for investment: Step 1: aggregate immigrant investor visa funding including, but not limited to, EB-5 funding for investment in port infrastructure; Step 2: aggregate immigrant investor visa funding including, but not limited to EB-5 funding, to be used as a PDP for investment in port infrastructure; Step 3: aggregate immigrant investor visa funding including, but not limited to, EB-5 funding for investment; Step 4: aggregate funding to be used as credit enhancement; Step 5: aggregate funding to be used in and for guarantor loans.

Some embodiments of the invention comprise a computer-implemented method that includes at least specifically programming at least one computer system or a portion of at least one computer system to perform at least one of the following: aggregate immigrant investor visas and/or immigrant investor visa funding including, but not limited to, EB-5, for the purposes of: investment in port infrastructure; immigrant investor visa automated application processing; immigrant investor visa automated legal processing; immigrant investor visa automated processing of recaptured visas including, but not limited to, recaptured EB-5 visas; immigrant investor visa automated processing of unused visas including, but not limited to, unused EB-5 visas; immigrant investor visa automated expedited processing; immigrant investor visa automated authentication of source of funds processing; immigrant investor visa automated background check processing; immigrant investor visa automated national security related screening and processing; automated processing of investment related to port infrastructure; automated processing of credit enhancement related to port infrastructure; and automated processing of loan guarantees related to port infrastructure.

### Port Infrastructure and Immigration Investor Visas/EB-5 According to Some Embodiments:

Some embodiments of the invention comprise a computer-implemented method that includes at least: specifically programming at least one computer system or a portion of at least one computer system to perform at least one of the following: aggregate immigrant investor visas and/or immigrant investor visa funding including, but not limited to, EB-5 for investment in port infrastructure; aggregate immigrant investor visas and/or immigrant investor visa funding including, but not limited to, EB-5 for credit enhancement; aggregate immigrant investor visas and/or immigrant investor visa funding including, but not limited to, EB-5 for guarantor loans.

### Port Infrastructure and Recaptured Immigration Investor Visas/Recaptured EB-5 According to Some Embodiments:

Some embodiments of the invention comprise a computer-implemented method that includes at least: specifically programming at least one computer system or a portion of at least one computer system to perform at least one of the following: aggregate recaptured immigrant investor visas including, but not limited to, recaptured EB-5 for investment in port infrastructure; aggregate recaptured immigrant investor visas including, but not limited to, recaptured EB-5 for credit enhancement; aggregate recaptured immigrant investor visas including, but not limited to, recaptured EB-5 for guarantor loans.

### Port Infrastructure and Unused Immigration Investor Visas/Unused EB-5 According to Some Embodiments:

Some embodiments of the invention comprise a computer-implemented method that includes at least: specifically programming at least one computer system or a portion of at least one computer system to perform at least one of the following: aggregate unused immigrant investor visas including, but not limited to, unused EB-5 for investment in port infrastructure; aggregate unused immigrant investor visas including, but not limited to, unused EB-5 for credit enhancement; aggregate unused immigrant investor visas including, but not limited to, unused EB-5 for guarantor loans.

### Seaport Infrastructure According to Some Embodiments:

Some embodiments of the invention comprise a computer-implemented method that includes at least: specifically programming at least one computer system or a portion of at least one computer system to perform at least one of the following: aggregate immigrant investor visas and/or immigrant investor visa funding including, but not limited to, EB-5 for investment in seaport infrastructure; aggregate recaptured immigrant investor visas including, but not limited to, recaptured EB-5 for investment in seaport infrastructure; aggregate unused immigrant investor visas including, but not limited to, unused EB-5 for investment in seaport infrastructure.

Some embodiments of the invention comprise a computer-implemented method that includes at least specifically programming at least one computer system or a portion of at least one computer system to perform at least one of the following: aggregate immigrant investor visas and/or immigrant investor visa funding including, but not limited to, EB-5, for the purposes of: investment in seaport infrastructure; immigrant investor visa automated application processing; immigrant investor visa automated legal processing; immigrant investor visa automated expedited processing; immigrant investor visa automated authentication of source of funds processing; immigrant investor visa automated background check processing; immigrant investor visa automated national security related screening and processing; immigrant investor visa automated processing of visas including, but not limited to, EB-5 visas; immigrant investor visa automated processing of recaptured visas including, but not limited to, recaptured EB-5 visas; immigrant investor visa automated processing of unused visas including, but not limited to, unused EB-5 visas; automated processing of investment; automated processing of credit enhancement; and automated processing of loan guarantees and other types of financing.

Some embodiments of the invention comprise a method for aggregate funding including, but not limited to, immigrant investor visa funding including, but not limited to, EB-5 funding for investment: Step 1: aggregate immigrant investor visa funding including, but not limited to, EB-5 funding for investment in seaport infrastructure; Step 2: aggregate immigrant investor visa funding including, but not limited to EB-5 funding, to be used as a PDP for investment in seaport infrastructure; Step 3: aggregate immigrant investor visa funding including, but not limited to, EB-5 funding for investment; Step 4: aggregate funding to be used as credit enhancement; Step 5: aggregate funding to be used in and for guarantor loans.

Some embodiments of the invention comprise a computer-implemented method that includes at least specifically programming at least one computer system or a portion of at least one computer system to perform at least one of the following: aggregate immigrant investor visas and/or immigrant investor visa funding including, but not limited to, EB-5, for the purposes of: investment in seaport infrastructure; immigrant investor visa automated application processing; immigrant investor visa automated legal processing; immigrant investor visa automated processing of recaptured visas including, but not limited to, recaptured EB-5 visas; immigrant investor visa automated processing of unused visas including, but not limited to, unused EB-5 visas; immigrant investor visa automated expedited processing; immigrant investor visa automated authentication of source of funds processing; immigrant investor visa automated background check processing; immigrant investor visa automated national security related screening and processing; automated processing of investment related to seaport infrastructure; automated processing of credit enhancement related to seaport infrastructure; and automated processing of loan guarantees related to seaport infrastructure.

### Seaport Infrastructure and Immigration Investor Visas/EB-5 According to Some Embodiments:

Some embodiments of the invention comprise a computer-implemented method that includes at least: specifically programming at least one computer system or a portion of at least one computer system to perform at least one of the following: aggregate immigrant investor visas and/or immigrant investor visa funding including, but not limited to, EB-5 for investment in seaport infrastructure; aggregate immigrant investor visas and/or immigrant investor visa funding including, but not limited to, EB-5 for credit enhancement; aggregate immigrant investor visas and/or immigrant investor visa funding including, but not limited to, EB-5 for guarantor loans.

### Seaport Infrastructure and Recaptured Immigration Investor Visas/Recaptured EB-5 According to Some Embodiments:

Some embodiments of the invention comprise a computer-implemented method that includes at least: specifically programming at least one computer system or a portion of at least one computer system to perform at least one of the following: aggregate recaptured immigrant investor visas including, but not limited to, recaptured EB-5 for investment in seaport infrastructure; aggregate recaptured immigrant investor visas including, but not limited to, recaptured EB-5 for credit enhancement; aggregate recaptured immigrant investor visas including, but not limited to, recaptured EB-5 for guarantor loans.

### Seaport Infrastructure and Unused Immigration Investor Visas/Unused EB-5 According to Some Embodiments:

Some embodiments of the invention comprise a computer-implemented method that includes at least: specifically programming at least one computer system or a portion of at least one computer system to perform at least one of the following: aggregate unused immigrant investor visas including, but not limited to, unused EB-5 for investment in seaport infrastructure; aggregate unused immigrant investor visas including, but not limited to, unused EB-5 for credit enhancement; aggregate unused immigrant investor visas including, but not limited to, unused EB-5 for guarantor loans.

### Inland Port Infrastructure According to Some Embodiments:

Some embodiments of the invention comprise a computer-implemented method that includes at least: specifically programming at least one computer system or a portion of at least one computer system to perform at least one of the following: aggregate immigrant investor visas and/or immigrant investor visa funding including, but not limited to, EB-5 for investment in inland port infrastructure; aggregate recaptured immigrant investor visas including, but not limited to, recaptured EB-5 for investment in inland port infrastructure; aggregate unused immigrant investor visas including, but not limited to, unused EB-5 for investment in inland port infrastructure.

Some embodiments of the invention comprise a computer-implemented method that includes at least specifically programming at least one computer system or a portion of at least one computer system to perform at least one of the following: aggregate immigrant investor visas and/or immigrant investor visa funding including, but not limited to, EB-5, for the purposes of: investment in inland port infrastructure; immigrant investor visa automated application processing; immigrant investor visa automated legal processing; immigrant investor visa automated expedited processing; immigrant investor visa automated authentication of source of funds processing; immigrant investor visa automated background check processing; immigrant investor visa automated national security related screening and processing; immigrant investor visa automated processing of visas including, but not limited to, EB-5 visas; immigrant investor visa automated processing of recaptured visas including, but not limited to, recaptured EB-5 visas; immigrant investor visa automated processing of unused visas including, but not limited to, unused EB-5 visas; automated processing of investment; automated processing of credit enhancement; and automated processing of loan guarantees and other types of financing.

Some embodiments of the invention comprise a method for aggregate funding including, but not limited to, immigrant investor visa funding including, but not limited to, EB-5 funding for investment: Step 1: aggregate immigrant investor visa funding including, but not limited to, EB-5 funding for investment in inland port infrastructure; Step 2: aggregate immigrant investor visa funding including, but not limited to EB-5 funding, to be used as a PDP for investment in inland port infrastructure; Step 3: aggregate immigrant investor visa funding including, but not limited to, EB-5 funding for investment; Step 4: aggregate funding to be used as credit enhancement; Step 5: aggregate funding to be used in and for guarantor loans.

Some embodiments of the invention comprise a computer-implemented method that includes at least specifically programming at least one computer system or a portion of at least one computer system to perform at least one of the following: aggregate immigrant investor visas and/or immigrant investor visa funding including, but not limited to, EB-5, for the purposes of: investment in inland port infrastructure; immigrant investor visa automated application processing; immigrant investor visa automated legal processing; immigrant investor visa automated processing of recaptured visas including, but not limited to, recaptured EB-5 visas; immigrant investor visa automated processing of unused visas including, but not limited to, unused EB-5 visas; immigrant investor visa automated expedited processing; immigrant investor visa automated authentication of source of funds processing; immigrant investor visa automated background check processing; immigrant investor visa automated national security related screening and processing; automated processing of investment related to inland port infrastructure; automated processing of credit enhancement related to inland port infrastructure; and automated processing of loan guarantees related to inland port infrastructure.

### Inland Port Infrastructure and Immigration Investor Visas/EB-5 According to Some Embodiments:

Some embodiments of the invention comprise a computer-implemented method that includes at least: specifically programming at least one computer system or a portion of at least one computer system to perform at least one of the following: aggregate immigrant investor visas and/or immigrant investor visa funding including, but not limited to, EB-5 for investment in inland port infrastructure; aggregate immigrant investor visas and/or immigrant investor visa funding including, but not limited to, EB-5 for credit enhancement; aggregate immigrant investor visas and/or immigrant investor visa funding including, but not limited to, EB-5 for guarantor loans.

### Inland Port Infrastructure and Recaptured Immigration Investor Visas/Recaptured EB-5 According to Some Embodiments:

Some embodiments of the invention comprise a computer-implemented method that includes at least: specifically programming at least one computer system or a portion of at least one computer system to perform at least one of the following: aggregate recaptured immigrant investor visas including, but not limited to, recaptured EB-5 for investment in inland port infrastructure; aggregate recaptured immigrant investor visas including, but not limited to, recaptured EB-5 for credit enhancement; aggregate recaptured immigrant investor visas including, but not limited to, recaptured EB-5 for guarantor loans.

### Inland Port Infrastructure and Unused Immigration Investor Visas/Unused EB-5 According to Some Embodiments:

Some embodiments of the invention comprise a computer-implemented method that includes at least: specifically programming at least one computer system or a portion of at least one computer system to perform at least one of the following: aggregate unused immigrant investor visas including, but not limited to, unused EB-5 for investment in inland port infrastructure; aggregate unused immigrant investor visas including, but not limited to, unused EB-5 for credit enhancement; aggregate unused immigrant investor visas including, but not limited to, unused EB-5 for guarantor loans.

### Sports Venue According to Some Embodiments:

Some embodiments of the invention comprise a computer-implemented method that includes at least: specifically programming at least one computer system or a portion of at least one computer system to perform at least one of the following: aggregate immigrant investor visas and/or immigrant investor visa funding including, but not limited to, EB-5 for investment in sports venue; aggregate recaptured immigrant investor visas including, but not limited to, recaptured EB-5 for investment in sports venue; aggregate unused immigrant investor visas including, but not limited to, unused EB-5 for investment in sports venue.

Some embodiments of the invention comprise a computer-implemented method that includes at least specifically programming at least one computer system or a portion of at least one computer system to perform at least one of the following: aggregate immigrant investor visas and/or immigrant investor visa funding including, but not limited to, EB-5, for the purposes of: investment in sports venue; immigrant investor visa automated application processing; immigrant investor visa automated legal processing; immigrant investor visa automated expedited processing; immigrant investor visa automated authentication of source of funds processing; immigrant investor visa automated background check processing; immigrant investor visa automated national security related screening and processing; immigrant investor visa automated processing of visas including, but not limited to, EB-5 visas; immigrant investor visa automated processing of recaptured visas including, but not limited to, recaptured EB-5 visas; immigrant investor visa automated processing of unused visas including, but not limited to, unused EB-5 visas; automated processing of investment; automated processing of credit enhancement; and automated processing of loan guarantees and other types of financing.

Some embodiments of the invention comprise a method for aggregate funding including, but not limited to, immigrant investor visa funding including, but not limited to, EB-5 funding for investment: Step 1: aggregate immigrant investor visa funding including, but not limited to, EB-5 funding for investment in sports venue; Step 2: aggregate immigrant investor visa funding including, but not limited to EB-5 funding, to be used as a PDP for investment in sports venue; Step 3: aggregate immigrant investor visa funding including, but not limited to, EB-5 funding for investment; Step 4: aggregate funding to be used as credit enhancement; Step 5: aggregate funding to be used in and for guarantor loans.

Some embodiments of the invention comprise a computer-implemented method that includes at least specifically programming at least one computer system or a portion of at least one computer system to perform at least one of the following: aggregate immigrant investor visas and/or immigrant investor visa funding including, but not limited to, EB-5, for the purposes of: investment in sports venue; immigrant investor visa automated application processing; immigrant investor visa automated legal processing; immigrant investor visa automated processing of recaptured visas including, but not limited to, recaptured EB-5 visas; immigrant investor visa automated processing of unused visas including, but not limited to, unused EB-5 visas; immigrant investor visa automated expedited processing; immigrant investor visa automated authentication of source of funds processing; immigrant investor visa automated background check processing; immigrant investor visa automated national security related screening and processing; automated processing of investment related to sports venue; automated processing of credit enhancement related to sports venue; and automated processing of loan guarantees related to sports venue.

### Sports Venue and Immigration Investor Visas/EB-5 According to Some Embodiments:

Some embodiments of the invention comprise a computer-implemented method that includes at least: specifically programming at least one computer system or a portion of at least one computer system to perform at least one of the following: aggregate immigrant investor visas and/or immigrant investor visa funding including, but not limited to, EB-5 for investment in sports venue; aggregate immigrant investor visas and/or immigrant investor visa funding including, but not limited to, EB-5 for credit enhancement; aggregate immigrant investor visas and/or immigrant investor visa funding including, but not limited to, EB-5 for guarantor loans.

### Sports Venue and Recaptured Immigration Investor Visas/Recaptured EB-5 According to Some Embodiments:

Some embodiments of the invention comprise a computer-implemented method that includes at least: specifically programming at least one computer system or a portion of at least one computer system to perform at least one of the following: aggregate recaptured immigrant investor visas including, but not limited to, recaptured EB-5 for investment in sports venue; aggregate recaptured immigrant investor visas including, but not limited to, recaptured EB-5 for credit enhancement; aggregate recaptured immigrant investor visas including, but not limited to, recaptured EB-5 for guarantor loans.

### Sports Venue and Unused Immigration Investor Visas/Unused EB-5 According to Some Embodiments:

Some embodiments of the invention comprise a computer-implemented method that includes at least: specifically programming at least one computer system or a portion of at least one computer system to perform at least one of the following: aggregate unused immigrant investor visas including, but not limited to, unused EB-5 for investment in sports venue; aggregate unused immigrant investor visas including, but not limited to, unused EB-5 for credit enhancement; aggregate unused immigrant investor visas including, but not limited to, unused EB-5 for guarantor loans.

### Air Transportation Infrastructure According to Some Embodiments:

Some embodiments of the invention comprise a computer-implemented method that includes at least: specifically programming at least one computer system or a portion of at least one computer system to perform at least one of the following: aggregate immigrant investor visas and/or immigrant investor visa funding including, but not limited to, EB-5 for investment in air transportation infrastructure; aggregate recaptured immigrant investor visas including, but not limited to, recaptured EB-5 for investment in air transportation infrastructure; aggregate unused immigrant investor visas including, but not limited to, unused EB-5 for investment in air transportation infrastructure.

Some embodiments of the invention comprise a computer-implemented method that includes at least specifically programming at least one computer system or a portion of at least one computer system to perform at least one of the following: aggregate immigrant investor visas and/or immigrant investor visa funding including, but not limited to, EB-5, for the purposes of: investment in air transportation infrastructure; immigrant investor visa automated application processing; immigrant investor visa automated legal processing; immigrant investor visa automated expedited processing; immigrant investor visa automated authentication of source of funds processing; immigrant investor visa automated background check processing; immigrant investor visa automated national security related screening and processing; immigrant investor visa automated processing of visas including, but not limited to, EB-5 visas; immigrant investor visa automated processing of recaptured visas including, but not limited to, recaptured EB-5 visas; immigrant investor visa automated processing of unused visas including, but not limited to, unused EB-5 visas; automated processing of investment; automated processing of credit enhancement; and automated processing of loan guarantees and other types of financing.

Some embodiments of the invention comprise a method for aggregate funding including, but not limited to, immigrant investor visa funding including, but not limited to, EB-5 funding for investment: Step 1: aggregate immigrant investor visa funding including, but not limited to, EB-5 funding for investment in air transportation infrastructure; Step 2: aggregate immigrant investor visa funding including, but not limited to EB-5 funding, to be used as a PDP for investment in air transportation infrastructure; Step 3: aggregate immigrant investor visa funding including, but not limited to, EB-5 funding for investment; Step 4: aggregate funding to be used as credit enhancement; Step 5: aggregate funding to be used in and for guarantor loans.

Some embodiments of the invention comprise a computer-implemented method that includes at least specifically programming at least one computer system or a portion of at least one computer system to perform at least one of the following: aggregate immigrant investor visas and/or immigrant investor visa funding including, but not limited to, EB-5, for the purposes of: investment in air transportation infrastructure; immigrant investor visa automated application processing; immigrant investor visa automated legal processing; immigrant investor visa automated processing of recaptured visas including, but not limited to, recaptured EB-5 visas; immigrant investor visa automated processing of unused visas including, but not limited to, unused EB-5 visas; immigrant investor visa automated expedited processing; immigrant investor visa automated authentication of source of funds processing; immigrant investor visa automated background check processing; immigrant investor visa automated national security related screening and processing; automated processing of investment related to air transportation infrastructure; automated processing of credit enhancement related to air transportation infrastructure; and automated processing of loan guarantees related to air transportation infrastructure.

### Air Transportation Infrastructure and Immigration Investor Visas/EB-5 According to Some Embodiments:

Some embodiments of the invention comprise a computer-implemented method that includes at least: specifically programming at least one computer system or a portion of at least one computer system to perform at least one of the following: aggregate immigrant investor visas and/or immigrant investor visa funding including, but not limited to, EB-5 for investment in air transportation infrastructure; aggregate immigrant investor visas and/or immigrant investor visa funding including, but not limited to, EB-5 for credit enhancement; aggregate immigrant investor visas and/or immigrant investor visa funding including, but not limited to, EB-5 for guarantor loans.

### Air Transportation Infrastructure and Recaptured Immigration Investor Visas/Recaptured EB-5 According to Some Embodiments:

Some embodiments of the invention comprise a computer-implemented method that includes at least: specifically programming at least one computer system or a portion of at least one computer system to perform at least one of the following: aggregate recaptured immigrant investor visas including, but not limited to, recaptured EB-5 for investment in air transportation infrastructure; aggregate recaptured immigrant investor visas including, but not limited to, recaptured EB-5 for credit enhancement; aggregate recaptured immigrant investor visas including, but not limited to, recaptured EB-5 for guarantor loans.

### Air Transportation Infrastructure and Unused Immigration Investor Visas/Unused EB-5 According to Some Embodiments:

Some embodiments of the invention comprise a computer-implemented method that includes at least: specifically programming at least one computer system or a portion of at least one computer system to perform at least one of the following: aggregate unused immigrant investor visas including, but not limited to, unused EB-5 for investment in air transportation infrastructure; aggregate unused immigrant investor visas including, but not limited to, unused EB-5 for credit enhancement; aggregate unused immigrant investor visas including, but not limited to, unused EB-5 for guarantor loans.

### Surface Transportation Infrastructure According to Some Embodiments:

Some embodiments of the invention comprise a computer-implemented method that includes at least: specifically programming at least one computer system or a portion of at least one computer system to perform at least one of the following: aggregate immigrant investor visas and/or immigrant investor visa funding including, but not limited to, EB-5 for investment in surface transportation infrastructure; aggregate recaptured immigrant investor visas including, but not limited to, recaptured EB-5 for investment in surface transportation infrastructure; aggregate unused immigrant investor visas including, but not limited to, unused EB-5 for investment in surface transportation infrastructure.

Some embodiments of the invention comprise a computer-implemented method that includes at least specifically programming at least one computer system or a portion of at least one computer system to perform at least one of the following: aggregate immigrant investor visas and/or immigrant investor visa funding including, but not limited to, EB-5, for the purposes of: investment in surface transportation infrastructure; immigrant investor visa automated application processing; immigrant investor visa automated legal processing; immigrant investor visa automated expedited processing; immigrant investor visa automated authentication of source of funds processing; immigrant investor visa automated background check processing; immigrant investor visa automated national security related screening and processing; immigrant investor visa automated processing of visas including, but not limited to, EB-5 visas; immigrant investor visa automated processing of recaptured visas including, but not limited to, recaptured EB-5 visas; immigrant investor visa automated processing of unused visas including, but not limited to, unused EB-5 visas; automated processing of investment; automated processing of credit enhancement; and automated processing of loan guarantees and other types of financing.

Some embodiments of the invention comprise a method for aggregate funding including, but not limited to, immigrant investor visa funding including, but not limited to, EB-5 funding for investment: Step 1: aggregate immigrant investor visa funding including, but not limited to, EB-5 funding for investment in surface transportation infrastructure; Step 2: aggregate immigrant investor visa funding including, but not limited to EB-5 funding, to be used as a PDP for investment in surface transportation infrastructure; Step 3: aggregate immigrant investor visa funding including, but not limited to, EB-5 funding for investment; Step 4: aggregate funding to be used as credit enhancement; Step 5: aggregate funding to be used in and for guarantor loans.

Some embodiments of the invention comprise a computer-implemented method that includes at least specifically programming at least one computer system or a portion of at least one computer system to perform at least one of the following: aggregate immigrant investor visas and/or immigrant investor visa funding including, but not limited to, EB-5, for the purposes of: investment in surface transportation infrastructure; immigrant investor visa automated application processing; immigrant investor visa automated legal processing; immigrant investor visa automated processing of recaptured visas including, but not limited to, recaptured EB-5 visas; immigrant investor visa automated processing of unused visas including, but not limited to, unused EB-5 visas; immigrant investor visa automated expedited processing; immigrant investor visa automated authentication of source of funds processing; immigrant investor visa automated background check processing; immigrant investor visa automated national security related screening and processing; automated processing of investment related to surface transportation infrastructure; automated processing of credit enhancement related to surface transportation infrastructure; and automated processing of loan guarantees related to surface transportation infrastructure.

### Surface Transportation Infrastructure and Immigration Investor Visas/EB-5 According to Some Embodiments:

Some embodiments of the invention comprise a computer-implemented method that includes at least: specifically programming at least one computer system or a portion of at least one computer system to perform at least one of the following: aggregate immigrant investor visas and/or immigrant investor visa funding including, but not limited to, EB-5 for investment in surface transportation infrastructure; aggregate immigrant investor visas and/or immigrant investor visa funding including, but not limited to, EB-5 for credit enhancement; aggregate immigrant investor visas and/or immigrant investor visa funding including, but not limited to, EB-5 for guarantor loans.

### Surface Transportation Infrastructure and Recaptured Immigration Investor Visas/Recaptured EB-5 According to Some Embodiments:

Some embodiments of the invention comprise a computer-implemented method that includes at least: specifically programming at least one computer system or a portion of at least one computer system to perform at least one of the following: aggregate recaptured immigrant investor visas including, but not limited to, recaptured EB-5 for investment in surface transportation infrastructure; aggregate recaptured immigrant investor visas including, but not limited to, recaptured EB-5 for credit enhancement; aggregate recaptured immigrant investor visas including, but not limited to, recaptured EB-5 for guarantor loans.

### Surface Transportation Infrastructure and Unused Immigration Investor Visas/Unused EB-5 According to Some Embodiments:

Some embodiments of the invention comprise a computer-implemented method that includes at least: specifically programming at least one computer system or a portion of at least one computer system to perform at least one of the following: aggregate unused immigrant investor visas including, but not limited to, unused EB-5 for investment in surface transportation infrastructure; aggregate unused immigrant investor visas including, but not limited to, unused EB-5 for credit enhancement; aggregate unused immigrant investor visas including, but not limited to, unused EB-5 for guarantor loans.

### Rail Infrastructure According to Some Embodiments:

Some embodiments of the invention comprise a computer-implemented method that includes at least: specifically programming at least one computer system or a portion of at least one computer system to perform at least one of the following: aggregate immigrant investor visas and/or immigrant investor visa funding including, but not limited to, EB-5 for investment in rail infrastructure; aggregate recaptured immigrant investor visas including, but not limited to, recaptured EB-5 for investment in rail infrastructure; aggregate unused immigrant investor visas including, but not limited to, unused EB-5 for investment in rail infrastructure.

Some embodiments of the invention comprise a computer-implemented method that includes at least specifically programming at least one computer system or a portion of at least one computer system to perform at least one of the following: aggregate immigrant investor visas and/or immigrant investor visa funding including, but not limited to, EB-5, for the purposes of: investment in rail infrastructure; immigrant investor visa automated application processing; immigrant investor visa automated legal processing; immigrant investor visa automated expedited processing; immigrant investor visa automated authentication of source of funds processing; immigrant investor visa automated background check processing; immigrant investor visa automated national security related screening and processing; immigrant investor visa automated processing of visas including, but not limited to, EB-5 visas; immigrant investor visa automated processing of recaptured visas including, but not limited to, recaptured EB-5 visas; immigrant investor visa automated processing of unused visas including, but not limited to, unused EB-5 visas; automated processing of investment; automated processing of credit enhancement; and automated processing of loan guarantees and other types of financing.

Some embodiments of the invention comprise a method for aggregate funding including, but not limited to, immigrant investor visa funding including, but not limited to, EB-5 funding for investment: Step 1: aggregate immigrant investor visa funding including, but not limited to, EB-5 funding for investment in rail infrastructure; Step 2: aggregate immigrant investor visa funding including, but not limited to EB-5 funding, to be used as a PDP for investment in rail infrastructure; Step 3: aggregate immigrant investor visa funding including, but not limited to, EB-5 funding for investment; Step 4: aggregate funding to be used as credit enhancement; Step 5: aggregate funding to be used in and for guarantor loans.

Some embodiments of the invention comprise a computer-implemented method that includes at least specifically programming at least one computer system or a portion of at least one computer system to perform at least one of the following: aggregate immigrant investor visas and/or immigrant investor visa funding including, but not limited to, EB-5, for the purposes of: investment in rail infrastructure; immigrant investor visa automated application processing; immigrant investor visa automated legal processing; immigrant investor visa automated processing of recaptured visas including, but not limited to, recaptured EB-5 visas; immigrant investor visa automated processing of unused visas including, but not limited to, unused EB-5 visas; immigrant investor visa automated expedited processing; immigrant investor visa automated authentication of source of funds processing; immigrant investor visa automated background check processing; immigrant investor visa automated national security related screening and processing; automated processing of investment related to rail infrastructure; automated processing of credit enhancement related to rail infrastructure; and automated processing of loan guarantees related to rail infrastructure.

### Rail Infrastructure and Immigration Investor Visas/EB-5 According to Some Embodiments:

Some embodiments of the invention comprise a computer-implemented method that includes at least: specifically programming at least one computer system or a portion of at least one computer system to perform at least one of the following: aggregate immigrant investor visas and/or immigrant investor visa funding including, but not limited to, EB-5 for investment in rail infrastructure; aggregate immigrant investor visas and/or immigrant investor visa funding including, but not limited to, EB-5 for credit enhancement; aggregate immigrant investor visas and/or immigrant investor visa funding including, but not limited to, EB-5 for guarantor loans.

### Rail Infrastructure and Recaptured Immigration Investor Visas/Recaptured EB-5 According to Some Embodiments:

Some embodiments of the invention comprise a computer-implemented method that includes at least: specifically programming at least one computer system or a portion of at least one computer system to perform at least one of the following: aggregate recaptured immigrant investor visas including, but not limited to, recaptured EB-5 for investment in rail infrastructure; aggregate recaptured immigrant investor visas including, but not limited to, recaptured EB-5 for credit enhancement; aggregate recaptured immigrant investor visas including, but not limited to, recaptured EB-5 for guarantor loans.

### Rail Infrastructure and Unused Immigration Investor Visas/Unused EB-5 According to Some Embodiments:

Some embodiments of the invention comprise a computer-implemented method that includes at least: specifically programming at least one computer system or a portion of at least one computer system to perform at least one of the following: aggregate unused immigrant investor visas including, but not limited to, unused EB-5 for investment in rail infrastructure; aggregate unused immigrant investor visas including, but not limited to, unused EB-5 for credit enhancement; aggregate unused immigrant investor visas including, but not limited to, unused EB-5 for guarantor loans.

### Highway Infrastructure According to Some Embodiments:

Some embodiments of the invention comprise a computer-implemented method that includes at least: specifically programming at least one computer system or a portion of at least one computer system to perform at least one of the following: aggregate immigrant investor visas and/or immigrant investor visa funding including, but not limited to, EB-5 for investment in highway infrastructure; aggregate recaptured immigrant investor visas including, but not limited to, recaptured EB-5 for investment in highway infrastructure; aggregate unused immigrant investor visas including, but not limited to, unused EB-5 for investment in highway infrastructure.

Some embodiments of the invention comprise a computer-implemented method that includes at least specifically programming at least one computer system or a portion of at least one computer system to perform at least one of the following: aggregate immigrant investor visas and/or immigrant investor visa funding including, but not limited to, EB-5, for the purposes of: investment in highway infrastructure; immigrant investor visa automated application processing; immigrant investor visa automated legal processing; immigrant investor visa automated expedited processing; immigrant investor visa automated authentication of source of funds processing; immigrant investor visa automated background check processing; immigrant investor visa automated national security related screening and processing; immigrant investor visa automated processing of visas including, but not limited to, EB-5 visas; immigrant investor visa automated processing of recaptured visas including, but not limited to, recaptured EB-5 visas; immigrant investor visa automated processing of unused visas including, but not limited to, unused EB-5 visas; automated processing of investment; automated processing of credit enhancement; and automated processing of loan guarantees and other types of financing.

Some embodiments of the invention comprise a method for aggregate funding including, but not limited to, immigrant investor visa funding including, but not limited to, EB-5 funding for investment: Step 1: aggregate immigrant investor visa funding including, but not limited to, EB-5 funding for investment in highway infrastructure; Step 2: aggregate immigrant investor visa funding including, but not limited to EB-5 funding, to be used as a PDP for investment in highway infrastructure; Step 3: aggregate immigrant investor visa funding including, but not limited to, EB-5 funding for investment; Step 4: aggregate funding to be used as credit enhancement; Step 5: aggregate funding to be used in and for guarantor loans.

Some embodiments of the invention comprise a computer-implemented method that includes at least specifically programming at least one computer system or a portion of at least one computer system to perform at least one of the following: aggregate immigrant investor visas and/or immigrant investor visa funding including, but not limited to, EB-5, for the purposes of: investment in highway infrastructure; immigrant investor visa automated application processing; immigrant investor visa automated legal processing; immigrant investor visa automated processing of recaptured visas including, but not limited to, recaptured EB-5 visas; immigrant investor visa automated processing of unused visas including, but not limited to, unused EB-5 visas; immigrant investor visa automated expedited processing; immigrant investor visa automated authentication of source of funds processing; immigrant investor visa automated background check processing; immigrant investor visa automated national security related screening and processing; automated processing of investment related to highway infrastructure; automated processing of credit enhancement related to highway infrastructure; and automated processing of loan guarantees related to highway infrastructure.

### Highway Infrastructure and Immigration Investor Visas/EB-5 According to Some Embodiments:

Some embodiments of the invention comprise a computer-implemented method that includes at least: specifically programming at least one computer system or a portion of at least one computer system to perform at least one of the following: aggregate immigrant investor visas and/or immigrant investor visa funding including, but not limited to, EB-5 for investment in highway infrastructure; aggregate immigrant investor visas and/or immigrant investor visa funding including, but not limited to, EB-5 for credit enhancement; aggregate immigrant investor visas and/or immigrant investor visa funding including, but not limited to, EB-5 for guarantor loans.

### Highway Infrastructure and Recaptured Immigration Investor Visas/Recaptured EB-5 According to Some Embodiments:

Some embodiments of the invention comprise a computer-implemented method that includes at least: specifically programming at least one computer system or a portion of at least one computer system to perform at least one of the following: aggregate recaptured immigrant investor visas including, but not limited to, recaptured EB-5 for investment in highway infrastructure; aggregate recaptured immigrant investor visas including, but not limited to, recaptured EB-5 for credit enhancement; aggregate recaptured immigrant investor visas including, but not limited to, recaptured EB-5 for guarantor loans.

### Highway Infrastructure and Unused Immigration Investor Visas/Unused EB-5 According to Some Embodiments:

Some embodiments of the invention comprise a computer-implemented method that includes at least: specifically programming at least one computer system or a portion of at least one computer system to perform at least one of the following: aggregate unused immigrant investor visas including, but not limited to, unused EB-5 for investment in highway infrastructure; aggregate unused immigrant investor visas including, but not limited to, unused EB-5 for credit enhancement; aggregate unused immigrant investor visas including, but not limited to, unused EB-5 for guarantor loans.

### Road Infrastructure According to Some Embodiments:

Some embodiments of the invention comprise a computer-implemented method that includes at least: specifically programming at least one computer system or a portion of at least one computer system to perform at least one of the following: aggregate immigrant investor visas and/or immigrant investor visa funding including, but not limited to, EB-5 for investment in road infrastructure; aggregate recaptured immigrant investor visas including, but not limited to, recaptured EB-5 for investment in road infrastructure; aggregate unused immigrant investor visas including, but not limited to, unused EB-5 for investment in road infrastructure.

Some embodiments of the invention comprise a computer-implemented method that includes at least specifically programming at least one computer system or a portion of at least one computer system to perform at least one of the following: aggregate immigrant investor visas and/or immigrant investor visa funding including, but not limited to, EB-5, for the purposes of: investment in road infrastructure; immigrant investor visa automated application processing; immigrant investor visa automated legal processing; immigrant investor visa automated expedited processing; immigrant investor visa automated authentication of source of funds processing; immigrant investor visa automated background check processing; immigrant investor visa automated national security related screening and processing; immigrant investor visa automated processing of visas including, but not limited to, EB-5 visas; immigrant investor visa automated processing of recaptured visas including, but not limited to, recaptured EB-5 visas; immigrant investor visa automated processing of unused visas including, but not limited to, unused EB-5 visas; automated processing of investment; automated processing of credit enhancement; and automated processing of loan guarantees and other types of financing.

Some embodiments of the invention comprise a method for aggregate funding including, but not limited to, immigrant investor visa funding including, but not limited to, EB-5 funding for investment: Step 1: aggregate immigrant investor visa funding including, but not limited to, EB-5 funding for investment in road infrastructure; Step 2: aggregate immigrant investor visa funding including, but not limited to EB-5 funding, to be used as a PDP for investment in road infrastructure; Step 3: aggregate immigrant investor visa funding including, but not limited to, EB-5 funding for investment; Step 4: aggregate funding to be used as credit enhancement; Step 5: aggregate funding to be used in and for guarantor loans.

Some embodiments of the invention comprise a computer-implemented method that includes at least specifically programming at least one computer system or a portion of at least one computer system to perform at least one of the following: aggregate immigrant investor visas and/or immigrant investor visa funding including, but not limited to, EB-5, for the purposes of: investment in road infrastructure; immigrant investor visa automated application processing; immigrant investor visa automated legal processing; immigrant investor visa automated processing of recaptured visas including, but not limited to, recaptured EB-5 visas; immigrant investor visa automated processing of unused visas including, but not limited to, unused EB-5 visas; immigrant investor visa automated expedited processing; immigrant investor visa automated authentication of source of funds processing; immigrant investor visa automated background check processing; immigrant investor visa automated national security related screening and processing; automated processing of investment related to road infrastructure; automated processing of credit enhancement related to road infrastructure; and automated processing of loan guarantees related to road infrastructure.

### Road Infrastructure and Immigration Investor Visas/EB-5 According to Some Embodiments:

Some embodiments of the invention comprise a computer-implemented method that includes at least: specifically programming at least one computer system or a portion of at least one computer system to perform at least one of the following: aggregate immigrant investor visas and/or immigrant investor visa funding including, but not limited to, EB-5 for investment in road infrastructure; aggregate immigrant investor visas and/or immigrant investor visa funding including, but not limited to, EB-5 for credit enhancement; aggregate immigrant investor visas and/or immigrant investor visa funding including, but not limited to, EB-5 for guarantor loans.

### Road Infrastructure and Recaptured Immigration Investor Visas/Recaptured EB-5 According to Some Embodiments:

Some embodiments of the invention comprise a computer-implemented method that includes at least: specifically programming at least one computer system or a portion of at least one computer system to perform at least one of the following: aggregate recaptured immigrant investor visas including, but not limited to, recaptured EB-5 for investment in road infrastructure; aggregate recaptured immigrant investor visas including, but not limited to, recaptured EB-5 for credit enhancement; aggregate recaptured immigrant investor visas including, but not limited to, recaptured EB-5 for guarantor loans.

### Road Infrastructure and Unused Immigration Investor Visas/Unused EB-5 According to Some Embodiments:

Some embodiments of the invention comprise a computer-implemented method that includes at least: specifically programming at least one computer system or a portion of at least one computer system to perform at least one of the following: aggregate unused immigrant investor visas including, but not limited to, unused EB-5 for investment in road infrastructure; aggregate unused immigrant investor visas including, but not limited to, unused EB-5 for credit enhancement; aggregate unused immigrant investor visas including, but not limited to, unused EB-5 for guarantor loans.

### Education According to Some Embodiments:

Some embodiments of the invention comprise a computer-implemented method that includes at least: specifically programming at least one computer system or a portion of at least one computer system to perform at least one of the following: aggregate immigrant investor visas and/or immigrant investor visa funding including, but not limited to, EB-5 for investment in education; aggregate recaptured immigrant investor visas including, but not limited to, recaptured EB-5 for investment in education; aggregate unused immigrant investor visas including, but not limited to, unused EB-5 for investment in education.

Some embodiments of the invention comprise a computer-implemented method that includes at least specifically programming at least one computer system or a portion of at least one computer system to perform at least one of the following: aggregate immigrant investor visas and/or immigrant investor visa funding including, but not limited to, EB-5, for the purposes of: investment in education; immigrant investor visa automated application processing; immigrant investor visa automated legal processing; immigrant investor visa automated expedited processing; immigrant investor visa automated authentication of source of funds processing; immigrant investor visa automated background check processing; immigrant investor visa automated national security related screening and processing; immigrant investor visa automated processing of visas including, but not limited to, EB-5 visas; immigrant investor visa automated processing of recaptured visas including, but not limited to, recaptured EB-5 visas; immigrant investor visa automated processing of unused visas including, but not limited to, unused EB-5 visas; automated processing of investment; automated processing of credit enhancement; and automated processing of loan guarantees and other types of financing.

Some embodiments of the invention comprise a method for aggregate funding including, but not limited to, immigrant investor visa funding including, but not limited to, EB-5 funding for investment: Step 1: aggregate immigrant investor visa funding including, but not limited to, EB-5 funding for investment in education; Step 2: aggregate immigrant investor visa funding including, but not limited to EB-5 funding, to be used as a PDP for investment in education; Step 3: aggregate immigrant investor visa funding including, but not limited to, EB-5 funding for investment; Step 4: aggregate funding to be used as credit enhancement; Step 5: aggregate funding to be used in and for guarantor loans.

Some embodiments of the invention comprise a computer-implemented method that includes at least specifically programming at least one computer system or a portion of at least one computer system to perform at least one of the following: aggregate immigrant investor visas and/or immigrant investor visa funding including, but not limited to, EB-5, for the purposes of: investment in education; immigrant investor visa automated application processing; immigrant investor visa automated legal processing; immigrant investor visa automated processing of recaptured visas including, but not limited to, recaptured EB-5 visas; immigrant investor visa automated processing of unused visas including, but not limited to, unused EB-5 visas; immigrant investor visa automated expedited processing; immigrant investor visa automated authentication of source of funds processing; immigrant investor visa automated background check processing; immigrant investor visa automated national security related screening and processing; automated processing of investment related to education; automated processing of credit enhancement related to education; and automated processing of loan guarantees related to education.

### Education and Immigration Investor Visas/EB-5 According to Some Embodiments:

Some embodiments of the invention comprise a computer-implemented method that includes at least: specifically programming at least one computer system or a portion of at least one computer system to perform at least one of the following: aggregate immigrant investor visas and/or immigrant investor visa funding including, but not limited to, EB-5 for investment in education; aggregate immigrant investor visas and/or immigrant investor visa funding including, but not limited to, EB-5 for credit enhancement; aggregate immigrant investor visas and/or immigrant investor visa funding including, but not limited to, EB-5 for guarantor loans.

### Education and Recaptured Immigration Investor Visas/Recaptured EB-5 According to Some Embodiments:

Some embodiments of the invention comprise a computer-implemented method that includes at least: specifically programming at least one computer system or a portion of at least one computer system to perform at least one of the following: aggregate recaptured immigrant investor visas including, but not limited to, recaptured EB-5 for investment in education; aggregate recaptured immigrant investor visas including, but not limited to, recaptured EB-5 for credit enhancement; aggregate recaptured immigrant investor visas including, but not limited to, recaptured EB-5 for guarantor loans.

### Education and Unused Immigration Investor Visas/Unused EB-5 According to Some Embodiments:

Some embodiments of the invention comprise a computer-implemented method that includes at least: specifically programming at least one computer system or a portion of at least one computer system to perform at least one of the following: aggregate unused immigrant investor visas including, but not limited to, unused EB-5 for investment in education; aggregate unused immigrant investor visas including, but not limited to, unused EB-5 for credit enhancement; aggregate unused immigrant investor visas including, but not limited to, unused EB-5 for guarantor loans.

### Energy Infrastructure According to Some Embodiments:

Some embodiments of the invention comprise a computer-implemented method that includes at least: specifically programming at least one computer system or a portion of at least one computer system to perform at least one of the following: aggregate immigrant investor visas and/or immigrant investor visa funding including, but not limited to, EB-5 for investment in energy infrastructure; aggregate recaptured immigrant investor visas including, but not limited to, recaptured EB-5 for investment in energy infrastructure; aggregate unused immigrant investor visas including, but not limited to, unused EB-5 for investment in energy infrastructure.

Some embodiments of the invention comprise a computer-implemented method that includes at least specifically programming at least one computer system or a portion of at least one computer system to perform at least one of the following: aggregate immigrant investor visas and/or immigrant investor visa funding including, but not limited to, EB-5, for the purposes of: investment in energy infrastructure; immigrant investor visa automated application processing; immigrant investor visa automated legal processing; immigrant investor visa automated expedited processing; immigrant investor visa automated authentication of source of funds processing; immigrant investor visa automated background check processing; immigrant investor visa automated national security related screening and processing; immigrant investor visa automated processing of visas including, but not limited to, EB-5 visas; immigrant investor visa automated processing of recaptured visas including, but not limited to, recaptured EB-5 visas; immigrant investor visa automated processing of unused visas including, but not limited to, unused EB-5 visas; automated processing of investment; automated processing of credit enhancement; and automated processing of loan guarantees and other types of financing.

Some embodiments of the invention comprise a method for aggregate funding including, but not limited to, immigrant investor visa funding including, but not limited to, EB-5 funding for investment: Step 1: aggregate immigrant investor visa funding including, but not limited to, EB-5 funding for investment in energy infrastructure; Step 2: aggregate immigrant investor visa funding including, but not limited to EB-5 funding, to be used as a PDP for investment in energy infrastructure; Step 3: aggregate immigrant investor visa funding including, but not limited to, EB-5 funding for investment; Step 4: aggregate funding to be used as credit enhancement; Step 5: aggregate funding to be used in and for guarantor loans.

Some embodiments of the invention comprise a computer-implemented method that includes at least specifically programming at least one computer system or a portion of at least one computer system to perform at least one of the following: aggregate immigrant investor visas and/or immigrant investor visa funding including, but not limited to, EB-5, for the purposes of: investment in energy infrastructure; immigrant investor visa automated application processing; immigrant investor visa automated legal processing; immigrant investor visa automated processing of recaptured visas including, but not limited to, recaptured EB-5 visas; immigrant investor visa automated processing of unused visas including, but not limited to, unused EB-5 visas; immigrant investor visa automated expedited processing; immigrant investor visa automated authentication of source of funds processing; immigrant investor visa automated background check processing; immigrant investor visa automated national security related screening and processing; automated processing of investment related to energy infrastructure; automated processing of credit enhancement related to energy infrastructure; and automated processing of loan guarantees related to energy infrastructure.

### Energy Infrastructure and Immigration Investor Visas/EB-5 According to Some Embodiments:

Some embodiments of the invention comprise a computer-implemented method that includes at least: specifically programming at least one computer system or a portion of at least one computer system to perform at least one of the following: aggregate immigrant investor visas and/or immigrant investor visa funding including, but not limited to, EB-5 for investment in energy infrastructure; aggregate immigrant investor visas and/or immigrant investor visa funding including, but not limited to, EB-5 for credit enhancement; aggregate immigrant investor visas and/or immigrant investor visa funding including, but not limited to, EB-5 for guarantor loans.

### Energy Infrastructure and Recaptured Immigration Investor Visas/Recaptured EB-5 According to Some Embodiments:

Some embodiments of the invention comprise a computer-implemented method that includes at least: specifically programming at least one computer system or a portion of at least one computer system to perform at least one of the following: aggregate recaptured immigrant investor visas including, but not limited to, recaptured EB-5 for investment in energy infrastructure; aggregate recaptured immigrant investor visas including, but not limited to, recaptured EB-5 for credit enhancement; aggregate recaptured immigrant investor visas including, but not limited to, recaptured EB-5 for guarantor loans.

### Energy Infrastructure and Unused Immigration Investor Visas/Unused EB-5 According to Some Embodiments:

Some embodiments of the invention comprise a computer-implemented method that includes at least: specifically programming at least one computer system or a portion of at least one computer system to perform at least one of the following: aggregate unused immigrant investor visas including, but not limited to, unused EB-5 for investment in energy infrastructure; aggregate unused immigrant investor visas including, but not limited to, unused EB-5 for credit enhancement; aggregate unused immigrant investor visas including, but not limited to, unused EB-5 for guarantor loans.

### Renewable Energy According to Some Embodiments:

Some embodiments of the invention comprise a computer-implemented method that includes at least: specifically programming at least one computer system or a portion of at least one computer system to perform at least one of the following: aggregate immigrant investor visas and/or immigrant investor visa funding including, but not limited to, EB-5 for investment in renewable energy; aggregate recaptured immigrant investor visas including, but not limited to, recaptured EB-5 for investment in renewable energy; aggregate unused immigrant investor visas including, but not limited to, unused EB-5 for investment in renewable energy.

Some embodiments of the invention comprise a computer-implemented method that includes at least specifically programming at least one computer system or a portion of at least one computer system to perform at least one of the following: aggregate immigrant investor visas and/or immigrant investor visa funding including, but not limited to, EB-5, for the purposes of: investment in renewable energy; immigrant investor visa automated application processing; immigrant investor visa automated legal processing; immigrant investor visa automated expedited processing; immigrant investor visa automated authentication of source of funds processing; immigrant investor visa automated background check processing; immigrant investor visa automated national security related screening and processing; immigrant investor visa automated processing of visas including, but not limited to, EB-5 visas; immigrant investor visa automated processing of recaptured visas including, but not limited to, recaptured EB-5 visas; immigrant investor visa automated processing of unused visas including, but not limited to, unused EB-5 visas; automated processing of investment; automated processing of credit enhancement; and automated processing of loan guarantees and other types of financing.

Some embodiments of the invention comprise a method for aggregate funding including, but not limited to, immigrant investor visa funding including, but not limited to, EB-5 funding for investment: Step 1: aggregate immigrant investor visa funding including, but not limited to, EB-5 funding for investment in renewable energy; Step 2: aggregate immigrant investor visa funding including, but not limited to EB-5 funding, to be used as a PDP for investment in renewable energy; Step 3: aggregate immigrant investor visa funding including, but not limited to, EB-5 funding for investment; Step 4: aggregate funding to be used as credit enhancement; Step 5: aggregate funding to be used in and for guarantor loans.

Some embodiments of the invention comprise a computer-implemented method that includes at least specifically programming at least one computer system or a portion of at least one computer system to perform at least one of the following: aggregate immigrant investor visas and/or immigrant investor visa funding including, but not limited to, EB-5, for the purposes of: investment in renewable energy; immigrant investor visa automated application processing; immigrant investor visa automated legal processing; immigrant investor visa automated processing of recaptured visas including, but not limited to, recaptured EB-5 visas; immigrant investor visa automated processing of unused visas including, but not limited to, unused EB-5 visas; immigrant investor visa automated expedited processing; immigrant investor visa automated authentication of source of funds processing; immigrant investor visa automated background check processing; immigrant investor visa automated national security related screening and processing; automated processing of investment related to renewable energy; automated processing of credit enhancement related to renewable energy; and automated processing of loan guarantees related to renewable energy.

### Renewable Energy and Immigration Investor Visas/EB-5 According to Some Embodiments:

Some embodiments of the invention comprise a computer-implemented method that includes at least: specifically programming at least one computer system or a portion of at least one computer system to perform at least one of the following: aggregate immigrant investor visas and/or immigrant investor visa funding including, but not limited to, EB-5 for investment in renewable energy; aggregate immigrant investor visas and/or immigrant investor visa funding including, but not limited to, EB-5 for credit enhancement; aggregate immigrant investor visas and/or immigrant investor visa funding including, but not limited to, EB-5 for guarantor loans.

### Renewable Energy and Recaptured Immigration Investor Visas/Recaptured EB-5 According to Some Embodiments:

Some embodiments of the invention comprise a computer-implemented method that includes at least: specifically programming at least one computer system or a portion of at least one computer system to perform at least one of the following: aggregate recaptured immigrant investor visas including, but not limited to, recaptured EB-5 for investment in renewable energy; aggregate recaptured immigrant investor visas including, but not limited to, recaptured EB-5 for credit enhancement; aggregate recaptured immigrant investor visas including, but not limited to, recaptured EB-5 for guarantor loans.

### Renewable Energy and Unused Immigration Investor Visas/Unused EB-5 According to Some Embodiments:

Some embodiments of the invention comprise a computer-implemented method that includes at least: specifically programming at least one computer system or a portion of at least one computer system to perform at least one of the following: aggregate unused immigrant investor visas including, but not limited to, unused EB-5 for investment in renewable energy; aggregate unused immigrant investor visas including, but not limited to, unused EB-5 for credit enhancement; aggregate unused immigrant investor visas including, but not limited to, unused EB-5 for guarantor loans.

### Nuclear Energy According to Some Embodiments:

Some embodiments of the invention comprise a computer-implemented method that includes at least: specifically programming at least one computer system or a portion of at least one computer system to perform at least one of the following: aggregate immigrant investor visas and/or immigrant investor visa funding including, but not limited to, EB-5 for investment in nuclear energy; aggregate recaptured immigrant investor visas including, but not limited to, recaptured EB-5 for investment in nuclear energy; aggregate unused immigrant investor visas including, but not limited to, unused EB-5 for investment in nuclear energy.

Some embodiments of the invention comprise a computer-implemented method that includes at least specifically programming at least one computer system or a portion of at least one computer system to perform at least one of the following: aggregate immigrant investor visas and/or immigrant investor visa funding including, but not limited to, EB-5, for the purposes of: investment in nuclear energy; immigrant investor visa automated application processing; immigrant investor visa automated legal processing; immigrant investor visa automated expedited processing; immigrant investor visa automated authentication of source of funds processing; immigrant investor visa automated background check processing; immigrant investor visa automated national security related screening and processing; immigrant investor visa automated processing of visas including, but not limited to, EB-5 visas; immigrant investor visa automated processing of recaptured visas including, but not limited to, recaptured EB-5 visas; immigrant investor visa automated processing of unused visas including, but not limited to, unused EB-5 visas; automated processing of investment; automated processing of credit enhancement; and automated processing of loan guarantees and other types of financing.

Some embodiments of the invention comprise a method for aggregate funding including, but not limited to, immigrant investor visa funding including, but not limited to, EB-5 funding for investment: Step 1: aggregate immigrant investor visa funding including, but not limited to, EB-5 funding for investment in nuclear energy; Step 2: aggregate immigrant investor visa funding including, but not limited to EB-5 funding, to be used as a PDP for investment in nuclear energy; Step 3: aggregate immigrant investor visa funding including, but not limited to, EB-5 funding for investment; Step 4: aggregate funding to be used as credit enhancement; Step 5: aggregate funding to be used in and for guarantor loans.

Some embodiments of the invention comprise a computer-implemented method that includes at least specifically programming at least one computer system or a portion of at least one computer system to perform at least one of the following: aggregate immigrant investor visas and/or immigrant investor visa funding including, but not limited to, EB-5, for the purposes of: investment in nuclear energy; immigrant investor visa automated application processing; immigrant investor visa automated legal processing; immigrant investor visa automated processing of recaptured visas including, but not limited to, recaptured EB-5 visas; immigrant investor visa automated processing of unused visas including, but not limited to, unused EB-5 visas; immigrant investor visa automated expedited processing; immigrant investor visa automated authentication of source of funds processing; immigrant investor visa automated background check processing; immigrant investor visa automated national security related screening and processing; automated processing of investment related to nuclear energy; automated processing of credit enhancement related to nuclear energy; and automated processing of loan guarantees related to nuclear energy.

### Nuclear Energy and Immigration Investor Visas/EB-5 According to Some Embodiments:

Some embodiments of the invention comprise a computer-implemented method that includes at least: specifically programming at least one computer system or a portion of at least one computer system to perform at least one of the following: aggregate immigrant investor visas and/or immigrant investor visa funding including, but not limited to, EB-5 for investment in nuclear energy; aggregate immigrant investor visas and/or immigrant investor visa funding including, but not limited to, EB-5 for credit enhancement; aggregate immigrant investor visas and/or immigrant investor visa funding including, but not limited to, EB-5 for guarantor loans.

### Nuclear Energy and Recaptured Immigration Investor Visas/Recaptured EB-5 According to Some Embodiments:

Some embodiments of the invention comprise a computer-implemented method that includes at least: specifically programming at least one computer system or a portion of at least one computer system to perform at least one of the following: aggregate recaptured immigrant investor visas including, but not limited to, recaptured EB-5 for investment in nuclear energy; aggregate recaptured immigrant investor visas including, but not limited to, recaptured EB-5 for credit enhancement; aggregate recaptured immigrant investor visas including, but not limited to, recaptured EB-5 for guarantor loans.

### Nuclear Energy and Unused Immigration Investor Visas/Unused EB-5 According to Some Embodiments:

Some embodiments of the invention comprise a computer-implemented method that includes at least: specifically programming at least one computer system or a portion of at least one computer system to perform at least one of the following: aggregate unused immigrant investor visas including, but not limited to, unused EB-5 for investment in nuclear energy; aggregate unused immigrant investor visas including, but not limited to, unused EB-5 for credit enhancement; aggregate unused immigrant investor visas including, but not limited to, unused EB-5 for guarantor loans.

### Civil Infrastructure According to Some Embodiments:

Some embodiments of the invention comprise a computer-implemented method that includes at least: specifically programming at least one computer system or a portion of at least one computer system to perform at least one of the following: aggregate immigrant investor visas and/or immigrant investor visa funding including, but not limited to, EB-5 for investment in civil infrastructure; aggregate recaptured immigrant investor visas including, but not limited to, recaptured EB-5 for investment in civil infrastructure; aggregate unused immigrant investor visas including, but not limited to, unused EB-5 for investment in civil infrastructure.

Some embodiments of the invention comprise a computer-implemented method that includes at least specifically programming at least one computer system or a portion of at least one computer system to perform at least one of the following: aggregate immigrant investor visas and/or immigrant investor visa funding including, but not limited to, EB-5, for the purposes of: investment in civil infrastructure; immigrant investor visa automated application processing; immigrant investor visa automated legal processing; immigrant investor visa automated expedited processing; immigrant investor visa automated authentication of source of funds processing; immigrant investor visa automated background check processing; immigrant investor visa automated national security related screening and processing; immigrant investor visa automated processing of visas including, but not limited to, EB-5 visas; immigrant investor visa automated processing of recaptured visas including, but not limited to, recaptured EB-5 visas; immigrant investor visa automated processing of unused visas including, but not limited to, unused EB-5 visas; automated processing of investment; automated processing of credit enhancement; and automated processing of loan guarantees and other types of financing.

Some embodiments of the invention comprise a method for aggregate funding including, but not limited to, immigrant investor visa funding including, but not limited to, EB-5 funding for investment: Step 1: aggregate immigrant investor visa funding including, but not limited to, EB-5 funding for investment in civil infrastructure; Step 2: aggregate immigrant investor visa funding including, but not limited to EB-5 funding, to be used as a PDP for investment in civil infrastructure; Step 3: aggregate immigrant investor visa funding including, but not limited to, EB-5 funding for investment; Step 4: aggregate funding to be used as credit enhancement; Step 5: aggregate funding to be used in and for guarantor loans.

Some embodiments of the invention comprise a computer-implemented method that includes at least specifically programming at least one computer system or a portion of at least one computer system to perform at least one of the following: aggregate immigrant investor visas and/or immigrant investor visa funding including, but not limited to, EB-5, for the purposes of: investment in civil infrastructure; immigrant investor visa automated application processing; immigrant investor visa automated legal processing; immigrant investor visa automated processing of recaptured visas including, but not limited to, recaptured EB-5 visas; immigrant investor visa automated processing of unused visas including, but not limited to, unused EB-5 visas; immigrant investor visa automated expedited processing; immigrant investor visa automated authentication of source of funds processing; immigrant investor visa automated background check processing; immigrant investor visa automated national security related screening and processing; automated processing of investment related to civil infrastructure; automated processing of credit enhancement related to civil infrastructure; and automated processing of loan guarantees related to civil infrastructure.

### Civil Infrastructure and Immigration Investor Visas/EB-5 According to Some Embodiments:

Some embodiments of the invention comprise a computer-implemented method that includes at least: specifically programming at least one computer system or a portion of at least one computer system to perform at least one of the following: aggregate immigrant investor visas and/or immigrant investor visa funding including, but not limited to, EB-5 for investment in civil infrastructure; aggregate immigrant investor visas and/or immigrant investor visa funding including, but not limited to, EB-5 for credit enhancement; aggregate immigrant investor visas and/or immigrant investor visa funding including, but not limited to, EB-5 for guarantor loans.

### Civil Infrastructure and Recaptured Immigration Investor Visas/Recaptured EB-5 According to Some Embodiments:

Some embodiments of the invention comprise a computer-implemented method that includes at least: specifically programming at least one computer system or a portion of at least one computer system to perform at least one of the following: aggregate recaptured immigrant investor visas including, but not limited to, recaptured EB-5 for investment in civil infrastructure; aggregate recaptured immigrant investor visas including, but not limited to, recaptured EB-5 for credit enhancement; aggregate recaptured immigrant investor visas including, but not limited to, recaptured EB-5 for guarantor loans.

### Civil Infrastructure and Unused Immigration Investor Visas/Unused EB-5 According to Some Embodiments:

Some embodiments of the invention comprise a computer-implemented method that includes at least: specifically programming at least one computer system or a portion of at least one computer system to perform at least one of the following: aggregate unused immigrant investor visas including, but not limited to, unused EB-5 for investment in civil infrastructure; aggregate unused immigrant investor visas including, but not limited to, unused EB-5 for credit enhancement; aggregate unused immigrant investor visas including, but not limited to, unused EB-5 for guarantor loans.

### Autonomous Vehicle Infrastructure According to Some Embodiments:

Some embodiments of the invention comprise a computer-implemented method that includes at least: specifically programming at least one computer system or a portion of at least one computer system to perform at least one of the following: aggregate immigrant investor visas and/or immigrant investor visa funding including, but not limited to, EB-5 for investment in autonomous vehicle infrastructure; aggregate recaptured immigrant investor visas including, but not limited to, recaptured EB-5 for investment in autonomous vehicle infrastructure; aggregate unused immigrant investor visas including, but not limited to, unused EB-5 for investment in autonomous vehicle infrastructure.

Some embodiments of the invention comprise a computer-implemented method that includes at least specifically programming at least one computer system or a portion of at least one computer system to perform at least one of the following: aggregate immigrant investor visas and/or immigrant investor visa funding including, but not limited to, EB-5, for the purposes of: investment in autonomous vehicle infrastructure; immigrant investor visa automated application processing; immigrant investor visa automated legal processing; immigrant investor visa automated expedited processing; immigrant investor visa automated authentication of source of investor visa automated national security related screening and processing; immigrant investor visa automated processing of visas including, but not limited to, EB-5 visas; immigrant investor visa automated processing of recaptured visas including, but not limited to, recaptured EB-5 visas; immigrant investor visa automated processing of unused visas including, but not limited to, unused EB-5 visas; automated processing of investment; automated processing of credit enhancement; and automated processing of loan guarantees and other types of financing.

Some embodiments of the invention comprise a method for aggregate funding including, but not limited to, immigrant investor visa funding including, but not limited to, EB-5 funding for investment: Step 1: aggregate immigrant investor visa funding including, but not limited to, EB-5 funding for investment in autonomous vehicle infrastructure; Step 2: aggregate immigrant investor visa funding including, but not limited to EB-5 funding, to be used as a PDP for investment in autonomous vehicle infrastructure; Step 3: aggregate immigrant investor visa funding including, but not limited to, EB-5 funding for investment; Step 4: aggregate funding to be used as credit enhancement; Step 5: aggregate funding to be used in and for guarantor loans.

Some embodiments of the invention comprise a computer-implemented method that includes at least specifically programming at least one computer system or a portion of at least one computer system to perform at least one of the following: aggregate immigrant investor visas and/or immigrant investor visa funding including, but not limited to, EB-5, for the purposes of: investment in autonomous vehicle infrastructure; immigrant investor visa automated application processing; immigrant investor visa automated legal processing; immigrant investor visa automated processing of recaptured visas including, but not limited to, recaptured EB-5 visas; immigrant investor visa automated processing of unused visas including, but not limited to, unused EB-5 visas; immigrant investor visa automated expedited processing; immigrant investor visa automated authentication of source of funds processing; immigrant investor visa automated background check processing; immigrant investor visa automated national security related screening and processing; automated processing of investment related to autonomous vehicle infrastructure; automated processing of credit enhancement related to autonomous vehicle infrastructure; and automated processing of loan guarantees related to autonomous vehicle infrastructure.

### Autonomous Vehicle Infrastructure and Immigration Investor Visas/EB-5 According to Some Embodiments:

Some embodiments of the invention comprise a computer-implemented method that includes at least: specifically programming at least one computer system or a portion of at least one computer system to perform at least one of the following: aggregate immigrant investor visas and/or immigrant investor visa funding including, but not limited to, EB-5 for investment in autonomous vehicle infrastructure; aggregate immigrant investor visas and/or immigrant investor visa funding including, but not limited to, EB-5 for credit enhancement; aggregate immigrant investor visas and/or immigrant investor visa funding including, but not limited to, EB-5 for guarantor loans.

### Autonomous Vehicle Infrastructure and Recaptured Immigration Investor Visas/Recaptured EB-5 According to Some Embodiments:

Some embodiments of the invention comprise a computer-implemented method that includes at least: specifically programming at least one computer system or a portion of at least one computer system to perform at least one of the following: aggregate recaptured immigrant investor visas including, but not limited to, recaptured EB-5 for investment in autonomous vehicle infrastructure; aggregate recaptured immigrant investor visas including, but not limited to, recaptured EB-5 for credit enhancement; aggregate recaptured immigrant investor visas including, but not limited to, recaptured EB-5 for guarantor loans.

### Autonomous Vehicle Infrastructure and Unused Immigration Investor Visas/Unused EB-5 According to Some Embodiments:

Some embodiments of the invention comprise a computer-implemented method that includes at least: specifically programming at least one computer system or a portion of at least one computer system to perform at least one of the following: aggregate unused immigrant investor visas including, but not limited to, unused EB-5 for investment in autonomous vehicle infrastructure; aggregate unused immigrant investor visas including, but not limited to, unused EB-5 for credit enhancement; aggregate unused immigrant investor visas including, but not limited to, unused EB-5 for guarantor loans.

### Flying Vehicle Infrastructure According to Some Embodiments:

Some embodiments of the invention comprise a computer-implemented method that includes at least: specifically programming at least one computer system or a portion of at least one computer system to perform at least one of the following: aggregate immigrant investor visas and/or immigrant investor visa funding including, but not limited to, EB-5 for investment in flying vehicle infrastructure; aggregate recaptured immigrant investor visas including, but not limited to, recaptured EB-5 for investment in flying vehicle infrastructure; aggregate unused immigrant investor visas including, but not limited to, unused EB-5 for investment in flying vehicle infrastructure.

Some embodiments of the invention comprise a computer-implemented method that includes at least specifically programming at least one computer system or a portion of at least one computer system to perform at least one of the following: aggregate immigrant investor visas and/or immigrant investor visa funding including, but not limited to, EB-5, for the purposes of: investment in flying vehicle infrastructure; immigrant investor visa automated application processing; immigrant investor visa automated legal processing; immigrant investor visa automated expedited processing; immigrant investor visa automated authentication of source of funds processing; immigrant investor visa automated background check processing; immigrant investor visa automated national security related screening and processing; immigrant investor visa automated processing of visas including, but not limited to, EB-5 visas; immigrant investor visa automated processing of recaptured visas including, but not limited to, recaptured EB-5 visas; immigrant investor visa automated processing of unused visas including, but not limited to, unused EB-5 visas; automated processing of investment; automated processing of credit enhancement; and automated processing of loan guarantees and other types of financing.

Some embodiments of the invention comprise a method for aggregate funding including, but not limited to, immigrant investor visa funding including, but not limited to, EB-5 funding for investment: Step 1: aggregate immigrant investor visa funding including, but not limited to, EB-5 funding for investment in flying vehicle infrastructure; Step 2: aggregate immigrant investor visa funding including, but not limited to EB-5 funding, to be used as a PDP for investment in flying vehicle infrastructure; Step 3: aggregate immigrant investor visa funding including, but not limited to, EB-5 funding for investment; Step 4: aggregate funding to be used as credit enhancement; Step 5: aggregate funding to be used in and for guarantor loans.

Some embodiments of the invention comprise a computer-implemented method that includes at least specifically programming at least one computer system or a portion of at least one computer system to perform at least one of the following: aggregate immigrant investor visas and/or immigrant investor visa funding including, but not limited to, EB-5, for the purposes of: investment in flying vehicle infrastructure; immigrant investor visa automated application processing; immigrant investor visa automated legal processing; immigrant investor visa automated processing of recaptured visas including, but not limited to, recaptured EB-5 visas; immigrant investor visa automated processing of unused visas including, but not limited to, unused EB-5 visas; immigrant investor visa automated expedited processing; immigrant investor visa automated authentication of source of funds processing; immigrant investor visa automated background check processing; immigrant investor visa automated national security related screening and processing; automated processing of investment related to flying vehicle infrastructure; automated processing of credit enhancement related to flying vehicle infrastructure; and automated processing of loan guarantees related to flying vehicle infrastructure.

### Flying Vehicle Infrastructure and Immigration Investor Visas/EB-5 According to Some Embodiments:

Some embodiments of the invention comprise a computer-implemented method that includes at least: specifically programming at least one computer system or a portion of at least one computer system to perform at least one of the following: aggregate immigrant investor visas and/or immigrant investor visa funding including, but not limited to, EB-5 for investment in flying vehicle infrastructure; aggregate immigrant investor visas and/or immigrant investor visa funding including, but not limited to, EB-5 for credit enhancement; aggregate immigrant investor visas and/or immigrant investor visa funding including, but not limited to, EB-5 for guarantor loans.

### Flying Vehicle Infrastructure and Recaptured Immigration Investor Visas/Recaptured EB-5 According to Some Embodiments:

Some embodiments of the invention comprise a computer-implemented method that includes at least: specifically programming at least one computer system or a portion of at least one computer system to perform at least one of the following: aggregate recaptured immigrant investor visas including, but not limited to, recaptured EB-5 for investment in flying vehicle infrastructure; aggregate recaptured immigrant investor visas including, but not limited to, recaptured EB-5 for credit enhancement; aggregate recaptured immigrant investor visas including, but not limited to, recaptured EB-5 for guarantor loans.

### Flying Vehicle Infrastructure and Unused Immigration Investor Visas/Unused EB-5 According to Some Embodiments:

Some embodiments of the invention comprise a computer-implemented method that includes at least: specifically programming at least one computer system or a portion of at least one computer system to perform at least one of the following: aggregate unused immigrant investor visas including, but not limited to, unused EB-5 for investment in flying vehicle infrastructure; aggregate unused immigrant investor visas including, but not limited to, unused EB-5 for credit enhancement; aggregate unused immigrant investor visas including, but not limited to, unused EB-5 for guarantor loans.

### Military Infrastructure According to Some Embodiments:

Some embodiments of the invention comprise a computer-implemented method that includes at least: specifically programming at least one computer system or a portion of at least one computer system to perform at least one of the following: aggregate immigrant investor visas and/or immigrant investor visa funding including, but not limited to, EB-5 for investment in military infrastructure; aggregate recaptured immigrant investor visas including, but not limited to, recaptured EB-5 for investment in military infrastructure; aggregate unused immigrant investor visas including, but not limited to, unused EB-5 for investment in military infrastructure.

Some embodiments of the invention comprise a computer-implemented method that includes at least specifically programming at least one computer system or a portion of at least one computer system to perform at least one of the following: aggregate immigrant investor visas and/or immigrant investor visa funding including, but not limited to, EB-5, for the purposes of: investment in military infrastructure; immigrant investor visa automated application processing; immigrant investor visa automated legal processing; immigrant investor visa automated expedited processing; immigrant investor visa automated authentication of source of funds processing; immigrant investor visa automated background check processing; immigrant investor visa automated national security related screening and processing; immigrant investor visa automated processing of visas including, but not limited to, EB-5 visas; immigrant investor visa automated processing of recaptured visas including, but not limited to, recaptured EB-5 visas; immigrant investor visa automated processing of unused visas including, but not limited to, unused EB-5 visas; automated processing of investment; automated processing of credit enhancement; and automated processing of loan guarantees and other types of financing.

Some embodiments of the invention comprise a method for aggregate funding including, but not limited to, immigrant investor visa funding including, but not limited to, EB-5 funding for investment: Step 1: aggregate immigrant investor visa funding including, but not limited to, EB-5 funding for investment in military infrastructure; Step 2: aggregate immigrant investor visa funding including, but not limited to EB-5 funding, to be used as a PDP for investment in military infrastructure; Step 3: aggregate immigrant investor visa funding including, but not limited to, EB-5 funding for investment; Step 4: aggregate funding to be used as credit enhancement; Step 5: aggregate funding to be used in and for guarantor loans.

Some embodiments of the invention comprise a computer-implemented method that includes at least specifically programming at least one computer system or a portion of at least one computer system to perform at least one of the following: aggregate immigrant investor visas and/or immigrant investor visa funding including, but not limited to, EB-5, for the purposes of: investment in military infrastructure; immigrant investor visa automated application processing; immigrant investor visa automated legal processing; immigrant investor visa automated processing of recaptured visas including, but not limited to, recaptured EB-5 visas; immigrant investor visa automated processing of unused visas including, but not limited to, unused EB-5 visas; immigrant investor visa automated expedited processing; immigrant investor visa automated authentication of source of funds processing; immigrant investor visa automated background check processing; immigrant investor visa automated national security related screening and processing; automated processing of investment related to military infrastructure; automated processing of credit enhancement related to military infrastructure; and automated processing of loan guarantees related to military infrastructure.

### Military Infrastructure and Immigration Investor Visas/EB-5 According to Some Embodiments:

Some embodiments of the invention comprise a computer-implemented method that includes at least: specifically programming at least one computer system or a portion of at least one computer system to perform at least one of the following: aggregate immigrant investor visas and/or immigrant investor visa funding including, but not limited to, EB-5 for investment in military infrastructure; aggregate immigrant investor visas and/or immigrant investor visa funding including, but not limited to, EB-5 for credit enhancement; aggregate immigrant investor visas and/or immigrant investor visa funding including, but not limited to, EB-5 for guarantor loans.

### Military Infrastructure and Recaptured Immigration Investor Visas/Recaptured EB-5 According to Some Embodiments:

Some embodiments of the invention comprise a computer-implemented method that includes at least: specifically programming at least one computer system or a portion of at least one computer system to perform at least one of the following: aggregate recaptured immigrant investor visas including, but not limited to, recaptured EB-5 for investment in military infrastructure; aggregate recaptured immigrant investor visas including, but not limited to, recaptured EB-5 for credit enhancement; aggregate recaptured immigrant investor visas including, but not limited to, recaptured EB-5 for guarantor loans.

### Military Infrastructure and Unused Immigration Investor Visas/Unused EB-5 According to Some Embodiments:

Some embodiments of the invention comprise a computer-implemented method that includes at least: specifically programming at least one computer system or a portion of at least one computer system to perform at least one of the following: aggregate unused immigrant investor visas including, but not limited to, unused EB-5 for investment in military infrastructure; aggregate unused immigrant investor visas including, but not limited to, unused EB-5 for credit enhancement; aggregate unused immigrant investor visas including, but not limited to, unused EB-5 for guarantor loans.

### Autonomous Vehicle Manufacturing According to Some Embodiments:

Some embodiments of the invention comprise a computer-implemented method that includes at least: specifically programming at least one computer system or a portion of at least one computer system to perform at least one of the following: aggregate immigrant investor visas and/or immigrant investor visa funding including, but not limited to, EB-5 for investment in autonomous vehicle manufacturing; aggregate recaptured immigrant investor visas including, but not limited to, recaptured EB-5 for investment in autonomous vehicle manufacturing; aggregate unused immigrant investor visas including, but not limited to, unused EB-5 for investment in autonomous vehicle manufacturing.

Some embodiments of the invention comprise a computer-implemented method that includes at least specifically programming at least one computer system or a portion of at least one computer system to perform at least one of the following: aggregate immigrant investor visas and/or immigrant investor visa funding including, but not limited to, EB-5, for the purposes of: investment in autonomous vehicle manufacturing; immigrant investor visa automated application processing; immigrant investor visa automated legal processing; immigrant investor visa automated expedited processing; immigrant investor visa automated authentication of source of funds processing; immigrant investor visa automated background check processing; immigrant investor visa automated national security related screening and processing; immigrant investor visa automated processing of visas including, but not limited to, EB-5 visas; immigrant investor visa automated processing of recaptured visas including, but not limited to, recaptured EB-5 visas; immigrant investor visa automated processing of unused visas including, but not limited to, unused EB-5 visas; automated processing of investment; automated processing of credit enhancement; and automated processing of loan guarantees and other types of financing.

Some embodiments of the invention comprise a method for aggregate funding including, but not limited to, immigrant investor visa funding including, but not limited to, EB-5 funding for investment: Step 1: aggregate immigrant investor visa funding including, but not limited to, EB-5 funding for investment in autonomous vehicle manufacturing; Step 2: aggregate immigrant investor visa funding including, but not limited to EB-5 funding, to be used as a PDP for investment in autonomous vehicle manufacturing; Step 3: aggregate immigrant investor visa funding including, but not limited to, EB-5 funding for investment; Step 4: aggregate funding to be used as credit enhancement; Step 5: aggregate funding to be used in and for guarantor loans.

Some embodiments of the invention comprise a computer-implemented method that includes at least specifically programming at least one computer system or a portion of at least one computer system to perform at least one of the following: aggregate immigrant investor visas and/or immigrant investor visa funding including, but not limited to, EB-5, for the purposes of: investment in autonomous vehicle manufacturing; immigrant investor visa automated application processing; immigrant investor visa automated legal processing; immigrant investor visa automated processing of recaptured visas including, but not limited to, recaptured EB-5 visas; immigrant investor visa automated processing of unused visas including, but not limited to, unused EB-5 visas; immigrant investor visa automated expedited processing; immigrant investor visa automated authentication of source of funds processing; immigrant investor visa automated background check processing; immigrant investor visa automated national security related screening and processing; automated processing of investment related to autonomous vehicle manufacturing; automated processing of credit enhancement related to autonomous vehicle manufacturing; and automated processing of loan guarantees related to autonomous vehicle manufacturing.

### Autonomous Vehicle Manufacturing and Immigration Investor Visas/EB-5 According to Some Embodiments:

Some embodiments of the invention comprise a computer-implemented method that includes at least: specifically programming at least one computer system or a portion of at least one computer system to perform at least one of the following: aggregate immigrant investor visas and/or immigrant investor visa funding including, but not limited to, EB-5 for investment in autonomous vehicle manufacturing; aggregate immigrant investor visas and/or immigrant investor visa funding including, but not limited to, EB-5 for credit enhancement; aggregate immigrant investor visas and/or immigrant investor visa funding including, but not limited to, EB-5 for guarantor loans.

### Autonomous Vehicle Manufacturing and Recaptured Immigration Investor Visas/Recaptured EB-5 According to Some Embodiments:

Some embodiments of the invention comprise a computer-implemented method that includes at least: specifically programming at least one computer system or a portion of at least one computer system to perform at least one of the following: aggregate recaptured immigrant investor visas including, but not limited to, recaptured EB-5 for investment in autonomous vehicle manufacturing; aggregate recaptured immigrant investor visas including, but not limited to, recaptured EB-5 for credit enhancement; aggregate recaptured immigrant investor visas including, but not limited to, recaptured EB-5 for guarantor loans.

### Autonomous Vehicle Manufacturing and Unused Immigration Investor Visas/Unused EB-5 According to Some Embodiments:

Some embodiments of the invention comprise a computer-implemented method that includes at least: specifically programming at least one computer system or a portion of at least one computer system to perform at least one of the following: aggregate unused immigrant investor visas including, but not limited to, unused EB-5 for investment in autonomous vehicle manufacturing; aggregate unused immigrant investor visas including, but not limited to, unused EB-5 for credit enhancement; aggregate unused immigrant investor visas including, but not limited to, unused EB-5 for guarantor loans.

### Flying Vehicle Manufacturing According to Some Embodiments:

Some embodiments of the invention comprise a computer-implemented method that includes at least: specifically programming at least one computer system or a portion of at least one computer system to perform at least one of the following: aggregate immigrant investor visas and/or immigrant investor visa funding including, but not limited to, EB-5 for investment in flying vehicle manufacturing; aggregate recaptured immigrant investor visas including, but not limited to, recaptured EB-5 for investment in flying vehicle manufacturing; aggregate unused immigrant investor visas including, but not limited to, unused EB-5 for investment in flying vehicle manufacturing.

Some embodiments of the invention comprise a computer-implemented method that includes at least specifically programming at least one computer system or a portion of at least one computer system to perform at least one of the following: aggregate immigrant investor visas and/or immigrant investor visa funding including, but not limited to, EB-5, for the purposes of: investment in flying vehicle manufacturing; immigrant investor visa automated application processing; immigrant investor visa automated legal processing; immigrant investor visa automated expedited processing; immigrant investor visa automated authentication of source of funds processing; immigrant investor visa automated background check processing; immigrant investor visa automated national security related screening and processing; immigrant investor visa automated processing of visas including, but not limited to, EB-5 visas; immigrant investor visa automated processing of recaptured visas including, but not limited to, recaptured EB-5 visas; immigrant investor visa automated processing of unused visas including, but not limited to, unused EB-5 visas; automated processing of investment; automated processing of credit enhancement; and automated processing of loan guarantees and other types of financing.

Some embodiments of the invention comprise a method for aggregate funding including, but not limited to, immigrant investor visa funding including, but not limited to, EB-5 funding for investment: Step 1: aggregate immigrant investor visa funding including, but not limited to, EB-5 funding for investment in flying vehicle manufacturing; Step 2: aggregate immigrant investor visa funding including, but not limited to EB-5 funding, to be used as a PDP for investment in flying vehicle manufacturing; Step 3: aggregate immigrant investor visa funding including, but not limited to, EB-5 funding for investment; Step 4: aggregate funding to be used as credit enhancement; Step 5: aggregate funding to be used in and for guarantor loans.

Some embodiments of the invention comprise a computer-implemented method that includes at least specifically programming at least one computer system or a portion of at least one computer system to perform at least one of the following: aggregate immigrant investor visas and/or immigrant investor visa funding including, but not limited to, EB-5, for the purposes of: investment in flying vehicle manufacturing; immigrant investor visa automated application processing; immigrant investor visa automated legal processing; immigrant investor visa automated processing of recaptured visas including, but not limited to, recaptured EB-5 visas; immigrant investor visa automated processing of unused visas including, but not limited to, unused EB-5 visas; immigrant investor visa automated expedited processing; immigrant investor visa automated authentication of source of funds processing; immigrant investor visa automated background check processing; immigrant investor visa automated national security related screening and processing; automated processing of investment related to flying vehicle manufacturing; automated processing of credit enhancement related to flying vehicle manufacturing; and automated processing of loan guarantees related to flying vehicle manufacturing.

### Flying Vehicle Manufacturing and Immigration Investor Visas/EB-5 According to Some Embodiments:

Some embodiments of the invention comprise a computer-implemented method that includes at least: specifically programming at least one computer system or a portion of at least one computer system to perform at least one of the following: aggregate immigrant investor visas and/or immigrant investor visa funding including, but not limited to, EB-5 for investment in flying vehicle manufacturing; aggregate immigrant investor visas and/or immigrant investor visa funding including, but not limited to, EB-5 for credit enhancement; aggregate immigrant investor visas and/or immigrant investor visa funding including, but not limited to, EB-5 for guarantor loans.

### Flying Vehicle Manufacturing and Recaptured Immigration Investor Visas/Recaptured EB-5 According to Some Embodiments:

Some embodiments of the invention comprise a computer-implemented method that includes at least: specifically programming at least one computer system or a portion of at least one computer system to perform at least one of the following: aggregate recaptured immigrant investor visas including, but not limited to, recaptured EB-5 for investment in flying vehicle manufacturing; aggregate recaptured immigrant investor visas including, but not limited to, recaptured EB-5 for credit enhancement; aggregate recaptured immigrant investor visas including, but not limited to, recaptured EB-5 for guarantor loans.

### Flying Vehicle Manufacturing and Unused Immigration Investor Visas/Unused EB-5 According to Some Embodiments:

Some embodiments of the invention comprise a computer-implemented method that includes at least: specifically programming at least one computer system or a portion of at least one computer system to perform at least one of the following: aggregate unused immigrant investor visas including, but not limited to, unused EB-5 for investment in flying vehicle manufacturing; aggregate unused immigrant investor visas including, but not limited to, unused EB-5 for credit enhancement; aggregate unused immigrant investor visas including, but not limited to, unused EB-5 for guarantor loans.

### Cryptocurrency According to Some Embodiments:

Some embodiments of the invention comprise a computer-implemented method that includes at least: specifically programming at least one computer system or a portion of at least one computer system to perform at least one of the following: aggregate immigrant investor visas and/or immigrant investor visa funding including, but not limited to, EB-5 for investment in cryptocurrency; aggregate recaptured immigrant investor visas including, but not limited to, recaptured EB-5 for investment in cryptocurrency; aggregate unused immigrant investor visas including, but not limited to, unused EB-5 for investment in cryptocurrency.

Some embodiments of the invention comprise a computer-implemented method that includes at least specifically programming at least one computer system or a portion of at least one computer system to perform at least one of the following: aggregate immigrant investor visas and/or immigrant investor visa funding including, but not limited to, EB-5, for the purposes of: investment in cryptocurrency; immigrant investor visa automated application processing; immigrant investor visa automated legal processing; immigrant investor visa automated expedited processing; immigrant investor visa automated authentication of source of funds processing; immigrant investor visa automated background check processing; immigrant investor visa automated national security related screening and processing; immigrant investor visa automated processing of visas including, but not limited to, EB-5 visas; immigrant investor visa automated processing of recaptured visas including, but not limited to, recaptured EB-5 visas; immigrant investor visa automated processing of unused visas including, but not limited to, unused EB-5 visas; automated processing of investment; automated processing of credit enhancement; and automated processing of loan guarantees and other types of financing.

Some embodiments of the invention comprise a method for aggregate funding including, but not limited to, immigrant investor visa funding including, but not limited to, EB-5 funding for investment: Step 1: aggregate immigrant investor visa funding including, but not limited to, EB-5 funding for investment in cryptocurrency; Step 2: aggregate immigrant investor visa funding including, but not limited to EB-5 funding, to be used as a PDP for investment in cryptocurrency; Step 3: aggregate immigrant investor visa funding including, but not limited to, EB-5 funding for investment; Step 4: aggregate funding to be used as credit enhancement; Step 5: aggregate funding to be used in and for guarantor loans.

Some embodiments of the invention comprise a computer-implemented method that includes at least specifically programming at least one computer system or a portion of at least one computer system to perform at least one of the following: aggregate immigrant investor visas and/or immigrant investor visa funding including, but not limited to, EB-5, for the purposes of: investment in cryptocurrency; immigrant investor visa automated application processing; immigrant investor visa automated legal processing; immigrant investor visa automated processing of recaptured visas including, but not limited to, recaptured EB-5 visas; immigrant investor visa automated processing of unused visas including, but not limited to, unused EB-5 visas; immigrant investor visa automated expedited processing; immigrant investor visa automated authentication of source of funds processing; immigrant investor visa automated background check processing; immigrant investor visa automated national security related screening and processing; automated processing of investment related to cryptocurrency; automated processing of credit enhancement related to cryptocurrency; and automated processing of loan guarantees related to cryptocurrency.

### Cryptocurrency and Immigration Investor Visas/EB-5 According to Some Embodiments:

Some embodiments of the invention comprise a computer-implemented method that includes at least: specifically programming at least one computer system or a portion of at least one computer system to perform at least one of the following: aggregate immigrant investor visas and/or immigrant investor visa funding including, but not limited to, EB-5 for investment in cryptocurrency; aggregate immigrant investor visas and/or immigrant investor visa funding including, but not limited to, EB-5 for credit enhancement; aggregate immigrant investor visas and/or immigrant investor visa funding including, but not limited to, EB-5 for guarantor loans.

### Cryptocurrency and Recaptured Immigration Investor Visas/Recaptured EB-5 According to Some Embodiments:

Some embodiments of the invention comprise a computer-implemented method that includes at least: specifically programming at least one computer system or a portion of at least one computer system to perform at least one of the following: aggregate recaptured immigrant investor visas including, but not limited to, recaptured EB-5 for investment in cryptocurrency; aggregate recaptured immigrant investor visas including, but not limited to, recaptured EB-5 for credit enhancement; aggregate recaptured immigrant investor visas including, but not limited to, recaptured EB-5 for guarantor loans.

### Cryptocurrency and Unused Immigration Investor Visas/Unused EB-5 According to Some Embodiments:

Some embodiments of the invention comprise a computer-implemented method that includes at least: specifically programming at least one computer system or a portion of at least one computer system to perform at least one of the following: aggregate unused immigrant investor visas including, but not limited to, unused EB-5 for investment in cryptocurrency; aggregate unused immigrant investor visas including, but not limited to, unused EB-5 for credit enhancement; aggregate unused immigrant investor visas including, but not limited to, unused EB-5 for guarantor loans.

### Blockchain According to Some Embodiments:

Some embodiments of the invention comprise a computer-implemented method that includes at least: specifically programming at least one computer system or a portion of at least one computer system to perform at least one of the following: aggregate immigrant investor visas and/or immigrant investor visa funding including, but not limited to, EB-5 for investment in blockchain; aggregate recaptured immigrant investor visas including, but not limited to, recaptured EB-5 for investment in blockchain; aggregate unused immigrant investor visas including, but not limited to, unused EB-5 for investment in blockchain.

Some embodiments of the invention comprise a computer-implemented method that includes at least specifically programming at least one computer system or a portion of at least one computer system to perform at least one of the following: aggregate immigrant investor visas and/or immigrant investor visa funding including, but not limited to, EB-5, for the purposes of: investment in blockchain; immigrant investor visa automated application processing; immigrant investor visa automated legal processing; immigrant investor visa automated expedited processing; immigrant investor visa automated authentication of source of funds processing; immigrant investor visa automated background check processing; immigrant investor visa automated national security related screening and processing; immigrant investor visa automated processing of visas including, but not limited to, EB-5 visas; immigrant investor visa automated processing of recaptured visas including, but not limited to, recaptured EB-5 visas; immigrant investor visa automated processing of unused visas including, but not limited to, unused EB-5 visas; automated processing of investment; automated processing of credit enhancement; and automated processing of loan guarantees and other types of financing.

Some embodiments of the invention comprise a method for aggregate funding including, but not limited to, immigrant investor visa funding including, but not limited to, EB-5 funding for investment: Step 1: aggregate immigrant investor visa funding including, but not limited to, EB-5 funding for investment in blockchain; Step 2: aggregate immigrant investor visa funding including, but not limited to EB-5 funding, to be used as a PDP for investment in blockchain; Step 3: aggregate immigrant investor visa funding including, but not limited to, EB-5 funding for investment; Step 4: aggregate funding to be used as credit enhancement; Step 5: aggregate funding to be used in and for guarantor loans.

Some embodiments of the invention comprise a computer-implemented method that includes at least specifically programming at least one computer system or a portion of at least one computer system to perform at least one of the following: aggregate immigrant investor visas and/or immigrant investor visa funding including, but not limited to, EB-5, for the purposes of: investment in blockchain; immigrant investor visa automated application processing; immigrant investor visa automated legal processing; immigrant investor visa automated processing of recaptured visas including, but not limited to, recaptured EB-5 visas; immigrant investor visa automated processing of unused visas including, but not limited to, unused EB-5 visas; immigrant investor visa automated expedited processing; immigrant investor visa automated authentication of source of funds processing; immigrant investor visa automated background check processing; immigrant investor visa automated national security related screening and processing; automated processing of investment related to blockchain; automated processing of credit enhancement related to blockchain; and automated processing of loan guarantees related to blockchain.

### Blockchain and Immigration Investor Visas/EB-5 According to Some Embodiments:

Some embodiments of the invention comprise a computer-implemented method that includes at least: specifically programming at least one computer system or a portion of at least one computer system to perform at least one of the following: aggregate immigrant investor visas and/or immigrant investor visa funding including, but not limited to, EB-5 for investment in blockchain; aggregate immigrant investor visas and/or immigrant investor visa funding including, but not limited to, EB-5 for credit enhancement; aggregate immigrant investor visas and/or immigrant investor visa funding including, but not limited to, EB-5 for guarantor loans.

### Blockchain and Recaptured Immigration Investor Visas/Recaptured EB-5 According to Some Embodiments:

Some embodiments of the invention comprise a computer-implemented method that includes at least: specifically programming at least one computer system or a portion of at least one computer system to perform at least one of the following: aggregate recaptured immigrant investor visas including, but not limited to, recaptured EB-5 for investment in blockchain; aggregate recaptured immigrant investor visas including, but not limited to, recaptured EB-5 for credit enhancement; aggregate recaptured immigrant investor visas including, but not limited to, recaptured EB-5 for guarantor loans.

### Blockchain and Unused Immigration Investor Visas/Unused EB-5 According to Some Embodiments:

Some embodiments of the invention comprise a computer-implemented method that includes at least: specifically programming at least one computer system or a portion of at least one computer system to perform at least one of the following: aggregate unused immigrant investor visas including, but not limited to, unused EB-5 for investment in blockchain; aggregate unused immigrant investor visas including, but not limited to, unused EB-5 for credit enhancement; aggregate unused immigrant investor visas including, but not limited to, unused EB-5 for guarantor loans.

### Military Hardware According to Some Embodiments:

Some embodiments of the invention comprise a computer-implemented method that includes at least: specifically programming at least one computer system or a portion of at least one computer system to perform at least one of the following: aggregate immigrant investor visas and/or immigrant investor visa funding including, but not limited to, EB-5 for investment in military hardware; aggregate recaptured immigrant investor visas including, but not limited to, recaptured EB-5 for investment in military hardware; aggregate unused immigrant investor visas including, but not limited to, unused EB-5 for investment in military hardware.

Some embodiments of the invention comprise a computer-implemented method that includes at least specifically programming at least one computer system or a portion of at least one computer system to perform at least one of the following: aggregate immigrant investor visas and/or immigrant investor visa funding including, but not limited to, EB-5, for the purposes of: investment in military hardware; immigrant investor visa automated application processing; immigrant investor visa automated legal processing; immigrant investor visa automated expedited processing; immigrant investor visa automated authentication of source of funds processing; immigrant investor visa automated background check processing; immigrant investor visa automated national security related screening and processing; immigrant investor visa automated processing of visas including, but not limited to, EB-5 visas; immigrant investor visa automated processing of recaptured visas including, but not limited to, recaptured EB-5 visas; immigrant investor visa automated processing of unused visas including, but not limited to, unused EB-5 visas; automated processing of investment; automated processing of credit enhancement; and automated processing of loan guarantees and other types of financing.

Some embodiments of the invention comprise a method for aggregate funding including, but not limited to, immigrant investor visa funding including, but not limited to, EB-5 funding for investment: Step 1: aggregate immigrant investor visa funding including, but not limited to, EB-5 funding for investment in military hardware; Step 2: aggregate immigrant investor visa funding including, but not limited to EB-5 funding, to be used as a PDP for investment in military hardware; Step 3: aggregate immigrant investor visa funding including, but not limited to, EB-5 funding for investment; Step 4: aggregate funding to be used as credit enhancement; Step 5: aggregate funding to be used in and for guarantor loans.

Some embodiments of the invention comprise a computer-implemented method that includes at least specifically programming at least one computer system or a portion of at least one computer system to perform at least one of the following: aggregate immigrant investor visas and/or immigrant investor visa funding including, but not limited to, EB-5, for the purposes of: investment in military hardware; immigrant investor visa automated application processing; immigrant investor visa automated legal processing; immigrant investor visa automated processing of recaptured visas including, but not limited to, recaptured EB-5 visas; immigrant investor visa automated processing of unused visas including, but not limited to, unused EB-5 visas; immigrant investor visa automated expedited processing; immigrant investor visa automated authentication of source of funds processing; immigrant investor visa automated background check processing; immigrant investor visa automated national security related screening and processing; automated processing of investment related to military hardware; automated processing of credit enhancement related to military hardware; and automated processing of loan guarantees related to military hardware.

### Military Hardware and Immigration Investor Visas/EB-5 According to Some Embodiments:

Some embodiments of the invention comprise a computer-implemented method that includes at least: specifically programming at least one computer system or a portion of at least one computer system to perform at least one of the following: aggregate immigrant investor visas and/or immigrant investor visa funding including, but not limited to, EB-5 for investment in military hardware; aggregate immigrant investor visas and/or immigrant investor visa funding including, but not limited to, EB-5 for credit enhancement; aggregate immigrant investor visas and/or immigrant investor visa funding including, but not limited to, EB-5 for guarantor loans.

### Military Hardware and Recaptured Immigration Investor Visas/Recaptured EB-5 According to Some Embodiments:

Some embodiments of the invention comprise a computer-implemented method that includes at least: specifically programming at least one computer system or a portion of at least one computer system to perform at least one of the following: aggregate recaptured immigrant investor visas including, but not limited to, recaptured EB-5 for investment in military hardware; aggregate recaptured immigrant investor visas including, but not limited to, recaptured EB-5 for credit enhancement; aggregate recaptured immigrant investor visas including, but not limited to, recaptured EB-5 for guarantor loans.

### Military Hardware and Unused Immigration Investor Visas/Unused EB-5 According to Some Embodiments:

Some embodiments of the invention comprise a computer-implemented method that includes at least: specifically programming at least one computer system or a portion of at least one computer system to perform at least one of the following: aggregate unused immigrant investor visas including, but not limited to, unused EB-5 for investment in military hardware; aggregate unused immigrant investor visas including, but not limited to, unused EB-5 for credit enhancement; aggregate unused immigrant investor visas including, but not limited to, unused EB-5 for guarantor loans.

### Automobile Manufacturing According to Some Embodiments:

Some embodiments of the invention comprise a computer-implemented method that includes at least: specifically programming at least one computer system or a portion of at least one computer system to perform at least one of the following: aggregate immigrant investor visas and/or immigrant investor visa funding including, but not limited to, EB-5 for investment in automobile manufacturing; aggregate recaptured immigrant investor visas including, but not limited to, recaptured EB-5 for investment in automobile manufacturing; aggregate unused immigrant investor visas including, but not limited to, unused EB-5 for investment in automobile manufacturing.

Some embodiments of the invention comprise a computer-implemented method that includes at least specifically programming at least one computer system or a portion of at least one computer system to perform at least one of the following: aggregate immigrant investor visas and/or immigrant investor visa funding including, but not limited to, EB-5, for the purposes of: investment in automobile manufacturing; immigrant investor visa automated application processing; immigrant investor visa automated legal processing; immigrant investor visa automated expedited processing; immigrant investor visa automated authentication of source of funds processing; immigrant investor visa automated background check processing; immigrant investor visa automated national security related screening and processing; immigrant investor visa automated processing of visas including, but not limited to, EB-5 visas; immigrant investor visa automated processing of recaptured visas including, but not limited to, recaptured EB-5 visas; immigrant investor visa automated processing of unused visas including, but not limited to, unused EB-5 visas; automated processing of investment; automated processing of credit enhancement; and automated processing of loan guarantees and other types of financing.

Some embodiments of the invention comprise a method for aggregate funding including, but not limited to, immigrant investor visa funding including, but not limited to, EB-5 funding for investment: Step 1: aggregate immigrant investor visa funding including, but not limited to, EB-5 funding for investment in automobile manufacturing; Step 2: aggregate immigrant investor visa funding including, but not limited to EB-5 funding, to be used as a PDP for investment in automobile manufacturing; Step 3: aggregate immigrant investor visa funding including, but not limited to, EB-5 funding for investment; Step 4: aggregate funding to be used as credit enhancement; Step 5: aggregate funding to be used in and for guarantor loans.

Some embodiments of the invention comprise a computer-implemented method that includes at least specifically programming at least one computer system or a portion of at least one computer system to perform at least one of the following: aggregate immigrant investor visas and/or immigrant investor visa funding including, but not limited to, EB-5, for the purposes of: investment in automobile manufacturing; immigrant investor visa automated application processing; immigrant investor visa automated legal processing; immigrant investor visa automated processing of recaptured visas including, but not limited to, recaptured EB-5 visas; immigrant investor visa automated processing of unused visas including, but not limited to, unused EB-5 visas; immigrant investor visa automated expedited processing; immigrant investor visa automated authentication of source of funds processing; immigrant investor visa automated background check processing; immigrant investor visa automated national security related screening and processing; automated processing of investment related to automobile manufacturing; automated processing of credit enhancement related to automobile manufacturing; and automated processing of loan guarantees related to automobile manufacturing.

### Automobile Manufacturing and Immigration Investor Visas/EB-5 According to Some Embodiments:

Some embodiments of the invention comprise a computer-implemented method that includes at least: specifically programming at least one computer system or a portion of at least one computer system to perform at least one of the following: aggregate immigrant investor visas and/or immigrant investor visa funding including, but not limited to, EB-5 for investment in automobile manufacturing; aggregate immigrant investor visas and/or immigrant investor visa funding including, but not limited to, EB-5 for credit enhancement; aggregate immigrant investor visas and/or immigrant investor visa funding including, but not limited to, EB-5 for guarantor loans.

### Automobile Manufacturing and Recaptured Immigration Investor Visas/Recaptured EB-5 According to Some Embodiments:

Some embodiments of the invention comprise a computer-implemented method that includes at least: specifically programming at least one computer system or a portion of at least one computer system to perform at least one of the following: aggregate recaptured immigrant investor visas including, but not limited to, recaptured EB-5 for investment in automobile manufacturing; aggregate recaptured immigrant investor visas including, but not limited to, recaptured EB-5 for credit enhancement; aggregate recaptured immigrant investor visas including, but not limited to, recaptured EB-5 for guarantor loans.

### Automobile Manufacturing and Unused Immigration Investor Visas/Unused EB-5 According to Some Embodiments:

Some embodiments of the invention comprise a computer-implemented method that includes at least: specifically programming at least one computer system or a portion of at least one computer system to perform at least one of the following: aggregate unused immigrant investor visas including, but not limited to, unused EB-5 for investment in automobile manufacturing; aggregate unused immigrant investor visas including, but not limited to, unused EB-5 for credit enhancement; aggregate unused immigrant investor visas including, but not limited to, unused EB-5 for guarantor loans.

### Aircraft Manufacturing According to Some Embodiments:

Some embodiments of the invention comprise a computer-implemented method that includes at least: specifically programming at least one computer system or a portion of at least one computer system to perform at least one of the following: aggregate immigrant investor visas and/or immigrant investor visa funding including, but not limited to, EB-5 for investment in aircraft manufacturing; aggregate recaptured immigrant investor visas including, but not limited to, recaptured EB-5 for investment in aircraft manufacturing; aggregate unused immigrant investor visas including, but not limited to, unused EB-5 for investment in aircraft manufacturing.

Some embodiments of the invention comprise a computer-implemented method that includes at least specifically programming at least one computer system or a portion of at least one computer system to perform at least one of the following: aggregate immigrant investor visas and/or immigrant investor visa funding including, but not limited to, EB-5, for the purposes of: investment in aircraft manufacturing; immigrant investor visa automated application processing; immigrant investor visa automated legal processing; immigrant investor visa automated expedited processing; immigrant investor visa automated authentication of source of funds processing; immigrant investor visa automated background check processing; immigrant investor visa automated national security related screening and processing; immigrant investor visa automated processing of visas including, but not limited to, EB-5 visas; immigrant investor visa automated processing of recaptured visas including, but not limited to, recaptured EB-5 visas; immigrant investor visa automated processing of unused visas including, but not limited to, unused EB-5 visas; automated processing of investment; automated processing of credit enhancement; and automated processing of loan guarantees and other types of financing.

Some embodiments of the invention comprise a method for aggregate funding including, but not limited to, immigrant investor visa funding including, but not limited to, EB-5 funding for investment: Step 1: aggregate immigrant investor visa funding including, but not limited to, EB-5 funding for investment in aircraft manufacturing; Step 2: aggregate immigrant investor visa funding including, but not limited to EB-5 funding, to be used as a PDP for investment in aircraft manufacturing; Step 3: aggregate immigrant investor visa funding including, but not limited to, EB-5 funding for investment; Step 4: aggregate funding to be used as credit enhancement; Step 5: aggregate funding to be used in and for guarantor loans.

Some embodiments of the invention comprise a computer-implemented method that includes at least specifically programming at least one computer system or a portion of at least one computer system to perform at least one of the following: aggregate immigrant investor visas and/or immigrant investor visa funding including, but not limited to, EB-5, for the purposes of: investment in aircraft manufacturing; immigrant investor visa automated application processing; immigrant investor visa automated legal processing; immigrant investor visa automated processing of recaptured visas including, but not limited to, recaptured EB-5 visas; immigrant investor visa automated processing of unused visas including, but not limited to, unused EB-5 visas; immigrant investor visa automated expedited processing; immigrant investor visa automated authentication of source of funds processing; immigrant investor visa automated background check processing; immigrant investor visa automated national security related screening and processing; automated processing of investment related to aircraft manufacturing; automated processing of credit enhancement related to aircraft manufacturing; and automated processing of loan guarantees related to aircraft manufacturing.

### Aircraft Manufacturing and Immigration Investor Visas/EB-5 According to Some Embodiments:

Some embodiments of the invention comprise a computer-implemented method that includes at least: specifically programming at least one computer system or a portion of at least one computer system to perform at least one of the following: aggregate immigrant investor visas and/or immigrant investor visa funding including, but not limited to, EB-5 for investment in aircraft manufacturing; aggregate immigrant investor visas and/or immigrant investor visa funding including, but not limited to, EB-5 for credit enhancement; aggregate immigrant investor visas and/or immigrant investor visa funding including, but not limited to, EB-5 for guarantor loans.

### Aircraft Manufacturing and Recaptured Immigration Investor Visas/Recaptured EB-5 According to Some Embodiments:

Some embodiments of the invention comprise a computer-implemented method that includes at least: specifically programming at least one computer system or a portion of at least one computer system to perform at least one of the following: aggregate recaptured immigrant investor visas including, but not limited to, recaptured EB-5 for investment in aircraft manufacturing; aggregate recaptured immigrant investor visas including, but not limited to, recaptured EB-5 for credit enhancement; aggregate recaptured immigrant investor visas including, but not limited to, recaptured EB-5 for guarantor loans.

### Aircraft Manufacturing and Unused Immigration Investor Visas/Unused EB-5 According to Some Embodiments:

Some embodiments of the invention comprise a computer-implemented method that includes at least: specifically programming at least one computer system or a portion of at least one computer system to perform at least one of the following: aggregate unused immigrant investor visas including, but not limited to, unused EB-5 for investment in aircraft manufacturing; aggregate unused immigrant investor visas including, but not limited to, unused EB-5 for credit enhancement; aggregate unused immigrant investor visas including, but not limited to, unused EB-5 for guarantor loans.

### Aviation Education According to Some Embodiments:

Some embodiments of the invention comprise a computer-implemented method that includes at least: specifically programming at least one computer system or a portion of at least one computer system to perform at least one of the following: aggregate immigrant investor visas and/or immigrant investor visa funding including, but not limited to, EB-5 for investment in aviation education; aggregate recaptured immigrant investor visas including, but not limited to, recaptured EB-5 for investment in aviation education; aggregate unused immigrant investor visas including, but not limited to, unused EB-5 for investment in aviation education.

Some embodiments of the invention comprise a computer-implemented method that includes at least specifically programming at least one computer system or a portion of at least one computer system to perform at least one of the following: aggregate immigrant investor visas and/or immigrant investor visa funding including, but not limited to, EB-5, for the purposes of: investment in aviation education; immigrant investor visa automated application processing; immigrant investor visa automated legal processing; immigrant investor visa automated expedited processing; immigrant investor visa automated authentication of source of funds processing; immigrant investor visa automated background check processing; immigrant investor visa automated national security related screening and processing; immigrant investor visa automated processing of visas including, but not limited to, EB-5 visas; immigrant investor visa automated processing of recaptured visas including, but not limited to, recaptured EB-5 visas; immigrant investor visa automated processing of unused visas including, but not limited to, unused EB-5 visas; automated processing of investment; automated processing of credit enhancement; and automated processing of loan guarantees and other types of financing.

Some embodiments of the invention comprise a method for aggregate funding including, but not limited to, immigrant investor visa funding including, but not limited to, EB-5 funding for investment: Step 1: aggregate immigrant investor visa funding including, but not limited to, EB-5 funding for investment in aviation education; Step 2: aggregate immigrant investor visa funding including, but not limited to EB-5 funding, to be used as a PDP for investment in aviation education; Step 3: aggregate immigrant investor visa funding including, but not limited to, EB-5 funding for investment; Step 4: aggregate funding to be used as credit enhancement; Step 5: aggregate funding to be used in and for guarantor loans.

Some embodiments of the invention comprise a computer-implemented method that includes at least specifically programming at least one computer system or a portion of at least one computer system to perform at least one of the following: aggregate immigrant investor visas and/or immigrant investor visa funding including, but not limited to, EB-5, for the purposes of: investment in aviation education; immigrant investor visa automated application processing; immigrant investor visa automated legal processing; immigrant investor visa automated processing of recaptured visas including, but not limited to, recaptured EB-5 visas; immigrant investor visa automated processing of unused visas including, but not limited to, unused EB-5 visas; immigrant investor visa automated expedited processing; immigrant investor visa automated authentication of source of funds processing; immigrant investor visa automated background check processing; immigrant investor visa automated national security related screening and processing; automated processing of investment related to aviation education; automated processing of credit enhancement related to aviation education; and automated processing of loan guarantees related to aviation education.

### Aviation Education and Immigration Investor Visas/EB-5 According to Some Embodiments:

Some embodiments of the invention comprise a computer-implemented method that includes at least: specifically programming at least one computer system or a portion of at least one computer system to perform at least one of the following: aggregate immigrant investor visas and/or immigrant investor visa funding including, but not limited to, EB-5 for investment in aviation education; aggregate immigrant investor visas and/or immigrant investor visa funding including, but not limited to, EB-5 for credit enhancement; aggregate immigrant investor visas and/or immigrant investor visa funding including, but not limited to, EB-5 for guarantor loans.

### Aviation Education and Recaptured Immigration Investor Visas/Recaptured EB-5 According to Some Embodiments:

Some embodiments of the invention comprise a computer-implemented method that includes at least: specifically programming at least one computer system or a portion of at least one computer system to perform at least one of the following: aggregate recaptured immigrant investor visas including, but not limited to, recaptured EB-5 for investment in aviation education; aggregate recaptured immigrant investor visas including, but not limited to, recaptured EB-5 for credit enhancement; aggregate recaptured immigrant investor visas including, but not limited to, recaptured EB-5 for guarantor loans.

### Aviation Education and Unused Immigration Investor Visas/Unused EB-5 According to Some Embodiments:

Some embodiments of the invention comprise a computer-implemented method that includes at least: specifically programming at least one computer system or a portion of at least one computer system to perform at least one of the following: aggregate unused immigrant investor visas including, but not limited to, unused EB-5 for investment in aviation education; aggregate unused immigrant investor visas including, but not limited to, unused EB-5 for credit enhancement; aggregate unused immigrant investor visas including, but not limited to, unused EB-5 for guarantor loans.

### Crowd Funding According to Some Embodiments:

Some embodiments of the invention comprise a computer-implemented method that includes at least: specifically programming at least one computer system or a portion of at least one computer system to perform at least one of the following: aggregate immigrant investor visas and/or immigrant investor visa funding including, but not limited to, EB-5 for investment involving crowd funding; aggregate recaptured immigrant investor visas including, but not limited to, recaptured EB-5 for investment involving crowd funding; aggregate unused immigrant investor visas including, but not limited to, unused EB-5 for investment involving crowd funding.

Some embodiments of the invention comprise a computer-implemented method that includes at least specifically programming at least one computer system or a portion of at least one computer system to perform at least one of the following: aggregate immigrant investor visas and/or immigrant investor visa funding including, but not limited to, EB-5, for the purposes of: investment involving crowd funding; immigrant investor visa automated application processing; immigrant investor visa automated legal processing; immigrant investor visa automated expedited processing; immigrant investor visa automated authentication of source of funds processing; immigrant investor visa automated background check processing; immigrant investor visa automated national security related screening and processing; immigrant investor visa automated processing of visas including, but not limited to, EB-5 visas; immigrant investor visa automated processing of recaptured visas including, but not limited to, recaptured EB-5 visas; immigrant investor visa automated processing of unused visas including, but not limited to, unused EB-5 visas; automated processing of investment; automated processing of credit enhancement; and automated processing of loan guarantees and other types of financing.

Some embodiments of the invention comprise a method for aggregate funding including, but not limited to, immigrant investor visa funding including, but not limited to, EB-5 funding for investment: Step 1: aggregate immigrant investor visa funding including, but not limited to, EB-5 funding for investment involving crowd funding; Step 2: aggregate immigrant investor visa funding including, but not limited to EB-5 funding, to be used as a PDP for investment involving crowd funding; Step 3: aggregate immigrant investor visa funding including, but not limited to, EB-5 funding for investment; Step 4: aggregate funding to be used as credit enhancement; Step 5: aggregate funding to be used in and for guarantor loans.

Some embodiments of the invention comprise a computer-implemented method that includes at least specifically programming at least one computer system or a portion of at least one computer system to perform at least one of the following: aggregate immigrant investor visas and/or immigrant investor visa funding including, but not limited to, EB-5, for the purposes of: investment involving crowd funding; immigrant investor visa automated application processing; immigrant investor visa automated legal processing; immigrant investor visa automated processing of recaptured visas including, but not limited to, recaptured EB-5 visas; immigrant investor visa automated processing of unused visas including, but not limited to, unused EB-5 visas; immigrant investor visa automated expedited processing; immigrant investor visa automated authentication of source of funds processing; immigrant investor visa automated background check processing; immigrant investor visa automated national security related screening and processing; automated processing of investment involving crowd funding; automated processing of credit enhancement involving crowd funding; and automated processing of loan guarantees involving crowd funding.

### Crowd Funding and Immigration Investor Visas/EB-5 According to Some Embodiments:

Some embodiments of the invention comprise a computer-implemented method that includes at least: specifically programming at least one computer system or a portion of at least one computer system to perform at least one of the following: aggregate immigrant investor visas and/or immigrant investor visa funding including, but not limited to, EB-5 for investment involving crowd funding; aggregate immigrant investor visas and/or immigrant investor visa funding including, but not limited to, EB-5 for credit enhancement; aggregate immigrant investor visas and/or immigrant investor visa funding including, but not limited to, EB-5 for guarantor loans.

### Crowd Funding and Recaptured Immigration Investor Visas/Recaptured EB-5 According to Some Embodiments:

Some embodiments of the invention comprise a computer-implemented method that includes at least: specifically programming at least one computer system or a portion of at least one computer system to perform at least one of the following: aggregate recaptured immigrant investor visas including, but not limited to, recaptured EB-5 for investment involving crowd funding; aggregate recaptured immigrant investor visas including, but not limited to, recaptured EB-5 for credit enhancement; aggregate recaptured immigrant investor visas including, but not limited to, recaptured EB-5 for guarantor loans.

### Crowd Funding and Unused Immigration Investor Visas/Unused EB-5 According to Some Embodiments:

Some embodiments of the invention comprise a computer-implemented method that includes at least: specifically programming at least one computer system or a portion of at least one computer system to perform at least one of the following: aggregate unused immigrant investor visas including, but not limited to, unused EB-5 for investment involving crowd funding; aggregate unused immigrant investor visas including, but not limited to, unused EB-5 for credit enhancement; aggregate unused immigrant investor visas including, but not limited to, unused EB-5 for guarantor loans.

### Islamic Finance & Investment Areas According to Some Embodiments:

Some embodiments of the invention comprise a computer-implemented method that includes at least: specifically programming at least one computer system or a portion of at least one computer system to perform at least one of the following: aggregate Islamic finance for investment; and/or Islamic finance for investment in aircraft; and/or Islamic finance or investment in satellites; and/or Islamic finance for investment in spacecraft; and/or Islamic finance for investment in commercial aviation; and/or Islamic finance for investment in aerospace; and/or Islamic finance for investment in infrastructure; and/or Islamic finance for investment in real estate; and/or Islamic finance for investment in information technology software; and/or Islamic finance for investment in information technology hardware; and/or Islamic finance for investment in telecommunications; and/or Islamic finance for investment in aircraft and/or satellites and/or spacecraft to finance infrastructure; and/or Islamic finance for investment in high-speed rail; and/or Islamic finance for investment in smart grid; and/or Islamic finance for investment in 5G; and/or Islamic finance for investment in Space Internet; and/or Islamic finance for investment in water supply system or water supply network; and/or Islamic finance for investment in water infrastructure; and/or Islamic finance for investment in airport infrastructure; and/or Islamic finance for investment in port infrastructure; and/or Islamic finance for investment in inland port infrastructure; and/or Islamic finance for investment in sports venue; and/or Islamic finance for investment in air transportation Infrastructure; and/or Islamic finance for investment in surface Transportation Infrastructure; and/or Islamic finance for investment in rail infrastructure; and/or Islamic finance for investment in highway infrastructure; and/or Islamic finance for investment in road Infrastructure; and/or Islamic finance for investment in education; and/or Islamic finance for investment in energy infrastructure; and/or Islamic finance for investment in renewable energy; and/or Islamic finance for investment in nuclear energy; and/or Islamic finance for investment in civil infrastructure; and/or Islamic finance for investment in autonomous vehicle infrastructure; and/or Islamic finance for investment in flying vehicle infrastructure; and/or Islamic finance for investment in military infrastructure; and/or Islamic finance for investment in autonomous vehicle manufacturing; and/or Islamic finance for investment in flying vehicle manufacturing; and/or Islamic finance for investment in crypto currency; and/or Islamic finance for investment in block chain; and/or Islamic finance for investment in military hardware; and/or Islamic finance for investment in automobile manufacturing; and/or Islamic finance for investment in aircraft manufacturing; and/or Islamic finance for investment in aviation education; and/or Islamic finance for investment involving Islamic finance; and/or Islamic finance for investment involving donation; and/or Islamic finance for investment involving crowd funding.

### Donation & Investment Areas According to Some Embodiments:

Some embodiments of the invention comprise a computer-implemented method that includes at least: specifically programming at least one computer system or a portion of at least one computer system to perform at least one of the following: aggregate donation for investment; and/or donation for investment in aircraft; and/or donation for investment in satellites; and/or donation for investment in spacecraft; and/or donation for investment in commercial aviation; and/or donation for investment in aerospace; and/or donation for investment in infrastructure; and/or donation for investment in real estate; and/or donation for investment in information technology software; and/or donation for investment in information technology hardware; and/or donation for investment in telecommunications; and/or donation for investment in aircraft and/or satellites and/or spacecraft to finance infrastructure; and/or donation for investment in high-speed rail; and/or donation for investment in smart grid; and/or donation for investment in 5G; and/or donation for investment in Space Internet; and/or donation for investment in water supply system or water supply network; and/or donation for investment in water infrastructure; and/or donation for investment in airport infrastructure; and/or donation for investment in port infrastructure; and/or donation for investment in inland port infrastructure; and/or donation for investment in sports venue; and/or donation for investment in air transportation infrastructure; and/or donation for investment in highway infrastructure; and/or donation for investment in road infrastructure; and/or donation for investment in education; and/or donation for investment in energy infrastructure; and/or donation for investment in renewable energy; and/or donation for investment in nuclear energy; and/or donation for investment in civil infrastructure; and/or donation for investment in autonomous vehicle infrastructure; and/or donation for investment in flying vehicle infrastructure; and/or donation for investment in military infrastructure; and/or donation for investment in autonomous vehicle manufacturing; and/or donation for investment in flying vehicle manufacturing; and/or donation for investment in crypto currency; and/or donation for investment in block chain; and/or donation for investment in military hardware; and/or donation for investment in automobile manufacturing; and/or donation for investment in aircraft manufacturing; and/or donation for investment in aviation education; and/or donation for investment involving Islamic finance; and/or donation for investment involving donation; and/or donation for investment involving crowd funding.

### Crowd Funding & Investment Areas According to Some Embodiments:

Some embodiments of the invention comprise a computer-implemented method that includes at least: specifically programming at least one computer system or a portion of at least one computer system to perform at least one of the following: aggregate crowd funding for investment; and/or crowd funding for investment in aircraft; and/or crowd funding for investment in satellites; and/or crowd funding for investment in spacecraft; and/or crowd funding for investment in commercial aviation; and/or crowd funding for investment in aerospace; and/or crowd funding for investment in infrastructure; and/or crowd funding for investment in real estate; and/or crowd funding for investment in information technology software; and/or crowd funding for investment in information technology hardware; and/or crowd funding for investment in telecommunications; and/or crowd funding for investment in aircraft and/or satellites and/or spacecraft to finance infrastructure; and/or crowd funding for investment in high-speed rail; and/or crowd funding for investment in smart grid; and/or crowd funding for investment in 5G; and/or crowd funding for investment in Space Internet; and/or crowd funding for investment in water supply system or water supply network; and/or crowd funding for investment in water infrastructure; and/or crowd funding for investment in airport infrastructure; and/or crowd funding for investment in port infrastructure; and/or crowd funding for investment in inland port infrastructure; and/or crowd funding for investment in sports venue; and/or crowd funding for investment in air transportation Infrastructure; and/or crowd funding for investment in highway Infrastructure; and/or crowd funding for investment in road Infrastructure; and/or crowd funding for investment in education; and/or crowd funding for investment in energy infrastructure; and/or crowd funding for investment in renewable energy; and/or crowd funding for investment in nuclear energy; and/or crowd funding for investment in civil infrastructure; and/or crowd funding for investment in autonomous vehicle infrastructure; and/or crowd funding for investment in flying vehicle infrastructure; and/or crowd funding for investment in military infrastructure; and/or crowd funding for investment in autonomous vehicle manufacturing; and/or crowd funding for investment in flying vehicle manufacturing; and/or crowd funding for investment in crypto currency; and/or crowd funding for investment in block chain; and/or crowd funding for investment in military hardware; and/or crowd funding for investment in automobile manufacturing; and/or crowd funding for investment in aircraft manufacturing; and/or crowd funding for investment in aviation education; and/or crowd funding for investment involving Islamic finance; and/or crowd funding for investment involving donation; and/or crowd funding for investment involving crowd funding.

### Deriving Revenues Through the Leasing Model and Investment Areas According to Some Embodiments:

Some embodiments of the invention comprise a computer-implemented method that includes at least: specifically programming at least one computer system or a portion of at least one computer system to perform at least one of the following: deriving revenues through the leasing model involving investment; and/or deriving revenues through the leasing model involving investment in aircraft; and/or deriving revenues through the leasing model involving investment in satellites; and/or deriving revenues through the leasing model involving investment in spacecraft; and/or deriving revenues through the leasing model involving investment in commercial aviation; and/or deriving revenues through the leasing model involving investment in aerospace; and/or deriving revenues through the leasing model involving investment in infrastructure; and/or deriving revenues through the leasing model involving investment in real estate; and/or deriving revenues through the leasing model involving investment in information technology software; and/or deriving revenues through the leasing model involving investment in information technology hardware; and/or deriving revenues through the leasing model involving investment in telecommunications; and/or deriving revenues through the leasing model involving investment in aircraft and/or satellites and/or spacecraft to finance infrastructure; and/or deriving revenues through the leasing model involving investment in high-speed rail; and/or deriving revenues through the leasing model involving investment in smart grid; and/or deriving revenues through the leasing model involving investment in 5G; and/or deriving revenues through the leasing model involving investment in Space Internet; and/or deriving revenues through the leasing model involving investment in water supply system or water supply network; and/or deriving revenues through the leasing model involving investment in water infrastructure; and/or deriving revenues through the leasing model involving investment in airport infrastructure; and/or deriving revenues through the leasing model involving investment in port infrastructure; and/or deriving revenues through the leasing model involving investment in inland port infrastructure; and/or deriving revenues through the leasing model involving investment in sports venue; and/or deriving revenues through the leasing model involving investment in air transportation Infrastructure; and/or deriving revenues through the leasing model involving investment in surface Transportation Infrastructure; and/or deriving revenues through the leasing model involving investment in rail infrastructure; and/or deriving revenues through the leasing model involving investment in highway infrastructure; and/or deriving revenues through the leasing model involving investment in road Infrastructure; and/or deriving revenues through the leasing model involving investment in education; and/or deriving revenues through the leasing model involving investment in energy infrastructure; and/or deriving revenues through the leasing model involving investment in renewable energy; and/or deriving revenues through the leasing model involving investment in nuclear energy; and/or deriving revenues through the leasing model involving investment in civil infrastructure; and/or deriving revenues through the leasing model involving investment in autonomous vehicle infrastructure; and/or deriving revenues through the leasing model involving investment in flying vehicle infrastructure; and/or deriving revenues through the leasing model involving investment in military infrastructure; and/or deriving revenues through the leasing model involving investment in autonomous vehicle manufacturing; and/or deriving revenues through the leasing model involving investment in flying vehicle manufacturing; and/or deriving revenues through the leasing model involving investment in crypto currency; and/or deriving revenues through the leasing model involving investment in block chain; and/or deriving revenues through the leasing model involving investment in military hardware; and/or deriving revenues through the leasing model involving investment in automobile manufacturing; and/or deriving revenues through the leasing model involving investment in aircraft manufacturing; and/or deriving revenues through the leasing model involving investment in aviation education; and/or deriving revenues through the leasing model in investment involving Islamic finance; and/or deriving revenues through the leasing model in investment involving donation; and/or deriving revenues through the leasing model in investment involving crowd funding.

### Immigrant Questionnaire & Investment Areas According to Some Embodiments:

Some embodiments of the invention comprise a computer-implemented method that includes at least: specifically programming at least one computer system or a portion of at least one computer system to perform at least one of the following: compile immigrant investor information from a questionnaire for investment; and/or compile immigrant investor information from a questionnaire for investment in aircraft; and/or compile immigrant investor information from a questionnaire for investment in satellites; and/or compile immigrant investor information from a questionnaire for investment in spacecraft; and/or compile immigrant investor information from a questionnaire for investment in commercial aviation; and/or compile immigrant investor information from a questionnaire for investment in aerospace; and/or compile immigrant investor information from a questionnaire for investment in infrastructure; and/or compile immigrant investor information from a questionnaire for investment in real estate; and/or compile immigrant investor information from a questionnaire for investment in information technology software; and/or compile immigrant investor information from a questionnaire for investment in information technology hardware; and/or compile immigrant investor information from a questionnaire for investment in telecommunications; and/or compile immigrant investor information from a questionnaire for investment in aircraft and/or satellites and/or spacecraft to finance infrastructure; and/or compile immigrant investor information from a questionnaire for investment in high-speed rail; and/or compile immigrant investor information from a questionnaire for investment in smart grid; and/or compile immigrant investor information from a questionnaire for investment in 5G; and/or compile immigrant investor information from a questionnaire for investment in Space Internet; and/or compile immigrant investor information from a questionnaire for investment in water supply system or water supply network; and/or compile immigrant investor information from a questionnaire for investment in water infrastructure; and/or compile immigrant investor information from a questionnaire for investment in airport infrastructure; and/or compile immigrant investor information from a questionnaire for investment in port infrastructure; and/or compile immigrant investor information from a questionnaire for investment in inland port infrastructure; and/or compile immigrant investor information from a questionnaire for investment involving sports venue; and/or compile immigrant investor information from a questionnaire for investment in air transportation infrastructure; and/or compile immigrant investor information from a questionnaire for investment in surface transportation infrastructure; and/or compile immigrant investor information from a questionnaire for investment in rail infrastructure; and/or compile immigrant investor information from a questionnaire for investment in highway infrastructure; and/or compile immigrant investor information from a questionnaire for investment in road infrastructure; and/or compile immigrant investor information from a questionnaire for investment in education; and/or compile immigrant investor information from a questionnaire for investment in energy infrastructure; and/or compile immigrant investor information from a questionnaire for investment in renewable energy; and/or compile immigrant investor information from a questionnaire for investment in nuclear energy; and/or compile immigrant investor information from a questionnaire for investment in civil infrastructure; and/or compile immigrant investor information from a questionnaire for investment in autonomous vehicle infrastructure; and/or compile immigrant investor information from a questionnaire for investment in flying vehicle infrastructure; and/or compile immigrant investor information from a questionnaire for investment in military infrastructure; and/or compile immigrant investor information from a questionnaire for investment in autonomous vehicle manufacturing; and/or compile immigrant investor information from a questionnaire for investment in flying vehicle manufacturing; and/or compile immigrant investor information from a questionnaire for investment in crypto currency; and/or compile immigrant investor information from a questionnaire for investment in block chain; and/or compile immigrant investor information from a questionnaire for investment in military hardware; and/or compile immigrant investor information from a questionnaire for investment in automobile manufacturing; and/or compile immigrant investor information from a questionnaire for investment in aircraft manufacturing; and/or compile immigrant investor information from a questionnaire for investment in aviation education; and/or compile immigrant investor information from a questionnaire for investment involving Islamic finance; and/or compile immigrant investor information from a questionnaire for investment involving donation; and/or compile immigrant investor information from a questionnaire for investment involving crowd funding.

### Immigration Questionnaire & Securities Law & National Security Law According to Some Embodiments:

Some embodiments of the invention comprise a computer-implemented method that includes at least: specifically programming at least one computer system or a portion of at least one computer system to perform at least one of the following: compile immigrant investor information from a questionnaire for investment and compliance with the Securities Act of 1933; and/or compliance with the Securities Exchange Act of 1934; and/or compliance with the Investment Company Act of 1940; and/or compliance with the Investment Advisers Act of 1940; and/or compliance with the JOBS Act; and or compliance with the CROWDFUND Act; and/or compliance with State “Blue Sky” laws; and/or compliance with laws related to immigration and national security of the United States.

Some embodiments of the invention comprise a computer-implemented method that includes at least: specifically programming at least one computer system or a portion of at least one computer system to perform at least one of the following: compile immigrant investor information from a questionnaire for investment in aircraft and compliance with Securities Act of 1933; and/or compliance with the Securities Exchange Act of 1934; and/or compliance with the Investment Company Act of 1940; and/or compliance with the Investment Advisers Act of 1940; and/or compliance with the JOBS Act; and or compliance with the CROWDFUND Act; and/or compliance with State “Blue Sky” laws; and/or compliance with laws related to immigration and national security of the United States.

Some S embodiments of the invention comprise a computer-implemented method that includes at least: specifically programming at least one computer system or a portion of at least one computer system to perform at least one of the following: compile immigrant investor information from a questionnaire for investment in satellites and compliance with Securities Act of 1933; and/or compliance with the Securities Exchange Act of 1934; and/or compliance with the Investment Company Act of 1940; and/or compliance with the Investment Advisers Act of 1940; and/or compliance with the JOBS Act; and or compliance with the CROWDFUND Act; and/or compliance with State “Blue Sky” laws; and/or compliance with laws related to immigration and national security of the United States.

Some embodiments of the invention comprise a computer-implemented method that includes at least: specifically programming at least one computer system or a portion of at least one computer system to perform at least one of the following: compile immigrant investor information from a questionnaire for investment in spacecraft and compliance with Securities Act of 1933; and/or compliance with the Securities Exchange Act of 1934; and/or compliance with the Investment Company Act of 1940; and/or compliance with the Investment Advisers Act of 1940; and/or compliance with the JOBS Act; and or compliance with the CROWDFUND Act; and/or compliance with State “Blue Sky” laws; and/or compliance with laws related to immigration and national security of the United States.

Some embodiments of the invention comprise a computer-implemented method that includes at least: specifically programming at least one computer system or a portion of at least one computer system to perform at least one of the following: compile immigrant investor information from a questionnaire for investment in commercial aviation and compliance with Securities Act of 1933; and/or compliance with the Securities Exchange Act of 1934; and/or compliance with the Investment Company Act of 1940; and/or compliance with the Investment Advisers Act of 1940; and/or compliance with the JOBS Act; and or compliance with the CROWDFUND Act; and/or compliance with State “Blue Sky” laws; and/or compliance with laws related to immigration and national security of the United States.

Some embodiments of the invention comprise a computer-implemented method that includes at least: specifically programming at least one computer system or a portion of at least one computer system to perform at least one of the following: compile immigrant investor information from a questionnaire for investment in aerospace and compliance with Securities Act of 1933; and/or compliance with the Securities Exchange Act of 1934; and/or compliance with the Investment Company Act of 1940; and/or compliance with the Investment Advisers Act of 1940; and/or compliance with the JOBS Act; and or compliance with the CROWDFUND Act; and/or compliance with State “Blue Sky” laws; and/or compliance with laws related to immigration and national security of the United States.

Some embodiments of the invention comprise a computer-implemented method that includes at least: specifically programming at least one computer system or a portion of at least one computer system to perform at least one of the following: compile immigrant investor information from a questionnaire for investment in infrastructure and compliance with Securities Act of 1933; and/or compliance with the Securities Exchange Act of 1934; and/or compliance with the Investment Company Act of 1940; and/or compliance with the Investment Advisers Act of 1940; and/or compliance with the JOBS Act; and or compliance with the CROWDFUND Act; and/or compliance with State “Blue Sky” laws; and/or compliance with laws related to immigration and national security of the United States.

Some embodiments of the invention comprise a computer-implemented method that includes at least: specifically programming at least one computer system or a portion of at least one computer system to perform at least one of the following: compile immigrant investor information from a questionnaire for investment in real estate and compliance with Securities Act of 1933; and/or compliance with the Securities Exchange Act of 1934; and/or compliance with the Investment Company Act of 1940; and/or compliance with the Investment Advisers Act of 1940; and/or compliance with the JOBS Act; and or compliance with the CROWDFUND Act; and/or compliance with State “Blue Sky” laws; and/or compliance with laws related to immigration and national security of the United States.

Some embodiments of the invention comprise a computer-implemented method that includes at least: specifically programming at least one computer system or a portion of at least one computer system to perform at least one of the following: compile immigrant investor information from a questionnaire for investment in information technology software and compliance with Securities Act of 1933; and/or compliance with the Securities Exchange Act of 1934; and/or compliance with the Investment Company Act of 1940; and/or compliance with the Investment Advisers Act of 1940; and/or compliance with the JOBS Act; and or compliance with the CROWDFUND Act; and/or compliance with State “Blue Sky” laws; and/or compliance with laws related to immigration and national security of the United States.

Some embodiments of the invention comprise a computer-implemented method that includes at least: specifically programming at least one computer system or a portion of at least one computer system to perform at least one of the following: compile immigrant investor information from a questionnaire for investment in information technology hardware and compliance with Securities Act of 1933; and/or compliance with the Securities Exchange Act of 1934; and/or compliance with the Investment Company Act of 1940; and/or compliance with the Investment Advisers Act of 1940; and/or compliance with the JOBS Act; and or compliance with the CROWDFUND Act; and/or compliance with State “Blue Sky” laws; and/or compliance with laws related to immigration and national security of the United States.

Some embodiments of the invention comprise a computer-implemented method that includes at least: specifically programming at least one computer system or a portion of at least one computer system to perform at least one of the following: compile immigrant investor information from a questionnaire for investment in telecommunications and compliance with Securities Act of 1933; and/or compliance with the Securities Exchange Act of 1934; and/or compliance with the Investment Company Act of 1940; and/or compliance with the Investment Advisers Act of 1940; and/or compliance with the JOBS Act; and or compliance with the CROWDFUND Act; and/or compliance with State “Blue Sky” laws; and/or compliance with laws related to immigration and national security of the United States.

Some embodiments of the invention comprise a computer-implemented method that includes at least: specifically programming at least one computer system or a portion of at least one computer system to perform at least one of the following: compile immigrant investor information from a questionnaire for investment in aircraft and/or satellites and/or spacecraft to finance infrastructure and compliance with Securities Act of 1933; and/or compliance with the Securities Exchange Act of 1934; and/or compliance with the Investment Company Act of 1940; and/or compliance with the Investment Advisers Act of 1940; and/or compliance with the JOBS Act; and or compliance with the CROWDFUND Act; and/or compliance with State “Blue Sky” laws; and/or compliance with laws related to immigration and national security of the United States.

Some embodiments of the invention comprise a computer-implemented method that includes at least: specifically programming at least one computer system or a portion of at least one computer system to perform at least one of the following: compile immigrant investor information from a questionnaire for investment in high-speed rail and compliance with Securities Act of 1933; and/or compliance with the Securities Exchange Act of 1934; and/or compliance with the Investment Company Act of 1940; and/or compliance with the Investment Advisers Act of 1940; and/or compliance with the JOBS Act; and or compliance with the CROWDFUND Act; and/or compliance with State “Blue Sky” laws; and/or compliance with laws related to immigration and national security of the United States.

Some embodiments of the invention comprise a computer-implemented method that includes at least: specifically programming at least one computer system or a portion of at least one computer system to perform at least one of the following: compile immigrant investor information from a questionnaire for investment in smart grid; compile immigrant investor information from a questionnaire for investment in 5G and compliance with Securities Act of 1933; and/or compliance with the Securities Exchange Act of 1934; and/or compliance with the Investment Company Act of 1940; and/or compliance with the Investment Advisers Act of 1940; and/or compliance with State “Blue Sky” laws; and/or compliance with laws related to immigration and national security of the United States.

Some embodiments of the invention comprise a computer-implemented method that includes at least: specifically programming at least one computer system or a portion of at least one computer system to perform at least one of the following: compile immigrant investor information from a questionnaire for investment in Space Internet and compliance with Securities Act of 1933; and/or compliance with the Securities Exchange Act of 1934; and/or compliance with the Investment Company Act of 1940; and/or compliance with the Investment Advisers Act of 1940; and/or compliance with the JOBS Act; and or compliance with the CROWDFUND Act; and/or compliance with State “Blue Sky” laws; and/or compliance with laws related to immigration and national security of the United States.

Some embodiments of the invention comprise a computer-implemented method that includes at least: specifically programming at least one computer system or a portion of at least one computer system to perform at least one of the following: compile immigrant investor information from a questionnaire for investment in water supply system or water supply network and compliance with Securities Act of 1933; and/or compliance with the Securities Exchange Act of 1934; and/or compliance with the Investment Company Act of 1940; and/or compliance with the Investment Advisers Act of 1940; and/or compliance with the JOBS Act; and or compliance with the CROWDFUND Act; and/or compliance with State “Blue Sky” laws; and/or compliance with laws related to immigration and national security of the United States.

Some embodiments of the invention comprise a computer-implemented method that includes at least: specifically programming at least one computer system or a portion of at least one computer system to perform at least one of the following: compile immigrant investor information from a questionnaire for investment in water infrastructure and compliance with Securities Act of 1933; and/or compliance with the Securities Exchange Act of 1934; and/or compliance with the Investment Company Act of 1940; and/or compliance with the Investment Advisers Act of 1940; and/or compliance with the JOBS Act; and or compliance with the CROWDFUND Act; and/or compliance with State “Blue Sky” laws; and/or compliance with laws related to immigration and national security of the United States.

Some embodiments of the invention comprise a computer-implemented method that includes at least: specifically programming at least one computer system or a portion of at least one computer system to perform at least one of the following: compile immigrant investor information from a questionnaire for investment in airport infrastructure and compliance with Securities Act of 1933; and/or compliance with the Securities Exchange Act of 1934; and/or compliance with the Investment Company Act of 1940; and/or compliance with the Investment Advisers Act of 1940; and/or compliance with the JOBS Act; and or compliance with the CROWDFUND Act; and/or compliance with State “Blue Sky” laws; and/or compliance with laws related to immigration and national security of the United States.

Some embodiments of the invention comprise a computer-implemented method that includes at least: specifically programming at least one computer system or a portion of at least one computer system to perform at least one of the following: compile immigrant investor information from a questionnaire for investment in port infrastructure and compliance with Securities Act of 1933; and/or compliance with the Securities Exchange Act of 1934; and/or compliance with the Investment Company Act of 1940; and/or compliance with the Investment Advisers Act of 1940; and/or compliance with the JOBS Act; and or compliance with the CROWDFUND Act; and/or compliance with State “Blue Sky” laws; and/or compliance with laws related to immigration and national security of the United States.

Some embodiments of the invention comprise a computer-implemented method that includes at least: specifically programming at least one computer system or a portion of at least one computer system to perform at least one of the following: compile immigrant investor information from a questionnaire for investment in inland port infrastructure and compliance with Securities Act of 1933; and/or compliance with the Securities Exchange Act of 1934; and/or compliance with the Investment Company Act of 1940; and/or compliance with the Investment Advisers Act of 1940; and/or compliance with the JOBS Act; and or compliance with the CROWDFUND Act; and/or compliance with State “Blue Sky” laws; and/or compliance with laws related to immigration and national security of the United States.

Some embodiments of the invention comprise a computer-implemented method that includes at least: specifically programming at least one computer system or a portion of at least one computer system to perform at least one of the following: compile immigrant investor information from a questionnaire for investment in sports venue and compliance with Securities Act of 1933; and/or compliance with the Securities Exchange Act of 1934; and/or compliance with the Investment Company Act of 1940; and/or compliance with the Investment Advisers Act of 1940; and/or compliance with the JOBS Act; and or compliance with the CROWDFUND Act; and/or compliance with State “Blue Sky” laws; and/or compliance with laws related to immigration and national security of the United States.

Some embodiments of the invention comprise a computer-implemented method that includes at least: specifically programming at least one computer system or a portion of at least one computer system to perform at least one of the following: compile immigrant investor information from a questionnaire for investment in air transportation infrastructure and compliance with Securities Act of 1933; and/or compliance with the Securities Exchange Act of 1934; and/or compliance with the Investment Company Act of 1940; and/or compliance with the Investment Advisers Act of 1940; and/or compliance with the JOBS Act; and or compliance with the CROWDFUND Act; and/or compliance with State “Blue Sky” laws; and/or compliance with laws related to immigration and national security of the United States.

Some embodiments of the invention comprise a computer-implemented method that includes at least: specifically programming at least one computer system or a portion of at least one computer system to perform at least one of the following: and/or compile immigrant investor information from a questionnaire for investment in surface transportation infrastructure and compliance with Securities Act of 1933; and/or compliance with the Securities Exchange Act of 1934; and/or compliance with the Investment Company Act of 1940; and/or compliance with the Investment Advisers Act of 1940; and/or compliance with the JOBS Act; and or compliance with the CROWDFUND Act; and/or compliance with State “Blue Sky” laws; and/or compliance with laws related to immigration and national security of the United States.

Some embodiments of the invention comprise a computer-implemented method that includes at least: specifically programming at least one computer system or a portion of at least one computer system to perform at least one of the following: and/or compile immigrant investor information from a questionnaire for investment in rail infrastructure and compliance with Securities Act of 1933; and/or compliance with the Securities Exchange Act of 1934; and/or compliance with the Investment Company Act of 1940; and/or compliance with the Investment Advisers Act of 1940; and/or compliance with the JOBS Act; and or compliance with the CROWDFUND Act; and/or compliance with State “Blue Sky” laws; and/or compliance with laws related to immigration and national security of the United States.

Some embodiments of the invention comprise a computer-implemented method that includes at least: specifically programming at least one computer system or a portion of at least one computer system to perform at least one of the following: and/or compile immigrant investor information from a questionnaire for investment in highway infrastructure and compliance with Securities Act of 1933; and/or compliance with the Securities Exchange Act of 1934; and/or compliance with the Investment Company Act of 1940; and/or compliance with the Investment Advisers Act of 1940; and/or compliance with the JOBS Act; and or compliance with the CROWDFUND Act; and/or compliance with State “Blue Sky” laws; and/or compliance with laws related to immigration and national security of the United States.

Some embodiments of the invention comprise a computer-implemented method that includes at least: specifically programming at least one computer system or a portion of at least one computer system to perform at least one of the following: and/or compile immigrant investor information from a questionnaire for investment in road infrastructure and compliance with Securities Act of 1933; and/or compliance with the Securities Exchange Act of 1934; and/or compliance with the Investment Company Act of 1940; and/or compliance with the Investment Advisers Act of 1940; and/or compliance with the JOBS Act; and or compliance with the CROWDFUND Act; and/or compliance with State “Blue Sky” laws; and/or compliance with laws related to immigration and national security of the United States.

Some embodiments of the invention comprise a computer-implemented method that includes at least: specifically programming at least one computer system or a portion of at least one computer system to perform at least one of the following: and/or compile immigrant investor information from a questionnaire for investment in education and compliance with Securities Act of 1933; and/or compliance with the Securities Exchange Act of 1934; and/or compliance with the Investment Company Act of 1940; and/or compliance with the Investment Advisers Act of 1940; and/or compliance with the JOBS Act; and or compliance with the CROWDFUND Act; and/or compliance with State “Blue Sky” laws; and/or compliance with laws related to immigration and national security of the United States.

Some embodiments of the invention comprise a computer-implemented method that includes at least: specifically programming at least one computer system or a portion of at least one computer system to perform at least one of the following: and/or compile immigrant investor information from a questionnaire for investment in energy infrastructure and compliance with Securities Act of 1933; and/or compliance with the Securities Exchange Act of 1934; and/or compliance with the Investment Company Act of 1940; and/or compliance with the Investment Advisers Act of 1940; and/or compliance with the JOBS Act; and or compliance with the CROWDFUND Act; and/or compliance with State “Blue Sky” laws; and/or compliance with laws related to immigration and national security of the United States.

Some embodiments of the invention comprise a computer-implemented method that includes at least: specifically programming at least one computer system or a portion of at least one computer system to perform at least one of the following: and/or compile immigrant investor information from a questionnaire for investment in renewable energy and compliance with Securities Act of 1933; and/or compliance with the Securities Exchange Act of 1934; and/or compliance with the Investment Company Act of 1940; and/or compliance with the Investment Advisers Act of 1940; and/or compliance with the JOBS Act; and or compliance with the CROWDFUND Act; and/or compliance with State “Blue Sky” laws; and/or compliance with laws related to immigration and national security of the United States.

Some embodiments of the invention comprise a computer-implemented method that includes at least: specifically programming at least one computer system or a portion of at least one computer system to perform at least one of the following: and/or compile immigrant investor information from a questionnaire for investment in nuclear energy and compliance with Securities Act of 1933; and/or compliance with the Securities Exchange Act of 1934; and/or compliance with the Investment Company Act of 1940; and/or compliance with the Investment Advisers Act of 1940; and/or compliance with the JOBS Act; and or compliance with the CROWDFUND Act; and/or compliance with State “Blue Sky” laws; and/or compliance with laws related to immigration and national security of the United States.

Some embodiments of the invention comprise a computer-implemented method that includes at least: specifically programming at least one computer system or a portion of at least one computer system to perform at least one of the following: and/or compile immigrant investor information from a questionnaire for investment in civil infrastructure and compliance with Securities Act of 1933; and/or compliance with the Securities Exchange Act of 1934; and/or compliance with the Investment Company Act of 1940; and/or compliance with the Investment Advisers Act of 1940; and/or compliance with the JOBS Act; and or compliance with the CROWDFUND Act; and/or compliance with State “Blue Sky” laws; and/or compliance with laws related to immigration and national security of the United States.

Some embodiments of the invention comprise a computer-implemented method that includes at least: specifically programming at least one computer system or a portion of at least one computer system to perform at least one of the following: and/or compile immigrant investor information from a questionnaire for investment in autonomous vehicle infrastructure and compliance with Securities Act of 1933; and/or compliance with the Securities Exchange Act of 1934; and/or compliance with the Investment Company Act of 1940; and/or compliance with the Investment Advisers Act of 1940; and/or compliance with the JOBS Act; and or compliance with the CROWDFUND Act; and/or compliance with State “Blue Sky” laws; and/or compliance with laws related to immigration and national security of the United States.

Some embodiments of the invention comprise a computer-implemented method that includes at least: specifically programming at least one computer system or a portion of at least one computer system to perform at least one of the following: and/or compile immigrant investor information from a questionnaire for investment in flying vehicle infrastructure and compliance with Securities Act of 1933; and/or compliance with the Securities Exchange Act of 1934; and/or compliance with the Investment Company Act of 1940; and/or compliance with the Investment Advisers Act of 1940; and/or compliance with the JOBS Act; and or compliance with the CROWDFUND Act; and/or compliance with State “Blue Sky” laws; and/or compliance with laws related to immigration and national security of the United States.

Some embodiments of the invention comprise a computer-implemented method that includes at least: specifically programming at least one computer system or a portion of at least one computer system to perform at least one of the following: and/or compile immigrant investor information from a questionnaire for investment in military infrastructure and compliance with Securities Act of 1933; and/or compliance with the Securities Exchange Act of 1934; and/or compliance with the Investment Company Act of 1940; and/or compliance with the Investment Advisers Act of 1940; and/or compliance with the JOBS Act; and or compliance with the CROWDFUND Act; and/or compliance with State “Blue Sky” laws; and/or compliance with laws related to immigration and national security of the United States.

Some embodiments of the invention comprise a computer-implemented method that includes at least: specifically programming at least one computer system or a portion of at least one computer system to perform at least one of the following: and/or compile immigrant investor information from a questionnaire for investment in autonomous vehicle manufacturing and compliance with Securities Act of 1933; and/or compliance with the Securities Exchange Act of 1934; and/or compliance with the Investment Company Act of 1940; and/or compliance with the Investment Advisers Act of 1940; and/or compliance with the JOBS Act; and or compliance with the CROWDFUND Act; and/or compliance with State “Blue Sky” laws; and/or compliance with laws related to immigration and national security of the United States.

Some embodiments of the invention comprise a computer-implemented method that includes at least: specifically programming at least one computer system or a portion of at least one computer system to perform at least one of the following: and/or compile immigrant investor information from a questionnaire for investment in flying vehicle manufacturing and compliance with Securities Act of 1933; and/or compliance with the Securities Exchange Act of 1934; and/or compliance with the Investment Company Act of 1940; and/or compliance with the Investment Advisers Act of 1940; and/or compliance with the JOBS Act; and or compliance with the CROWDFUND Act; and/or compliance with State “Blue Sky” laws; and/or compliance with laws related to immigration and national security of the United States.

Some embodiments of the invention comprise a computer-implemented method that includes at least: specifically programming at least one computer system or a portion of at least one computer system to perform at least one of the following: and/or compile immigrant investor information from a questionnaire for investment in crypto currency and compliance with Securities Act of 1933; and/or compliance with the Securities Exchange Act of 1934; and/or compliance with the Investment Company Act of 1940; and/or compliance with the Investment Advisers Act of 1940; and/or compliance with the JOBS Act; and or compliance with the CROWDFUND Act; and/or compliance with State “Blue Sky” laws; and/or compliance with laws related to immigration and national security of the United States.

Some embodiments of the invention comprise a computer-implemented method that includes at least: specifically programming at least one computer system or a portion of at least one computer system to perform at least one of the following: and/or compile immigrant investor information from a questionnaire for investment in block chain and compliance with Securities Act of 1933; and/or compliance with the Securities Exchange Act of 1934; and/or compliance with the Investment Company Act of 1940; and/or compliance with the Investment Advisers Act of 1940; and/or compliance with the JOBS Act; and or compliance with the CROWDFUND Act; and/or compliance with State “Blue Sky” laws; and/or compliance with laws related to immigration and national security of the United States.

Some embodiments of the invention comprise a computer-implemented method that includes at least: specifically programming at least one computer system or a portion of at least one computer system to perform at least one of the following: and/or compile immigrant investor information from a questionnaire for investment in military hardware and compliance with Securities Act of 1933; and/or compliance with the Securities Exchange Act of 1934; and/or compliance with the Investment Company Act of 1940; and/or compliance with the Investment Advisers Act of 1940; and/or compliance with the JOBS Act; and or compliance with the CROWDFUND Act; and/or compliance with State “Blue Sky” laws; and/or compliance with laws related to immigration and national security of the United States.

Some embodiments of the invention comprise a computer-implemented method that includes at least: specifically programming at least one computer system or a portion of at least one computer system to perform at least one of the following: and/or compile immigrant investor information from a questionnaire for investment in automobile manufacturing and compliance with Securities Act of 1933; and/or compliance with the Securities Exchange Act of 1934; and/or compliance with the Investment Company Act of 1940; and/or compliance with the Investment Advisers Act of 1940; and/or compliance with the JOBS Act; and or compliance with the CROWDFUND Act; and/or compliance with State “Blue Sky” laws; and/or compliance with laws related to immigration and national security of the United States.

Some embodiments of the invention comprise a computer-implemented method that includes at least: specifically programming at least one computer system or a portion of at least one computer system to perform at least one of the following: and/or compile immigrant investor information from a questionnaire for investment in aircraft manufacturing and compliance with Securities Act of 1933; and/or compliance with the Securities Exchange Act of 1934; and/or compliance with the Investment Company Act of 1940; and/or compliance with the Investment Advisers Act of 1940; and/or compliance with the JOBS Act; and or compliance with the CROWDFUND Act; and/or compliance with State “Blue Sky” laws; and/or compliance with laws related to immigration and national security of the United States.

Some embodiments of the invention comprise a computer-implemented method that includes at least: specifically programming at least one computer system or a portion of at least one computer system to perform at least one of the following: and/or compile immigrant investor information from a questionnaire for investment in aviation education and compliance with Securities Act of 1933; and/or compliance with the Securities Exchange Act of 1934; and/or compliance with the Investment Company Act of 1940; and/or compliance with the Investment Advisers Act of 1940; and/or compliance with the JOBS Act; and or compliance with the CROWDFUND Act; and/or compliance with State “Blue Sky” laws; and/or compliance with laws related to immigration and national security of the United States.

Some embodiments of the invention comprise a computer-implemented method that includes at least: specifically programming at least one computer system or a portion of at least one computer system to perform at least one of the following: and/or compile immigrant investor information from a questionnaire for investment involving Islamic finance and compliance with Securities Act of 1933; and/or compliance with the Securities Exchange Act of 1934; and/or compliance with the Investment Company Act of 1940; and/or compliance with the Investment Advisers Act of 1940; and/or compliance with the JOBS Act; and or compliance with the CROWDFUND Act; and/or compliance with State “Blue Sky” laws; and/or compliance with laws related to immigration and national security of the United States.

Some embodiments of the invention comprise a computer-implemented method that includes at least: specifically programming at least one computer system or a portion of at least one computer system to perform at least one of the following: compile immigrant investor information from a questionnaire for investment in Islamic finance and compliance with Securities Act of 1933; and/or compliance with the Securities Exchange Act of 1934; and/or compliance with the Investment Company Act of 1940; and/or compliance with the Investment Advisers Act of 1940; and/or compliance with the JOBS Act; and or compliance with the CROWDFUND Act; and/or compliance with State “Blue Sky” laws; and/or compliance with laws related to immigration and national security of the United States.

Some embodiments of the invention comprise a computer-implemented method that includes at least: specifically programming at least one computer system or a portion of at least one computer system to perform at least one of the following: compile immigrant investor information from a questionnaire for investment involving donation and compliance with Securities Act of 1933; and/or compliance with the Securities Exchange Act of 1934; and/or compliance with the Investment Company Act of 1940; and/or compliance with the Investment Advisers Act of 1940; and/or compliance with the JOBS Act; and or compliance with the CROWDFUND Act; and/or compliance with State “Blue Sky” laws; and/or compliance with laws related to immigration and national security of the United States.

Some embodiments of the invention comprise a computer-implemented method that includes at least: specifically programming at least one computer system or a portion of at least one computer system to perform at least one of the following: compile immigrant investor information from a questionnaire for investment crowd funding and compliance with Securities Act of 1933; and/or compliance with the Securities Exchange Act of 1934; and/or compliance with the Investment Company Act of 1940; and/or compliance with the Investment Advisers Act of 1940; and/or compliance with the JOBS Act; and or compliance with the CROWDFUND Act; and/or compliance with State “Blue Sky” laws; and/or compliance with laws related to immigration and national security of the United States.

Some embodiments include a computer-implemented method that includes at least specifically programming at least one computer system or a portion of at least one computer system to aggregate the funding sources and ensure compliance with national security-related concerns including, but not limited to: (i) detailed source of funds review; (ii) compliance with Know-Your-Customer (KYC), Anti-Money Laundering (AML), Bank Secrecy Act (BSA) requirements and; (iii) Office of Foreign Asset Control (OFAC) requirements.

Some embodiments include a computer-implemented method that includes at least specifically programming at least one computer system or a portion of at least one computer system to aggregate for one or more of the purposes of infrastructure financing listed above at least one of: Islamic capital funding, sovereign wealth funds, bank deposits to be invested consistent with Islamic principles including, without limitation, commercial aircraft financing, global Islamic Zakat, other religious-based financing and crowdfunding.

Some embodiments include a computer-implemented method that includes at least specifically programming at least one computer system or a portion of at least one computer system to aggregate the funding sources and ensure compliance with religious, regulatory, and other restrictions, limitations and/or guidelines.

Any of the methods and operations described herein that form part of the invention can be useful machine operations. The invention also relates to a device or an apparatus for performing these operations. The apparatus can be specially constructed for the required purpose, such as a special purpose computer. When defined as a special purpose computer, the computer can also perform other processing, program execution or routines that are not part of the special purpose, while still being capable of operating for the special purpose. Alternatively, the operations can be processed by a general-purpose computer selectively activated or configured by one or more computer programs stored in the computer memory, cache, or obtained over a network. When data is obtained over a network the data can be processed by other computers on the network, e.g. a cloud of computing resources.

Some embodiments of the invention can also be defined as a machine that transforms data from one state to another state. The data can represent an article, that can be represented as an electronic signal and electronically manipulate data according to some embodiments. The transformed data can, in some cases, be visually depicted on a display, representing the physical object that results from the transformation of data according to some embodiments. The transformed data can be saved to storage generally or in particular formats that enable the construction or depiction of a physical and tangible object according to some embodiments. In some embodiments, the manipulation can be performed by a processor. In such an example, the processor thus transforms the data from one thing to another according to some embodiments. Still further, the methods can be processed by one or more machines or processors that can be connected over a network according to some embodiments. Each machine can transform data from one state or thing to another, and can also process data, save data to storage, transmit data over a network, display the result, or communicate the result to another machine. Computer-readable storage media, as used herein, refers to physical or tangible storage (as opposed to signals) and includes without limitation volatile and non-volatile, removable and non-removable storage media implemented in any method or technology for the tangible storage of information such as computer-readable instructions, data structures, program modules or other data according to some embodiments.

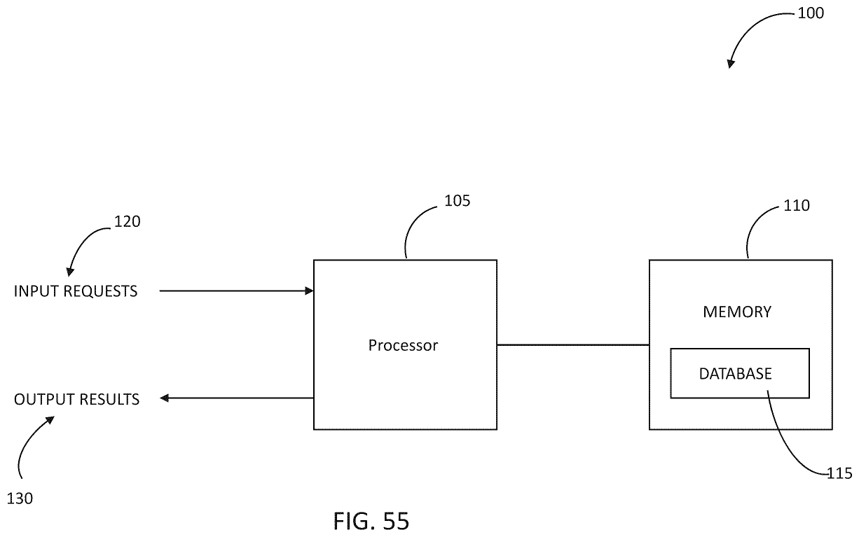

Turning to FIG. 55, a block diagram of a system 100 that can implement any one or more of the methods disclosed herein according to some embodiments. The system 100 includes a processor 105 connected with a memory 110, the memory 110 configured to store data according to some embodiments. In some embodiments, the processor 105 is configured to interface or otherwise communicate with the memory 110, for example, via electrical signals propagated along a conductive trace or wire. In some embodiments, the processor 105 can interface with the memory 110 via a wireless connection. In some embodiments, the memory 110 can include a database 115, a plurality of data or entries stored in the database 115 of the memory 110.

As discussed in greater detail herein, in some embodiments, the processor 105 can be tasked with executing software or other logical instructions to perform one or more of the aforementioned methods. In some embodiments, input requests 120 can be received by the processor 105 (e.g., via signals transmitted from a user at a remote system or device, such as a handheld device like a smartphone or tablet, to the processor 105 via a network or internet connection). In some embodiments, the input requests 120 can be received by the processor 105 via a user input device that is not at a geographically remote location (e.g., via a connected keyboard, mouse, etc. at a local computer terminal). In some embodiments, after performing tasks or instructions based upon the user input requests 120, for example, looking up information or data stored in the memory 110, the processor 105 can output results 130 back to the user that are based upon the input requests 120.

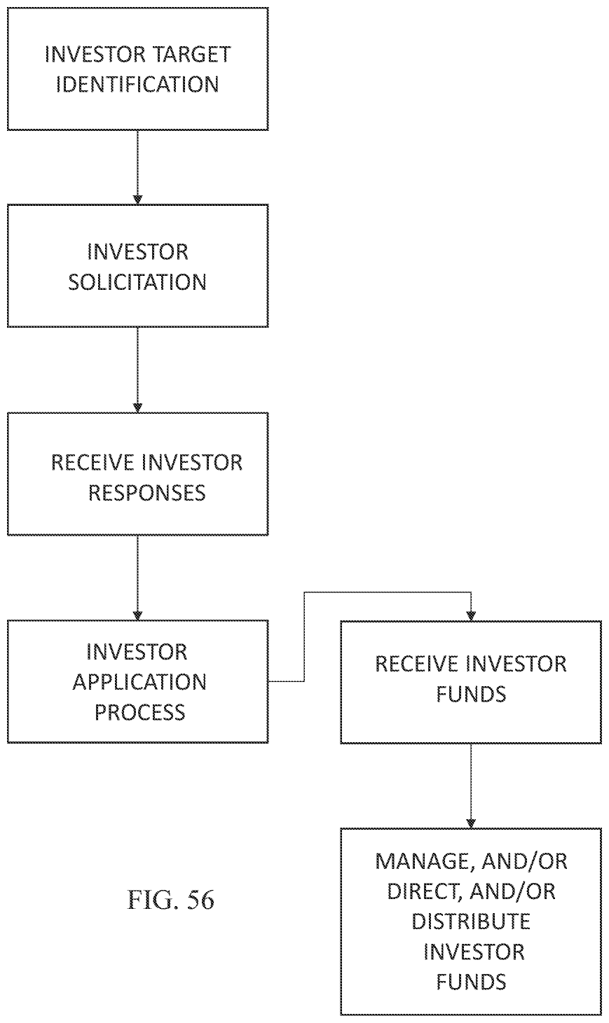

In some embodiments of the invention, one or more of the earlier-described investment and finance methods can proceed within a process illustrated in FIG. 56, illustrating an investor process in accordance with some embodiments of the invention. In some embodiments, an initial step can comprise investor target identification. In some embodiments, this can be handled by a third-party provider such as a bank or other financial institution. Some embodiments include an investor solicitation stage, followed by an investor responses process. Some embodiments of the invention include an investor application process that can lead to investor selection and financing as discussed below.

In some embodiments, investor target identification and/or solicitation can utilize conventional marketing methodologies. In some embodiments, investor target identification and/or solicitation can utilize print and/or graphic marketing methods. In some embodiments, investor target identification and/or solicitation can utilize multichannel marketing methods. In some embodiments, investor target identification and/or solicitation can utilize internet marking methods. In some embodiments, investor target identification and/or solicitation can utilize social media marketing methods. For example, in some non-limiting embodiments, the server system can couple to any conventional social network. In some embodiments, the server system can process text files, graphic files, audio files, and/or video files, and/or instant text messaging files, and/or instant graphical messaging files, and/or instant image message files, and/or instant video messaging files, instant audio or voice messaging files, and combinations thereof, for the purposes of marketing to investors. In some non-limiting embodiments of the invention, a service provider or server system can market through Instagram® accounts or webpages, and/or one or more Facebook® accounts or webpages, and/or one or more YouTube® accounts, channels or webpages, one or more TWITTER® accounts or webpages. In some further non-limiting embodiments of the invention, the server system can couple to any other conventional social network account, or any other Internet-enabled system or account.

Instagram® (Instagram is a registered trademark of Instagram, LLC). TWITTER® is a registered trademark of Twitter, Inc., San Francisco Calif. FACEBOOK® is a registered trademark of Facebook, Inc., Palo Alto California. “YouTube®” and the “YouTube logo®” are registered trademarks of Google Inc.

Some embodiments include an investor funding process stage which can include an aggregation and/or pooling of investor funds, followed by management, direction, and/or distribution of investment capital, including, but not limited to any one or more financial investment scenarios described earlier.

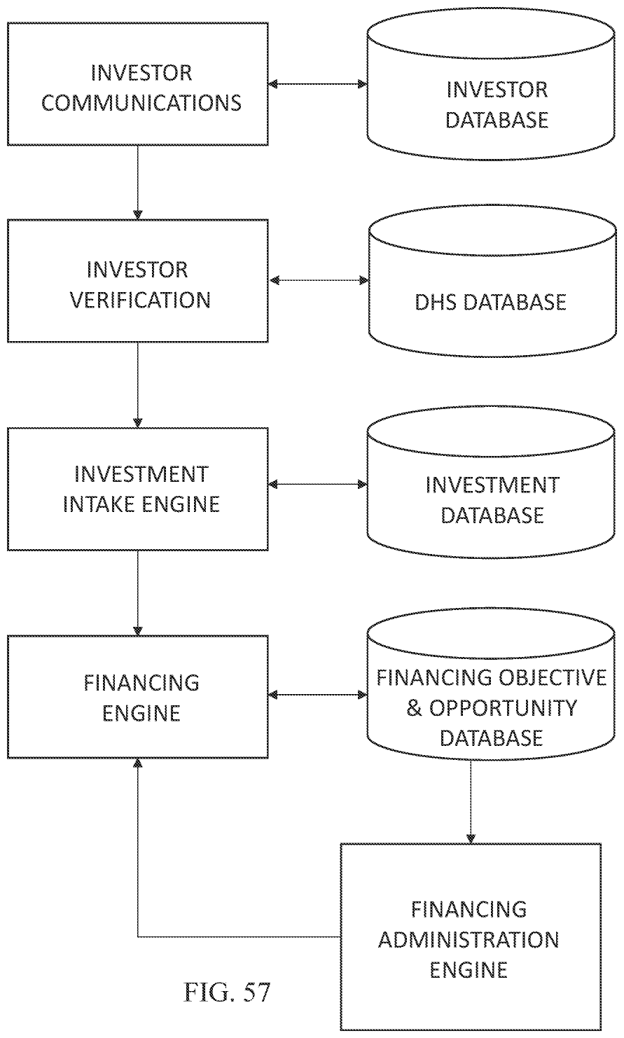

In some embodiments, the process illustrated in FIG. 56, can be performed as a system process shown in FIG. 57. Some embodiments can process investor communications using an investor database. In some embodiments, a system process can perform investor verification, coupling to one or more DHS databases as required. Some embodiments include an investment intake engine coupled to an investment database for aggregating and pooling investment funds. Some embodiments include a financing engine, working with a financing objective and opportunity database, and financing administration engine to identify, direct, and/or manage the channeling of investment funds.

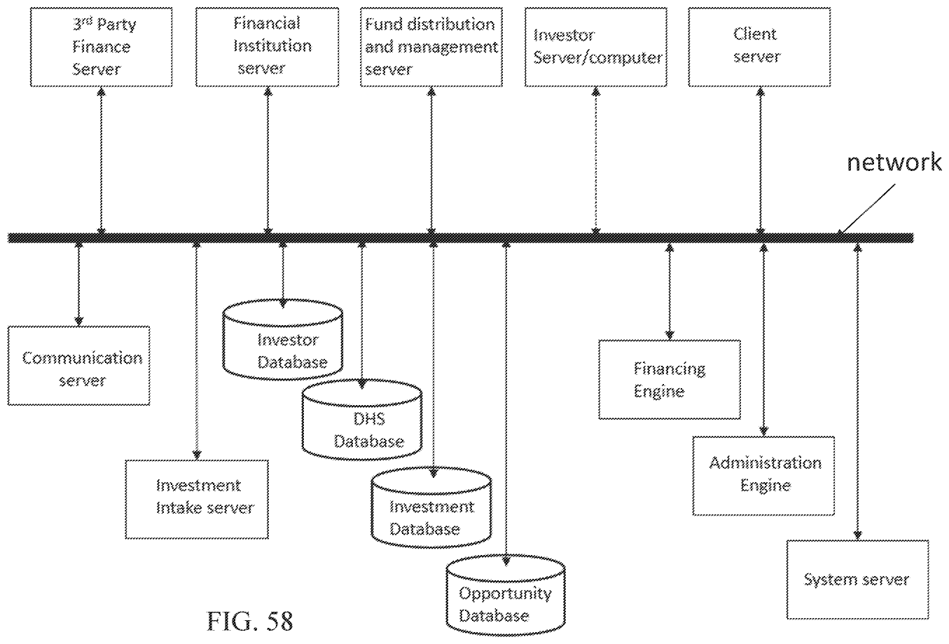

Further, FIG. 58 illustrates a system network for performing the processes of FIGS. 56-57 in accordance with some embodiments of the invention. In some embodiments, the server system as shown can comprise system 100 operating on at least one network. In some embodiments, functionally and/or operationally coupled to the network can be a plurality of servers and/or databases, and/or processes comprising an infrastructure enabling a system provider to identify, obtain, distribute, and manage financing using any of the investment processes described earlier. Some embodiments can include all the plurality of servers and/or databases, and/or processes shown. Other embodiments can exclude one or more of the servers, and/or databases, and/or processes shown. Some further embodiments can include one or more additional conventional servers and/or databases, and/or processes shown.

Some embodiments include at least one communication server configured for managing investment related communications. Some embodiments include at least one investment intake server configured to manage investment intake. Some further embodiments include at least one financing engine configured to process and manage investment financing. Some embodiments include at least one administration engine configured for administering one or more processes of the system. Some embodiments include at least one system server comprising a system provider. Some embodiments include one or more coupled databases, including, but not limited to, at least one investor database, at least one DHS database, at least one investment database, and at least one opportunity database.

In some embodiments, as shown in FIGS. 25-26, upon obtaining a USCIS order for the recapture of up to 200,000 unused EB-5 visas for the System Provider program, System Provider will raise debt financing to fund System Provider Credit Facility for Boeing® or Airbus® (or other company) customers. In some embodiments, the System Provider Credit Facility is based on the USCIS order to recapture up to or over 200,000 unused EB-5 visas itself and it is not necessary that System Provider receives EB-5 funding prior to structuring the System Provider Credit Facility. In some embodiments, the System Provider EB-5 funding is used to reduce the cost of capital, including debt financing, for predelivery payments and delivery financing for Boeing® customers.

In some embodiments, as shown in FIGS. 25-26, upon obtaining a USCIS order for the recapture of up to 200,000 unused EB-5 visas for the System Provider program, System Provider will raise debt financing to fund System Provider Credit Facility for Boeing® or Airbus® (or other company) customers. In some embodiments, the System Provider Credit Facility is based on the USCIS order to recapture up to or over 200,000 unused EB-5 visas itself and it is not necessary that System Provider receives EB-5 funding prior to structuring the System Provider Credit Facility. In some embodiments, the System Provider EB-5 funding is used to reduce the cost of capital, including debt financing, for predelivery payments and delivery financing for Boeing® customers.

In some embodiments, as shown in FIGS. 27-28, upon obtaining a USCIS order for EB-5 visas for the System Provider program, System Provider will raise debt financing to fund System Provider Credit Facility for U.S. Aerospace customers. In some embodiments, the System Provider Credit Facility is based on the USCIS order for EB-5 visas itself and it is not necessary that System Provider receives EB-5 funding prior to structuring the System Provider Credit Facility. In some embodiments, the System Provider EB-5 funding is used to reduce the cost of capital, including debt financing, for predelivery payments and delivery financing for U.S. Aerospace customers.

In some embodiments, as shown in FIGS. 29-30, upon obtaining a USCIS order for EB-5 visas for the System Provider program, System Provider will raise debt financing to fund System Provider Credit Facility for U.S. infrastructure. In some embodiments, the System Provider Credit Facility is based on the USCIS order for EB-5 visas itself and it is not necessary that System Provider receives EB-5 funding prior to structuring the System Provider Credit Facility. In some embodiments, the System Provider EB-5 funding is used to reduce the cost of capital, including debt financing, for U.S. infrastructure.

In some embodiments, as shown in FIGS. 29-30 upon obtaining a USCIS order for EB-5 visas for the System Provider program, System Provider will raise debt financing to fund System Provider Credit Facility for U.S. and/or infrastructure on a global basis. The System Provider Credit Facility is based on the USCIS order for EB-5 visas itself and it is not necessary that System Provider receives EB-5 funding prior to structuring the System Provider Credit Facility. In some embodiments, the System Provider EB-5 funding is used to reduce the cost of capital, including debt financing, for U.S. and/or global infrastructure.

In some embodiments, as shown in FIGS. 31-32, upon obtaining a USCIS order for EB-5 visas for the System Provider program, System Provider will raise debt financing to fund System Provider Credit Facility for U.S. investment. In some embodiments, the System Provider Credit Facility is based on the USCIS order for EB-5 visas itself and it is not necessary that System Provider receives EB-5 funding prior to structuring the System Provider Credit Facility. In some embodiments, the System Provider EB-5 funding is used to reduce the cost of capital, including debt financing, for U.S. investment.

In some embodiments, as shown in FIGS. 31-32, upon obtaining a USCIS order for EB-5 visas for the System Provider program, System Provider will raise debt financing to fund System Provider Credit Facility for U.S. and/or investment on a global basis. In some embodiments, the System Provider Credit Facility is based on the USCIS order for EB-5 visas itself and it is not necessary that System Provider receives EB-5 funding prior to structuring the System Provider Credit Facility. In some embodiments, the System Provider EB-5 funding is used to reduce the cost of capital, including debt financing, for U.S. and/or global investment.

In some embodiments, as shown in FIG. 39, the system includes Commercial Airplanes, Commercial Satellites, Spacecraft. In some embodiments, $120 billion of EB-5 funding is levered to finance the acquisition of $800 billion of Commercial Airplanes, Commercial Satellites and Spacecraft at list price, purchase price to be determined, creating or preserving 4.6 million jobs, providing the baseline jobs to recapture 200,000 EB-5 visas and the requisite 2 million jobs.

In some embodiments, the system includes U.S. Infrastructure Direct Investment & Credit Enhancement. In some embodiments, $120 billion of EB-5 funding for U.S. infrastructure direct investment and $240 billion of EB-5 funding for credit enhancement and loan guarantees is levered to raise an aggregate of $3.72 trillion, creating approximately 56 million jobs. In some embodiments, funds directly invested in infrastructure projects assume no debt issuance whereas credit enhancement and loan guarantees assume a ratio of 15:1 as provided by the Partnership to Build America Act (H.R. 2084), May 2013. Jobs supported is based on 15,000 jobs per $1 billion in infrastructure investment (U.S. Department of Transportation, Georgetown University, Duke University).

In some embodiments, the system includes U.S. Infrastructure Direct Investment & Credit Enhancement. In some embodiments, up to or over $360 billion of EB-5 funding for credit enhancement and loan guarantees is levered to raise an aggregate of $5.4 trillion, creating approximately 77 million jobs. In some embodiments, funds directly invested in infrastructure projects assume no debt issuance whereas credit enhancement and loan guarantees assume a ratio of 15:1 as provided by the Partnership to Build America Act (H.R. 2084), May 2013. Jobs supported is based on 15,000 jobs per $1 billion in infrastructure investment (U.S. Department of Transportation, Georgetown University, Duke University).

In some embodiments, as shown in FIG. 20, the System Provider parent company is investment-grade, serve as ultimate guarantor for airplanes and infrastructure investment, creating a well-capitalized vertically integrated entity.

In some embodiments, as shown in FIG. 21, the System Provider parent company is investment-grade, serve as ultimate guarantor for satellites and infrastructure investment, creating a well-capitalized vertically integrated entity.

In some embodiments, as shown in FIG. 22, the System Provider parent company is investment-grade, serve as ultimate guarantor for aerospace and infrastructure investment, creating a well-capitalized vertically integrated entity.

Some embodiments include at least one third-party finance server and/or at least one financial institution server configured to handle one or more financial transaction related to any of the investment processes described herein. Some embodiments include at least one fund distribution and management server. Some further embodiments include at least one investor server or computer that can be optionally coupled to the network. Some further embodiments include at least one client server coupled to the network to enable viewing, management, and analysis of client investments achieved through any of the investor financing methods described herein.

In some embodiments, System Provider Topline Scenario-U.S. Investment & U.S. Jobs includes:
Aerospace: $350 billion
Infrastructure: $5.05 Trillion
Total: $5.4 Trillion
Aerospace Jobs: 2,011,450
Infrastructure Jobs: 75,750,000
Total Jobs: 77,761,450
Jos per EB-5 Visa: 389

In some embodiments, System Provider Baseline Scenario-U.S. Investment & U.S. Jobs includes:
Aerospace: $350 billion
Infrastructure: $1.45 Trillion
Total Investment: $1.8 Trillion
Aerospace Jobs: 2,011,450
Infrastructure Jobs: 21,750,000
Total Jobs: 23,761,450
Jos per EB-5 Visa: 119

In some embodiments, System Provider PDP Scenario Level One & Level 2-U.S. Investment & U.S. Jobs includes:
Aerospace: $800 billion
Infrastructure: $3.72 Trillion
Total Investment: $4.52 Trillion
Aerospace Jobs: 4,597,600
Infrastructure Jobs: 55,800,000
Total Jobs: 60,397,600
Jos per EB-5 Visa: 302

Although one or more of the method operations can be described in a specific order, it should be understood that other housekeeping operations can be performed in between operations, or operations can be adjusted so that they occur at slightly different times, or can be distributed in a system which allows the occurrence of the processing operations at various intervals associated with the processing, as long as the processing of the overlay operations are performed in the desired way.

Furthermore, acting as Applicant's own lexicographer, Applicant defines the use of and/or, in terms of “A and/or B,” to mean one option could be “A and B” and another option could be “A or B.” Such an interpretation is consistent with ex parte Gross, where the Board established that “and/or” means element A alone, element B alone, or elements A and B together.

Some embodiments of the system are presented with specific values and/or setpoints. These values and setpoints are not intended to be limiting and are merely examples of a higher configuration versus a lower configuration and are intended as an aid for those of ordinary skill to make and use the system. In addition, “substantially” and “approximately” when used in conjunction with a value encompass a difference of 10% or less of the same unit and scale of that being measured. In some embodiments, “substantially” and “approximately” are defined as presented in the specification.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the description and figures herein.

1-20. (canceled)

21. A system for managing immigrant visa applications comprising:
one or more computers comprising one or more processors and one or more non-transitory computer readable media, the one or more non-transitory computer readable media comprising instructions that when executed by the one or more processors cause the one or more computers to:
receive, by the one or more processors, investment data and immigration data from one or more databases;
identify, by the one or more processors, an investment project associated with the investment data;
identify, by the one or more processors, available visas from the immigration data;
identify, by the one or more processors, job creation requirements associated with the available visas;
estimate, by the one or more processors, a number of jobs created for the investment project;
determine, by the one or more processors, a number of visas from the available visas needed to satisfy the job creation requirements and the number of jobs; and
assign, by the one or more processors, the number of visas to the investment project.

22. The system of claim 21,
wherein the available visas includes investor visas.

23. The system of claim 22,
wherein the available visas includes EB-5 immigrant investor program visas.

24. The system of claim 21,
wherein the investment project satisfies the job creation requirements for one or more EB-5 visas.

25. The system of claim 21,
wherein the one or more non-transitory computer readable media further comprises instructions that when executed by the one or more processors cause the one or more computers to:
receive, by the one or more processors, a current investment portfolio from an investor.

26. The system of claim 25,
wherein the system configured to identify, match, evaluate, score, store, and/or send information regarding investment projects that are similar in risk to an immigrant's current investment portfolio.

27. The system of claim 25,
wherein the system is configured to arrange investments by asset classes.

28. The system of claim 21,
wherein the one or more non-transitory computer readable media further comprises instructions that when executed by the one or more processors cause the one or more computers to:
return, by the one or more processors, a potential investments list that has a highest probability of obtaining an EB-5 visa.

29. The system of claim 21,
wherein the one or more non-transitory computer readable media further comprises instructions that when executed by the one or more processors cause the one or more computers to:
request, by the one or more processors, a recapture of one or more EB-5 visas.

30. The system of claim 21,
wherein the one or more non-transitory computer readable media further comprises instructions that when executed by the one or more processors cause the one or more computers to:
request, by the one or more processors, a processing of one or more EB-5 visas.

31. The system of claim 21,
wherein the one or more non-transitory computer readable media further comprises instructions that when executed by the one or more processors cause the one or more computers to:
determine, by the one or more processors, funds associated with the number of visas.

32. The system of claim 31,
wherein the one or more non-transitory computer readable media further comprises instructions that when executed by the one or more processors cause the one or more computers to:
determine, by the one or more processors, a portion of the funds that will be used for the investment project.

33. The system of claim 32,
wherein the one or more non-transitory computer readable media further comprises instructions that when executed by the one or more processors cause the one or more computers to:
determine, by the one or more processors, a credit enhancement calculation for the investment project.

34. The system of claim 33,
wherein the credit enhancement calculation includes an unused portion of the funds associated with the number of visas.

35. The system of claim 34,
wherein the one or more non-transitory computer readable media further comprises instructions that when executed by the one or more processors cause the one or more computers to:
execute, by the one or more processors, a request for a credit enhancement for the investment project.

36. The system of claim 21,
wherein the one or more non-transitory computer readable media further comprises instructions that when executed by the one or more processors cause the one or more computers to:
receive, by the one or more processors, visa applications from foreign immigrant investors.

37. The system of claim 36,
wherein the one or more non-transitory computer readable media further comprises instructions that when executed by the one or more processors cause the one or more computers to:
execute, by the one or more processors, a national security screening on the foreign immigrant investors.

38. The system of claim 37,
wherein the national security screening includes a background check and an investment source authentication.

39. The system of claim 38,
wherein the one or more non-transitory computer readable media further comprises instructions that when executed by the one or more processors cause the one or more computers to:
receive, by the one or more processors, funds from foreign immigrant investors.

40. The system of claim 39,
wherein the one or more non-transitory computer readable media further comprises instructions that when executed by the one or more processors cause the one or more computers to:
deposit, by the one or more processors, the funds into a project account associated with the investment project.
